(19) United States
(12) Patent Application Publication
(10) Pub. No.: US 2018/0295375 A1
(43) Pub. Date: Oct. 11, 2018

(54) VIDEO PROCESSING AND ENCODING

(71) Applicant: Lyrical Labs Video Compression Technology, LLC, New York, NY (US)

(72) Inventor: Edward Ratner, Iowa City, IA (US)

(21) Appl. No.: 15/480,366

(22) Filed: Apr. 5, 2017

(51) Int. Cl. H04N 19/436; G06T 7/12; G06T 7/13; G06T 7/136; G06T 7/194; G06K 9/62; H04N 19/23

(52) U.S. Cl. CPC H04N 19/436; G06T 7/12; G06T 7/13; G06T 7/136; G06T 7/194; G06K 9/4604; H04N 19/23; G06T 2207/10024; G06T 2207/10016; G06T 2207/20081; G06K 9/6267

(57) ABSTRACT

Embodiments of the present disclosure relate to image processing. In at least one embodiment, a method comprises: receiving the video file; segmenting the video file, determining foreground in the video file, estimating motion in the video file, determining objects in the video file, partitioning the video file and encoding the video file.

### TECHNICAL FIELD

Embodiments of the present disclosure relate to image processing. More specifically, embodiments of the present disclosure relate to processing video information.

### BACKGROUND

Video is ubiquitous on the Internet. In fact, many people today watch video exclusively online. And, according to the latest statistics, almost 90% of Internet traffic is attributable to video. All of this is possible, in part, due to sophisticated video compression. Video compression, thusly, plays an important role in the modern world's communication infrastructure. By way of illustration, uncompressed video at standard resolution (i.e., 640×480) would require 240 Mbps of bandwidth to transmit. This amount of bandwidth, for just a standard video, exceeds significantly the capacity of today's infrastructure and, for that matter, the widely available infrastructure of the foreseeable future.

### SUMMARY

Embodiments of the present disclosure include systems and methods for processing video data. Embodiments utilize segmentation and object analysis techniques to achieve video processing such as, for example, compression and/or encoding with greater efficiency and quality than conventional video processing techniques.

### BRIEF DESCRIPTION OF THE DRAWINGS

FIG. 1 is a block diagram of an illustrative image system 100 having a video processing platform, in accordance with embodiments of the disclosure.

FIG. 2 is a flow diagram depicting an illustrative video processing method 200, in accordance with embodiments of the disclosure.

FIG. 3 is a block diagram of an illustrative video processing platform 300, in accordance with embodiments of the disclosure.

FIG. 4A is an exemplary 640×480 color image.

FIG. 4B is a segmentation map of the color image of FIG. 1A wherein k=3.

FIG. 4C is a segmentation map of the color image of FIG. 1A wherein k=100.

FIG. 4D is a segmentation map of the color image of FIG. 1A wherein k=10,000.

FIG. 5 illustrates an exemplary image segmentation system, in accordance with embodiments of the disclosure.

FIG. 6A is a series of segmentation maps for a block of 160×120 pixels labeled A in the color image of FIG. 4A, wherein k ranges from 1 to 10,000.

FIG. 6B illustrates the weighted uncertainty, U_{w} of the segmentation maps of FIG. 6A as a function of k together with an evaluation performed by a human observer;

FIG. 7A illustrates the classification of training images performed by a human observer for image resolutions of 320×240 and an optimal segmentation line showing a desired segment number versus k.

FIG. 7B illustrates the classification of training images performed by a human observer for image resolutions of 640×480 and an optimal segmentation line showing a desired segment number versus k.

FIG. 8 illustrates an exemplary method for determining a value of k, in accordance with embodiments of the disclosure.

FIG. 9A illustrates the iterative method of estimating k of FIG. 6 for a 160×120 sub-image taken from a 640×480 image in the (log(k), U_{w}) plane, in accordance with embodiments of the disclosure.

FIG. 9B illustrates the corresponding segmentation based on the estimates in FIG. 9A, in accordance with embodiments of the disclosure.

FIG. 10 illustrates another exemplary method for determining a value of k, in accordance with embodiments of the disclosure.

FIG. 11A is an image at 640×480 resolution.

FIG. 11B is a scale map of k(x,y) of the image of FIG. 11A obtained using the method of FIG. 10, in accordance with embodiments of the invention.

FIG. 11C illustrates the corresponding segmentation of FIG. 11A using the method of FIG. 10, in accordance with embodiments of the disclosure.

FIG. 11D illustrates the corresponding segmentation of FIG. 11A using the method of Felzenszwalb and Huttenlocher, in which the scale parameter was chosen to obtain the same number of total segments as in the segmentation depicted in FIG. 11C.

FIG. 12A is an image at 640×480 resolution.

FIG. 12B is a scale map of k(x,y) of the image of FIG. 12A obtained using the method of FIG. 10, in accordance with embodiments of the disclosure.

FIG. 12C illustrates the corresponding segmentation of FIG. 12A using the method of FIG. 10, in accordance with embodiments of the invention.

FIG. 12D illustrates the corresponding segmentation of FIG. 12A using the method of Felzenszwalb and Huttenlocher, in which the same number of total segments were obtained as in the segmentation depicted in FIG. 12C.

FIG. 13 illustrates a method of segmenting a second image based on the segmentation of a first image, in accordance with embodiments of the disclosure.

FIG. 14 is a block diagram depicting an illustrative content delivery system, in accordance with embodiments of the present disclosure.

FIG. 15 is a block diagram illustrating an operating environment (and, in some embodiments, aspects of the present invention), in accordance with embodiments of the present disclosure.

FIG. 16 is a flow diagram depicting an illustrative method of logo identification, in accordance with embodiments of the present disclosure.

FIG. 17 is a flow diagram depicting another illustrative method of logo identification, in accordance with embodiments of the present disclosure.

FIG. 18A is an illustrative image of a video frame, in accordance with embodiments of the present disclosure.

FIG. 18B is an illustrative segment map generated by segmenting the illustrative image of FIG. 18A, in accordance with embodiments of the present disclosure.

FIG. 18C is an illustrative pre-filtered image generated by pre-filtering the image of FIG. 18A based on the segment map of FIG. 18B, in accordance with embodiments of the disclosure.

FIG. 19 is a block diagram illustrating an operating environment (and, in some embodiments, aspects of the present invention), in accordance with embodiments of the present disclosure.

FIG. 20 is a flow diagram depicting an illustrative method of detecting foreground, in accordance with embodiments of the present disclosure.

FIG. 21 is a flow diagram depicting an illustrative method of filtering a Binary Foreground Indication Map (BFIM), in accordance with embodiments of the present disclosure.

FIG. 22 is a flow diagram depicting an illustrative method for foreground detection using a BFIM, in accordance with embodiments of the present disclosure.

FIG. 23 is a flow diagram depicting an illustrative method of filtering a Non-Binary Foreground Indication Map (NBFIM), in accordance with embodiments of the present disclosure.

FIG. 24 is a flow diagram depicting an illustrative method for foreground detection using an NBFIM, in accordance with embodiments of the present disclosure.

FIGS. 25A-25W depict aspects of an exemplary implementation of a method for detecting foreground in a video frame using a BFIM, in accordance with embodiments of the present disclosure.

FIGS. 26A-26W depict aspects of another exemplary implementation of a method for detecting foreground in a video frame using a BFIM, in accordance with embodiments of the present disclosure.

FIGS. 27-33 depict aspects of an exemplary implementation of a method for detecting foreground in a video frame using an NBFIM, in accordance with the subject matter disclosed herein.

FIG. 34 is a block diagram of an operating environment, in accordance with embodiments of the subject matter disclosed herein.

FIG. 35 is a flow diagram depicting an illustrative multi-view motion estimation method, in accordance with embodiments of the subject matter disclosed herein.

FIG. 36 is a flow diagram depicting an illustrative motion vector extrapolation method, in accordance with embodiments of the subject matter disclosed herein.

FIG. 37 is a block diagram of an illustrative motion vector transformation, in accordance with embodiments of the subject matter disclosed herein.

FIGS. 38A and 38B are schematic diagrams depicting a prior art graph partitioning concept.

FIG. 38C is a schematic diagram depicting a graph partitioning concept, in accordance with embodiments of the subject matter disclosed herein.

FIG. 39 is a block diagram illustrating an operating environment, in accordance with embodiments of the subject matter disclosed herein.

FIG. 40 is a flow diagram depicting an illustrative method of identifying clusters of segments in a video scene, in accordance with embodiments of the subject matter disclosed herein.

FIG. 41 is a flow diagram depicting an illustrative method of partitioning an undirected weighted graph, in accordance with embodiments of the subject matter disclosed herein.

FIG. 42 is a flow diagram depicting an illustrative method of selecting source and drain vertices, in accordance with embodiments of the subject matter disclosed herein.

FIGS. 43A and 43B are schematic diagrams of a capacity graph, depicting an illustrative graph partitioning operation, in accordance with embodiments of the subject matter disclosed herein.

FIG. 44 is a block diagram illustrating an operating environment (and, in some embodiments, aspects of the present invention), in accordance with embodiments of the subject matter disclosed herein.

FIG. 45 is a schematic block diagram depicting an illustrative process for pattern recognition using object classification, in accordance with embodiments of the subject matter disclosed herein.

FIG. 46 is a flow diagram depicting an illustrative method of pattern recognition training using object classification, in accordance with embodiments of the subject matter disclosed herein.

FIG. 47 is a flow diagram depicting an illustrative method of object classification training, in accordance with embodiments of the subject matter disclosed herein.

FIG. 48 is a flow diagram depicting an illustrative method of object classification, in accordance with embodiments of the subject matter disclosed herein.

FIGS. 49A and 49B are graphs depicting illustrative classification distributions, in accordance with embodiments of the subject matter disclosed herein.

FIG. 50 is a block diagram of an operating environment, in accordance with embodiments of the subject matter disclosed herein.

FIG. 51 is a flow diagram depicting an illustrative multi-view object registration method, in accordance with embodiments of the subject matter disclosed herein.

FIG. 52 is a flow diagram depicting another illustrative multi-view object registration method, in accordance with embodiments of the subject matter disclosed herein.

FIG. 53 is a block diagram of an operating environment, in accordance with embodiments of the subject matter disclosed herein.

FIG. 54 is a flow diagram depicting a metatagging method, in accordance with embodiments of the subject matter disclosed herein.

FIG. 55 is a flow diagram depicting an illustrative object classification method, in accordance with embodiments of the subject matter disclosed herein.

FIG. 56 includes images illustrating a metatagging method, in accordance with embodiments of the subject matter disclosed herein.

FIG. 57 is a block diagram illustrating an operating environment (and, in some embodiments, aspects of the present invention), in accordance with embodiments of the subject matter disclosed herein.

FIG. 58 is a flow diagram depicting an illustrative method of encoding video, in accordance with embodiments of the subject matter disclosed herein.

FIG. 59 is a flow diagram depicting an illustrative method of partitioning a video frame, in accordance with embodiments of the subject matter disclosed herein.

FIG. 60 is a flow diagram depicting an illustrative method of encoding video, in accordance with embodiments of the subject matter disclosed herein.

FIG. 61 is a flow diagram depicting another illustrative method of partitioning a video frame, in accordance with embodiments of the subject matter disclosed herein.

FIG. 62 illustrates an exemplary video encoding system, in accordance with embodiments of the subject matter disclosed herein.

FIG. 63 illustrates an exemplary operation conducted by the system of FIG. 62, in accordance with embodiments of the subject matter disclosed herein.

FIG. 64 illustrates another exemplary operation conducted by the system of FIG. 62, in accordance with embodiments of the subject matter disclosed herein.

FIG. 65 illustrates another exemplary operation conducted by the system of FIG. 62, in accordance with embodiments of the subject matter disclosed herein.

FIG. 66 illustrates another exemplary operation conducted by the system of FIG. 62, in accordance with embodiments of the subject matter disclosed herein.

FIGS. 67A-67C illustrate exemplary video frames suitable for encoding, in accordance with embodiments of the subject matter disclosed herein.

FIGS. 68A-68C illustrate the frames of 6a-c after being processed to create segments therein, in accordance with embodiments of the subject matter disclosed herein.

FIGS. 69A-69C illustrate objects formed from the segments of FIGS. 68A-68C and partitioning blocks, in accordance with embodiments of the subject matter disclosed herein.

FIG. 70 illustrates an exemplary video encoding system in communication with a plurality of clients, in accordance with embodiments of the subject matter disclosed herein.

FIG. 71 illustrates an exemplary client computing system, in accordance with embodiments of the subject matter disclosed herein.

FIG. 72 illustrates an exemplary video encoding manager of the video encoding system of FIG. 70, in accordance with embodiments of the subject matter disclosed herein.

FIG. 73 illustrates a flow diagram for video encoding, in accordance with embodiments of the subject matter disclosed herein.

FIG. 74 illustrates an exemplary master worker instance of the video encoding system of FIG. 70, in accordance with embodiments of the subject matter disclosed herein.

FIG. 75 illustrates an exemplary worker instance of the video encoding system of FIG. 70, in accordance with embodiments of the subject matter disclosed herein.

FIG. 76 illustrates an exemplary embodiment of the video encoding system of FIG. 7, in accordance with embodiments of the subject matter disclosed herein.

FIG. 77 illustrates the interaction between a plurality of clients and a computer system of the video encoding manager through a messaging system, in accordance with embodiments of the subject matter disclosed herein.

FIG. 78 illustrates the interaction between a plurality of clients and a file transfer system of the video encoding system, in accordance with embodiments of the subject matter disclosed herein.

FIG. 79 illustrates the interaction between a master worker instance of the video encoding system and a file transfer system of the video encoding system, in accordance with embodiments of the subject matter disclosed herein.

FIG. 80 illustrates the interaction between the file transfer system of the video encoding system and an output directory of one of the clients of FIG. 76, in accordance with embodiments of the subject matter disclosed herein.

FIG. 81 illustrates an exemplary processing of the video encoding system of FIG. 70, in accordance with embodiments of the subject matter disclosed herein.

While the disclosed subject matter is amenable to various modifications and alternative forms, specific embodiments have been shown by way of example in the drawings and are described in detail below. The intention, however, is not to limit the subject matter disclosed herein to the particular embodiments described. On the contrary, the disclosure is intended to cover all modifications, equivalents, and alternatives falling within the scope of the subject matter disclosed herein, and as defined by the appended claims.

As used herein in association with values (e.g., terms of magnitude, measurement, and/or other degrees of qualitative and/or quantitative observations that are used herein with respect to characteristics (e.g., dimensions, measurements, attributes, components, etc.) and/or ranges thereof, of tangible things (e.g., products, inventory, etc.) and/or intangible things (e.g., data, electronic representations of currency, accounts, information, portions of things (e.g., percentages, fractions), calculations, data models, dynamic system models, algorithms, parameters, etc.), “about” and “approximately” may be used, interchangeably, to refer to a value, configuration, orientation, and/or other characteristic that is equal to (or the same as) the stated value, configuration, orientation, and/or other characteristic or equal to (or the same as) a value, configuration, orientation, and/or other characteristic that is reasonably close to the stated value, configuration, orientation, and/or other characteristic, but that may differ by a reasonably small amount such as will be understood, and readily ascertained, by individuals having ordinary skill in the relevant arts to be attributable to measurement error; differences in measurement and/or manufacturing equipment calibration; human error in reading and/or setting measurements; adjustments made to optimize performance and/or structural parameters in view of other measurements (e.g., measurements associated with other things); particular implementation scenarios; imprecise adjustment and/or manipulation of things, settings, and/or measurements by a person, a computing device, and/or a machine; system tolerances; control loops; machine-learning; foreseeable variations (e.g., statistically insignificant variations, chaotic variations, system and/or model instabilities, etc.); preferences; and/or the like.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. However, certain embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

The terms “up,” “upper,” and “upward,” and variations thereof, are used throughout this disclosure for the sole purpose of clarity of description and are only intended to refer to a relative direction (i.e., a certain direction that is to be distinguished from another direction), and are not meant to be interpreted to mean an absolute direction. Similarly, the terms “down,” “lower,” and “downward,” and variations thereof, are used throughout this disclosure for the sole purpose of clarity of description and are only intended to refer to a relative direction that is at least approximately opposite a direction referred to by one or more of the terms “up,” “upper,” and “upward,” and variations thereof.

### DETAILED DESCRIPTION

Embodiments of the disclosure include systems and methods for processing video data. According to embodiments, processing video data may include, for example, any number of different techniques, processes, and/or the like for performing one or more operations on video data. For example, in embodiments, processing video data may include compressing video data, encoding video data, transcoding vide data, analyzing video data, indexing features of video data, delivering (transporting) video data, and/or the like. In embodiments, video data may include any information associated with video content, such as, for example, image data, metadata, raw video information, compressed video information, encoded video information, view information, camera information (e.g., camera position information, camera angle information, camera settings, etc.), object information, segmentation information, encoding instructions (e.g., requested encoding formats and/or parameters), object group information, feature information, object information, quantization information, time information (e.g., time codes, markers, presentation time stamps (PTSs), decoding time stamps (DTSs), program clock references (PCRs), GPS time stamps, other times of reference time stamps, etc.), frame index information (e.g., information configured to facilitate reconstruction of a video file such as, e.g., information associated with the order of video frames, etc.), and/or the like.

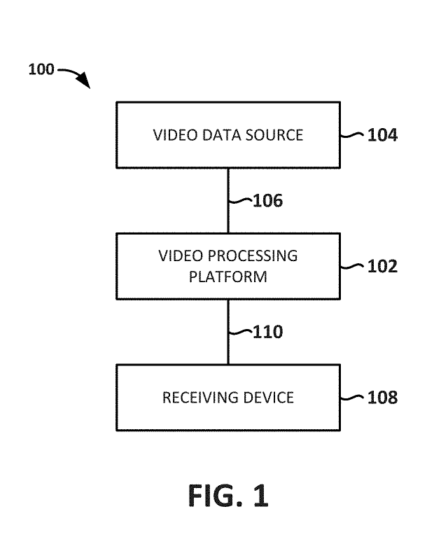

FIG. 1 depicts an illustrative media system 100 having a video processing platform 102. The video processing platform 102 is illustratively coupled to a video data source 104 by a communication link 106. In embodiments, the video processing platform 102 illustratively receives video data (e.g., a video file, an image file, etc.) from the video data source 104 over the communication link 106. Exemplary image files include, but are not limited to, digital photographs, digital image files from medical imaging, machine vision image files, video files, video information, and/or the like.

Video processing platform 102 is illustratively coupled to a receiving device 108 by a communication link 110. Although not illustrated herein, the receiving device 108 may include any combination of components described herein with reference to the video processing platform 102, components not shown or described, and/or combinations of these. In embodiments, the video processing platform 102 communicates video data over the communication link 110. The term “communication link” may refer to an ability to communicate some type of information in at least one direction between at least two devices, and is not meant to be limited to a direct, persistent, or otherwise limited communication channel. That is, according to embodiments, one or more of the communication links 106 and 110 may be a persistent communication link, an intermittent communication link, an ad-hoc communication link, and/or the like. The communication links 106 and/or 110 may refer to direct communications between the video image source 104 and the video processing platform 102, and between the video processing platform 102 and the receiving device 108, respectively, /or indirect communications that travel between the devices via at least one other device (e.g., a repeater, router, hub, and/or the like).

In embodiments, communication links 106 and/or 110 are, include, or are included in, a wired network, a wireless network, or a combination of wired and wireless networks. In embodiments, one or both of communication links 106 and 110 include a network. Illustrative networks include any number of different types of communication networks such as, a short messaging service (SMS), a local area network (LAN), a wireless LAN (WLAN), a wide area network (WAN), the Internet, a P2P network, or other suitable networks. The network may include a combination of multiple networks.

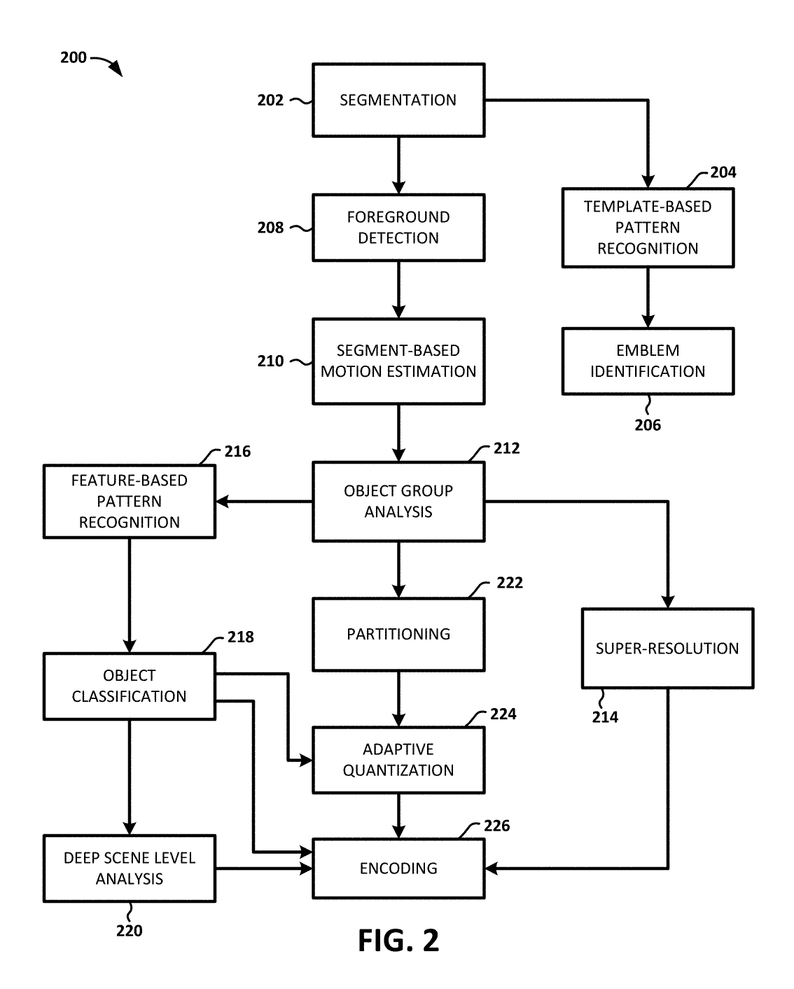

According to embodiments, the video processing platform 102 may be, include, be similar to, or be included in any one or more of a video encoding system, a video compression system, a video optimization system, a video analysis system, a video search system, a video index system, a content delivery network (CDN), a video-on-demand (VOD) system, a digital video recorder (DVR), a cloud DVR, a mobile video system, and/or the like. According to embodiments, the video processing platform 102 may include any number of different video processing technologies. For example, the video processing platform 102 may include number of different hardware, software, and/or firmware components configured to perform aspects of embodiments of the process 200 depicted in FIG. 2 and described below.

According to embodiments, the video processing platform 102 may be, include, be similar to, or be included in, any number of different aspects (or combinations thereof) of embodiments of the systems and methods described in U.S. application Ser. No. 13/428,707, filed Mar. 23, 2012, entitled “VIDEO ENCODING SYSTEM AND METHOD;” U.S. Provisional Application No. 61/468,872, filed Mar. 29, 2011, entitled “VIDEO ENCODING SYSTEM AND METHOD;” U.S. application Ser. No. 13/868,749, filed Apr. 23, 2013, entitled “MACROBLOCK PARTITIONING AND MOTION ESTIMATION USING OBJECT ANALYSIS FOR VIDEO COMPRESSION,” and issued on Sep. 20, 2016, as U.S. Pat. No. 9,451,253; U.S. application Ser. No. 15/269,960, filed Sep. 19, 2016, entitled “MACROBLOCK PARTITIONING AND MOTION ESTIMATION USING OBJECT ANALYSIS FOR VIDEO COMPRESSION;” U.S. Provisional Application No. 61/646,479, filed May 14, 2012, entitled “MACROBLOCK PARTITIONING AND MOTION ESTIMATION USING OBJECT ANALYSIS FOR VIDEO COMPRESSION;” U.S. Provisional Application No. 61/637,447, filed Apr. 24, 2012, entitled “MACROBLOCK PARTITIONING AND MOTION ESTIMATION USING OBJECT ANALYSIS FOR VIDEO COMPRESSION;” U.S. application Ser. No. 14/696,255, filed Apr. 24, 2015, entitled “METHOD AND SYSTEM FOR UNSUPERVISED IMAGE SEGMENTATION USING A TRAINED QUALITY METRIC,” and issued on Nov. 22, 2016, as U.S. Pat. No. 9,501,837; U.S. application Ser. No. 15/357,906, filed Nov. 21, 2016, entitled “METHOD AND SYSTEM FOR UNSUPERVISED IMAGE SEGMENTATION USING A TRAINED QUALITY METRIC;” U.S. Provisional Application No. 62/132,167, filed Mar. 12, 2015, entitled “TRAINING BASED MEASURE FOR SEGMENTATION QUALITY AND ITS APPLICATION;” U.S. Provisional Application No. 62/058,647, filed Oct. 1, 2014, entitled “A TRAINING BASED MEASURE FOR SEGMENTATION QUALITY AND ITS APPLICATION;” U.S. application Ser. No. 14/737,401, filed Jun. 11, 2015, entitled “LEARNING-BASED PARTITIONING FOR VIDEO ENCODING;” U.S. Provisional Application No. 62/042,188, filed Aug. 26, 2014, entitled “LEARNING-BASED PARTITIONING FOR VIDEO ENCODING;” U.S. application Ser. No. 14/737,418, filed Jun. 11, 2015, entitled “FOREGROUND DETECTION USING FRACTAL DIMENSIONAL MEASURES;” U.S. Provisional Application No. 62/134,534, filed Mar. 17, 2015, entitled “FOREGROUND DETECTION USING FRACTAL DIMENSIONAL MEASURES;” U.S. application Ser. No. 15/237,048, filed Aug. 15, 2016, entitled “OBJECT CATEGORIZATION USING STATISTICALLY-MODELED CLASSIFIER OUTPUTS;” U.S. Provisional Application No. 62/204,925, filed Aug. 13, 2015, entitled “OBJECT CATEGORIZATION USING STATISTICALLY-MODELED CLASSIFIER OUTPUTS;” and/or U.S. Provisional Application No. 62/368,853, filed Jul. 29, 2016, entitled “LOGO IDENTIFICATION;” the entirety of each of which is hereby incorporated herein by reference for all purposes.

The illustrative system 100 shown in FIG. 1 is not intended to suggest any limitation as to the scope of use or functionality of embodiments of the present disclosure. Neither should the illustrative system 100 be interpreted as having any dependency nor requirement related to any single component or combination of components illustrated therein. Additionally, various components depicted in FIG. 1 may be, in embodiments, integrated with various ones of the other components depicted therein (and/or components not illustrated), all of which are considered to be within the ambit of the present disclosure.

FIG. 2 is a flow diagram depicting an illustrative video processing process 200, in accordance with embodiments of the disclosure. In embodiments, aspects of the process 200 may be performed by a video processing platform (e.g., the video processing platform 102 depicted in FIG. 1). For example, aspects of embodiments of the process 200 may be performed by one or more computing devices such as, for example, one or more video processing devices, one or more video encoding devices, and/or the like. Embodiments of the process 200 may be configured to process video data such as, for example, by analyzing video data, compressing video data, encoding video data, transcoding video data, and/or the like. In embodiments, video data may include one or more video feeds, which may be referred to herein, interchangeably, as “video streams” and “video files.” For example, in embodiments, a scene recorded by a camera from a viewpoint may be referred to herein as a video feed and the scene recorded by multiple cameras from multiple viewpoints may be referred to herein as video feeds. Each video feed includes a plurality of video frames.

Embodiments of the process 200 include a segmentation process 202. According to embodiments, the segmentation process 202 may include any number of different image segmentation techniques, algorithms, and/or the like. In embodiments, for example, the segmentation process 202 is configured to be used to segment images (e.g., video frames) to generate segmentation information. Segmentation information may include any information associated with a segmentation of an image such as, for example, identification of segments (e.g., segment boundaries, segment types, etc.), segment maps, and/or the like.

According to embodiments, the segmentation process 202 may be performed to segment a video frame into a number of segments. The segments may include, for example, objects, groups, slices, tiles, and/or the like. The segmentation process 202 may include any number of various automatic image segmentation methods known in the field. In embodiments, the segmentation process 202 may use image color and corresponding gradients to subdivide an image into segments that have similar color and texture. Two examples of image segmentation techniques include the watershed algorithm and optimum cut partitioning of a pixel connectivity graph. For example, the segmentation process 202 may include Canny edge detection for detecting edges on a video frame for optimum cut partitioning, and may create segments using the optimum cut partitioning of the resulting pixel connectivity graph. In embodiments, the segmentation process may be, be similar to, include or be included in, aspects of embodiments of the segmentation techniques described in U.S. application Ser. No. 14/696,255, filed Apr. 24, 2015, entitled “METHOD AND SYSTEM FOR UNSUPERVISED IMAGE SEGMENTATION USING A TRAINED QUALITY METRIC,” the entirety of which is incorporated herein by reference for all purposes.

Embodiments of process 200 may include a template-based pattern recognition process 204. According to embodiments, the template-based pattern recognition process 204 may be, include, be similar to, or be included in, any number of different techniques, algorithms, and/or the like, configured to perform template-based pattern recognition on an image. According to embodiments, the process 200 may include an emblem identification process 206, which may be facilitated by template-based pattern recognition information generated by the template-based pattern recognition process 204. In embodiments, the emblem identification process 206 may be, be similar to, include, or be included in, aspects of embodiments of the logo identification techniques described in U.S. Application Ser. No. 62/368,853, filed Jul. 29, 2016, entitled “LOGO IDENTIFICATION,” the entirety of which is hereby incorporated herein by reference for all purposes.

Embodiments of the process 200 may include a foreground detection process 208. According to embodiments, the foreground detection process 208 may be, include, be similar to, or be included in, any number of different techniques, algorithms, and/or the like, configured to perform foreground and/or background detection on an image. For example, in embodiments, the foreground detection process 208 may include segment-based foreground detection, where the foreground segments, or portions of the segments, determined in the segmentation process 202 are detected using one or more aspects of embodiments of the methods described herein. In embodiments, the foreground detection process 208 may include foreground detection on images that have not been segmented. In embodiments, the foreground detection process 208 may be, be similar to, include, or be included in, aspects of embodiments of the foreground detection techniques described in U.S. application Ser. No. 14/737,418, filed Jun. 11, 2015, entitled “FOREGROUND DETECTION USING FRACTAL DIMENSIONAL MEASURES,” the entirety of which is hereby incorporated herein by reference for all purposes.

Embodiments of the process 200 may include a segment-based motion estimation process 210. According to embodiments, the segment-based motion estimation process 210 may be, include, be similar to, or be included in, any number of different techniques, algorithms, and/or the like, configured to perform motion estimation on an image. For example, in embodiments, the segment-based motion estimation process 210 may include any number of various motion estimation techniques known in the field. Two examples of motion estimation techniques are optical pixel flow and feature tracking. As an example, the segment-based motion estimation process 210 may include feature tracking in which Speeded Up Robust Features (SURF) are extracted from both a source image (e.g., a source frame) and a subsequent image (e.g., a subsequent frame). The individual features of the two images may then be compared using a Euclidean metric to establish a correspondence between features, thereby generating a motion vector for each feature. In embodiments, a motion vector for a segment may be the median of all of the motion vectors for each of the segment's features. After a motion vector for a segment is determined, each segment may be categorized based on its motion properties. For example, a segment may be categorized as either moving or stationary.

Embodiments of the process 200 may include an object group analysis process 212. According to embodiments, the object group analysis process 212 may be, include, be similar to, or be included in, any number of different techniques, algorithms, and/or the like, configured to perform analysis and/or tracking of one or objects in video data. For example, in embodiments, the object group analysis process 212 may be configured to identify, using a segment map and/or motion vectors, the presence of objects (e.g., clusters of segments that move together, or at least approximately together) within digital images such as, for example, frames of video. In embodiments, object group analysis process 212 may be configured to identify and/or analyze only objects that are moving within a particular scene. In embodiments, the object group analysis process 212 may include object analysis on images that have not been segmented.

Embodiments of the process 200 may include a super-resolution process 214. According to embodiments, the super-resolution process 214 may be, include, be similar to, or be included in, any number of different techniques, algorithms, and/or the like, configured to perform super-resolution upscaling video, encoding video, enhancing video and/or the like. In embodiments, the super-resolution process 214 may be, be similar to, include, or be included in, aspects of embodiments of the super-resolution techniques described in U.S. Pat. No. 8,958,484, issued Feb. 17, 2015, entitled “ENHANCED IMAGE AND VIDEO SUPER-RESOLUTION PROCESSING;” and/or U.S. Pat. No. 8,861,893, issued Oct. 14, 2014, entitled “ENHANCING VIDEO USING SUPER-RESOLUTION,” the entirety of which is hereby incorporated herein by reference for all purposes.

Embodiments of the process 200 may include a feature-based pattern recognition process 216. According to embodiments, the feature-based pattern recognition process 216 may be, include, be similar to, or be included in, any number of different techniques, algorithms, and/or the like, configured to perform feature-based pattern recognition on an image. According to embodiments, feature-based pattern recognition information may be used to facilitate object classification.

Embodiments of the process 200 may include an object classification process 216. According to embodiments, the object classification process 216 may be, include, be similar to, or be included in, any number of different techniques, algorithms, and/or the like, configured to perform classification of objects in video data. For example, in embodiments, the object classification process 216 may include one or more classifiers configured to classify objects within video data. That is, for example, the one or more classifiers may be configured to receive any number of different inputs such as, for example, video data, segmentation information associated with the video data, motion information associated with the video data, object group information associated with the video data, and/or feature-based pattern recognition information, and may be configured to use aspects of the received information to classify objects in the video data. Classifying an object in video data may include, for example, identifying the existence of an object, determining and/or tracking the location of the object, determining and/or tracking the motion of the object, determining a class to which the object belongs (e.g., determining whether the object is a person, an animal, an article of furniture, etc.), developing an object profile (e.g., a set of information corresponding to the object such as, e.g., characteristics of the object) corresponding to an identified object, and/or the like.

In embodiments, the object classification process 216 may be, be similar to, include, or be included in, aspects of embodiments of the object classification techniques described in U.S. application Ser. No. 15/237,048, filed Aug. 15, 2016, entitled “OBJECT CATEGORIZATION USING STATISTICALLY-MODELED CLASSIFIER OUTPUTS,” the entirety of which is hereby incorporated herein by reference for all purposes.

Embodiments of the process 200 may include a deep scene level analysis process 220. According to embodiments, the deep scene level analysis process 220 may be, include, be similar to, or be included in, any number of different techniques, algorithms, and/or the like, configured to perform analysis, indexing, metatagging, labelling, and/or the like, associated with video data (e.g., a video scene). For example, in embodiments, the deep scene level analysis process 220 may include analyzing video data to identify characteristics of a video scene (e.g., identification of objects in the scene, characteristics of the objects, behavior of the objects, characteristics of foreground/background features, characteristics of segmentation of the images of the video data, characteristics of motion of segments and/or objects in the scene, etc.). According to embodiments, characteristics of a video scene may be captured using a metatagging (referred to herein, interchangeably, as “labeling”) procedure. In embodiments, information resulting from a metatagging procedure may be referred to, for example, as “metadata.” In embodiments such metadata may be stored as a file, in a database, and/or the like.

Embodiments of the process 200 may include a partitioning process 222. According to embodiments, the partitioning process 222 may be, include, be similar to, or be included in, any number of different techniques, algorithms, and/or the like, configured to perform partitioning of video frames for encoding (e.g., macroblock partitioning). For example, the partitioning process 222 may include machine-learning techniques, and/or macroblock partitioning using biased cost calculations so as to encourage separation of objects among macroblock partitions. In embodiments, the partitioning process 222 may be, be similar to, include, or be included in, aspects of embodiments of the partitioning techniques described in U.S. application Ser. No. 14/737,401, filed Jun. 11, 2015, entitled “LEARNING-BASED PARTITIONING FOR VIDEO ENCODING” and/or U.S. application Ser. No. 13/868,749, filed Apr. 23, 2013, entitled “MACROBLOCK PARTITIONING AND MOTION ESTIMATION USING OBJECT ANALYSIS FOR VIDEO COMPRESSION;” the entirety of each of which is hereby incorporated herein by reference for all purposes.

Embodiments of the process 200 may include an adaptive quantization process 224. According to embodiments, the adaptive quantization process 224 may be, include, be similar to, or be included in, any number of different techniques, algorithms, and/or the like, configured to perform adaptive quantization for encoding. For example, in embodiments, an encoder may be configured to perform adaptive quantization and encoding that may utilize metadata, as described herein, to facilitate efficient encoding.

Embodiments of the process 200 may include an encoding process 226. According to embodiments, the encoding process 226 may be, include, be similar to, or be included in, any number of different techniques, algorithms, and/or the like, configured to perform encoding of video data. In embodiments, the encoding process 226 may be, be similar to, include, or be included in, aspects of embodiments of the encoding techniques described in U.S. application Ser. No. 13/428,707, filed Mar. 23, 2012, entitled “VIDEO ENCODING SYSTEM AND METHOD;” the entirety of each of which is hereby incorporated herein by reference for all purposes.

According to embodiments, any number of different aspects of one or more of the sub-processes (also referred to herein, interchangeably, as processes) of the illustrative process 200 may be performed in various implementations. In this manner, for example, embodiments of the process 200 may be implemented by a video processing platform (e.g., the video processing platform 102 depicted in FIG. 2) to facilitate providing various products and/or services. Embodiments include a configurable software-based video processing platform (e.g., the video processing platform 102 depicted in FIG. 1) having a number of modular program components that may be selectively combined to form various products and/or services (referred to collectively and interchangeably herein as “use cases” and “implementations”). In embodiments, for example, each program component (or a combination of program components) may be configured to perform embodiments of one or more of the processes depicted in FIG. 2.

For example, in embodiments, an illustrative video processing platform (e.g., the video processing platform 102 depicted in FIG. 2) may be implemented as a video encoding device and/or service. In embodiments, an illustrative video processing platform may be implemented as a video search/query service, an image segmentation service, a video analysis service (e.g., for analyzing, tracking, etc. objects in video), an ad provisioning service, a logo identification service, and/or the like. In embodiments, for example, a video processing platform implemented as an encoder may be configured to perform processes 202, 208, 210, 212, 216, 218, 222, 224, and 226, while a video processing platform implemented as a video search/query service may be configured to perform processes 202, 208, 210, 212, 216, 218, and 220. Any number of different implementations of embodiments of the subject matter disclosed herein may be configured to implement any number of different aspects of embodiments of the process 200 depicted in FIG. 2, including any number of different combinations thereof. Similarly, in embodiments, a video processing platform (e.g., the video processing platform 102 depicted in FIG. 1) may be configured to be used within the context of any number of different network environments and/or content delivery arrangements. For example, embodiments of the video processing platform and process described herein may be implemented to provide encoding, compression, and/or optimization of video data in an over-the-top (OTT) arrangement, a direct-to-consumer arrangement, a digital video recorder (DVR), a cloud-based DVR, a TV everywhere arrangement, a just-in-time packaging (JITP) arrangement, a just-in-time transcoding (JITT) arrangement, and/or the like.

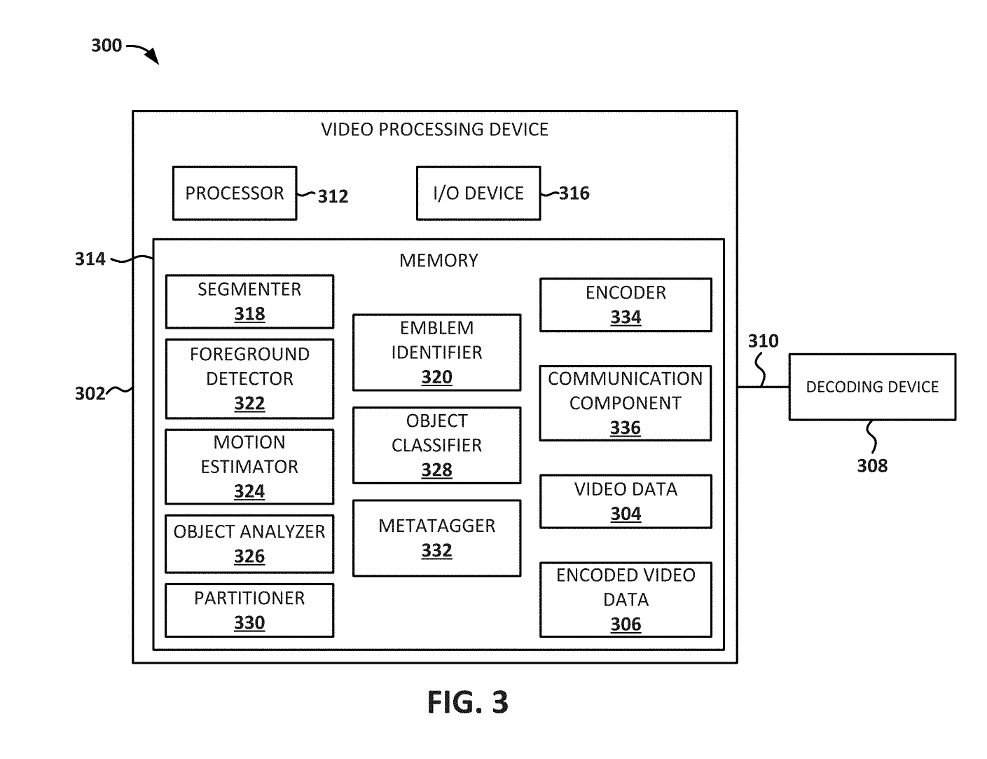

FIG. 3 is a block diagram depicting an illustrative operating environment 300, in accordance with embodiments of the subject matter disclosed herein. According to embodiments, the illustrative operating environment 300 may be, be similar to, include, or be included in, the content delivery system 100 depicted in FIG. 1. The operating environment 300 includes a video processing device 302 that may be configured to process video data 304. For example, in embodiments, the video processing device 302 may be configured to encode the video data 304 to create encoded video data 306. The video processing device 302 may be, include, be similar to, or be included in the video processing platform 102 depicted in FIG. 1.

As shown in FIG. 3, the video processing device 302 may also be configured to communicate the encoded video data 306 to a decoding device 308 via a communication link 310. In embodiments, the decoding device 308 may be, include, be similar to, or be included in the receiving device 108 depicted in FIG. 1. In embodiments, the communication link 310 may be, include, be similar to, or be included in, the communication links 106 and/or 110 depicted in FIG. 1.

As shown in FIG. 3, the video processing device 302 may be implemented on a computing device that includes a processor 312, a memory 314, and an input/output (I/O) device 316. Although the video processing device 302 is referred to herein in the singular, the video processing device 302 may be implemented in multiple instances, distributed across multiple computing devices, instantiated within multiple virtual machines, and/or the like. In embodiments, the processor 312 executes various program components stored in the memory 314, which may facilitate processing the video data 304. In embodiments, the processor 312 may be, or include, one processor or multiple processors. In embodiments, the I/O device 316 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

According to embodiments, as indicated above, various components of the operating environment 300, illustrated in FIG. 3, may be implemented on one or more computing devices. A computing device may include any type of computing device suitable for implementing embodiments of the invention. Examples of computing devices include specialized computing devices or general-purpose computing devices such as “workstations,” “servers,” “laptops,” “desktops,” “tablet computers,” “hand-held devices,” and the like, all of which are contemplated within the scope of FIG. 3 with reference to various components of the operating environment 300. For example, according to embodiments, the video processing device 302 (and/or the decoding device 308) may be, or include, a general purpose computing device (e.g., a desktop computer, a laptop, a mobile device, and/or the like), a specially-designed computing device (e.g., a dedicated video encoding device), and/or the like. Additionally, although not illustrated herein, the decoding device 308 may include any combination of components described herein with reference to the video processing device 302, components not shown or described, and/or combinations of these.

In embodiments, a computing device includes a bus that, directly and/or indirectly, couples the following devices: a processor, a memory, an input/output (I/O) port, an I/O component, and a power supply. Any number of additional components, different components, and/or combinations of components may also be included in the computing device. The bus represents what may be one or more busses (such as, for example, an address bus, data bus, or combination thereof). Similarly, in embodiments, the computing device may include a number of processors, a number of memory components, a number of I/O ports, a number of I/O components, and/or a number of power supplies. Additionally any number of these components, or combinations thereof, may be distributed and/or duplicated across a number of computing devices.

In embodiments, the memory 314 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; or any other medium that can be used to store information and can be accessed by a computing device such as, for example, quantum state memory, and the like. In embodiments, the memory 314 stores computer-executable instructions for causing the processor 312 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 318, an emblem identifier 320, a foreground detector 322, a motion estimator 324, an object analyzer 326, an object classifier 328, a partitioner 330, a metatagger 332, an encoder 334, and a communication component 336. Program components may be programmed using any number of different programming environments, including various languages, development kits, frameworks, and/or the like. Some or all of the functionality contemplated herein may also, or alternatively, be implemented in hardware and/or firmware.

In embodiments, the segmenter 318 may be configured to segment a video frame into a number of segments. The segments may include, for example, objects, groups, slices, tiles, and/or the like. The segmenter 318 may employ any number of various automatic image segmentation methods known in the field. In embodiments, the segmenter 318 may use image color and corresponding gradients to subdivide an image into segments that have similar color and texture. Two examples of image segmentation techniques include the watershed algorithm and optimum cut partitioning of a pixel connectivity graph. For example, the segmenter 318 may use Canny edge detection to detect edges on a video frame for optimum cut partitioning, and create segments using the optimum cut partitioning of the resulting pixel connectivity graph.

In embodiments, the emblem identifier 320 is configured to perform emblem identification with respect to video data. For example, in embodiments, the emblem identifier 320 may be configured to perform a template-based pattern recognition. According to embodiments, the template-based pattern recognition may include any number of different techniques for performing template-based pattern recognition with respect to images (e.g., video data).

In embodiments, the foreground detector 322 is configured to perform foreground detection on a video frame. For example, in embodiments, the foreground detector 322 may perform segment-based foreground detection, where the foreground segments, or portions of the segments, determined by the segmenter 318 are detected using one or more aspects of embodiments of the methods described herein. In embodiments, the foreground detector 322 may perform foreground detection on images that have not been segmented. In embodiments, results of foreground detection may be used by the segmenter 318 to inform a segmentation process.

In embodiments, the motion estimator 324 is configured to perform motion estimation on video data. For example, in embodiments, the motion estimator 324 may utilize any number of various motion estimation techniques known in the field. Two example motion estimation techniques are optical pixel flow and feature tracking. As an example, the motion estimator 324 may use feature tracking in which Speeded Up Robust Features (SURF) are extracted from both a source image (e.g., a source frame) and a subsequent image (e.g., a subsequent frame). The individual features of the two images may then be compared using a Euclidean metric to establish a correspondence between features, thereby generating a motion vector for each feature. In embodiments, a motion vector for a segment may be the median of all of the motion vectors for each of the segment's features. After a motion vector for a segment is determined, each segment may be categorized based on its motion properties. For example, a segment may be categorized as either moving or stationary.

In embodiments, the object analyzer 326 is configured to perform object analysis and/or object group analysis on video data. For example, in embodiments, the object analyzer 326 may be configured to identify, using a segment map and/or motion vectors computed by the motion estimator 324, the presence of objects (e.g., clusters of segments that move together, or at least approximately together) within digital images such as, for example, frames of video. In embodiments, the object analyzer 326 may be configured to identify and/or analyze only objects that are moving within a particular scene. In embodiments, the object analyzer 326 may perform object analysis on images that have not been segmented. Results of object group analysis may be used by the segmenter 318 to facilitate a segmentation process, by an encoder 334 to facilitate an encoding process, and/or the like.

In embodiments, the object classifier 328 is configured to perform object classification on video data. For example, in embodiments, the object classifier 328 may include one or more classifiers configured to classify objects within video data. That is, for example, the one or more classifiers may be configured to receive any number of different inputs such as, for example, video data, segmentation information associated with the video data (e.g., resulting from the segmentation process 202 depicted in FIG. 2), motion information associated with the video data (e.g., resulting from a motion estimation process such as, e.g., the segment-based motion estimation process 210 depicted in FIG. 2), object group information associated with the video data (e.g., resulting from an object group analysis process such as, for example, the object group analysis process 212 depicted in FIG. 2), and/or feature-based pattern recognition information (e.g., resulting from a feature-based pattern recognition process such as, e.g., the feature-based pattern recognition process 216 depicted in FIG. 2), and may be configured to use aspects of the received information to classify objects in the video data. Classifying an object in video data may include, for example, identifying the existence of an object, determining and/or tracking the location of the object, determining and/or tracking the motion of the object, determining a class to which the object belongs (e.g., determining whether the object is a person, an animal, an article of furniture, etc.), developing an object profile (e.g., a set of information corresponding to the object such as, e.g., characteristics of the object) corresponding to an identified object, and/or the like.

In embodiments, the partitioner 330 is configured to partition video frames for encoding. For example, in embodiments, the partitioner 330 may be configured to use any number of different partitioning techniques to partition a video frame. In embodiments, the partitioner 330 may be configured to utilize metadata (e.g., object information, segmentation information, etc.) as part of the partitioning process.

In embodiments, the metatagger 332 is configured to partition video frames for encoding. For example, in embodiments, the metatagger 332 analyzes video data to identify characteristics of a video scene (e.g., identification of objects in the scene, characteristics of the objects, behavior of the objects, characteristics of foreground/background features, characteristics of segmentation of the images of the video data, characteristics of motion of segments and/or objects in the scene, etc.). According to embodiments, characteristics of a video scene may be captured using a metatagging (referred to herein, interchangeably, as “labeling”) procedure. In embodiments, information resulting from a metatagging procedure may be referred to, for example, as “metadata.” In embodiments such metadata may be stored as a file, in a database, and/or the like.

In embodiments, the encoder 334 is configured to encode video data. For example, in embodiments, the encoder 334 may be configured to perform adaptive quantization and encoding that may utilize metadata, as described herein, to facilitate efficient encoding. In embodiments, the communication component 336 is configured to facilitate communications between the video processing device 302 and other devices such as, for example, the decoding device 308.

The illustrative operating environment 300 shown in FIG. 3 is not intended to suggest any limitation as to the scope of use or functionality of embodiments of the present disclosure. Neither should the illustrative operating environment 300 be interpreted as having any dependency nor requirement related to any single component or combination of components illustrated therein. Additionally, various components depicted in FIG. 3 may be, in embodiments, integrated with various ones of the other components depicted therein (and/or components not illustrated), all of which are considered to be within the ambit of the present disclosure.

### Segmentation

As explained above, embodiments of video processing processes and methods described herein include segmentation. Segmentation is a key processing step in many applications, ranging, for instance, from medical imaging to machine vision and video compression technology. Although different approaches to segmentation have been proposed, those based on graphs have been particularly attractive to researchers because of their computational efficiency.

Many segmentation algorithms are known to the practitioners in the field. Some examples include the watershed algorithm and simple linear iterative clustering (SLIC), a superpixel algorithm based on nearest neighbor aggregation. Typically, these algorithms have a common disadvantage in that they require a scale parameter to be set by a human supervisor. Thus, the practical applications have, in general, involved supervised segmentation. This may limit the range of applications, since in many instances segmentation is to be generated dynamically and there may be no time or opportunity for human supervision.

In embodiments, a graph-based segmentation algorithm based on the work of P. F. Felzenszwalb and D. P. Huttenlocher may be used to segment images (e.g., video frames). Felzenszwalb and Huttenlocher discussed basic principles of segmentation in general, and applied these principles to develop an efficient segmentation algorithm based on graph cutting in their paper, “Efficient Graph-Based Image Segmentation,” Int. Jour. Comp. Vis., 59(2), September 2004, the entirety of which is hereby incorporated herein by reference for all purposes. Felzenszwalb and Huttenlocher stated that any segmentation algorithm should “capture perceptually important groupings or regions, which often reflect global aspects of the image.”

Based on the principle of a graph-based approach to segmentation, Felzenszwalk and Huttenlocher first build an undirected graph, G=(V, E), where v₁ϵV is the set of pixels of the image to be segmented and (vᵢ, vⱼ)ϵE is the set of edges that connects pairs of neighboring pixels. A non-negative weight, w(vᵢ, vⱼ), is associated with each edge, and has a magnitude proportional to the difference between vᵢ and vⱼ. Image segmentation is identified by finding a partition of V such that each component is connected, and where the internal difference between the elements of each component is minimal whereas the difference between elements of different components is maximal. This is achieved by the definition of a predicate in Equation (1) that determines if a boundary exists between two adjacent components C₁ and C₂:

$$D ( {C}_{1} , {C}_{2} ) = \{ \begin{matrix}true if Dif ( {C}_{1} , {C}_{2} ) > MInt ( {C}_{1} , {C}_{2} ) \\ false otherwise\end{matrix} , \qquad ( 1 )$$

where Dif(C₁, C₂) is the difference between the two components, defined as the minimum weight of the set of edges that connects C₁ and C₂; and MInt(C₁, C₂) is the minimum internal difference, defined in Equation (2) as:

MInt(C₁,C₂)=min[Int(C₁)+τC₁,IntC₂+τC₂], (2)

where Int(C) is the largest weight in the minimum spanning tree of the component C and describes therefore the internal difference between the elements of C; and where τ(C)=k/|C| is a threshold function used to establish whether there is evidence for a boundary between two components. The threshold function forces two small segments not to fuse at least there if is a strong evidence of difference between them.

In practice, the segment parameter k sets the scale of observation. Although Felzenszwalb and Huttenlocher demonstrate that the algorithm generates a segmentation map that is neither too fine nor too coarse, the definition of fineness and coarseness depends on k, which is set by the user to obtain a perceptually reasonable segmentation.

The definition of the proper value of k for the graph-based algorithm, as well as the choice of the threshold value used for edge extraction in other edge-based segmentation algorithms such as, for example, the algorithms described by Iannizzotto and Vita in “Fast and Accurate Edge-Based Segmentation with No Contour Smoothing in 2-D Real Images,” Giancarlo Iannizzotto and Lorenzo Vita, IEEE Transactions on Image Processing, Vol. 9, No. 7, pp. 1232-1237 (July 2000), the entirety of which is hereby incorporated by reference herein for all purposes, had been, until development of the segmentation algorithm described herein, an open issue when “perceptually important groupings or regions” are to be extracted from an image. In the algorithm described by Iannizzotto and Vita, edges are detected by looking at gray-scale gradient maxima with gradient magnitudes above a threshold value. For this algorithm, k is this threshold value and is to be set appropriately for proper segmentation. In embodiments, segmentation based on edge-extraction may be used. In those embodiments, edge thresholds are established based on a strength parameter k. In the field of segmentation algorithms, in general, a parameter is used to set the scale of observation. In cases in which segmentation is performed in a supervised mode, a human user selects the k value for a particular image. It is, however, clear that the segmentation quality provided by a certain algorithm is generally related to the quality perceived by a human observer, especially for applications (like video compression) where a human being constitutes the final beneficiary of the output of the algorithm.

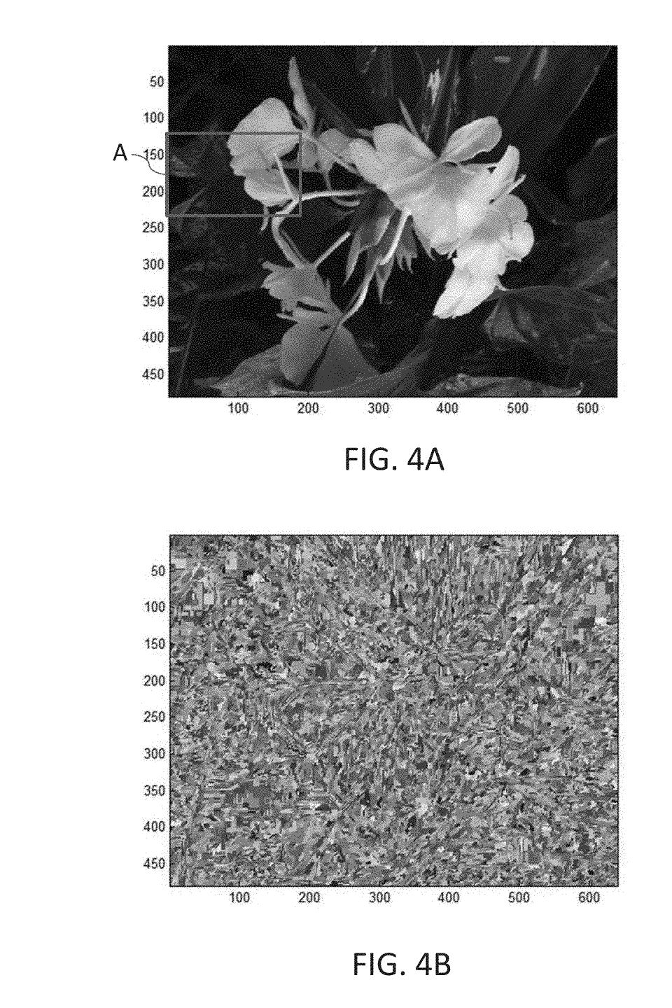

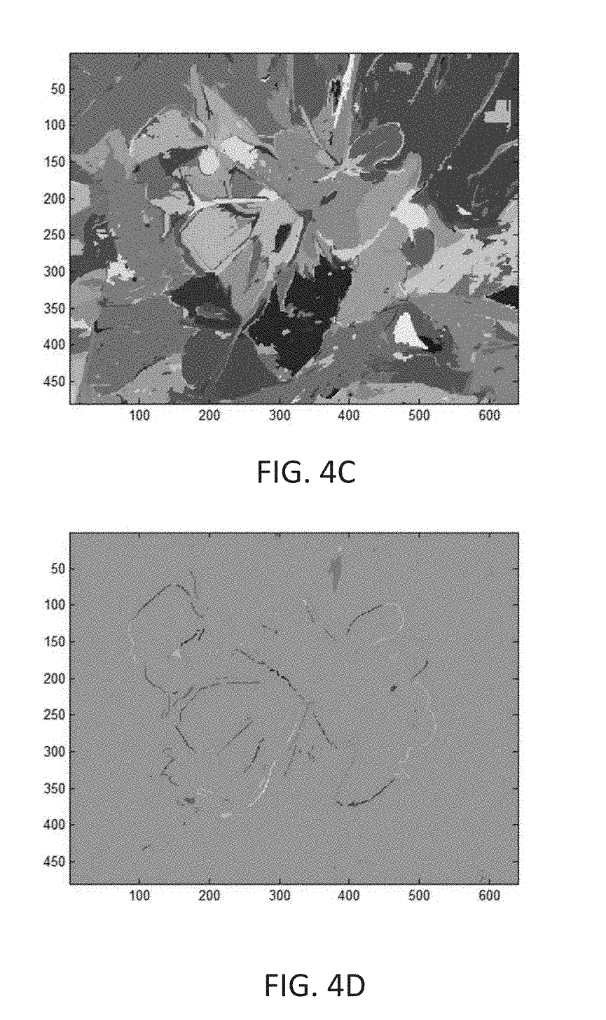

For example, a 640×480 color image is shown in FIG. 4A. A graph cut algorithm was used to generate the segmentation results associated with the image of FIG. 4A, as discussed herein. Segmentation maps with σ=0.5, and a min size of 5 of the image of FIG. 4A are shown in FIGS. 4B-4D for various values of k. In FIG. 4B, k=3, in FIG. 4C, k=100 and, in FIG. 4D, k=10,000. As illustrated in FIG. 4B, values of k that are too small may lead to over-segmentation. Conversely, as illustrated in FIG. 4D, large values of k may introduce under-segmentation.

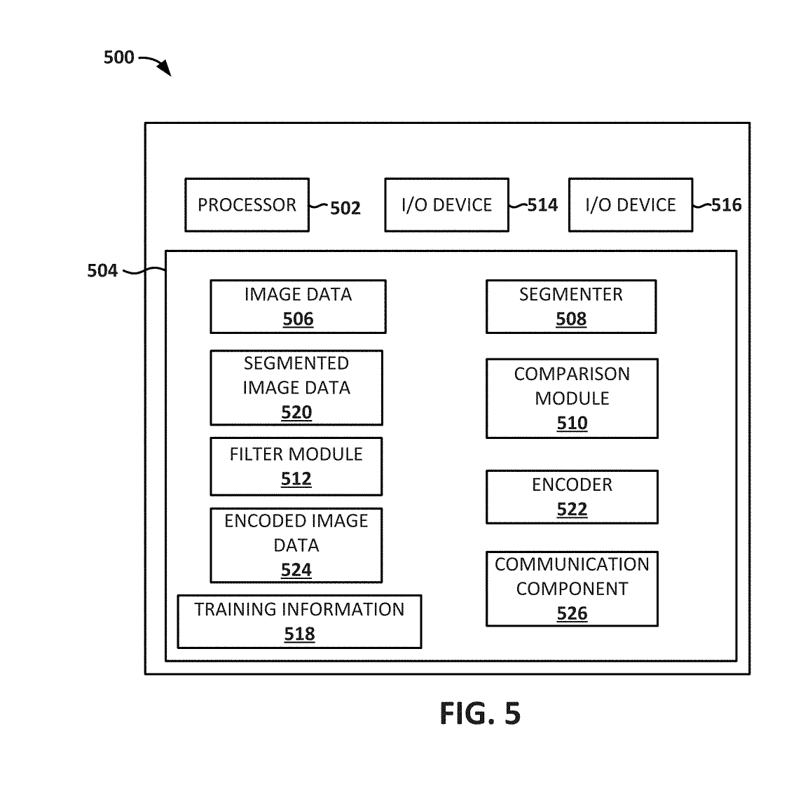

An illustrative segmentation device 500 is schematically illustrated in FIG. 5, in accordance with embodiments of the subject matter disclosed herein. Although referred to as a single device, in some embodiments, the segmentation device 500 may be implemented in multiple instances, distributed across multiple computing devices, instantiated within multiple virtual machines, and/or the like. According to embodiments, the segmentation device 500 may be, include, be similar to, or be included in the video processing device 302 depicted in FIG. 3. As shown in FIG. 5, the segmentation device 500 includes a processor 502 configured to execute computer-executable instructions stored in a memory 504 for causing the processor 502 to implement aspects of embodiments of system components discussed herein and/or to perform aspects of embodiments of methods and procedures discussed herein. For example, the processor 502 may execute various program components stored in the memory 504, which may facilitate encoding the image data 506 of the received image file. Examples of such program components include a segmenter 508, a comparison module 510, and a filter module 512. The processor 502 may include one or multiple processors and, in embodiments, may be, include, be similar to, or be included in the processor 312 depicted in FIG. 3. As shown in FIG. 5, the segmentation device 500 further includes at least one input/output (I/O) device 514, such as, for example, a monitor or other suitable display 516, a keyboard, a printer, a disk drive, a universal serial bus (USB) port, a speaker, pointer device, a trackball, a button, a switch, a touch screen, and/or other suitable I/O devices.

In embodiments, one or more of the program components utilize training information 518 to assist in determining the appropriate segmentation of an image. For example, the training information 518 may include a plurality of images segmented at different values of k. The training images may be used to determine a value for k that corresponds to a well-segmented segmentation for the given image type (medical image, video image, landscape image, etc.). As explained in more detail herein, this value of k from the training images may be used to assist in determining appropriate segmentation of further images automatically by segmentation device 500. In embodiments, the training information 518 includes information associated with a variety of different image types. In embodiments, the training information 518 includes a segmentation quality model that was derived from a set of training images, their segmentations and the classification of these segmentations by a human observer. In embodiments, the training images and their segmentations are not retained.

In embodiments, the segmenter 508 is configured to segment an image into a plurality of segments, as described in more detail below. The segments may be stored in memory 504 as segmented image data 520. The segmented image data 520 may include a plurality of pixels of the image. The segmented image data 520 may also include one or more parameters associated with the image data 520. The segments may include, for example, objects, groups, slices, tiles, and/or the like. The segmenter 508 may employ any number of various automatic image segmentation methods known in the field. In embodiments, the segmenter 508 may use image color of the pixels and corresponding gradients of the pixels to subdivide an image into segments that have similar color and texture. Two examples of image segmentation techniques include the watershed algorithm and optimum cut partitioning of a pixel connectivity graph. For example, the segmenter 508 may use Canny edge detection to detect edges on a video frame for optimum cut partitioning, and create segments using the optimum cut partitioning of the resulting pixel connectivity graph.

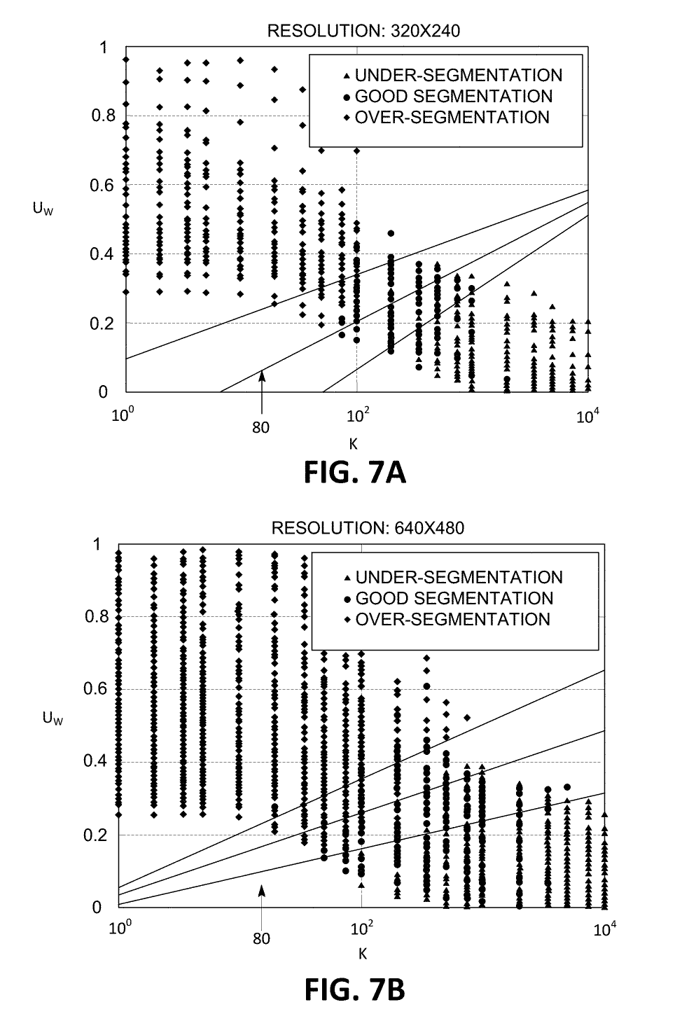

In embodiments, the comparison module 510 may compare a calculated value or pair of values as described in more detail below. For example, the comparison module 510 may compare the parameter kin Equation (2) above, and/or U_{w} in Equation (4) below, with a reference value or pair of values, such as is shown in FIG. 7A.

In embodiments, the filter module 512 may apply a filter to the image data 506 or the segmented image data 520, as described in more detail below. For example, the filter module 512 may apply a low pass filter to a scale map of an image to avoid sharp transitions between adjacent sub-images.

In the illustrative embodiment of FIG. 5, the segmentation device 500 includes an encoder 522 configured for encoding the image data 506 to produce the encoded image data 524. In embodiments, the image data 506 is both segmented and encoded. As illustrated in FIG. 5, the segmentation device 500 further includes a communication component 526. In some embodiments, the communication component 526 may facilitate communication of image data between an image source (e.g., the image source 104 depicted in FIG. 1) and the segmentation device 500. In some embodiments, the communication component 526 may facilitate communication of segmented image data 520 and/or encoded image data 524 between the segmentation device 500 and a receiving device (e.g., receiving device 108 depicted in FIG. 1).

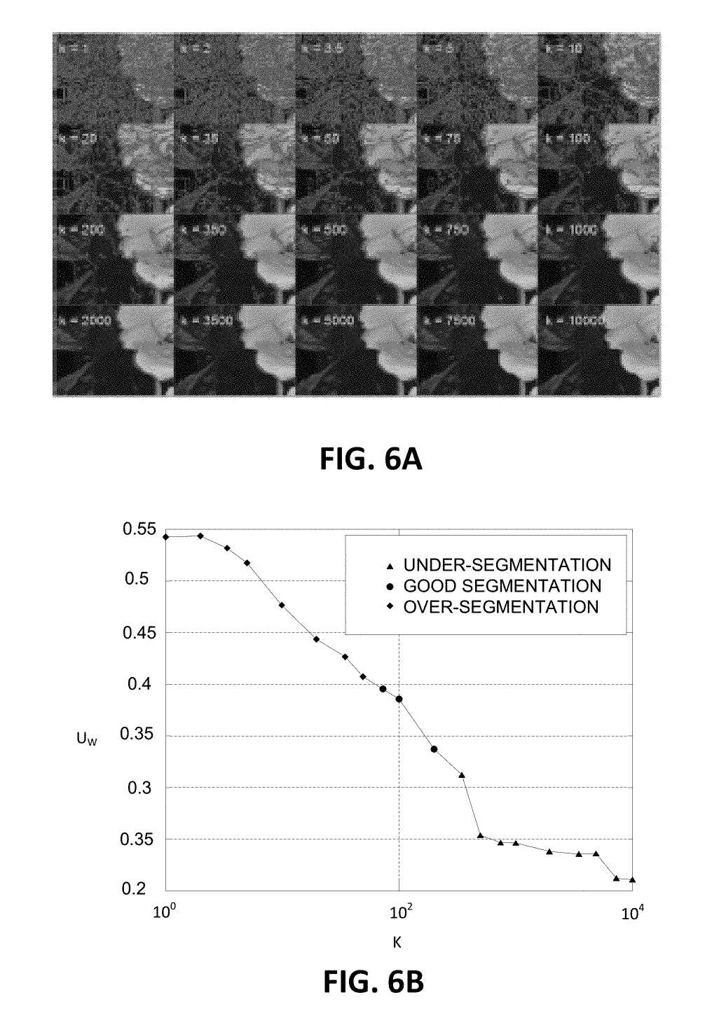

FIG. 6A illustrates portion A of FIG. 4A, showing a block of 160×120 pixels segmented with the graph-based approach of Felzenszwalb and Huttenlocher for σ=0.5, min size=5, and values of k ranging from 1 to 10,000. For relatively low values of k (e.g., from approximately 1 to approximately 50) (the first eight images of the twenty shown), over-segmentation generally occurs at visual inspection, thus meaning that perceptually important regions are erroneously divided into sets of segments. For relatively high values of k (e.g., ranging from approximately 350 to approximately 10,000) (the last nine images of the twenty shown), too few segments are present in the segmentation map, resulting from under-segmentation. For values of k from approximately 75 to approximately 200 (the remaining three images of twenty shown), the segmentation appears generally good. These results are indicated in FIG. 6B.

A similarity function such as, for example, a quantitative index, can be defined to represent the amount of information contained in the original image, img, that is captured by the segmentation process. In embodiments, for example, a color image may be defined by substituting the RGB value in each pixel with the average RGB value of the pixels in the corresponding segment, seg. For each color channel, the symmetric uncertainty U between img and seg can be computed by Equation (3), as given by Witten & Frank in Witten, Ian H. & Frank, Eibe, “Data Mining: Practical Machine Learning Tools and Techniques,” Morgan Kaufmann, Amsterdam, ISBN 978-0-12-374856-0, the entirety of which is hereby incorporated herein by reference for all purposes:

$${U}_{\{ R , G , B \}} = \frac{2 l ( {img}_{\{ R , G , B \}} , {seg}_{\{ R , G , B \}} )}{{S}_{\{ R , G , B \}}^{img} {S}_{\{ R , G , B \}}^{seg}} , \qquad ( 3 )$$

where Sᵢ^{j} indicates the Shannon's entropy, in bits, of the i-th channel for the image j, and where I(i,j) is the mutual information, in bits, of the images i and j.

The symmetric uncertainty U expresses the percentage of bits that are shared between img and seg for each color channel. The value of U tends to zero when the segmentation map is uncorrelated with the original color image channel, whereas it is close to one when the segmentation map represent any fine detail in the corresponding channel of img.

Different images have different quantity of information in each color channel. For example, the color image of FIG. 4A contains a large amount of information in the green channel. A weighted uncertainty index, U_{w} can be defined as follows:

$${U}_{w} = \frac{{U}_{R} * {S}_{R} + {U}_{G} * {S}_{G} + {U}_{G} * {S}_{B}}{{S}_{R} + {S}_{G} + {S}_{B}} , \qquad ( 4 )$$

where U is determined for each channel as in Equation (3), and S is the Shannon's entropy for each channel.

The index U_{w} is a value between 0 and 1 and is correlated with the segmentation quality. Referring to FIG. 6B, the weighted uncertainty index U_{w} is plotted as a function of log(k) for each of the 160×120 pixel blocks illustrated in FIG. 4A.

### Segmentation Quality Model

For a typical image, U_{w} will decrease as k increases, passing from over-segmentation to under-segmentation. For a particular segmentation quality model, a representative set of training images at representative resolutions may be selected. For example, the curve depicted in FIG. 6B shows how the number of segments varies with k for the segmentation of portion A of the image in FIG. 4A at a given resolution. Given multiple training images and human classification of their segmentation quality at different values of k as in FIGS. 7A and 7B, a quality model can be derived as was done with line 700 in FIGS. 7A and 7B by determining a straight-line fit through the well-segmented points on the graphs. A single quality model can be used for multiple resolutions, or a quality model can be generated for each resolution. A set of twelve images, including flowers, portraits, landscapes and sport environments images, at 320×240 and 640×480 resolutions, were next considered as training sets for the segmentation quality in one embodiment. According to embodiments, each image was divided into blocks of 160×120 pixels, and each block was segmented with the graph-based algorithm Felzenszwalb and Huttenlocher for σ=0.5, min size=5, and values of k ranging from 1 to 10,000. Each segmented block was displayed and classified by a human observer as over-segmented, well segmented, or under-segmented. A weighted uncertainty index, U_{w}, was determined for each segmented block according to Equation (4).

The results are presented in FIGS. 7A and 7B. As illustrated in FIGS. 7A and 7B, a single value or range of k does not correspond to well-segmented blocks at a given resolution. However, an area in the (log(k), U_{w}) plane can be defined for this purpose.

For each block considered, an S-shaped curve U_{w}=U_{w}[log(k)] in the (log(k), U_{w}) space was observed. As shown in FIGS. 7A and 7B, for relatively small k values, U_{w} remains almost constant, and a human observer generally classifies these data as over-segmented. As k increases, U_{w} decreases rapidly and a human observer generally classifies this data as well segmented. For relatively high k values, a human observer generally classifies this data as under-segmented, and U_{w} approaches another almost constant value.

Output of the segmentation algorithm was classified as under-segmented, well-segmented, or over-segmented by a human supervisor for each training image and each input value of k. In embodiments, the straight-line quality model was stored. In other embodiments, all of the training results may be stored and the quality model may be derived as needed. In embodiments, some form of classifier may be stored that allows the classification of the (k, numsegments(k)) ordered pair as over-segmented, under-segmented, or well-segmented. The (log(k), U_{w}) plane is subdivided into three different regions corresponding to 3 qualities of the segmentation result. Equation (5) was utilized to estimate the (m, b) parameters of the line U_{w}=m*log(k)+b that separates under-segmented and well-segmented regions:

$$E ( m , b ) = {\sum }_{i = 1}^{{N}_{US}} \frac{\vert m * log ( {k}_{i} ) - {U}_{w , i} + b \vert}{\sqrt{{m}^{2} + 1}} * {δ}_{US , i} + {\sum }_{i = 1}^{{N}_{WE}} \frac{\vert m * log ( {k}_{i} ) - {U}_{w , i} + b \vert}{\sqrt{{m}^{2} + 1}} * {δ}_{WE , i} , \qquad ( 5 )$$

where N_{US} and N_{WE} are respectively the number of under-segmented and well-segmented points; and where δ_{US,i} and δ_{WE,j} are 0 if the point is correctly classified (e.g., any under-segmentation point should lie under the U_{w}=m*log(k)+b line) and 1 otherwise.

Equation (6) was utilized to estimate the (m,b) parameters of the line U_{w}=m*log(k)+b that divides over-segmented and well-segmented regions:

$$E ( m , b ) = {\sum }_{i = 1}^{{N}_{WE}} \frac{\vert m * log ( {k}_{i} ) - {U}_{w , i} + b \vert}{\sqrt{{m}^{2} + 1}} * {δ}_{WE , i} + {\sum }_{i = 1}^{{N}_{OS}} \frac{\vert m * log ( {k}_{i} ) - {U}_{w , i} + b \vert}{\sqrt{{m}^{2} + 1}} * {δ}_{OS , i} , \qquad ( 6 )$$

where N_{OS} and N_{WE} are respectively the number of over-segmented and well segmented points; and where δ_{OS} and δ_{WE,j} are 0 if the point is correctly classified (e.g., any well-segmentation point should lie under the U_{w}=m*log(k)+b line) and 1 otherwise.

The values of Equations (5) and (6) were minimized using a numerical algorithm. In embodiments, a simplex method is used. In practice, the cost function in each of Equation (5) and Equation (6) is the sum of the distances from the line U_{w}=m*log(k)+b of all the points that are misclassified. The estimate of the two lines that divide the (log(k), U_{w}) plane may be performed independently.

The average line between the line dividing the under-segmented and well-segmented points, and the line dividing the well-segmented and over-segmented points, was assumed to be the optimal line 80 for segmentation in the (log(k), U_{w}) plane. Given the S-like shape of the typical U_{w}=U_{w}[log(k)] curve in the (log(k), U_{w}) plane, a point of intersection between the optimal line for segmentation and the U_{w}=U_{w}[log(k)] curve can generally be identified. In embodiments, Identification of this point gives an optimal k value for a given 160×120 image.

As used herein, the term “optimal” refers to a value, conclusion, result, setting, circumstance, and/or the like, that may facilitate achieving a particular objective, and is not meant to necessarily refer to a single, most appropriate, value, conclusion, result, setting, circumstance, and/or the like. That is, for example, an optimal value of a parameter may include any value of that parameter that facilitates achieving a result (e.g., a segmentation that is more appropriate for an image than the segmentation achieved based on some other value of that parameter). Similarly, the term “optimize” refers to a process of determining or otherwise identifying an optimal value, conclusion, result, setting, circumstance, and/or the like.

### Identification of the Optimal k

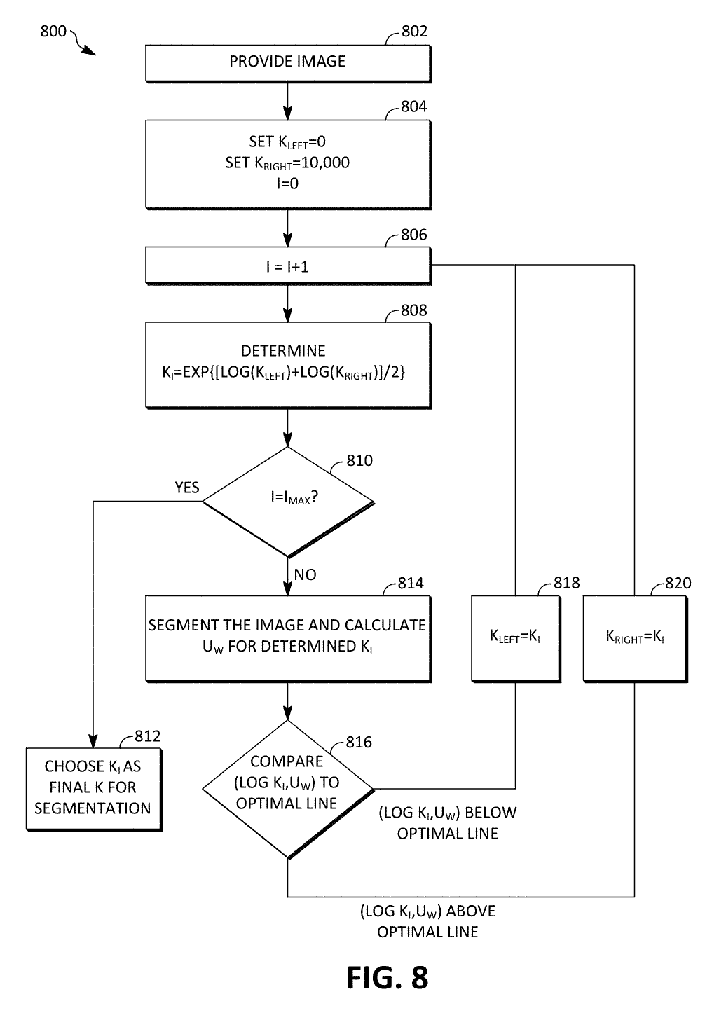

Referring next to FIG. 8, an illustrative method 800 of determining a k value is depicted, in accordance with embodiments of the subject matter disclosed herein. The optimal line for segmentation, m*log(k)+b, derived above, constitutes a set of points in the (log(k), U_{w}) plane that may be reasonably perceived as good segmentation by a human observer. Consequently, given a sub-image of size 160×120 pixels, an optimal k value may be defined as a k value that generates a segmentation whose weighted symmetric uncertainty U_{w} is close to m*log(k)+b. In other words, an optimal k value may include a k value for which a difference between the symmetric uncertainty, U_{w}, of the generated segmentation and a portion of a linear relationship such as, for example, m*log(k)+b, is minimized (or at least approximately minimized).

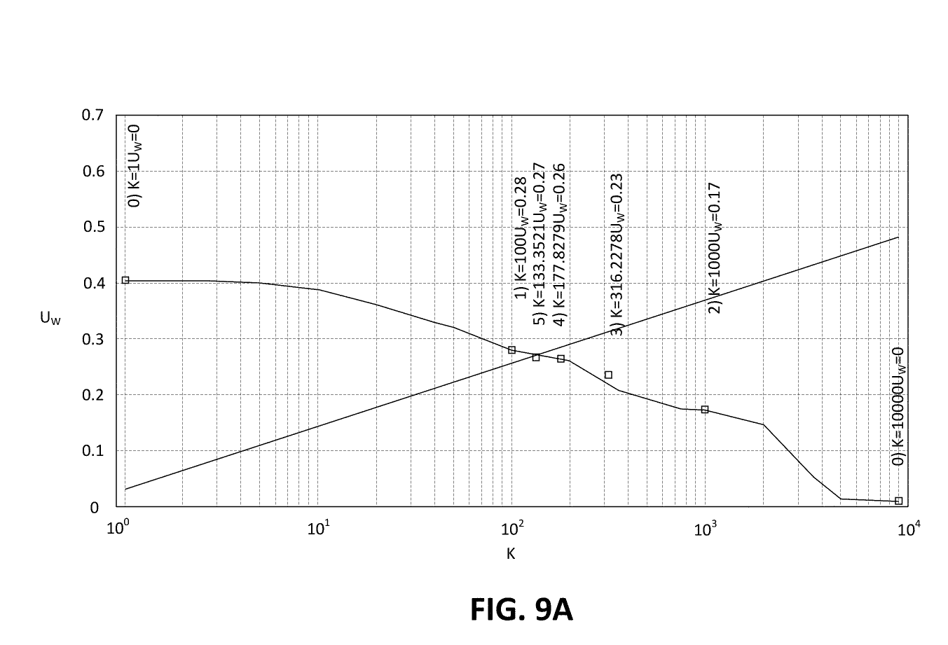

An optimal k value can be computed iteratively through a bisection method 800, as illustrated in FIGS. 9A and 9B. The results of an exemplary implementation of the first five iterations of embodiments of method 800 (FIG. 8) are provided in FIGS. 9A and 9B. In block 802, an image is provided, illustratively the image shown in FIG. 9B multiple times. The image is divided into a plurality of sub-images. The remainder of FIG. 8 is carried out for each sub-image of the image. As shown in block 804, at iteration 1=0, the sub-image is segmented for k_{Left}=1 and k_{Right}=10,000. In embodiments, other values of k may be utilized. As illustrated in FIG. 9A, in this example, the corresponding values of U_{w,Left} and U_{w,Right} are computed for each of k_{Left}=1 and k_{Right}=10,000. FIG. 9B illustrates the segmentation of the exemplary image(all sub-images) at iteration 1=0 for k_{Left}=1 (upper left of FIG. 9B, over-segmented) and k_{Right}=10,000 (upper right of FIG. 9B, under-segmented).

In block 806, the value of i is increased for the first iteration. In block 808, the mean log value (k=exp{[log(k_{Left})+log(k_{Right})]/2}) is used to determine a new k value.

In block 810, the current iteration i is compared to the maximum number of iterations. In embodiments, the maximum number of iterations is a predetermined integer, such as 5 or any other integer, which may be selected, for example, to optimize a trade-off between computational burden and image segmentation quality. In other embodiments, the maximum number of iterations is based on a difference between the k and/or U_{w} value determined in successive iterations. In embodiments, if the maximum number of iterations has been reached, the k value determined in block 808 is chosen as the final value of k for segmentation, as shown in block 812.

If the maximum number of iterations has not yet been reached in block 810, in block 814, the image is segmented and the corresponding U_{w} is computed for the k value determined in block 808. As shown in FIG. 9A, the first iteration of k was 100, and the U_{w} calculated in the first iteration was 0.28. An example of a resulting segmentation of a first iteration of k is shown in FIG. 9B (second row, left image).

In block 816, the determined kⱼ and U_{w} values are compared to the optimal line in the (log kᵢ, U_{w}) plane. For example, as shown in FIG. 9A, for the first iteration, (log kᵢ, U_{w}) is located above the optimal line. The value of k_{right} is replaced with kᵢ in block 820, and the method 800 returns to block 806. In contrast, for the second iteration, the value of k=1000 (second row, right image in FIG. 9B), U_{w}=0.17 is below the optimal line in the (log kᵢ, U_{w}) plane. In the second iteration, the value of k_{left} is replaced with kᵢ in block 818, and the method 800 returns to block 806.

Exemplary results of embodiments of method 8 are presented in FIG. 9A for the image of FIG. 9B. Although the initial k values of 0 and 10,000 resulted in strong over-segmentation and under-segmentation, respectively, after several iterations, the image of FIG. 9B appears well-segmented, and the corresponding point in the (log(k), U_{w}) plane lies close to the optimal segmentation line, as shown in FIG. 9A. At iteration i=5, the k of 133.3521 and U_{w} of 0.27 lies very close to the optimal segmentation line (FIG. 9A), and the image appears well-segmented (FIG. 9B, bottom image).

Although sub-images of 160×120 pixels were considered in FIGS. 9A and 9B, the parameters of the segmentation quality model change with the image resolution. In addition, the optimal segmentation line shown in FIG. 9A for a 320×240 resolution is lower than the optimal segmentation line shown in FIG. 9B for a 640×480 resolution. In embodiments, it is believed that at a higher resolution, more details may be generally visible in the image, thus indicating a higher segmentation quality. In embodiments, the application of the segmentation quality model to other image resolutions may indicate therefore to re-classify segmented sub-images of 160×120 pixels for the given resolution. In embodiments, interpolation or extrapolation of known image or sub-image resolutions may be used.

### Adaptive Selection of k

Method 800 (FIG. 8) was used to estimate the optimal k value for a sub-image of 160×120 pixels as illustrated in FIGS. 9A and 9B. In embodiments, to segment a full image at resolution of 320×240 or 640×480 pixels, a set of adjacent sub-images may be considered. In embodiments, putting together the independent segmentations of each sub-image may not produce a satisfying segmentation map, since segments across the borders of the sub-images may be divided into multiple segments.

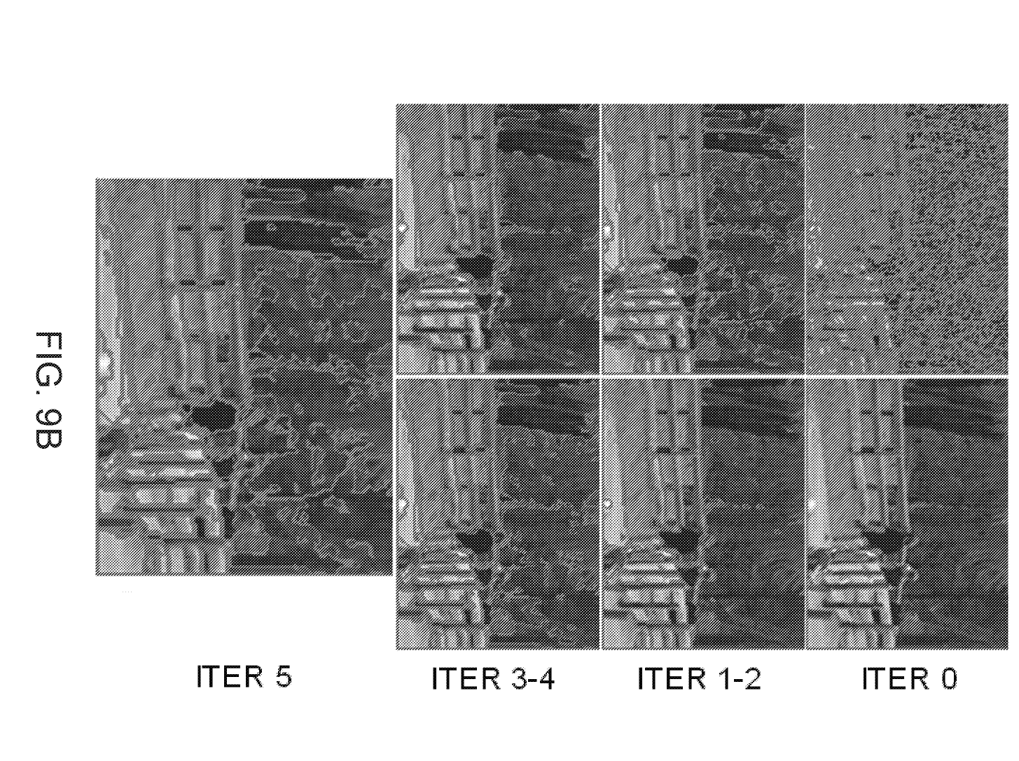

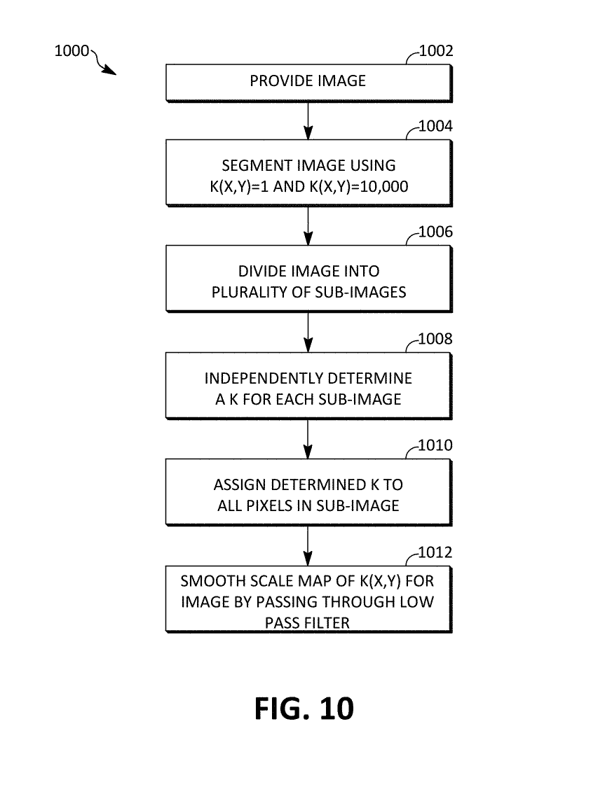

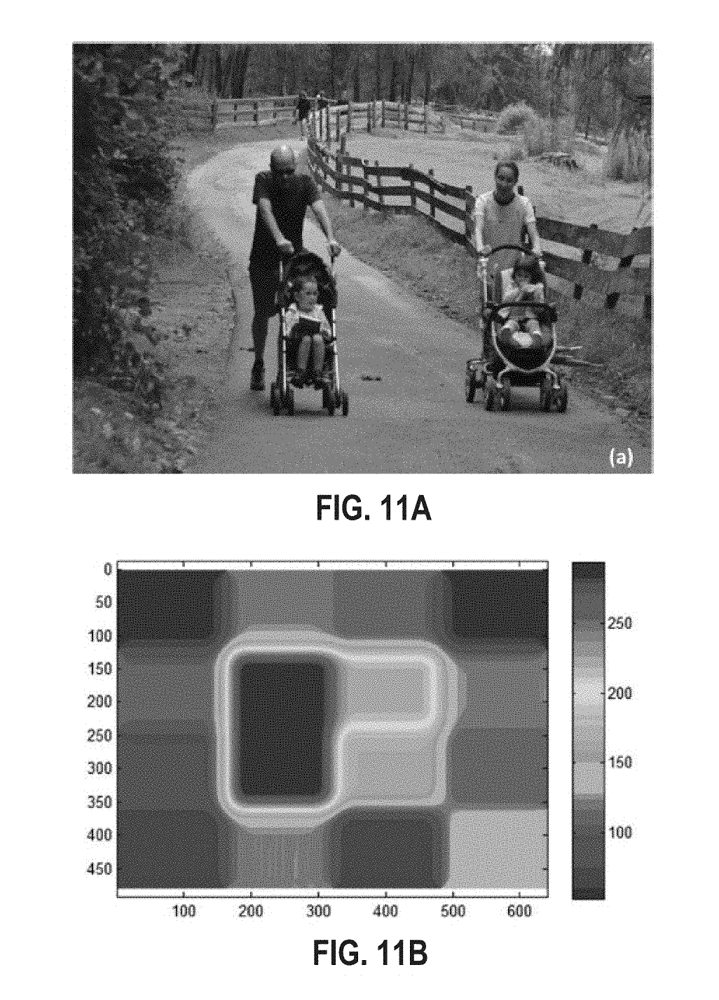

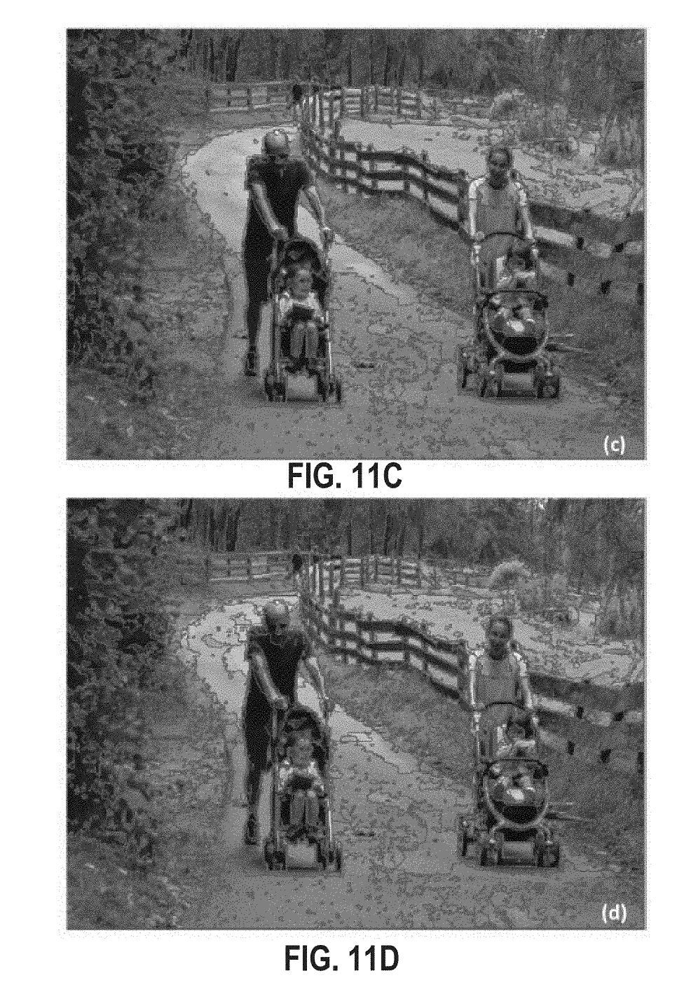

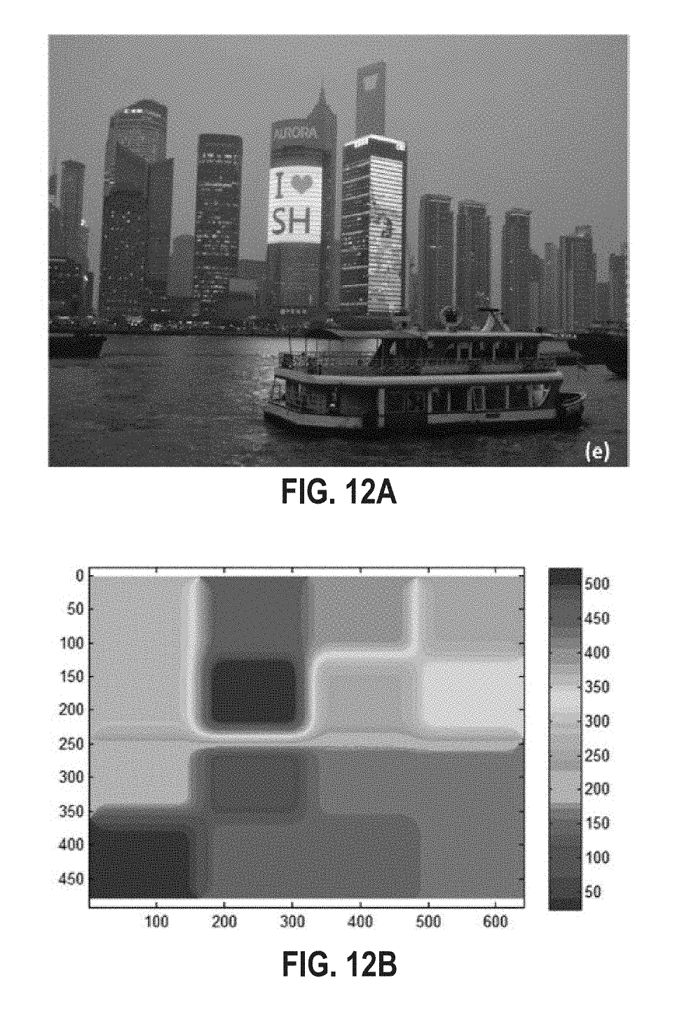

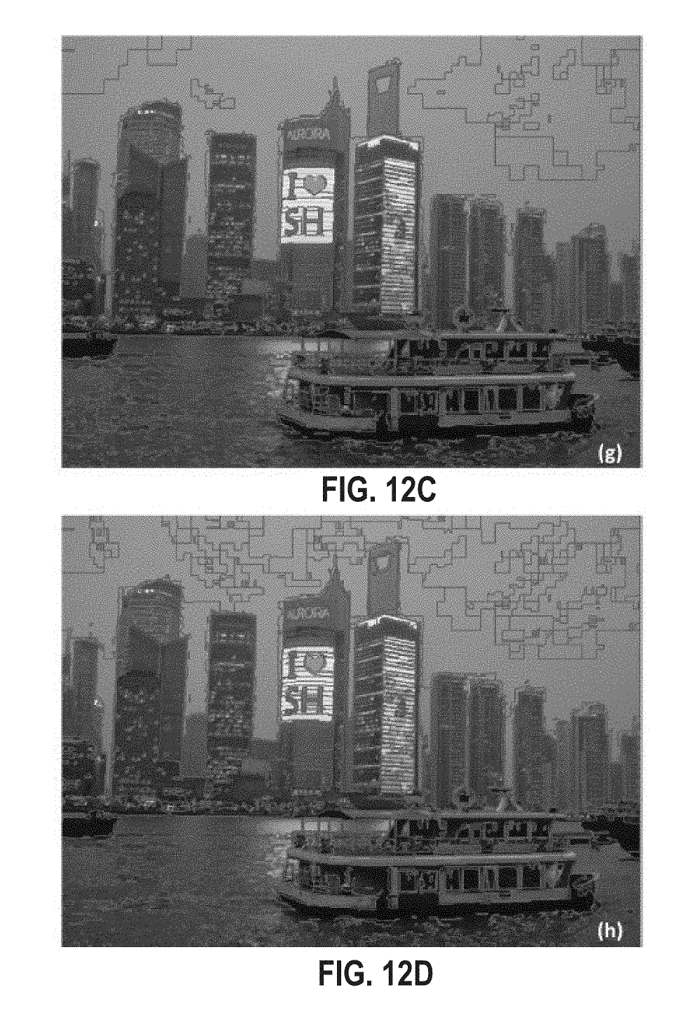

Referring next to FIG. 10, a modified method 1000 is presented. Method 1000 makes use of an adaptive scale factor k(x,y), and the threshold function τ(C)=k/|C| in Equation (2) becomes τ(C,x,y)=k(x,y)/|C|. In step 1002, an image is provided. Exemplary images are shown in FIG. 11A and FIG. 12A. For each image, as shown in block 1004, the image is segmented using k(x,y)=1 and k(x,y)=10,000 for all the image pixels.

As shown in block 1006, each image is then divided into a plurality of sub-images. Illustratively, each sub-image may be 160×120 pixels. In block 1008, for each sub-image, and independently from the other sub-images, a value of k for each sub-image was determined. In embodiments, the value of k is determined for the sub-image using method 800 as described above with respect to FIG. 8. In block 1010, the value of k determined in block 1008 is assigned to all pixels in the sub-image.

In block 1012, a scale map of k(x,y) for the image is smoothed through a low pass filter to avoid sharp transition of k(x,y) along the image.

The results of an exemplary method 1000 are illustrated in FIGS. 11 and 12. FIGS. 11A and 12A are two exemplary 640×480 pixel images taken from the dataset used for estimating the segmentation quality model in FIG. 7B. The k(x,y) scale map for each image following the smoothing through the low pass filter in block 1014 is presented in FIGS. 11B and 12B, and the corresponding segmentation is shown, respectively, in FIGS. 11C and 12C.

FIGS. 11D and 12D illustrate segmentation achieved with the graph-based approach of Felzenszwalb and Huttenlocher for σ=0.5, min size=5. The value of k was set experimentally to guarantee an equivalent number of segments as in FIGS. 11C and 12C. For FIG. 11D, k was set to 115, and for FIG. 12D, k was set to 187.

FIGS. 11B and 11C illustrate that the present method favors large segments (higher k value) in the area occupied by persons in the image, and finer segmentation (lower k value) in the upper left area of the image, where a large number of small leaves are present, when compared to the method of Felzenszwalb and Huttenlocher in FIG. 11D.

FIGS. 12B and 12C illustrate that embodiments of the present method may favor larger segments in the homogeneous area of the sky and skyscrapers, for example, preventing over-segmentation in the sky area, when compared to the method of Felzenszwalb and Huttenlocher as shown in FIG. 12D. In other embodiments, overlapping rectangular regions may be used.

### Estimation of k for Subsequent Images

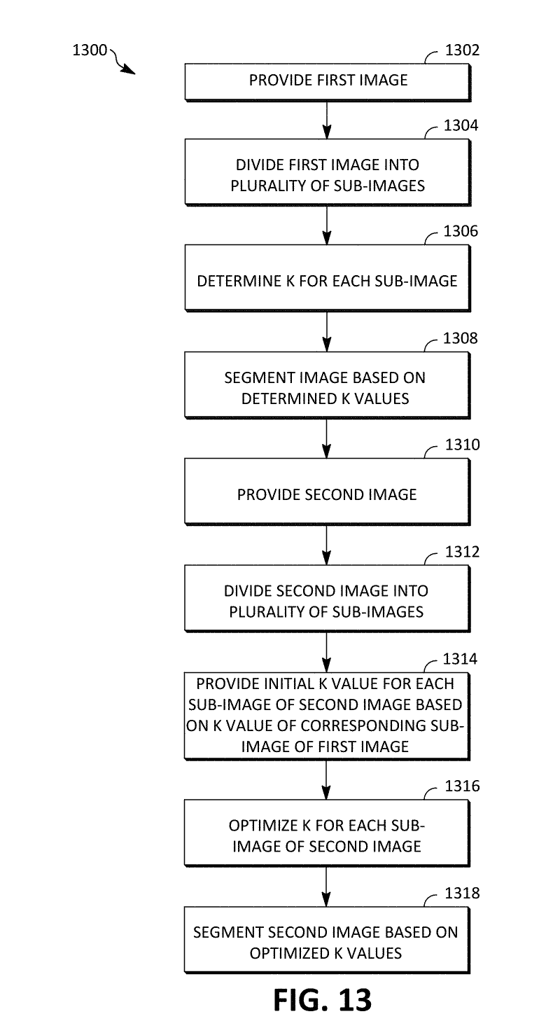

In some embodiments, the segmentation of a second image can be estimated based on the segmentation of a first image. Exemplary embodiments include video processing or video encoding, in which adjacent frames of images may be highly similar or highly correlated. A method 1300 for segmenting a second image is provided in FIG. 13. In block 1302, the first image is provided. The first image is segmented by dividing the first image into a plurality of sub-images in block 1304, determining a value of k for each sub-image in block 1306, and segmenting the image based on the determined k value in block 1308. In some embodiments, segmenting the first image in blocks 1304-1308 is performed using method 800 (FIG. 8) or method 1000 (FIG. 10). In block 1310, a second image is provided. In some embodiments, the first and second images are subsequent video images. The second image is divided into a plurality of sub-images in block 1312. In embodiments, one or more of the plurality of sub-images of the second image in block 1312 correspond in size and/or location to one or more of the plurality of sub-images of the first image in block 1304. In block 1314, the k value for each sub-image of the first image determined in block 1306 is provided as an initial estimate for the k value of each corresponding sub-image of the second image.

In embodiments, as shown in FIG. 13, in block 1316 the k values for the second image are optimized, using the estimated k values from the first image as an initial iteration, followed by segmenting the second image in block 1318. In other embodiments, the second image is segmented based on the estimated k value in block 1318 without first being optimized in block 1316. In embodiments, segmenting the second image in blocks 1314-1318 is performed using method 800 (FIG. 8) or method 1000 (FIG. 10).

In embodiments, such as in applications like video-encoding, it can also be noticed that the computational cost of segmenting the video images can be significantly reduced. When applied to a unique frame, embodiments of the proposed method include performing a research of the optimal k value for each sub-image considering the entire range for k. For a video-encoding application, since adjacent frames are highly correlated in videos, the range for k can be significantly reduced by considering the estimates obtained at previous frames for the same sub-image and/or corresponding sub-image. In embodiments, k values may be updated only at certain frame intervals and/or scene changes.

### Additional Segmentation Methods

Embodiments of the methods, described above, of automatically optimizing a segmentation algorithm may be performed based on edge thresholding and working in the YUV color space, achieving similar results. In embodiments in which multiple input parameters are used by the segmentation algorithm, a similar segmentation quality model may be used, but the optimal segmentation line as shows in FIGS. 7A, 7B, and 9A may be transformed into a plane or hyper-plane.

### Template-Based Pattern Recognition

### Logo Identification

Embodiments of the systems and methods described herein may include a template-based pattern-recognition process (e.g., the template-based pattern recognition process 204). Aspects of the template-based recognition process may be configured to facilitate an emblem identification process (e.g., the emblem identification process 206 depicted in FIG. 2).

There is a growing interest in identifying emblems in video scenes. An emblem is a visible representation of something. For example, emblems may include symbols, letters, numbers, pictures, drawings, logos, colors, patterns, and/or the like, and may represent any number of different things such as, for example, concepts, companies, brands, people, things, places, emotions, and/or the like. In embodiments, for example, marketers, corporations, and content providers have an interest in quantifying ad visibility, both from ads inserted by the content deliverer (e.g., commercials) and ads inserted by the content creators (e.g., product placement in-program). For example, knowing the visibility at point of delivery of a banner at a football match can inform decisions by marketers and stadium owners regarding value. Further, when purchasing ad space in content delivery networks (e.g., internet-based video providers), logo owners may desire to purchase ad space that is not proximal to ad space occupied by logos of their competitors. Conventional emblem identification techniques are characterized by computationally-intensive brute force pattern matching.

Embodiments of the disclosure include systems, methods, and computer-readable media for identifying emblems in a video stream. In embodiments, a video stream is analyzed frame-by-frame to identify emblems, utilizing the results of efficient and robust segmentation processes to facilitate the use of high-precision classification engines that might otherwise be too computationally expensive for large-scale deployment. In embodiments, the emblem identification may be performed by, or in conjunction with, and encoding device. Embodiments of the technology for identifying emblems in video streams disclosed herein may be used with emblems of any kind, and generally may be most effective with emblems that have relatively static color schemes, shapes, sizes, and/or the like. Emblems are visual representations of objects, persons, concepts, brands, and/or the like, and may include, for example, logos, aspects of trade dress, colors, symbols, crests, and/or the like.

Embodiments of the disclosed subject matter include systems and methods configured for identifying one or more emblems in a video stream. The video stream may include multimedia content targeted at end-user consumption. Embodiments of the system may perform segmentation, classification, tracking, and reporting.

Embodiments of the classification procedures described herein may be similar to, or include, cascade classification (as described, for example, in Rainer Lienhart and Jochen Maydt, “An Extended Set of Haar-like Features for Rapid Object Detection,” IEEE ICIP, Vol. 1, pp. 900-903 (September 2002), attached herein as Appendix A, the entirety of which is hereby incorporated herein by reference for all purposes), an industry standard in object detection. Cascade classification largely takes advantage of two types of features: haar-like and LBP. These feature detectors have shown substantial promise for a variety of applications. For example, live face detection for autofocusing cameras is typically accomplished using this technique.

In embodiments, emblem information is received from emblem owners (e.g., customers of ad services associated with delivery of the video streams), and the emblem information is processed to enable more robust classification. That is, for example, emblem information may include images of emblems. The images may be segmented and feature extraction may be performed on the segmented images. The results of the feature extraction may be used to train classifiers to more readily identify the emblems.

Disadvantages of that technology include multiple detection, sensitivity to lighting conditions, and classification performance. The multiple detection issue may be due to overlapping sub-windows (caused by the sliding-window part of the approach). Embodiments mitigate this disadvantage by implementing a segmentation algorithm that provides a complete but disjoint labeling of the image. The sensitivity and the performance issues may be mitigated by embodiments of the disclosure by using a more robust feature set that would normally be too computationally expensive for live detection.

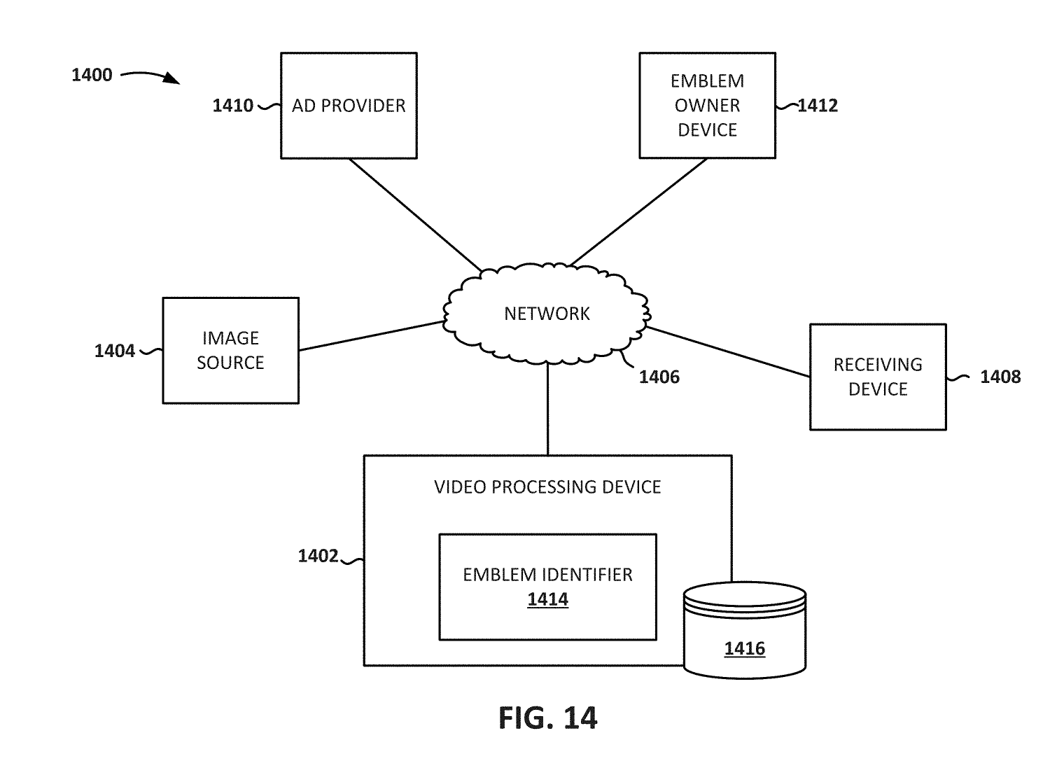

FIG. 14 depicts an illustrative content delivery system 1400 having a video processing device 1402. In embodiments, the video processing device 1402 illustratively receives an image from the image source 1404 over a network 1406. The image source 1404 may be a digital image device (e.g., a camera), a content provider, a storage device, and/or the like. Exemplary images include, but are not limited to, digital photographs, digital images from medical imaging, machine vision images, video images (e.g., frames of a video stream), and any other suitable images having a plurality of pixels.

According to embodiments, the video processing device 1402 may be, include, be similar to, or be included in the video processing device 302 depicted in FIG. 3. The video processing device 1402 is illustratively coupled to a receiving device 1408 by the network 1406. In embodiments, the video processing device 1402 communicates encoded video data to the receiving device 1408 over the network 1406. In some embodiments, the network 1406 may include a wired network, a wireless network, or a combination of wired and wireless networks, and may, in embodiments, be, include, be similar to, or be included within the communication links 106 and/or 110 depicted in FIG. 1, and/or the communication link 310 depicted in FIG. 3. Although not illustrated herein, the receiving device 1408 may include any combination of components described herein with reference to the video processing device 1402, components not shown or described, and/or combinations of these.

The video processing device 1402 may be, or include, an encoding device and may be configured to encode video data received from the image source 1404 and may, in embodiments, be configured to facilitate insertion of ads into the encoded video data. In embodiments, the video processing device 1402 may encode video data into which ads have already been inserted by other components (e.g., ad network components). The ads may be provided by an ad provider 1410 that communicates with the video processing device 1402 via the network 1406. In embodiments, an emblem owner (e.g., a company that purchases ads containing its emblem from the ad provider 1410) may interact, via the network 1406, with the ad provider 1410, the video processing device 1402, the image source 1404, and/or the like, using an emblem owner device 1412. In embodiments, the emblem owner may wish to receive reports containing information about the placement of its emblem(s) in content encoded by the encoding device. The emblem owner may also, or alternatively, wish to purchase ad space that is not also proximate to emblem placement by its competitors. For example, an emblem owner may require that a video stream into which its emblem is to be inserted not also contain an emblem of a competitor, or the emblem owner may require that its emblem be separated, within the video stream, from a competitor's emblem by a certain number of frames, a certain amount of playback time, and/or the like.

In embodiments, the video processing device 1402 may instantiate an emblem identifier 1414 configured to identify one or more emblems within a video stream. According to embodiments, emblem identification may be performed by an emblem identifier that is instantiated independently of the video processing device 1402. For example, the emblem identifier 1414 may be instantiated by another component such as a stand-alone emblem identification device, a virtual machine running in an encoding environment, by a device that is maintained by an entity that is not the entity that maintains/provides the video processing device 1402 (e.g., emblem identification may be provided by a third-party vendor), by a component of an ad provider, and/or the like. According to embodiments, an emblem identifier 1414 may be implemented on a device and/or in an environment that includes a segmenter (e.g., the segmenter 318 depicted in FIG. 3) and/or that interacts with another device/environment having a segmenter. That is, for example, in embodiments, an emblem identifier may utilize the output of a segmenter implemented by an encoding device. In embodiments, the emblem identifier may include a segmenter.

In embodiments, the emblem owner may provide emblem information to the emblem identifier 1414. The emblem information may include images of the emblem owner's emblem, images of emblems of the emblem owner's competitors, identifications of the emblem owner's competitors (e.g., which the emblem identifier 1414 may use to look up, from another source of information, emblem information associated with the competitors), and/or the like. The emblem identifier 1414 may store the emblem information in a database 1416. In embodiments, the emblem identifier 1414 may process the emblem information to facilitate more efficient and accurate identification of the associated emblem(s). For example, the emblem identifier 1414 may utilize a segmenter implemented by the video processing device 1402 to segment images of emblems, and may perform feature extraction on the segmented images of the emblems, to generate feature information that may be used to at least partially train one or more classifiers to identify the emblems. By associating the emblem identifier 1414 with the video processing device 1402 (e.g., by implementing the emblem identifier 1414 on the processing device 1402, by facilitating communication between the emblem identifier 1414 and the video processing device 1402, etc.), the emblem identifier 1414 may be configured to utilize the robust and efficient segmentation performed by the video processing device 1402 to facilitate emblem identification.

The illustrative system 1400 shown in FIG. 14 is not intended to suggest any limitation as to the scope of use or functionality of embodiments of the present disclosure. Neither should the illustrative system 1400 be interpreted as having any dependency or requirement related to any single component or combination of components illustrated therein. Additionally, any one or more of the components depicted in FIG. 14 may be, in embodiments, integrated with various ones of the other components depicted therein (and/or components not illustrated), all of which are considered to be within the ambit of the present disclosure.

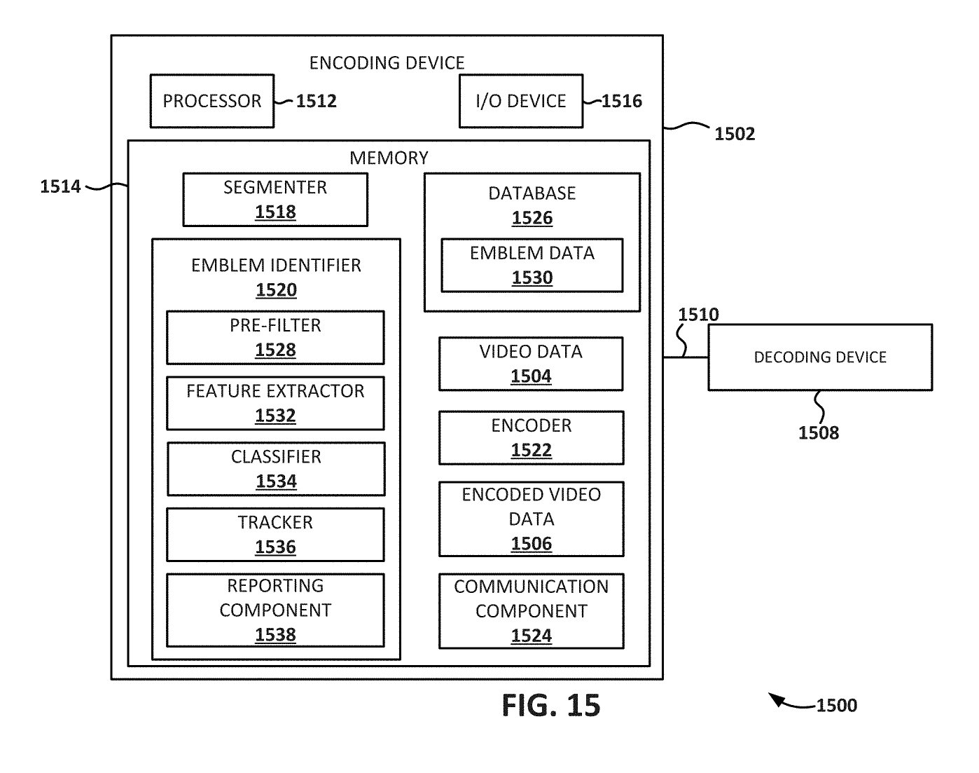

FIG. 15 is a block diagram illustrating an operating environment 1500, in accordance with embodiments of the present disclosure. In embodiments, aspects of the operating environment 1500 may be, include, or be included in, a system for identifying a target emblem in a video stream. The operating environment 1500 includes an encoding device 1502 (which may, e.g., be, include, be similar to, or be included in, the video processing device 1402 depicted in FIG. 14) that may be configured to encode video data 1504 to create encoded video data 1506. As shown in FIG. 15, the encoding device 1502 may also be configured to communicate the encoded video data 1506 to a decoding device 1508 (e.g., receiving device 1408 depicted in FIG. 14) via a communication link 1510. In embodiments, the communication link 1510 may be, include, and/or be included in, a network (e.g., the network 1406 depicted in FIG. 14).

As shown in FIG. 15, the encoding device 1502 may be implemented on a computing device that includes a processor 1512, a memory 1514, and an input/output (I/O) device 1516. Although the encoding device 1502 is referred to herein in the singular, the encoding device 1502 may be implemented in multiple instances, distributed across multiple computing devices, instantiated within multiple virtual machines, and/or the like. In embodiments, the processor 1512 executes various program components stored in the memory 1514, which may facilitate encoding the video data 1504. In embodiments, the processor 1512 may be, or include, one processor or multiple processors. In embodiments, the I/O device 1516 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 1514 stores computer-executable instructions for causing the processor 1512 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 1518, an emblem identifier 1520, an encoder 1522, and a communication component 1524.

In embodiments, as described above with reference to FIG. 14, the segmenter 1518 and/or the emblem identifier 1520 may be implemented on the encoding device 1502 and/or on (or in association with) any other device such as, for example, a device that is independent of (but that may communicate with) the encoding device 1502. Thus, although various aspects of embodiments of emblem identification are described herein in the context of a segmenter 1518 and an emblem identifier 1520 implemented as part of an encoding device 1502, this context is provided only as an example, and for clarity of description, and is not intended to limit the subject matter described herein to implementation on an encoding device.

In embodiments, the segmenter 1518 may be configured to segment a video frame into a number of segments to generate a segment map. The segments may include, for example, objects, groups, slices, tiles, and/or the like. The segmenter 1518 may employ any number of various automatic image segmentation methods known in the field. In embodiments, the segmenter 1518 may use image color and corresponding gradients to subdivide an image into segments that have similar color and texture. Two examples of image segmentation techniques include the watershed algorithm and optimum cut partitioning of a pixel connectivity graph. For example, the segmenter 1518 may use Canny edge detection to detect edges on a video frame for optimum cut partitioning, and create segments using the optimum cut partitioning of the resulting pixel connectivity graph. In embodiments, the segmenter 1518 implements aspects of the segmentation techniques described in Iuri Frosio and Ed Ratner, “Adaptive Segmentation Based on a Learned Quality Metric,” Proceedings of the 10^{th} International Conference on Computer Vision Theory and Applications, March 2015, the entirety of which is hereby incorporated herein by reference for all purposes.

The resulting segment map of image segments includes an assignment of indices to every pixel in the image, which allows for the frame to be dealt with in a piecemeal fashion. Each index, which may be indexed in a database 1526 stored in the memory 1514, may be considered a mask for this purpose. The database 1526, which may refer to one or more databases, may be, or include, one or more tables, one or more relational databases, one or more multi-dimensional data cubes, and the like. Further, though illustrated as a single component, the database 1526 may, in fact, be a plurality of databases 1526 such as, for instance, a database cluster, which may be implemented on a single computing device or distributed between a number of computing devices, memory components, or the like.

In embodiments, the emblem identifier 1520 may be configured to identify, using the segment map, the presence of emblems within digital images such as, for example, frames of video. In embodiments, the emblem identifier 1520 may perform emblem identification on images that have not been segmented. In embodiments, results of emblem identification may be used by the segmenter 1518 to inform a segmentation process. According to embodiments, as shown in FIG. 15, the emblem identifier 1520 includes a pre-filter 1528 configured to filter segments that are determined to be unlikely to contain an emblem from a segmented image.

According to embodiments, the pre-filter 1528 is configured to compute basic color metrics for each of the segments of a segmented image and to identify, based on emblem data 1530 (which may, for example, include processed emblem information), segments that are unlikely to contain a particular emblem. For example, the pre-filter 1528 may identify segments unlikely to contain a certain emblem based on emblem data, and/or may identify those segments based on other information such as, for example, texture information, known information regarding certain video frames, and/or the like.

In embodiments, the pre-filter 1528 is configured to determine, using one or more color metrics, that each segment of a first set of segments of a segment map is unlikely to include the target emblem; and to remove the first set of segments from the segment map to generate a pre-filtered segment map. As used herein, the term “target emblem” refers to an emblem that an emblem identifier (e.g., the emblem identifier 1520) is tasked with identifying within a video stream. The color metrics may include, in embodiments, color histogram matching to the emblem data 1530. For example, in embodiments, by comparing means and standard deviations associated with color distributions in the frame and the emblem data 1530, embodiments may facilitate removing segments that are unlikely to contain a target emblem. In embodiments, the pre-filter 1528 pre-filters the image on a per-emblem basis, thereby facilitating a more efficient and accurate feature extraction process.

The emblem identifier 1520 also may include a feature extractor 1532 configured to extract one or more features from an image to generate a feature map. In embodiments, the feature extractor 1532 may represent more than one feature extractors. The feature extractor 1532 may include any number of different types of feature extractors, implementations of feature extraction algorithms, and/or the like. For example, the feature extractor 1532 may perform histogram of oriented gradients feature extraction (“HOG,” as described, for example, in Navneet Dalal and Bill Triggs, “Histograms of Oriented Gradients for Human Detection,” available at http://lear.inrialpes.fr/people/triggs/pubs/Dalal-cvpr05.pdf, 2005, the entirety of which is hereby incorporated herein by reference for all purposes), Gabor feature extraction (as explained, for example, in John Daugman, “Complete Discrete 2-D Gabor Transforms by Neural Networks for Image Analysis and Compression,” IEEE Transaction on Acoustics, Speech, and Signal Processing, Vol. 36, No. 7, 1988, the entirety of which is hereby incorporated herein by reference for all purposes), Kaze feature extraction, speeded-up robust features (SURF, as explained, for example, in D. G. Lowe, “Distinctive Image Features from Scale-Invariant Keypoints,” International Journal of Computer Vision, 60, 2, pp. 91-110, 2004, the entirety of which is hereby incorporated herein by reference for all purposes) feature extraction, features from accelerated segment (FAST) feature extraction, scale-invariant feature transform (SIFT) feature extraction, and/or the like. In embodiments, the feature extractor 1532 may detect features in an image based on emblem data 1530. By generating the features on the full frame, embodiments allow for feature detection in cases where nearby data could still be useful (e.g. an edge at the end of a segment).

The emblem identifier 1520 (e.g., via the feature extractor 1532 and/or classifier 1534) may be further configured to use the list of culled segments from the pre-filter step to remove features that fall outside the expected areas of interest. The practice also may facilitate, for example, classification against different corporate emblems by masking different areas depending on the target emblem. For example, the emblem identifier 1520 may be configured to remove, from a feature map, a first set of features, wherein at least a portion of each of the first set of features is located in at least one of the segments of the first set of segments.

After masking, the remaining features may be classified using a classifier 1534 configured to classify at least one of the plurality of features to identify the target emblem in the video frame. In embodiments, the emblem identifier 1520 further comprising an additional classifier, the additional classifier configured to mask at least one feature corresponding to a non-target emblem. The classifier 1534 may be configured to receive input information and produce output that may include one or more classifications. In embodiments, the classifier 1534 may be a binary classifier and/or a non-binary classifier. The classifier 1534 may include any number of different types of classifiers such as, for example, a support vector machine (SVM), an extreme learning machine (ELM), a neural network, a kernel-based perceptron, a k-NN classifier, a bag-of-visual-words classifier, and/or the like. In embodiments, high quality matches are selected as matches, providing both identification and location for the target emblem. Embodiments of classification techniques that may be utilized by the classifier 1534 include, for example, techniques described in Andrey Gritsenko, Emil Eirola, Daniel Schupp, Ed Ratner, and Amaury Lendasse, “Probabilistic Methods for Multiclass Classification Problems,” Proceedings of ELM-2015, Vol. 2, January 2016; and Gabriella Csurka, Christopher R. Dance, Lixin Fan, Jutta Willamowski, and Cedric Bray, “Visual Categorization with Bags of Keypoints,” Xerox Research Centre Europe, 2004, the entirety of each of which is hereby incorporated herein by reference for all purposes.

The emblem identifier 1520 may include a tracker 1536 that is configured to track the identified target emblem by identifying an additional video frame in which the identified target emblem appears. For example, to provide valuable insights, it may be desirable to identify an emblem on more than a frame-by-frame basis, thereby eliminating the need for a human operator to interpret a marked-up stream to provide timing a report. That is, it may be desirable to track the identified emblem from frame to frame. According to embodiments, given a match in a frame (determined by the appearance of a high-quality feature match), the tracker 1536 looks at neighboring frames for high quality matches that are well localized. This not only allows robust reporting, but also may improve match quality. In embodiments, single-frame appearances may be discarded as false positives, and temporal hints may allow improved robustness for correct classification for each frame of the video. As an example, in embodiments, the classifier 1534 may classify at least one of a plurality of features to identify a candidate target emblem in the video frame. The tracker 1536 may be configured to determine that the candidate target emblem does not appear in an additional video frame; and identify, based on determining that the candidate target emblem does not appear in an additional video frame, the candidate target emblem as a false-positive.

The tracked identified emblems may be used to generate a report of emblem appearance, location, apparent size, and duration of appearance. As shown in FIG. 15, the emblem identifier 1520 may further include a reporting component 1538 configured to generate a report based on the tracked identified emblem. The report may include any number of different types of information including, for example, a listing of identified emblems, placement of each identified emblem, duration of appearance of each identified emblem, and/or the like. The reporting component 1538 may provide the report, via the communication component 1524, to an emblem owner. In embodiments, the communication component 1524 may be configured to send a notification to the emblem owner, facilitate access to the report via a webpage, and/or the like.

As shown in FIG. 15, the encoding device 1502 also includes an encoder 1522 configured for entropy encoding of partitioned video frames. In embodiments, the communication component 1524 is configured to communicate encoded video data 1506. For example, in embodiments, the communication component 1524 may facilitate communicating encoded video data 1506 to the decoding device 1508.

According to embodiments, the emblem identifier 1520 may be configured to process emblem information to generate the emblem data 1530. That is, for example, prior to live identification, the database 1526 of target emblems may be processed for feature identification offline. Processing the emblem information may be performed by the segmenter 1518 and the feature extractor 1532. By processing the emblem information before performing an emblem identification procedure, embodiments of the present disclosure facilitate training classifiers (e.g., the classifier 1534) that can more efficiently identify the emblems. Additionally, in this manner, emblems that are split by the segmentation algorithm at runtime may be still well identified by the classifier 1534. As an example, an emblem with several leaves incorporated has a high chance of the leaves being segmented apart. By identifying the local features for each segment (e.g. a shape/texture descriptor for a leaf), embodiments of the present disclosure facilitate identifying those features on a segment-by-segment basis in the video stream.

In embodiments, for example, the encoding device 1502 may be configured to receive target emblem information, the target emblem information including an image of the target emblem. The encoding device 1502 may be further configured to receive non-target emblem information, the non-target emblem information including an image of one or more non-target emblems. The segmenter 1518 may be configured to segment the images of the target emblems and/or non-target emblems, and the feature extractor 1532 may be configured to extract a set of target emblem features from the target emblem; and extract a set of non-target emblem features from the non-target emblem. In this manner, the emblem identifier 1520 may train the classifier 1534 based on the set of target emblem features and the set of non-target emblem features.

The illustrative operating environment 1500 shown in FIG. 15 is not intended to suggest any limitation as to the scope of use or functionality of embodiments of the present disclosure. Neither should the illustrative operating environment 1500 be interpreted as having any dependency or requirement related to any single component or combination of components illustrated therein. Additionally, any one or more of the components depicted in FIG. 15 may be, in embodiments, integrated with various ones of the other components depicted therein (and/or components not illustrated), all of which are considered to be within the ambit of the present disclosure.

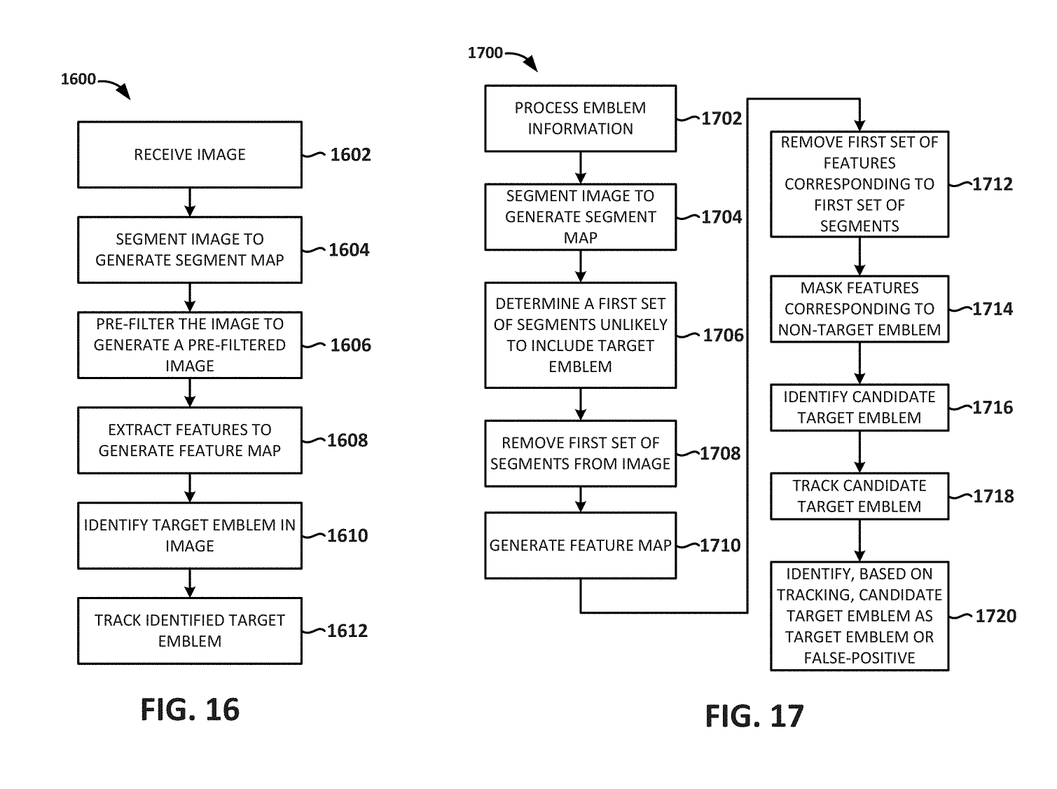

FIG. 16 is a flow diagram depicting an illustrative method 1600 of identifying a target emblem in a video stream, in accordance with embodiments of the present disclosure. In embodiments, aspects of the method 1600 may be performed by a video processing device (e.g., the video processing device 1402 depicted in FIG. 14 and/or the encoding device 1502 depicted in FIG. 15). As shown in FIG. 16, embodiments of the illustrative method 1600 may include receiving video data containing an image (block 1602). In embodiments, the image may be a video frame, which may include, for example, one or more video frames received by the video processing device from another device (e.g., a memory device, a server, and/or the like).

Embodiments of the method 1600 further include segmenting the image to generate a segment map (block 1604). The image may be pre-filtered (block 1606), based on the segment map. For example, in embodiments, the method 1600 includes pre-filtering the image by determining, using one or more color metrics, that each segment of a first set of segments is unlikely to include the target emblem; and removing the first set of segments from the image to generate a pre-filtered image. In embodiments, the one or more color metrics includes metrics generated by performing color histogram matching.

According to embodiments, the method 1600 further includes extracting features from the pre-filtered image to generate a feature map (block 1608). Embodiments of the method 1600 further include identifying the target emblem in the image (block 1610). Identifying the target emblem may include classifying at least one of a plurality of features, using a classifier, to identify the target emblem in the video frame. In embodiments, the classifier may include a bag-of-visual-words model. In embodiments, before classification, the method 1600 further includes removing, from the feature map, a first set of features, wherein at least a portion of each of the first set of features is located in at least one of the segments of the first set of segments. Additionally, or alternatively, embodiments of the method 1600 further include masking, using an additional classifier, at least one feature corresponding to a non-target emblem.

The method 1600 may further include tracking the identified target emblem by identifying an additional video frame in which the identified target emblem appears (block 1612). Although not illustrated, embodiments of the method 1600 may further include generating a report based on the tracked identified emblem. According to embodiments, the report may include any number of different types of information including, for example, target emblem appearance frequency, target emblem size, target emblem placement, and/or the like.

FIG. 17 is a flow diagram depicting another illustrative method 1700 of identifying a target emblem in a video stream, in accordance with embodiments of the present disclosure. The video stream may include video data, the video data including one or more video frames, where each video frame includes an image. In embodiments, aspects of the method 1700 may be performed by a video processing device (e.g., the video processing device 1402 depicted in FIG. 14 and/or the encoding device 1502 depicted in FIG. 15). As shown in FIG. 17, embodiments of the illustrative method 1700 include processing emblem information (block 1702). Processing emblem information may include, for example, receiving target emblem information, the target emblem information including an image of the target emblem; and extracting a set of target emblem features from the target emblem. Processing emblem information may also include receiving non-target emblem information, the non-target emblem information including an image of one or more non-target emblems; and extracting a set of non-target emblem features from the one or more non-target emblems. Processing the emblem information may further include training one or more classifiers based on the target and/or non-target emblem features.

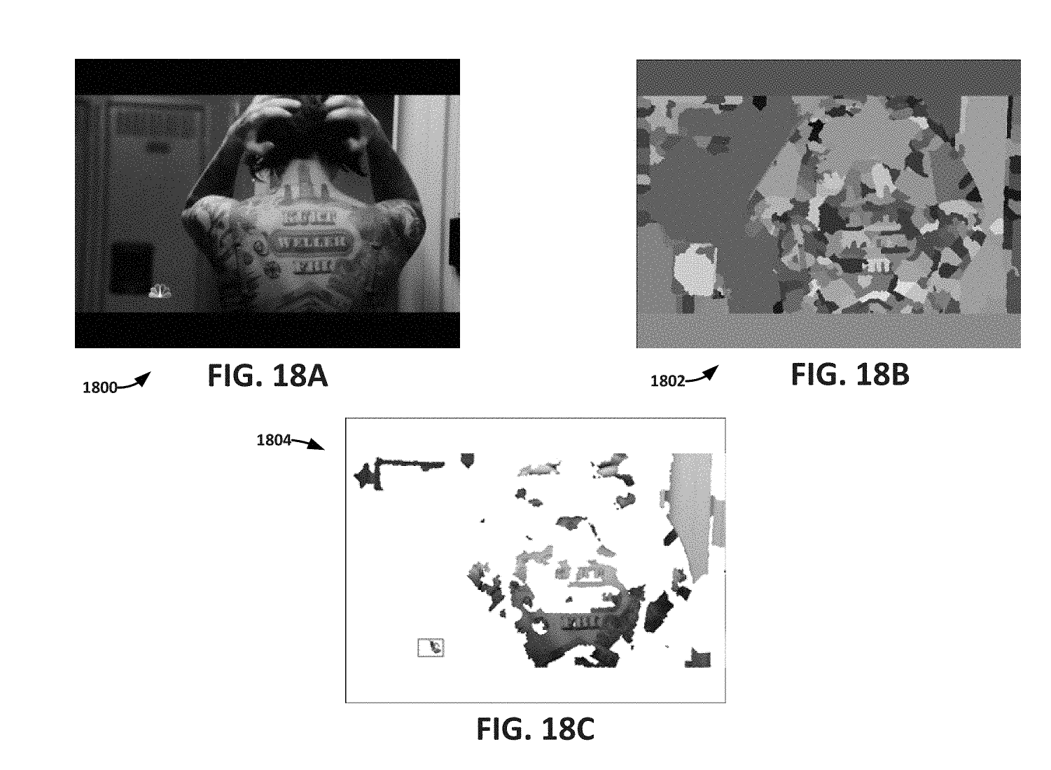

Embodiments of the illustrative method 1700 may include segmenting the image to generate a segment map (block 1704). Embodiments of the method 1700 further include pre-filtering the image by determining a first set of segments unlikely to include the target emblem (block 1706) and removing the first set of segments from the image to generate a pre-filtered image (block 1708). For example, the image may be the illustrative image 1800 depicted in FIG. 18A, containing an NBC emblem. The method 1700 may include segmenting the image 1800 to generate a segment map 1802, depicted in FIG. 18B. A pre-filter (e.g., the pre-filter 1528 depicted in FIG. 15) may be used to identify segments of the segment map 1802 that are not likely to include the NBC emblem. That is, for example, color metrics may be determined and matching utilized to identify segments that are not likely to include the colors and/or color patterns or characteristics of the NBC emblem. Those segments may be removed from the image to generate the filtered image 1804 depicted in FIG. 18C.

Embodiments of the method 1700 further include generating a feature map (block 1710). In embodiments, the method 1700 may also include removing a first set of features corresponding to the first set of segments (block 1712) and masking features corresponding to the non-target emblems (block 1714). A classifier is used to identify a candidate target emblem (block 1716). In embodiments, the method 1700 includes tracking the candidate target emblem (block 1718) and identifying, based on the tracking, the candidate target emblem as the target emblem or as a false-positive (block 1720). For example, in embodiments, the method 1700 includes determining that the candidate target emblem does not appear in an additional video frame; and identifying, based on determining that the candidate target emblem does not appear in an additional video frame, the candidate target emblem as a false-positive. In embodiments, the method 1700 may alternatively include determining that the candidate target emblem appears in an additional video frame; and identifying, based on determining that the candidate target emblem appears in an additional video frame, the candidate target emblem as the target emblem.

### Foreground Detection

As indicated in FIG. 2, embodiments of the illustrative video processing process 200 depicted in FIG. 2 include foreground detection 208. Foreground detection may facilitate providing both efficient allocation of computational resources and a method for reducing false-positives when determining which parts of a video sequence are “important” for some desired purpose. Many traditional methods of foreground detection consider the changes in pixel values between frames. Some methods of filtration—such as a median filter—are often used, and are described, for example, in P-M. Jodoin, S. Pierard, Y. Wang, and M. Van Droogenbroeck, “Overview and Benchmarking of Motion Detection Methods,” Background Modeling and Foreground Detection for Video Surveillance, Chapter 1, the entirety of which is hereby incorporated herein by reference for all purposes. A more recently developed approach is the use of a fractal measure applied to a portion of a video frame, with a fractal dimensionality of the joint histogram suggesting a contextual change, distinct from a local lighting change; here, the dimensionality is measured using a box-counting method, as described by Farmer in M. E. Farmer, “A Chaos Theoretic Analysis of Motion and Illumination in Video Sequences”, Journal of Multimedia, Vol. 2, No. 2, 2007, pp. 53-64; and M. E. Farmer, “Robust Pre-Attentive Attention Direction Using Chaos Theory for Video Surveillance”, Applied Mathematics, 4, 2013, pp. 43-55, the entirety of each of which is hereby incorporated herein by reference for all purposes. Searching for explicitly self-similar structures in image physical space has also been used with success to find important parts of an image, as described in H. Li, K. J. R. Lui, and S-C. B. Lo, “Fractal Modeling and Segmentation in the Enhancement of Microcalcifications in Digital Mammograms”, Report by Institute for Systems Research, University of Maryland, College Park, Md., 20742, 1997, the entirety of which is hereby incorporated herein by reference for all purposes.

Embodiments of the subject matter disclosed herein include systems and methods for foreground detection that facilitate identifying pixels that indicate a substantive change in visual content between frames, and applying a filtration technique that is based on fractal-dimension methods. For example, a filter may be applied that is configured to eliminate structures of dimensionality less than unity, while preserving those of dimensionality of unity or greater. Embodiments of techniques described herein may enable foreground detection to be performed in real-time (or near real-time) with modest computational burdens. Embodiments of the present disclosure also may utilize variable thresholds for foreground detection and image segmentation techniques. As the term is used herein, “foreground detection” (also referred to, interchangeably, as “foreground determination”) refers to the detection (e.g., identification, classification, etc.) of pixels that are part of a foreground of a digital image (e.g., a picture, a video frame, etc.).

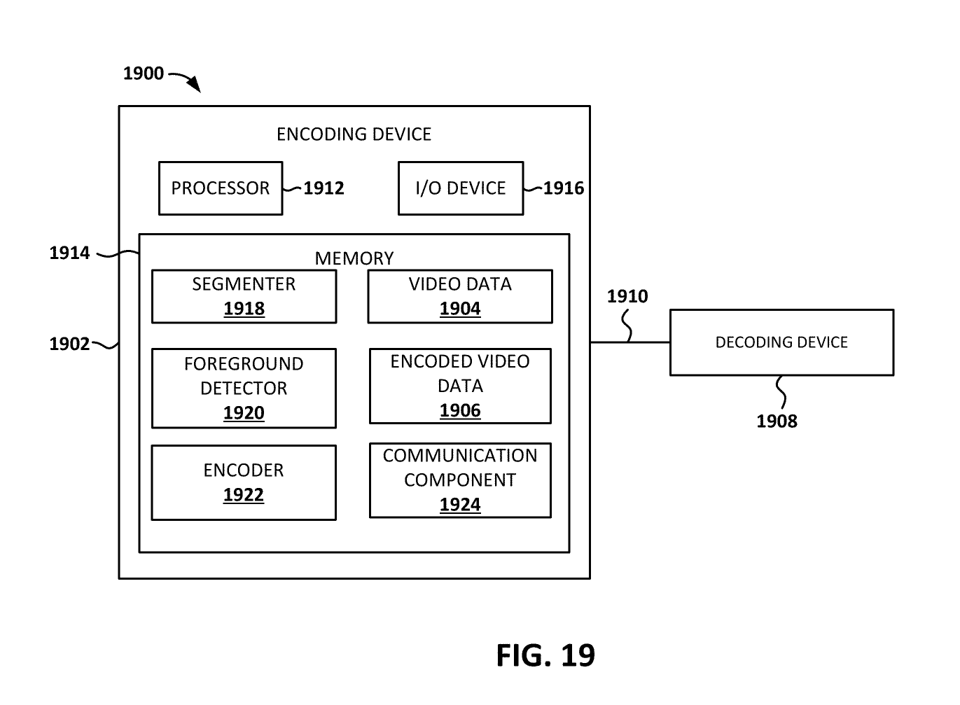

FIG. 19 is a block diagram illustrating an operating environment 1900 in accordance with embodiments of the present disclosure. The operating environment 1900 includes an encoding device 1902 that may be configured to encode video data 1904 to create encoded video data 1906. According to embodiments, the encoding device 202 may be, include, be similar to, or be included in, the video processing device 300 depicted in FIG. 3. As shown in FIG. 19, the encoding device 1902 may also be configured to communicate the encoded video data 1906 to a decoding device 1908 via a communication link 1910. In embodiments, the decoding device 1908 may be, include, be similar to, or be included in the decoding device 308 depicted in FIG. 3. In embodiments, the communication link 1910 may be, include, be similar to, or be included in, the communication links 106 and/or 110 depicted in FIG. 1, and/or the communication link 310 depicted in FIG. 3.

As shown in FIG. 19, the encoding device 1902 may be implemented on a computing device that includes a processor 1912, a memory 1914, and an input/output (I/O) device 1916. Although the encoding device 1902 is referred to herein in the singular, the encoding device 1902 may be implemented in multiple instances, distributed across multiple computing devices, instantiated within multiple virtual machines, and/or the like. In embodiments, the processor 19212 executes various program components stored in the memory 1914, which may facilitate encoding the video data 1906. In embodiments, the processor 1912 may be, or include, one processor or multiple processors. In embodiments, the I/O device 1916 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 1914 stores computer-executable instructions for causing the processor 1912 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 1918, a foreground detector 1920, an encoder 1922, and a communication component 1924.

In embodiments, the segmenter 1918 may be configured to segment a video frame into a number of segments. The segments may include, for example, objects, groups, slices, tiles, and/or the like. The segmenter 1918 may employ any number of various automatic image segmentation methods known in the field. In embodiments, the segmenter 1918 may use image color and corresponding gradients to subdivide an image into segments that have similar color and texture. Two examples of image segmentation techniques include the watershed algorithm and optimum cut partitioning of a pixel connectivity graph. For example, the segmenter 1918 may use Canny edge detection to detect edges on a video frame for optimum cut partitioning, and create segments using the optimum cut partitioning of the resulting pixel connectivity graph. According to embodiments, the segmenter 1918 may be, include, be similar to, or be included in the segmenter 318 depicted in FIG. 3.

In embodiments, the foreground detector 1920 is configured to perform foreground detection on a video frame. For example, in embodiments, the foreground detector 1920 may perform segment-based foreground detection, where the foreground segments, or portions of the segments, determined by the segmenter 1918 are detected using one or more aspects of embodiments of the methods described herein. In embodiments, the foreground detector 1920 may perform foreground detection on images that have not been segmented. In embodiments, results of foreground detection may be used by the segmenter 1918 to inform a segmentation process. According to embodiments, the foreground detector 1920 may be, include, be similar to, or be included in the foreground detector 322 depicted in FIG. 3.

As shown in FIG. 19, the encoding device 1902 also includes an encoder 1922 configured for entropy encoding of partitioned video frames, and a communication component 1924. According to embodiments, the encoder 1922 and the communication component 1924 may, be, include, be similar to, or be included in the encoder 334 or the communication component 336, respectively, depicted in FIG. 3. In embodiments, the communication component 1924 is configured to communicate encoded video data 1906. For example, in embodiments, the communication component 1924 may facilitate communicating encoded video data 1906 to the decoding device 1908.

The illustrative operating environment 1900 shown in FIG. 19 is not intended to suggest any limitation as to the scope of use or functionality of embodiments of the present disclosure. Neither should the illustrative operating environment 1900 be interpreted as having any dependency or requirement related to any single component or combination of components illustrated therein. Additionally, any one or more of the components depicted in FIG. 19 may be, in embodiments, integrated with various ones of the other components depicted therein (and/or components not illustrated), all of which are considered to be within the ambit of the present disclosure.

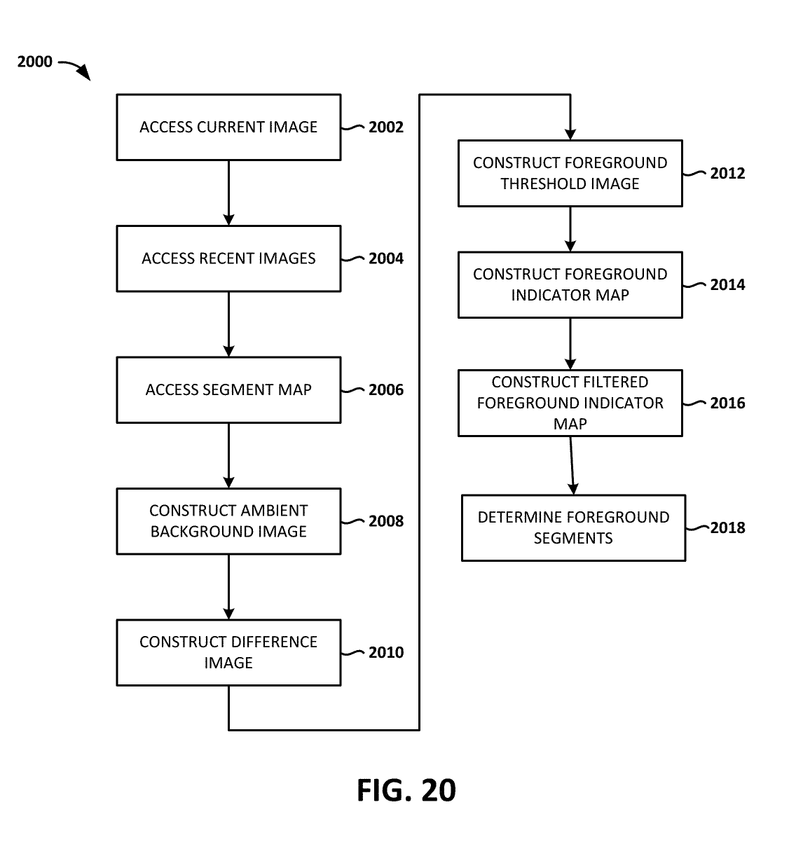

FIG. 20 is a flow diagram depicting an illustrative method 2000 of detecting foreground pixels in an image. In embodiments, aspects of the method 2000 may be performed by an encoding device (e.g., the encoding device 1902 depicted in FIG. 19). As shown in FIG. 20, embodiments of the illustrative method 2000 may include accessing a current image (block 2002) and accessing a set of previous images (block 2004). In embodiments, the current image and set of previous images may include one or more video frames received by the encoding device from another device (e.g., a memory device, a server, and/or the like). In embodiments, the set of recent images may include one image, two images, three images, four images, or more than four images. In embodiments, the previous (e.g., recent) images have been properly registered to align with the “current” (most recent) image, including, for example, corrections for global illumination changes, such as for example, is described in M. E. Farmer, “A Chaos Theoretic Analysis of Motion and Illumination in Video Sequences,” Journal of Multimedia, Vol. 2, No. 2, 2007, pp. 53-64; N. Chumchob and K. Chen, “A Robust Affine Image Registration Method,” International Journal of Numerical Analysis and Modeling, Vol. 6, No. 2, pp 311-334, 2009; and Sorwar, G.; Murshed, M. and Dooley, L. (2003), “Fast global motion estimation using iterative least-square estimation technique,” 4th International Conference on Information, Communications and Signal Processing and Pacific-Rim Conference on Multimedia (ICICS-PCM '03), 15-18 Dec. 2003, Singapore, the entirety of each of which is hereby incorporated herein by reference for all purposes. In this manner, the set of images may include a current image having a set of pixels, a first previous image having a set of pixels, at least one of which corresponds to at least one of the set of pixels of the current image, and a second previous image having a set of pixels, at least one of which corresponds to at least one pixel in each of the current image and the first previous image.

For instance, if a recording camera moves or changes zoom during recording of a video sequence, embodiments include providing a way to compensate for that motion, so that the background of the sequence may be kept at least substantially properly aligned between frames to a degree of acceptable accuracy. Similarly, if there is some sort of lighting change in the video sequence—e.g., due to a change in the physical lighting of the scene and/or due to a fade effect applied to the video—images may be adjusted to compensate for such effects.

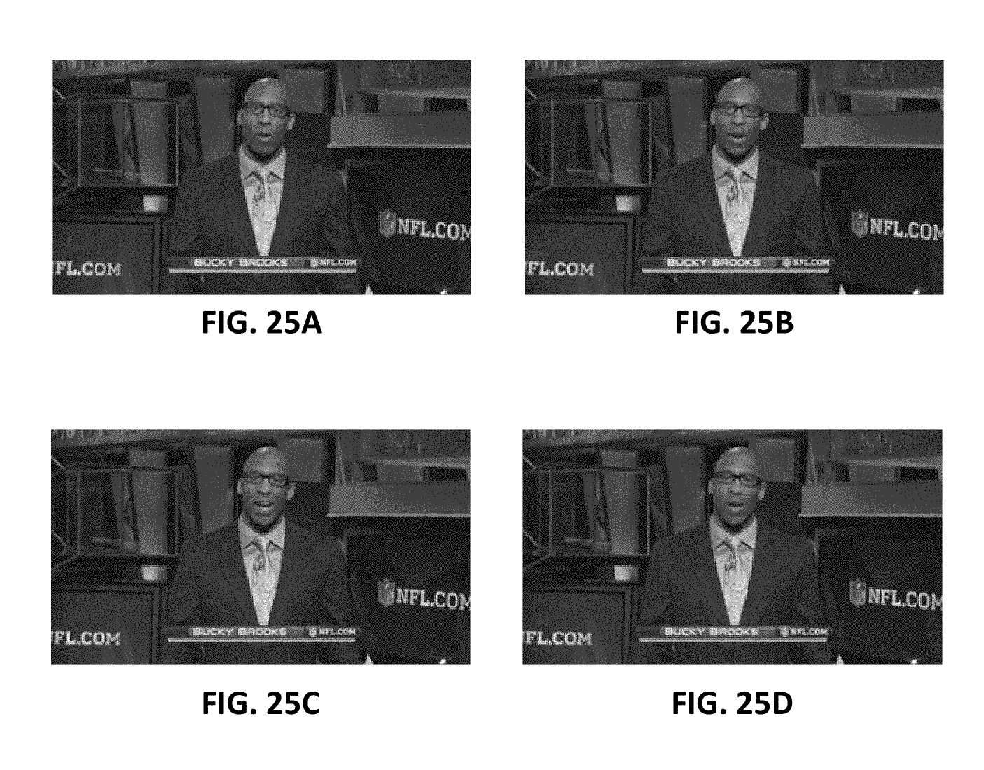

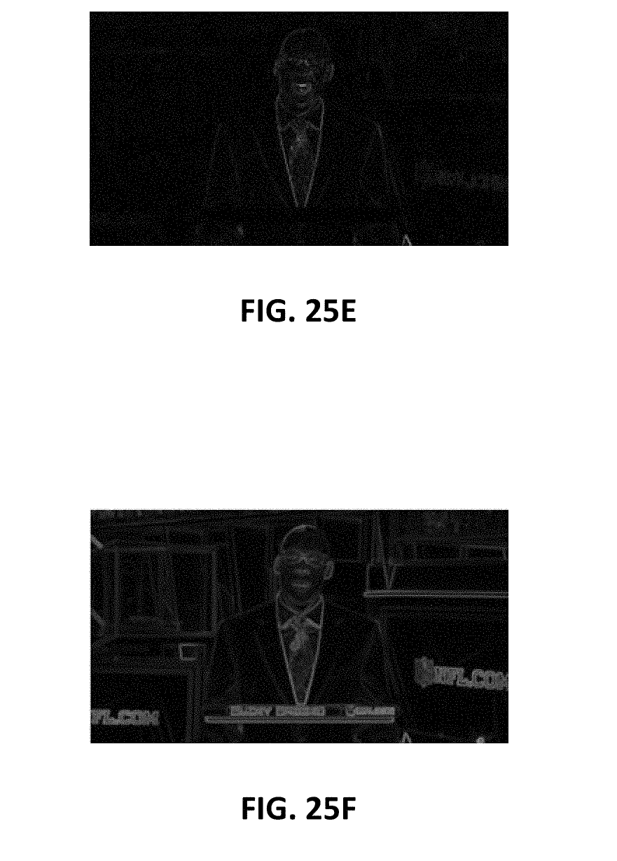

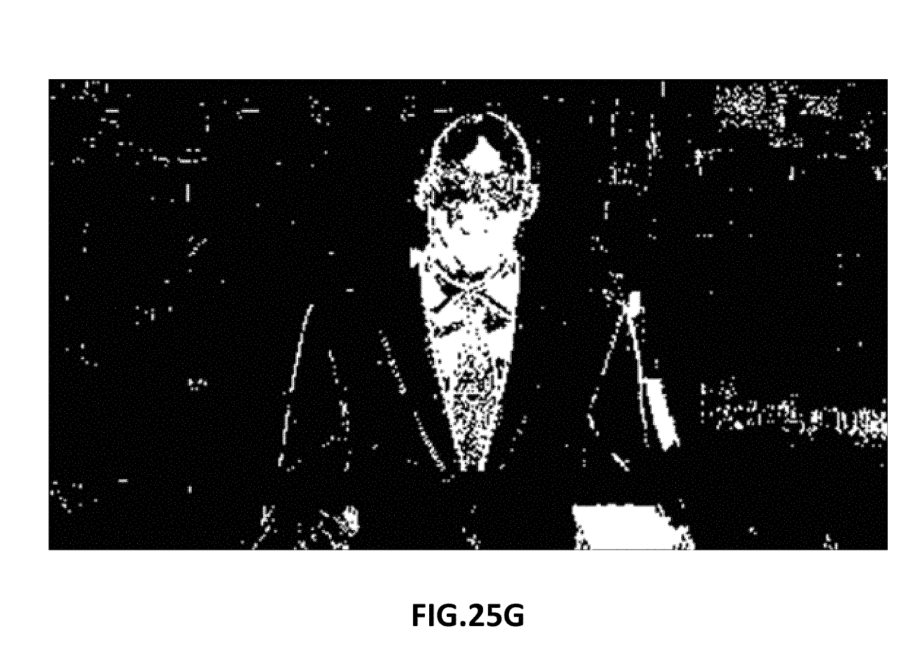

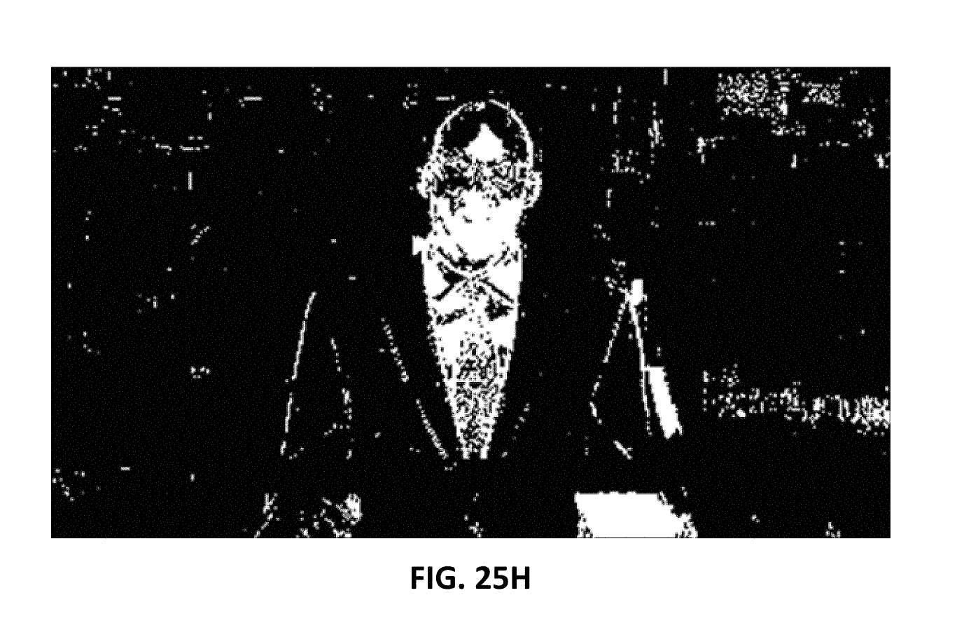

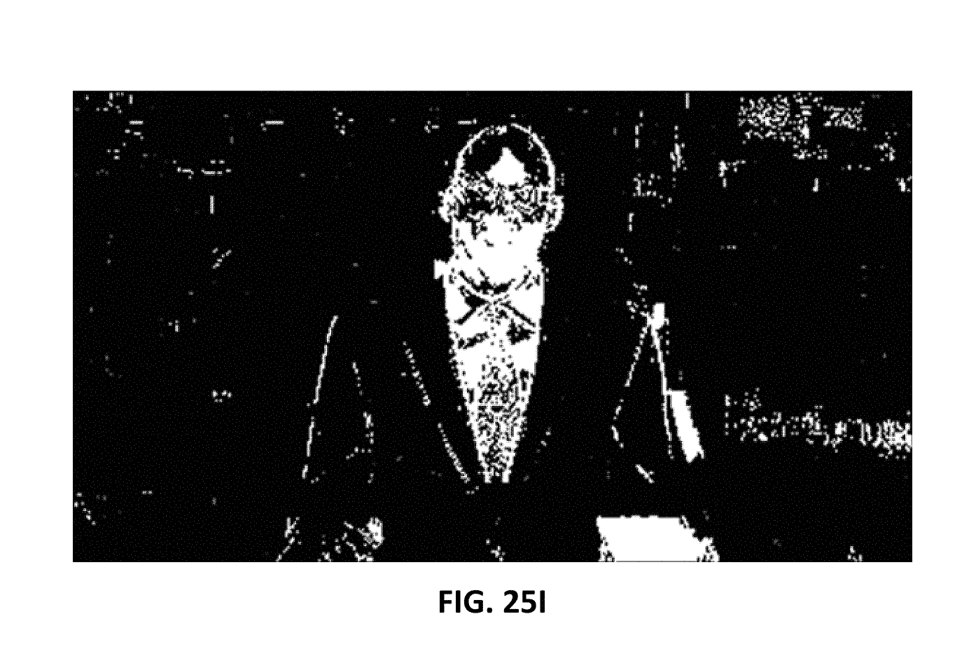

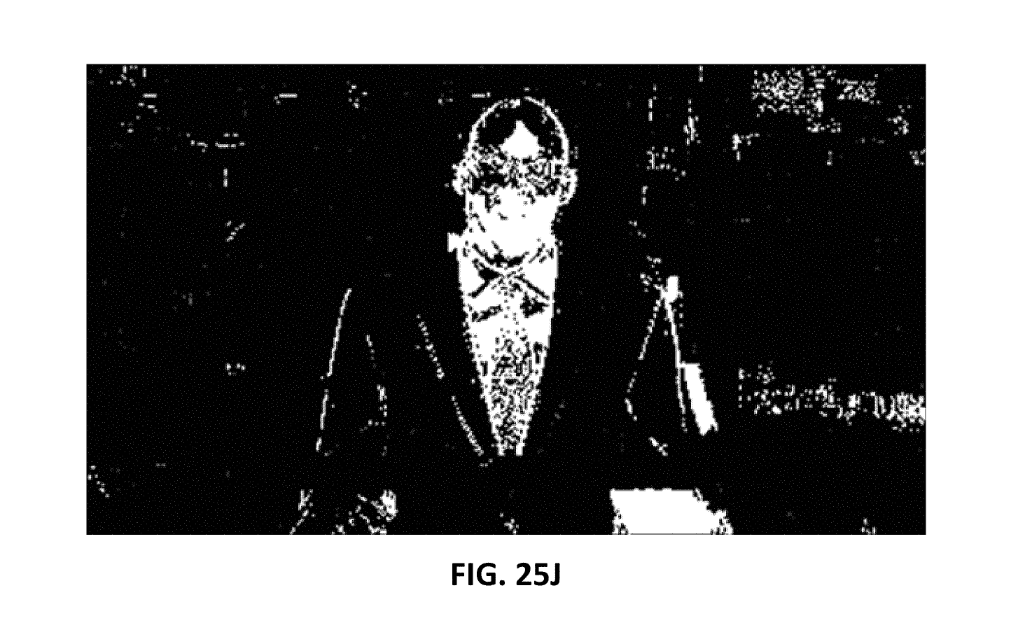

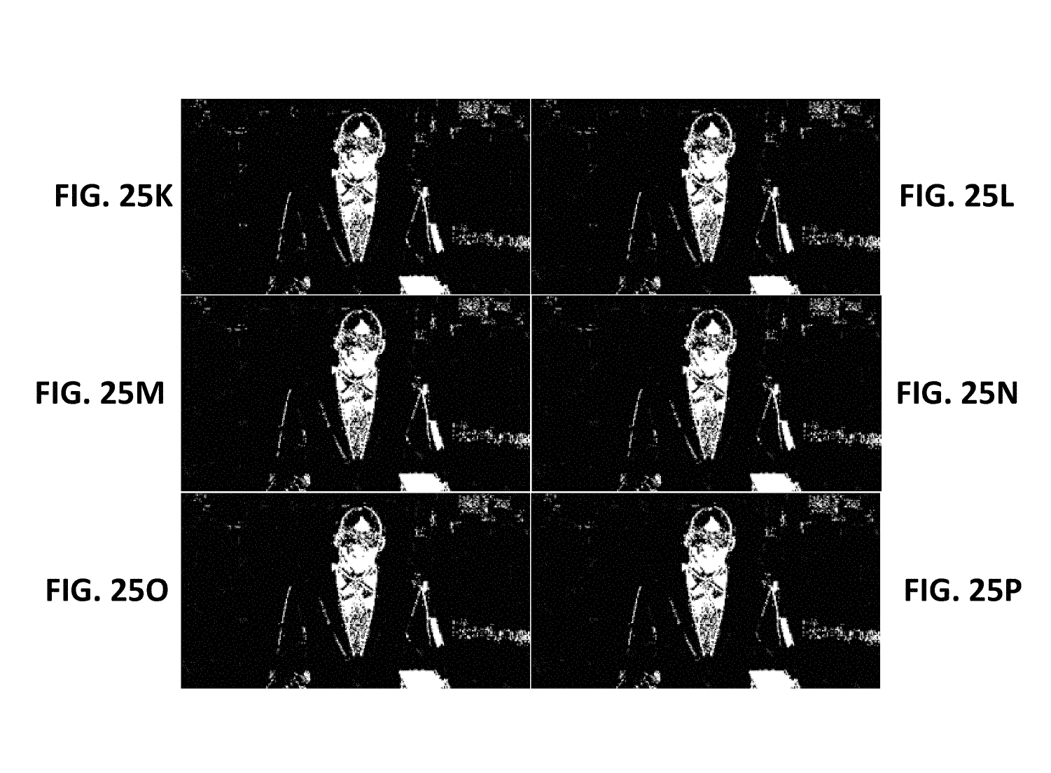

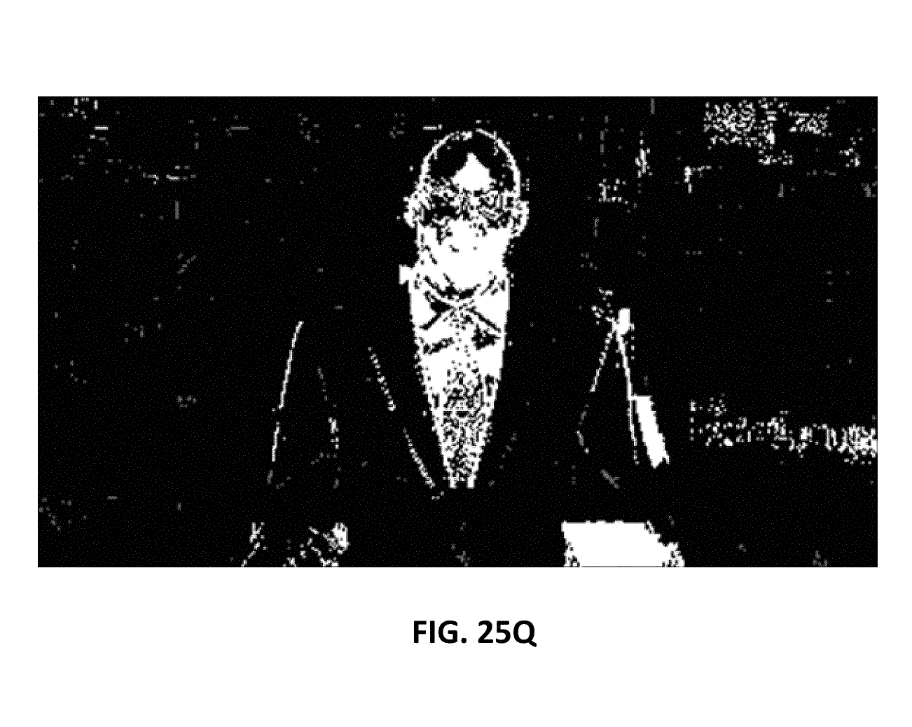

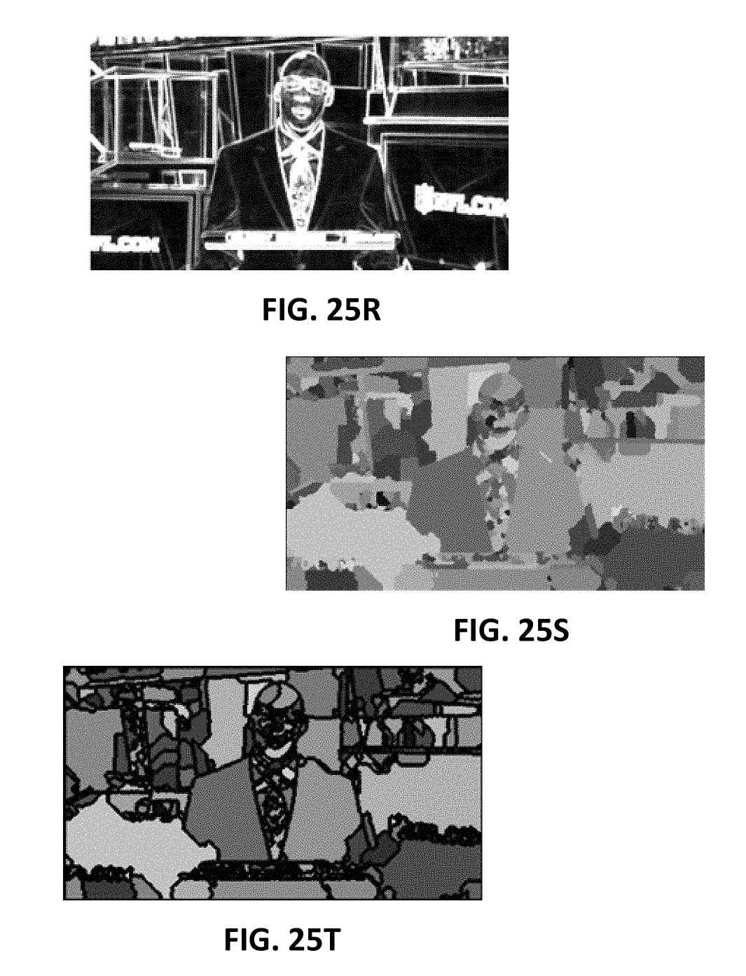

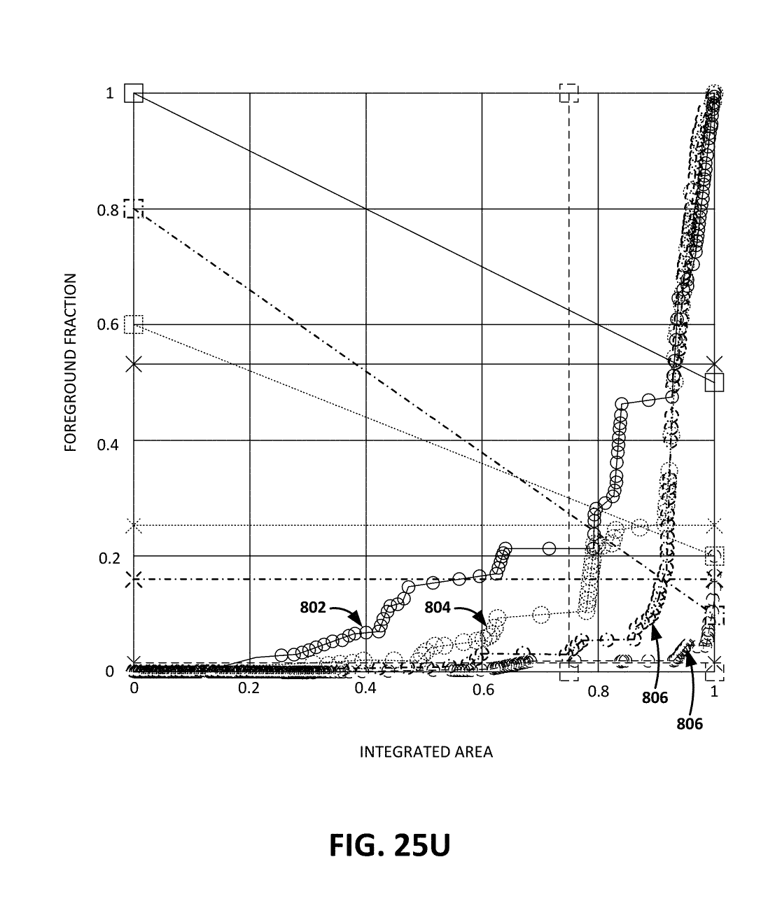

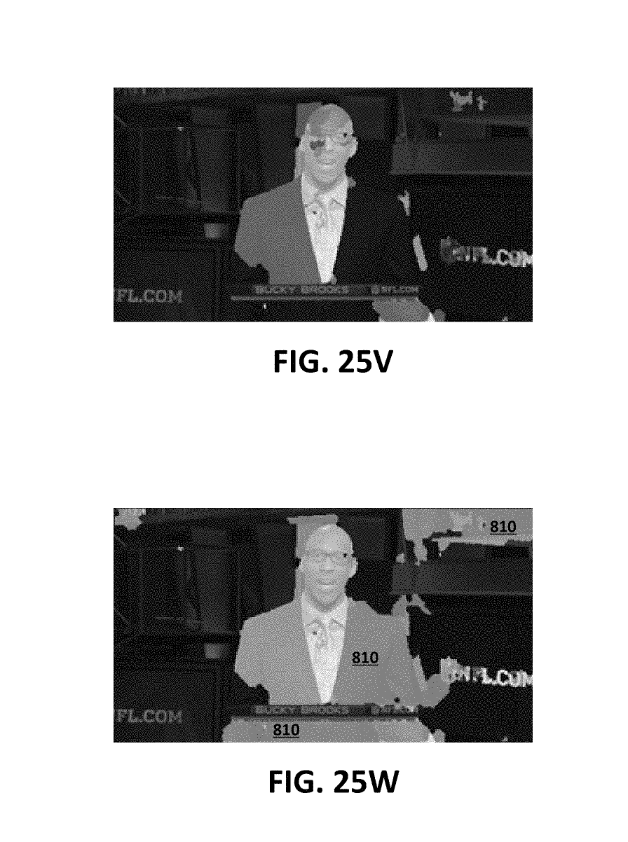

For example, FIGS. 25A and 25B depict illustrative previous frames associated with a first exemplary implementation of embodiments of an algorithm for detecting foreground in a video frame (“first example”). FIG. 25A (left) depicts a Frame 000123 of nfl_bucky.avi_384×216_444.yuv. FIG. 25B (right) depicts Frame 000124 of the same sequence. These frames are a second previous frame (e.g., a “previous frame”), and a first previous frame (e.g., a “previous frame”) for current frame 000125, which is analyzed in the following figures. The scene shows negligible camera motion and a nearly stationary man speaking to the viewer.

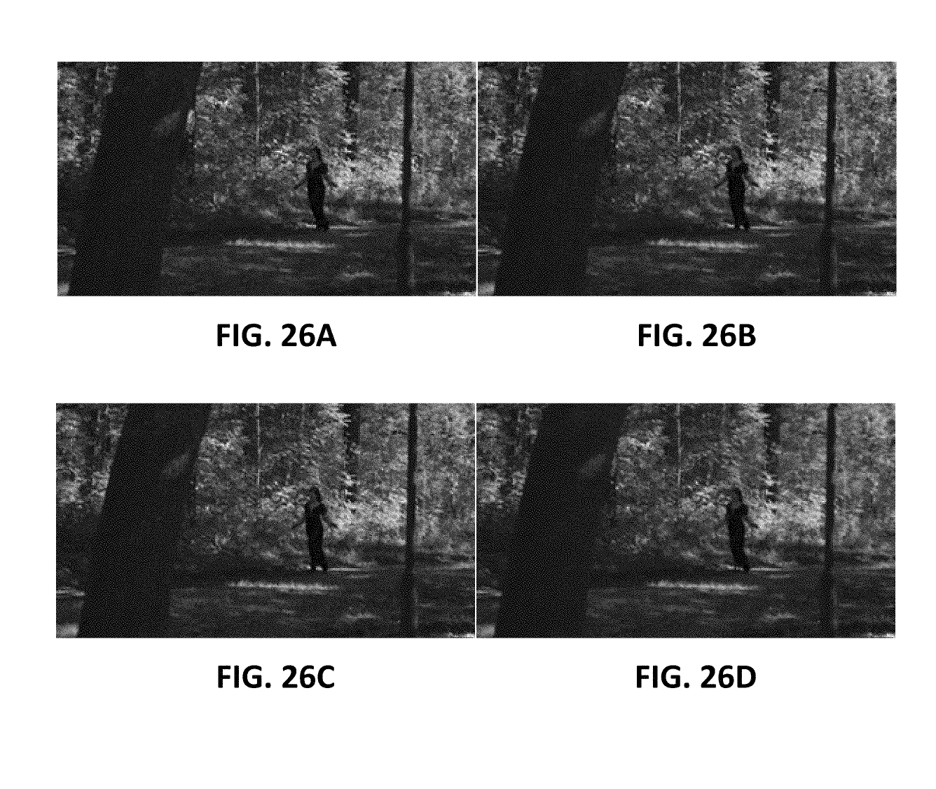

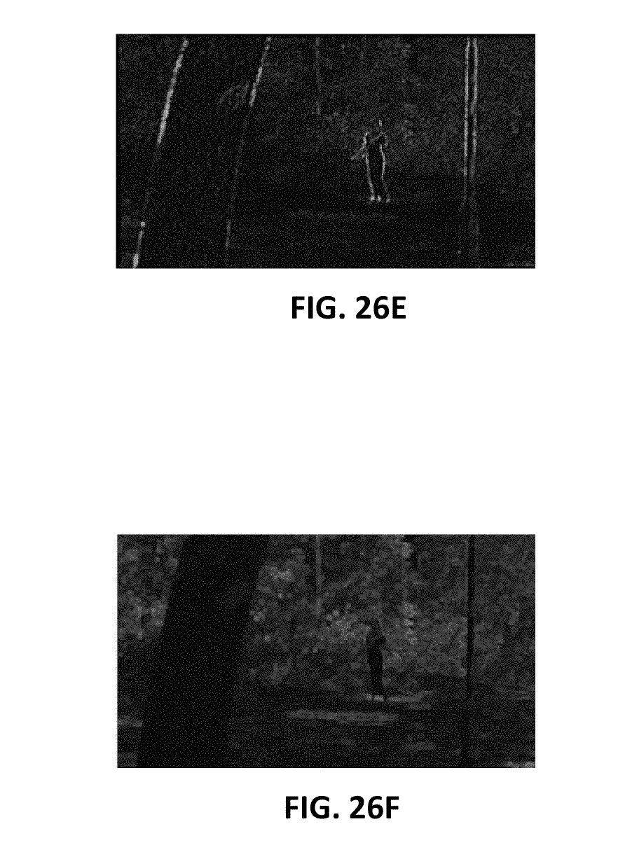

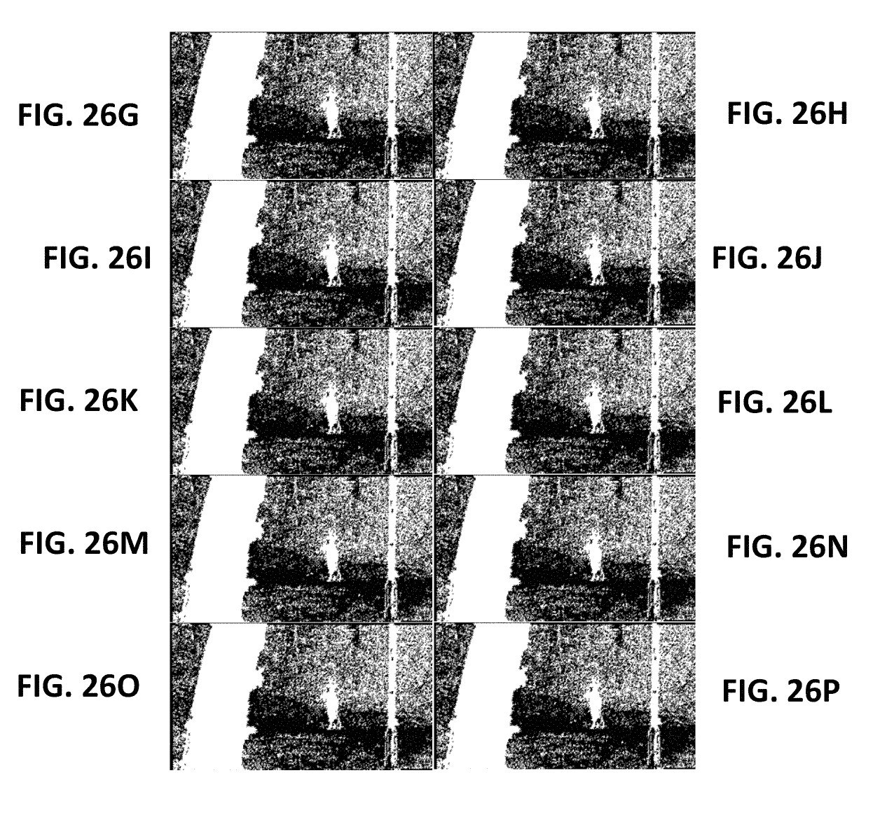

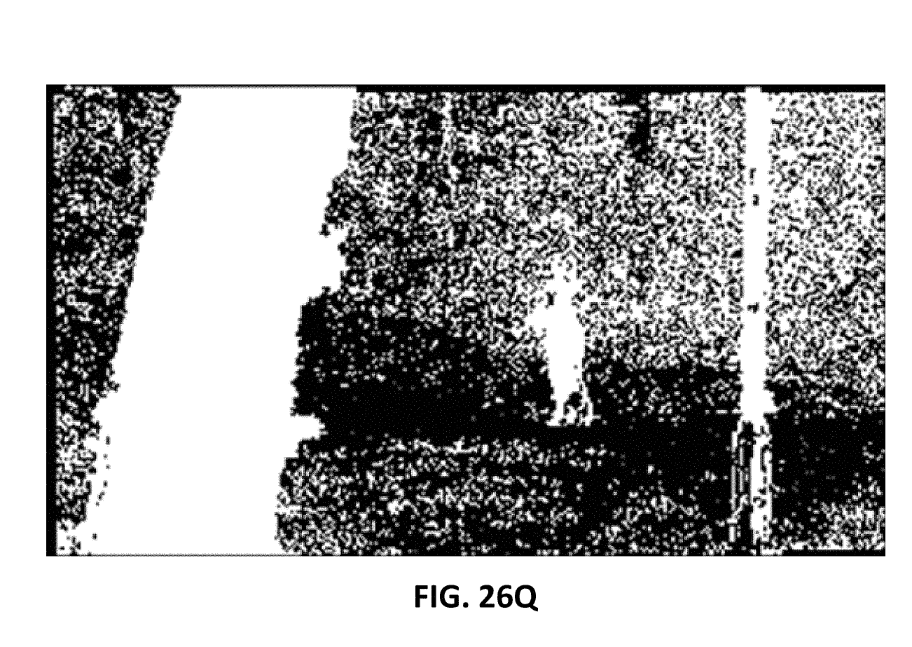

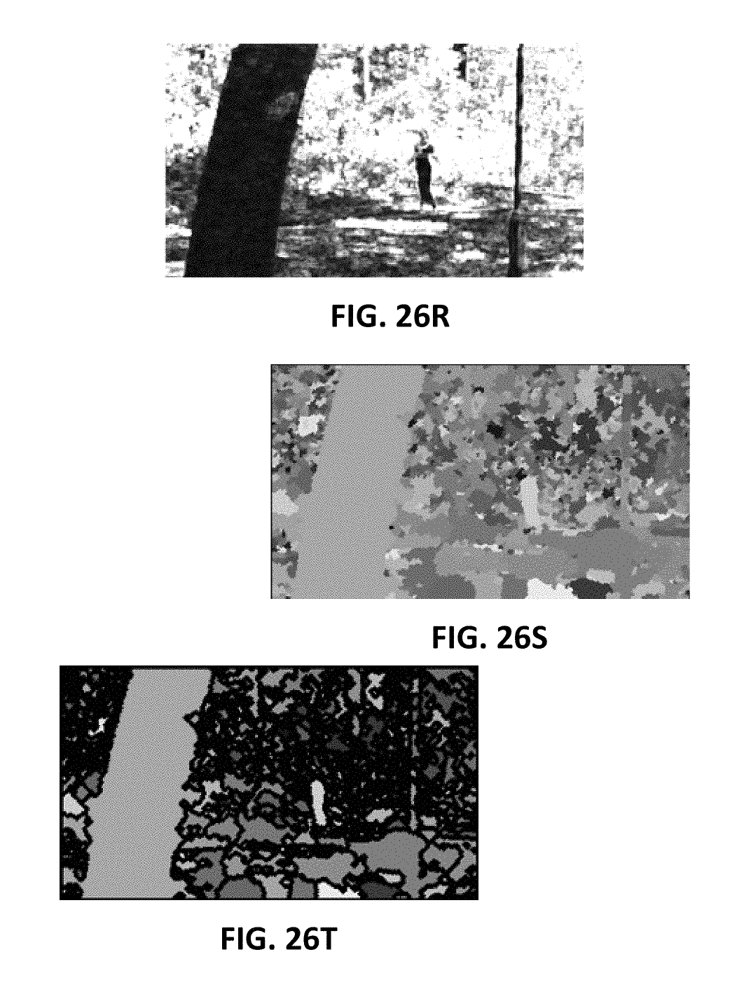

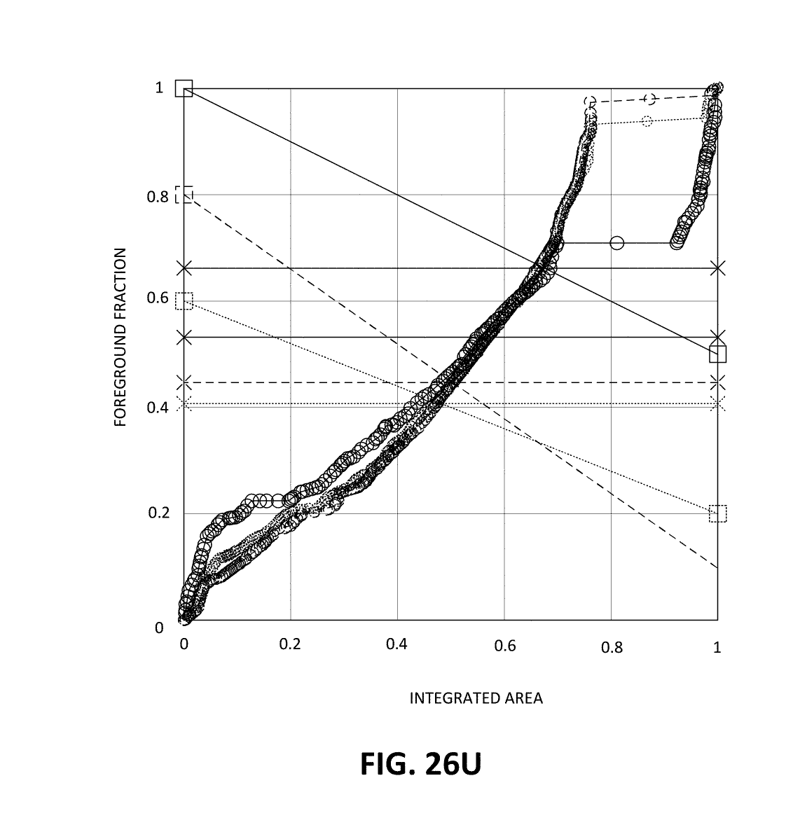

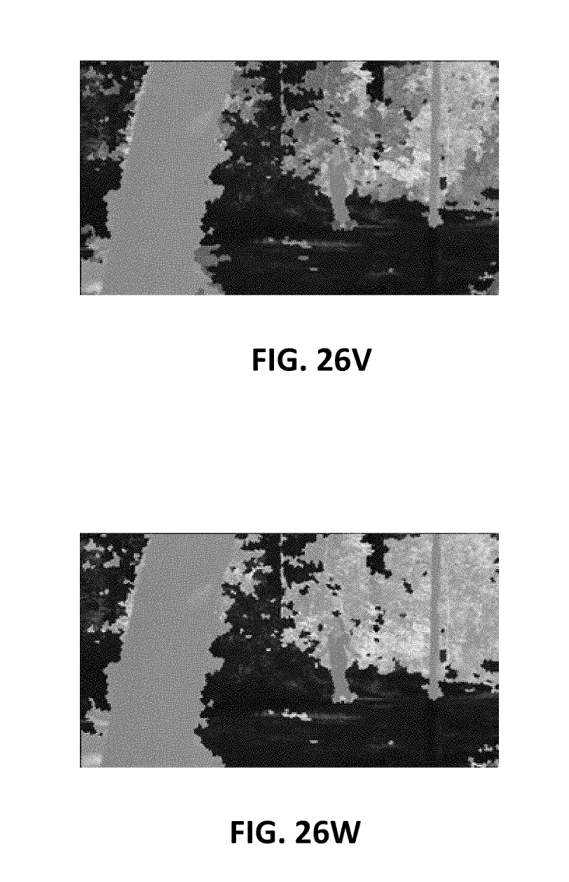

In a second exemplary implementation of embodiments of an algorithm for detecting foreground in a video frame (“second example”), FIG. 26A (left) depicts a Frame 002048 of AVC_720p_Stream2Encoders.y4m_320×180_444.yuv, which is a modified test video from the CableLabs research and development consortium. FIG. 26B (right) depicts Frame 002049 of the same sequence. The scene shows a woman walking through a forest with the camera tracking along with her, and several trees in the physical foreground have apparent motion due to parallax.

As shown in FIG. 20, the embodiments of the illustrative method 2000 may further include accessing a segment map (block 2006) that defines at least one segment of the current image such as, for example, is described in R. C. Gonzalez, R. E. Woods, “Image Segmentation,” Digital Image Processing, Second Edition, Chapter 10, Prentice-Hall, Inc, 2002j; and M. Sonka, V. Hlavac, R. Boyle, “Segmentation I,” Image Processing, Analysis, and Machine Vision, Chapter 6, Thomson Learning, 2008, the entirety of each of which is hereby incorporated herein by reference for all purposes. In embodiments, a segment map, in which the current frame is carved up in to distinct segments, may be accessed (e.g., generated, retrieved from storage, and/or the like), and may include each different visible object in the frame as its own segment. In embodiments, the segment map may include over-segmentation (individual objects being carved in to multiple segments). In embodiments, the segment map may include under-segmentation (multiple objects being joined as parts of the same segment). According to embodiments, foreground detection may include erring on the side of allowing false-positives.

As shown, embodiments of the illustrative method 2000 may include constructing an ambient background image (block 2008). The ambient background image may be used as an approximation of the unchanging background and may be constructed in any number of different ways. For example, in embodiments, the ambient background image may be a median background image that includes a set of pixels, each of the set of pixels of the median background image having a plurality of color components, where each color component of each pixel of the median background image is the median of a corresponding component of corresponding pixels in the current image, the first previous image, and the second previous image. In embodiments, the ambient background image may be constructed using other types of averages (e.g., mean and/or mode), interpolations, and/or the like.

Examples of a median background image are shown in the FIGS. 25D and 26D. For example, FIG. 25C (left) depicts Frame 000125, the “current frame” for the first example analysis described herein. FIG. 25D (right) depicts the median background image associated with the first example analysis. In this case, the median image is nearly identical to frame 000124, though careful comparison shows some changes around the man's mouth. In the second example, FIG. 26C (left) depicts Frame 002050, and FIG. 26D (right) depicts the median background image.

According to embodiments of the method 2000, a difference image is constructed (block 2010). In embodiments, the difference image includes a set of pixels, where each pixel of the difference image indicates a difference between a corresponding pixel in the ambient background image and a corresponding pixel in the current image. Embodiments further include constructing a foreground threshold image (block 2012). In embodiments, the threshold image includes a set of pixels, where each pixel of the threshold image indicates an amount by which a pixel can change between images and still be considered part of the background.

Examples of a difference image and foreground threshold image are shown in the FIGS. 25E, 25F, 26E, and 26F. In the first example, FIG. 25E (left) depicts the difference image multiplied by four. The green component shows four times the difference in Y between the current frame and the median background image, the blue component shows four times the difference in Cb, and the red component shows for times the difference in Cr. FIG. 25F (right) depicts the foreground threshold image. The green component indicates the threshold in Y, the blue component indicates the threshold in Cb, and the red component indicates the threshold in Cr.

In the second example, FIG. 26E (left) depicts the difference image multiplied by four. FIG. 26F (right) depicts the foreground threshold image. The meanings of these figures are analogous to those of FIGS. 25E and 25F. It may be observed that the two trees in the physical foreground and the woman have strong outlines in the difference image, suggesting that investigation of noise reduction in the difference image may also be useful.

As shown, embodiments of the illustrative method 2000 may include constructing a foreground indicator map (FIM) (block 2014). The foreground indicator map includes a set of pixels, where each of the set of pixels of the foreground indicator map corresponds to one of the set of pixels in the current image, and where each of the set of pixels of the foreground indicator map includes an initial classification corresponding to a foreground or a background. The foreground indicator map may be a binary map or a non-binary map. In a binary map, each of the pixels may be classified as foreground or background, while in a non-binary map, each pixel may provide a measure of the probability associated therewith, where the probability is a probability that the pixel is foreground. In embodiments of the method 2000, a binary foreground indicator map (BFIM) may be used, a non-binary foreground indicator map (NBFIM) may be used, or both may be used.

Embodiments of the illustrative method 2000 further include constructing a filtered FIM by filtering noise from the FIM (block 2016). In embodiments, the FIM is filtered to remove sparse noise while preserving meaningful structures—for example, it may be desirable to retain sufficiently large one-dimensional structures during the filter process because the FIM more readily shows the edges of a moving object than the body of a moving object. Motivated by the concept of the box-counting fractal dimension, embodiments may include techniques that involve looking at varying size box-regions of the FIM, and using various criteria to declare pixels in the FIM as noise. In embodiments, these criteria may be chosen such that sufficiently large one-dimensional structures with some gaps are not eliminated while sufficiently sparse noise is eliminated.

Embodiments of the illustrative method 2000 may further include determining foreground segments (block 2018). According to embodiments, identifying at least one segment as a foreground segment or a background segment may include determining, based on the filtered BFIM, at least one foreground metric corresponding to the at least one segment; determining, based on the at least one foreground metric, at least one variable threshold; and applying the at least one variable threshold to the filtered BFIM to identify the at least one segment as a foreground segment or a background segment. Embodiments of the foreground detection algorithm make use of an image segmentation of the current frame, and may include determining which segments are likely to be moving, erring on the side of allowing false-positives.

In embodiments, foreground may be detected by applying a static threshold for each of the three fractions for each segment, declaring any segment over any of the thresholds to be in the foreground. According to embodiments, the algorithm may use variable thresholds which simultaneously consider the foreground fractions of a plurality of (e.g., every) segments in the current frame, providing an empirically justified trade-off between the threshold and the area of the frame that is declared to be foreground. This may be justified under the assumption that the system will rarely consider input where it is both content-wise correct and computationally beneficial for the entire frame to be considered foreground, and, simultaneously, there is little overhead to allowing a few false-positives when the entire frame should be considered background.

As indicated above, embodiments of the illustrative method may include constructing a binary foreground indicator map (BFIM). In embodiments, constructing the BFIM includes determining, for each of the set of pixels in the BFIM, whether a corresponding pixel in the difference image corresponds to a difference that exceeds a threshold, where the threshold is indicated by a corresponding pixel in the threshold image, the threshold image comprising a set of pixels, where each pixel of the threshold image indicates an amount by which a pixel can change between images and still be considered part of the background; and assigning an initial classification to each of the set of pixels in the BFIM, wherein the initial classification of a pixel is foreground if the corresponding difference exceeds the threshold. That is, for example, in embodiments, each pixel of the BFIM is given a value of 1 if the corresponding pixel in the difference image shows a difference larger than the threshold indicated by the corresponding pixel in the threshold image; otherwise, the pixel is given a value of 0. Embodiments may allow for pixels to be marked as foreground in the BFIM based on any available analysis from previous frames, such as projected motion.

Examples of the BFIM are shown in FIGS. 25G and 26G. In the first example, FIG. 25G depicts the initial BFIM. It may be observed that there are some strong outlines of the man's body, but there are also many noise pixels spread throughout the image. Several regions in the initial BFIM were declared foreground based on motion information projected from a previous frame.

In embodiments, the BFIM is filtered to remove sparse noise while preserving meaningful structures—for example, it may be desirable to retain sufficiently large one-dimensional structures during the filter process because the edges of a moving object more readily show up in the BFIM than the body of the object. As discussed above, a modified box counting technique may be used to filter the BFIM. According to embodiments, using the modified box counting technique may include constructing a neighbor sum map, the neighbor sum map including, for a first pixel of the set of pixels in the BFIM, a first neighbor sum map value and a second neighbor sum map value, where the first pixel includes an initial classification as foreground. The technique may also include applying, for the first pixel, a set of filter criteria to the first and second neighbor sum map values; and retaining the initial classification corresponding to foreground for the first pixel if the filter criteria are satisfied.

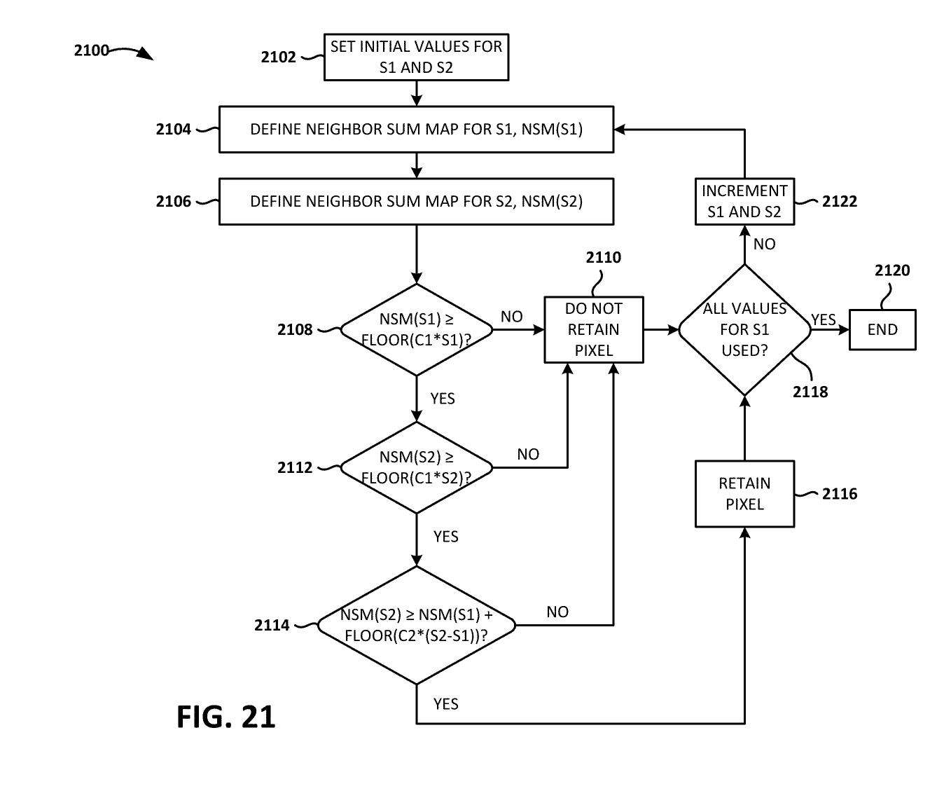

FIG. 21 depicts an illustrative method 2100 for filtering a BFIM in accordance with embodiments of the present disclosure. As shown, the illustrative method 2100 includes setting initial values for a first box half size, s1, and a second box half size, s2 (block 2102). In embodiments, s2 may be a function of s1. Embodiments of the method 2100 further include defining a neighbor sum map for s1 (NSM(S1)) (block 2104) and a neighbor sum map for s2 (NSM(S2)) (block 2106). In embodiments, for the BFIM and a given box half size, for any given pixel p, the technique includes looking at a box of size (1+2*box half size) by (1+2*box half size) centered on that pixel, and then counting the number of indicated foreground pixels in that box; this is the value of the neighbor sum map at the pixel p. To filter the BFIM, the neighbor sum map is defined using two different box half sizes, say s1 and s2, with s1<s2. A set of criteria may then be applied to the neighbor sum map for s1 and s2 to determine whether to retain a pixel as foreground.

For example, in embodiments of the method 2100 depicted in FIG. 21, for a foreground pixel to be retained, the neighbor sum maps at that pixel must pass all of the following conditions:

neighborSumMap(s1)≥floor(C1*s1); (1)

neighborSumMap(s2)≥floor(C1*s2); and, (2)

neighborSumMap(s2)≥neighborSumMap(s1)+floor(C2*(s2−s1)). (3)

In embodiments, all of the conditions may be tested. In other embodiments, as shown in FIG. 21, the conditions may be tested sequentially, for example, to avoid unnecessary computation if one of the conditions is not satisfied. As shown, the method 2100 includes determining whether NSM(s1)≥floor(C1*s1) (block 2108). If the inequality is not satisfied, the pixel is not retained as foreground (block 2110). If the inequality is satisfied, the method 2100 includes determining whether NSM(s2)≥floor(C1*s2) (block 2112). If the inequality is not satisfied, the pixel is not retained as foreground (block 2110). If the inequality is satisfied, the method 2100 includes determining whether NSM(s2)≥NSM(s1)+floor(C1*(s2−s1)) (block 2114). If this inequality is not satisfied, the pixel is not retained as foreground (block 2110), whereas, if this inequality is satisfied, the pixel is retained (block 2116).

As shown in FIG. 21, embodiments of the method 2100 include applying the criteria repeatedly, for varying values of s1 and s2. That is, for example, embodiments of the method 2100 include determining whether all of the predetermined values for s1 have been used (block 2118). If so, the method 2100 is concluded (block 2120), whereas, if all of the values for s1 have not been used, s1 and s2 are incremented and the process is repeated (block 2122). As the term is used herein, “increment” refers to assigning the next value in a set. The set of values may be predetermined, dynamically determined, and/or the like, and an increment in a value may include assigning a lower value than the previous value, a higher value than the previous value, or the same value as the previous value. In embodiments, for example, s2=s1+3 and the following values may be used for s1 in the specified order: {0, 2, 4, 6, 8, 0, 2, 4, 6}. For example, s1=0 means that we look at boxes of size 1×1 and 7×7 in the first iteration, and require there to be at least 2 pixels in the 7×7. Examples of the filtering technique are shown in FIGS. 25H through 25Q and 26H through 26Q.

According to embodiments, C1 and C2 may be selected based on empirical evidence, formulas, and/or the like, to produce desired results. In embodiments, for example, C1 may be 0.9 and C2 may be 0.4. Note that the coefficients less than unity may be used to allow for some gaps in the structures that are desired to be preserved; and, in embodiments, if it is desirable to preserve only structures without gaps, those could be increased to unity. Further, if it is desirable to preserve only internal points of the structures while allowing the ends to be eliminated, those coefficients could be increased to a value of 2. Also, in embodiments, the exponents of the half sizes for the requirements (s1, s2, and (s2-s1)) are all unity; and if a different dimensionality was desired for structures to be preserved, those exponents could be modified accordingly.

As for the exact values of s1 and s2 used, it may be desirable to take s2 to be sufficiently larger than s1 to sample enough of the space for the “sufficient increase requirement” (that is, requirement “(3)”) to be meaningful. Also, in embodiments, the maximum values of s1 and s2 that should be used depend on the expected sizes of the objects in the frames. The values presented here work well for video sequences that have been scaled to be a few hundred pixels by a few hundred pixels. As for the specific values of s1 chosen, the present iterative schedule has empirically been found to provide reasonably good achievement of the desired filtering; and subject to that level of quality, this schedule seems to be the minimum amount of work required.

For example, FIG. 25H depicts the change to the BFIM during the first iteration of noise reduction (s1=0). White indicates pixels which survive the iteration. Eliminated pixels are indicated in cyan. Because s1=0, there is essentially only one criteria for elimination during this iteration: eliminate if there are no other foreground pixels in a centered 7×7 box. FIG. 25I depicts the change to the BFIM during the second iteration (s1=2). Again, white indicate survival. Dark gray indicates previously eliminated pixels. Other colors indicate elimination during this iteration, and the R/G/B components tell what criteria the pixel was eliminated under: R indicates “(1) nsm(s1)<floor(0.9*s1)”, G indicates “(2) nsm(s2)<floor(0.9*s2)”, and B indicates “(3) nsm(s2)<nsm(s1)+floor(0.4*(s2−s1)).” For example, cyan indicates failing (2) and (3) while passing (1). A pixel failing all three criteria would be light gray, but there do not seem to be any such pixels here.

FIG. 25J depicts the change to the BFIM during the third iteration (s1=4). In this iteration, a few red, yellow, and light gray pixels are visible. FIGS. 25K-25P depict the change to the BFIM during the later iterations (s1=6, 8, 0, 2, 4, 6). In this case, the last few iterations seem to have little impact but seem to actually be slightly harmful. FIGS. 26G-26P depict the initial BFIM and the change during each iteration. These figures are analogous to FIGS. 25G through 25P. There is little change during iteration.

FIG. 25Q depicts a comparison of the initial and nose-reduced BFIMs. White pixels are pixels in the BFIM that survive the noise reduction process, while blue pixels were eliminated during the noise reduction process. It may be observed that most of the noise throughout the image has been eliminated, while the outlines of the man's body are mostly intact. In the second example, FIG. 26Q depicts a comparison of the initial and final BFIM. In this case, almost the entire frame is dominated by noise. While some of the pixels in the shadow regions get eliminated, the BFIM is largely unchanged by the noise reduction process. Note that several regions in the initial BFIM were declared foreground based on motion information projected from a previous frame.

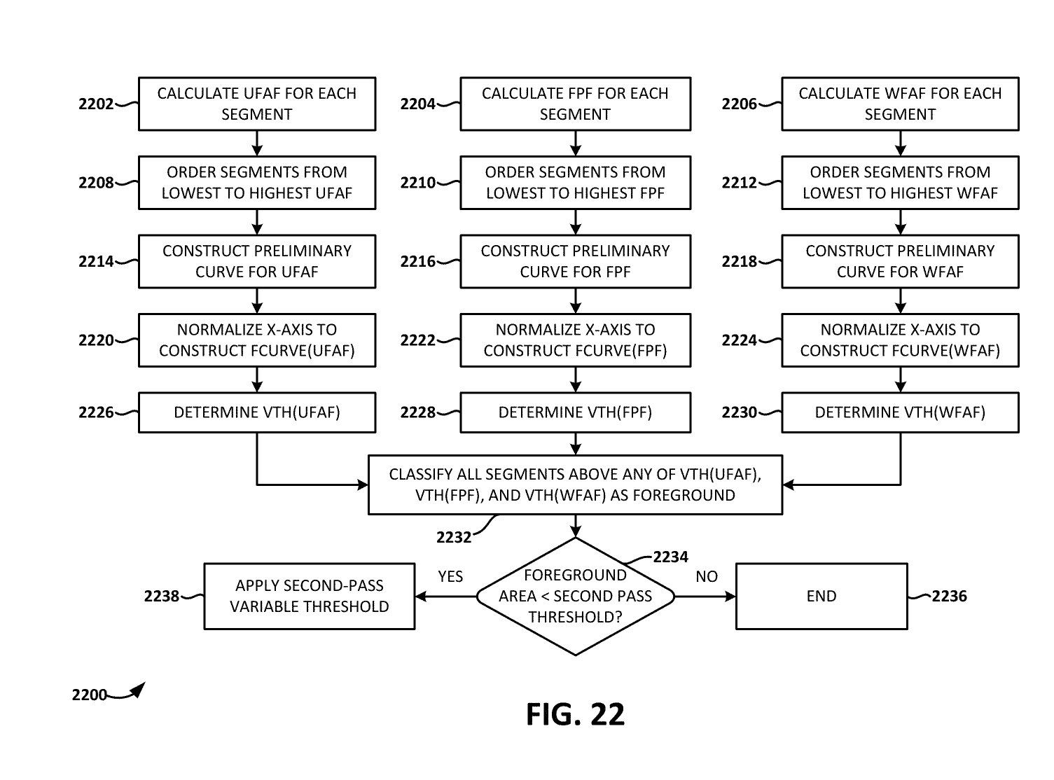

FIG. 22 depicts an illustrative method 2200 for determining foreground segments using a BFIM. In embodiments, for each segment, a number of foreground metrics may be determined. For example, as shown in FIG. 22, the method 2200 may include determining (1) the (unweighted) foreground area fraction (UFAF) (block 2202), (2) the foreground perimeter fraction (FPF) (block 2204), and (3) the weighted foreground area fraction (WFAF) (block 2206). The (unweighted) foreground area fraction (UFAF) of a segment may be the number of foreground pixels in that segment divided by the total number of pixels in that segment, with foreground pixels determined by the filtered BFIM. Similarly, the foreground perimeter fraction (FBF) may be the number of foreground pixels on the perimeter of that segment divided by the total number of pixels on the perimeter of that segment. In embodiments, the unfiltered BFIM may be used for the perimeter. The weighted foreground area fraction (WFAF) may be identical to the (unweighted) foreground area fraction (UFAF), except that each pixel in the segment may be given a variable weight (e.g., pixels in regions of greater spatial variation of color may be given a higher weight, up to some capped maximum).

Examples of the weight map are shown in FIGS. 25R and 26R. For example, FIGS. 25R and 26R depict the weight maps used for the weighted areas. The brightness at each pixel indicates the weight of that pixel, with black being a weight of zero and white being the maximum weight. FIGS. 25S and 26S (left) depict the segment maps provided for the frames. FIGS. 25T and 26T (right) depict the doubly eroded segment maps; black pixels are not counted as part of any segment.

According to embodiments, in order to make use of a variable threshold to detect foreground using a BFIM, three foreground curves may be constructed, one for each of the foreground fractions. Each foreground curve may represent the cumulative distribution function of the area-weighted foreground fraction for that metric. As shown in FIG. 22, for each of the three metrics, the method 2200 includes ordering the segments from lowest to highest foreground fraction (blocks 2208, 2210, and 2212). The method 2200 further includes constructing a preliminary curve for each of the metrics (blocks 2214, 2216, and 2218). For example, each curve may be constructed by starting at the point (0, 0), defining the next point as (0+area of first segment, foreground fraction of first segment), the point after that as (0+area of first segment+area of second segment, foreground fraction of second segment), and each successive point as (previous x value+area of next segment, foreground fraction of next segment). The x-axis may be normalized by the total area of all segments (blocks 2220, 2222, and 2224). In this way, embodiments of the method 2200 may facilitate constructing monotonically increasing curves (FCURVE(UFAF), FCURVE(FPF), and FCURVE(WFAF)) that start at (0, 0) and end at (1, highest foreground fraction among segments), each segment having an impact on the curve proportional to its area.

In embodiments, the method 2200 further includes determining variable thresholds for each metric (VTH(UFAF), VTH(FPF), and VTH(WFAF)) (blocks 2226, 2228, and 2230). The variable thresholds may be determined by finding the intersection of each foreground curve with a specified monotonically decreasing threshold curve. In the case of no intersection between the curves, all of the segments may be declared to be background. The inventors have achieved positive results by taking the threshold curves to be straight lines passing through the listed points: the (unweighted) area threshold curve (VTH(UFAF)) through (0, 0.8), (1, 0.1); the perimeter threshold curve (VTH(FPF)) through (0, 1.0), (1, 0.5); and the weighted area threshold curve (VTH(WFAF)) through (0, 0.6), (1, 0.2). The method 2200 may include classifying all segments which are above any of the variable thresholds as foreground (block 2232), and all other segments as background.

In many cases, where good moving foreground detection seems possible under human inspection, the above criteria generally function well. However, there are some low-noise cases where small foreground motion may not be detected by the above criteria but is possible under human inspection. In order to handle these cases, a conditional second pass may be utilized. For example, a determination may be made whether the total area declared foreground is less than a specified threshold (e.g., approximately 25%) of the total segment area (block 2234). If not, the classification depicted in block 2232 may be retained (block 2236), but if so, then, a second-pass variable threshold may be applied (block 2238). In embodiments, any other criteria may be used to determine whether a second-pass variable threshold may be applied.

This second-pass threshold may be applied, for example, only to the (unweighted) area fraction of doubly-eroded segments with the fraction normalized by the non-eroded area of the segment. Examples of a doubly eroded segment map are shown in FIGS. 25T and 26T. The threshold may be taken so that up to approximately 25% (or any other selected percentage) of the total segment area is ultimately declared to be foreground, whether during the already-performed first-pass or the to-be-performed second pass, but is not allowed to be less than a lower threshold such as, for example, 0.005. In embodiments, the second pass can alternatively be thought of as the intersection of the (unweighted) doubly-eroded foreground area fraction curve with the piece-wise curve composed of the line segments (0.75, 1.0) to (0.75, 0.005) to (1, 0.005). The upper threshold of approximately 25% of the total segment and the lower threshold of 0.005 may be adjusted and/or selected based on any number of different static and/or dynamic criteria, including, but not limited to, optimization criteria, computational burden criteria, and/or the like.

Examples of the foreground curves and determination of the thresholds for the first example are shown in FIGS. 25U and 26U. For example, FIG. 25U depicts the foreground curves, threshold curves, and calculated variable thresholds. Red indicates the first-pass perimeter criteria, green indicates the first-pass weighted area criteria, blue indicates the first-pass (unweighted) area criteria, and yellow indicates the second-pass area criteria applied to doubly eroded segments. The foreground curves are indicated with circles, the threshold curves are indicates with squares, and the obtained values of the variable thresholds are indicated with “x”s. For the second example, FIG. 26U depicts the foreground curve, threshold curves, and variable thresholds. This figure is analogous to FIG. 25U, but the second-pass has been omitted. Observe that the shape of the foreground curves are very different from the case shown in FIG. 25U.

Examples of the parts of an image declared to be foreground are shown in FIGS. 25V, 25W, 26V, and 26W. In the first example, FIG. 25V (left) depicts the foreground highlight image for the first-pass. Highlight regions indicate determined foreground, with each of the R, G, and B components indicating being above the perimeter, weighted area, and (unweighted) area thresholds, respectively. FIG. 25W (right) depicts the foreground highlight image for the second-pass. Foreground regions from the first-pass are indicated in white. Foreground regions from the second-pass are indicated in yellow. Observe that the second-pass manages to pick out most of the rest of the man's body without too many false-positives.

In the second example, FIG. 26V (left) depicts the foreground highlight image for the first-pass, analogous to FIG. 25V. FIG. 26W (right) depicts the foreground highlight image for the second-pass; but, since the second pass was not performed, the figure simply highlights the regions that were already determined to be foreground. It may be observed that many of the trees in the background are undesirably declared to be foreground, and further analysis may be necessary to determine that they are not moving objects.

In embodiments, double-erosion of the segments for the second-pass may be, e.g., due to providing a good balance between completely ignoring the foreground pixels in adjacent segments and their impact on noise reduction, versus fully considering them for that purpose.

As indicated above, the foreground indicator map (FIM) may be binary (BFIM) or non-binary (NBFIM) and various embodiments of methods described herein may use a BFIM, an NBFIM, or some combination of the two. As described above, the binary foreground indicator map (BFIM) may be calculated from the difference image and the foreground threshold image. Additional insight into foreground analysis may be provided by using a non-binary foreground indicator map (NBFIM). The use of a non-binary map may include a modified fractal-based analysis technique.

To construct the NBFIM, embodiments include defining the normalized absolute difference image (NADI) to be an image where each component of each pixel is equal to the corresponding value in the difference image divided by the corresponding value in the foreground threshold image. The foreground threshold image may be constructed so that it has a value of at least one for each component of each pixel. Each pixel of the unfiltered NBFIM may be defined to be equal to the arc-hyperbolic sine (asinh) of the sum of the squares of the components of the corresponding pixel in the normalized absolute difference image (NADI) with a coefficient of 0.5 for each of the chroma components; that is, for each pixel:

unfiltered NBFIM=a sin h(NADIŶ2+0.5*NADICb̂2+0.5*NADICr̂2).

The a sin h( ) function is used to provide a un-bounded quasi-normalization, as a sin h(x)˜x for small x and a sin h(x)˜log(x) for large x.

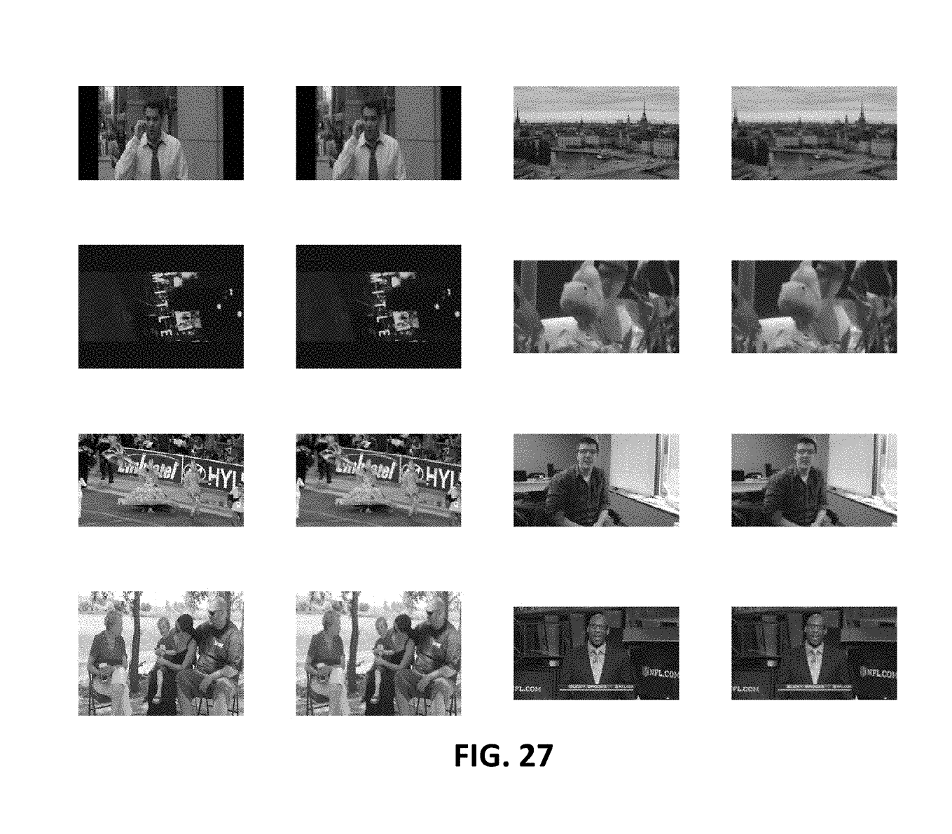

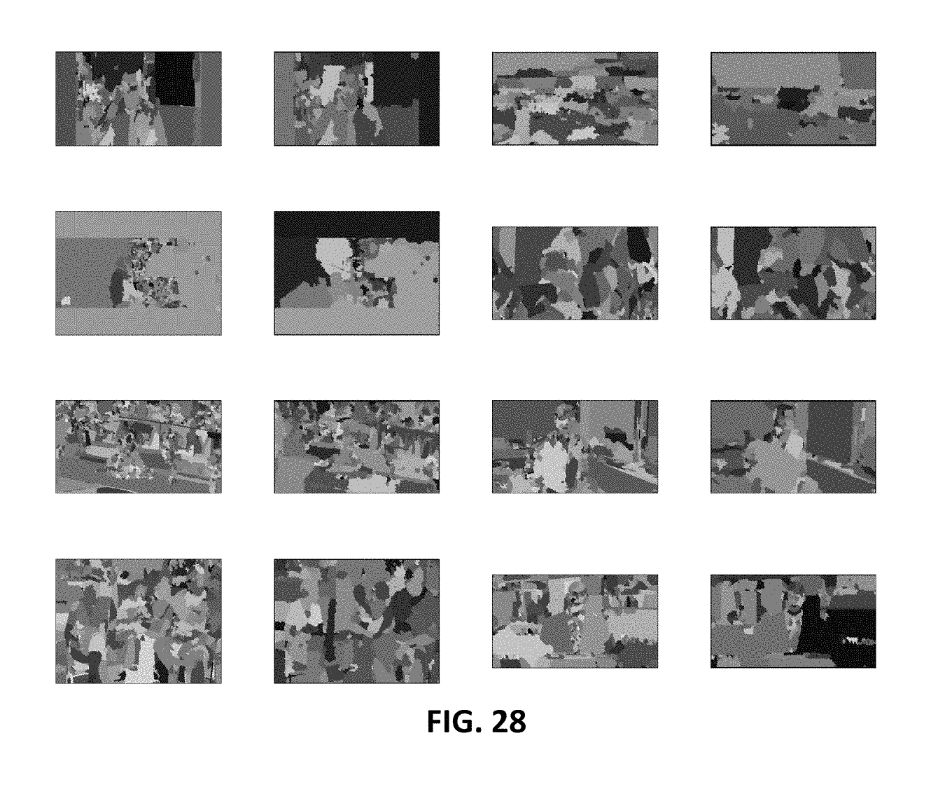

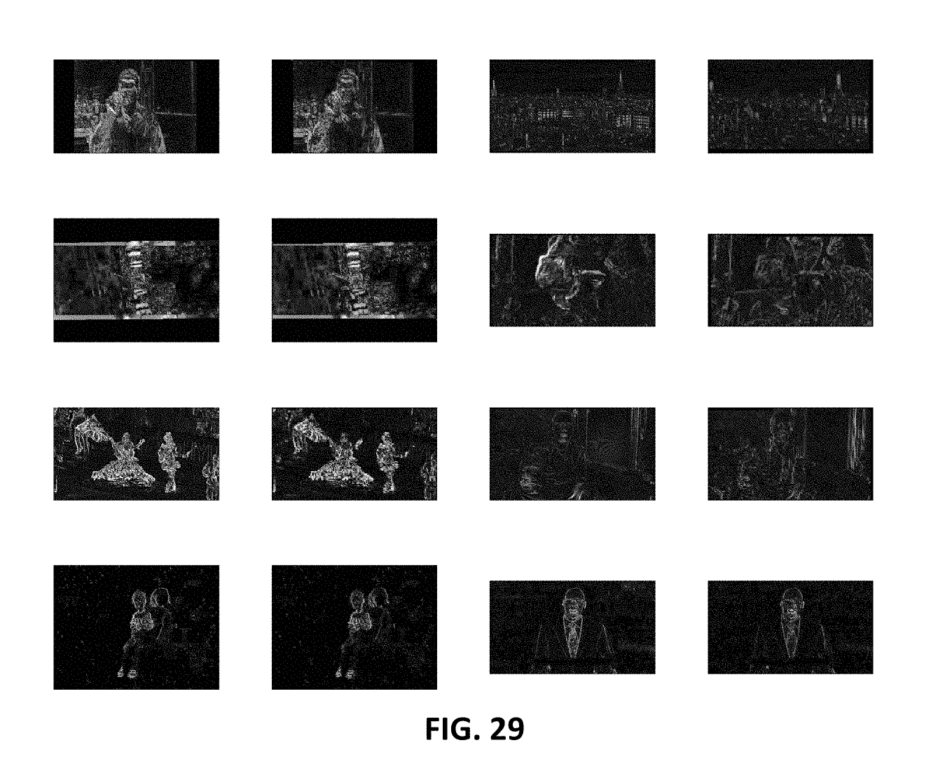

For example, FIG. 27 depicts the “current frame” for various test cases analyzed using a non-binary foreground indicator map (all sub-figures have been scaled to have the same width regardless of actual resolution). The case in column 3, row 4 is frame 000125 of nfl_bucky.avi_384×216_444.yuv, which was examined in FIGS. 25A through 25W under the binary analysis. FIG. 28 depicts segment maps for each of the current frames depicted in FIG. 27, and sample NADI are shown in FIG. 29. The green component of each sub-figure shows 64 times the luma component of the NADI, capped to a maximum of 256. For example, a luma NADI of 1.5 would show up as a green value of 96 in this figure. Similarly, the blue and red components of the figure show 64 times the Cb and Cr component of the NADI. It may be observed that the low-resolution fish case (column 4, row 2) has the background showing up almost as strongly as the fish; this is due to improper alignment of the previous frames to the current frame. As a result, this test case serves to illustrate possible behaviors of embodiments of the methods described herein when applied to images that are not properly aligned. The alignment for the cases in columns 3 and 4 of row 3 is also flawed, though not as severely as the low-resolution fish case.

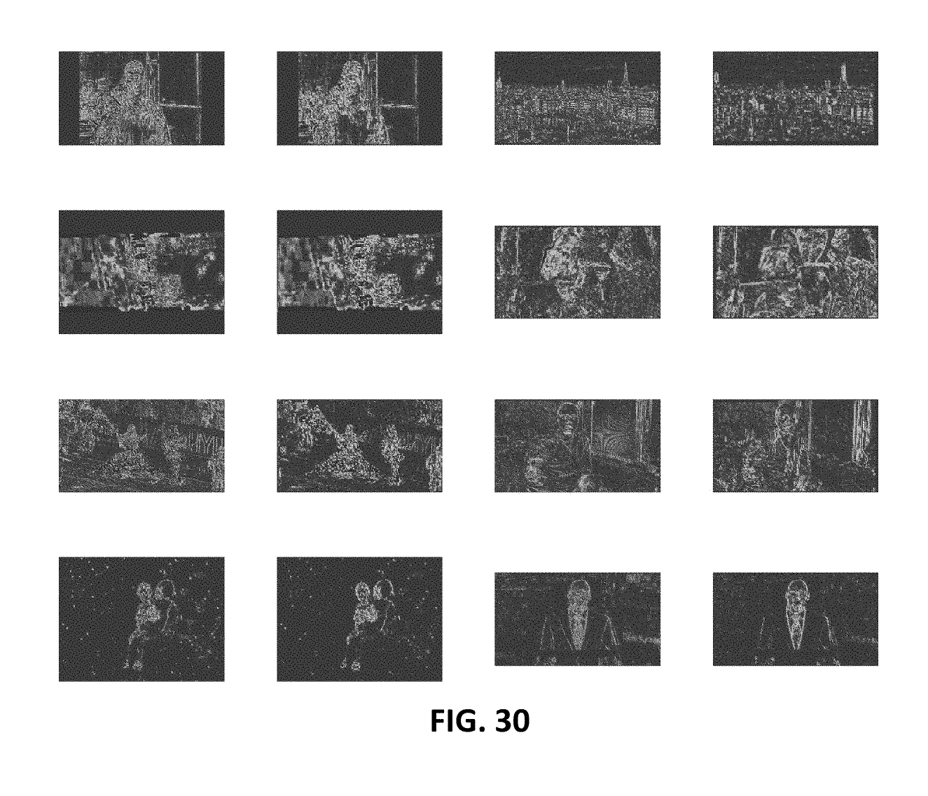

Sample unfiltered NBFIM are shown in FIG. 30. The sub-figures use the “jet” colormap, with dark blue corresponding to a value of 0.0 in the unfiltered NBFIM, green corresponding to a value of 2.0 in the unfiltered NBFIM, and dark red corresponding to a value of 4.0 or higher in the unfiltered NBFIM.

A non-binary fractal-based analysis may be used to generate the filtered NBFIM from the unfiltered NBFIM. The concept for the analysis may be the same as for the binary case, and may be based, for example, on a selected minimal linear growth rate in the neighborSumMap with respect to the box size; however, unlike the binary case, the coefficients for the growth may be based on the average value of pixels in the frame during that iteration.

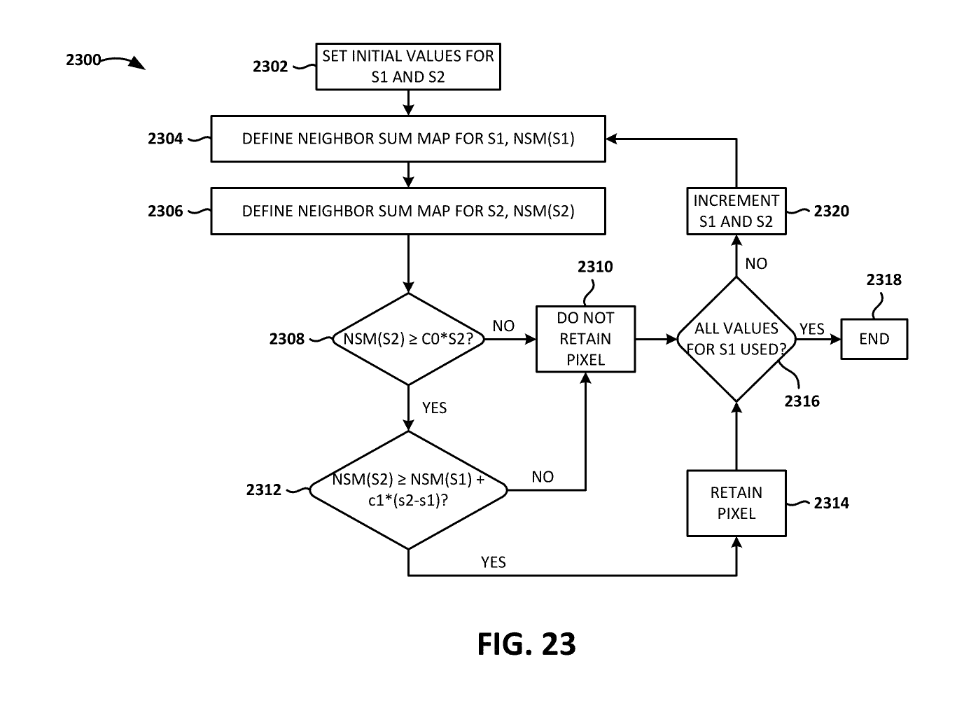

FIG. 23 depicts an illustrative method 2300 of filtering an NBFIM in accordance with embodiments of the disclosure. As shown, the illustrative method 2300 includes setting initial values for a first box half size, s1, and a second box half size, s2 (block 2302). In embodiments, s2 may be a function of s1. Embodiments of the method 2300 further include defining a neighbor sum map for s1 (NSM(S1)) (block 2304) and a neighbor sum map for s2 (NSM(S2)) (block 2306). For the NBFIM and a given box half size, for any given pixel p, the technique includes looking at a box of size (1+2*box half size) by (1+2*box half size) centered on that pixel, and then summing the pixel values of the NBFIM over that box; this is the value of the neighbor sum map at the pixel p. To filter the NBFIM, the neighbor sum map is defined using two different box half sizes, say s1 and s2, with s1<s2. A set of criteria may then be applied to the neighbor sum map for s1 and s2 to determine whether to retain a pixel as foreground. According to embodiments, any number of different criteria may be used to retain pixels.

For example, in embodiments, of the method 2300 depicted in FIG. 23, for a foreground pixel to be retained, the neighbor sum maps at that pixel must pass all of the following conditions:

neighborSumMap(s2)≥c0*s2; and, (1)

neighborSumMap(s2)neighborSumMap(s1)+(c1*(s2−s1)); (2)

where c0 is three times the average (mean) value of the NBFIM at that iteration and c1 is ten times the average (mean) value of the NBFIM at that iteration. For the first iteration, the NBFIM may simply be the unfiltered NBFIM; after that, at each iteration, the NBFIM may be the one produced by applying the rules to the previous iteration; and the filtered NBFIM may be the NBFIM after all iterations have been completed.

In embodiments, both of the conditions may be tested. In other embodiments, as shown in FIG. 23, the conditions may be tested sequentially, for example, to avoid unnecessary computation if one of the conditions is not satisfied. As shown, the method 2300 includes determining whether NSM(s2)≥C0*s2 (block 2308). If the inequality is not satisfied, the pixel is not retained as foreground (block 2310). If the inequality is satisfied, the method 2300 includes determining whether NSM(s2)≥NSM(s1)+C1*(s2−s1) (block 2312). If the inequality is not satisfied, the pixel is not retained as foreground (block 2310). If the inequality is satisfied, the pixel is retained (block 2314).

As shown in FIG. 23, embodiments of the method 2300 include applying the criteria repeatedly, for varying values of s1 and s2. That is, for example, embodiments of the method 2300 include determining whether all of the values for s1 have been used (block 2316). If so, the method 2300 is concluded (block 2318), whereas, if all of the values for s1 have not been used, s1 and s2 are incremented and the process is repeated (block 2320). In embodiments, when applying to frames that are a few hundred pixels by a few hundred pixels, s1 and s2 may be defined such that s2=s1+3 and the method 2300 may use, for example, the following values for s1 in the specified order: {2, 4, 6, 8, 10, 12, 2, 4, 6, 8, 10, 12}. Note that, unlike the binary case, we have not made use of a check on neighborSumMap(s1) by itself.

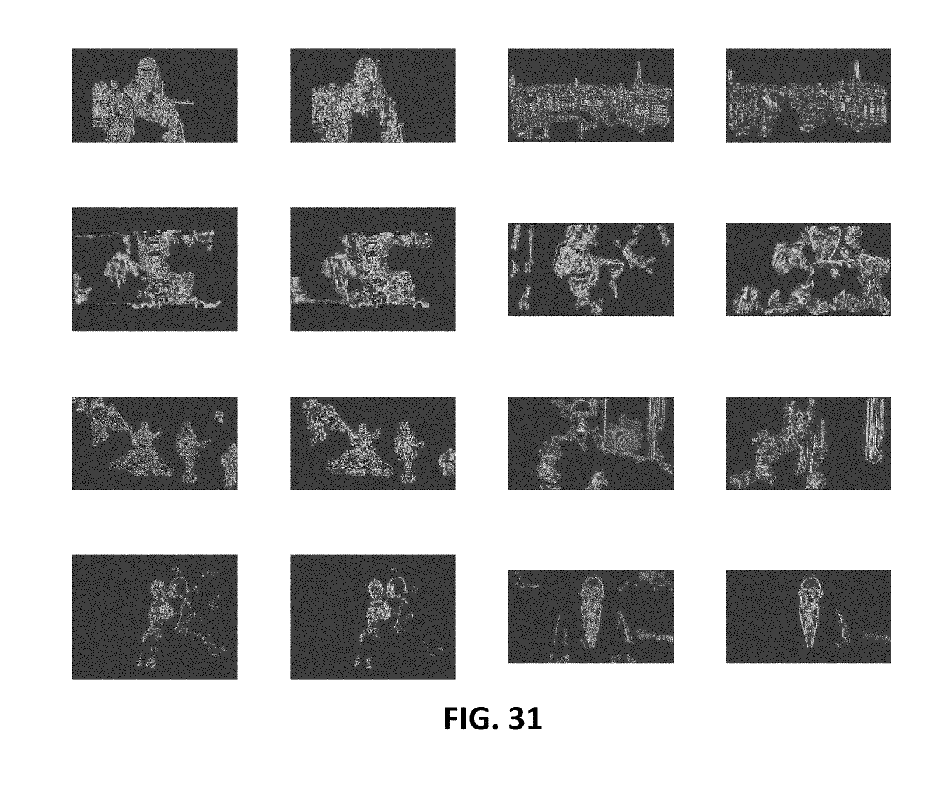

Sample filtered NBFIM are shown in FIG. 31. The color scale is the same as in FIG. 30. It may be observed that the filtering provided by embodiments of the fractal-based analysis described herein facilitates reduction of the noise and background pixels in most of the images while preserving most of the one-dimensional structures in the foreground.

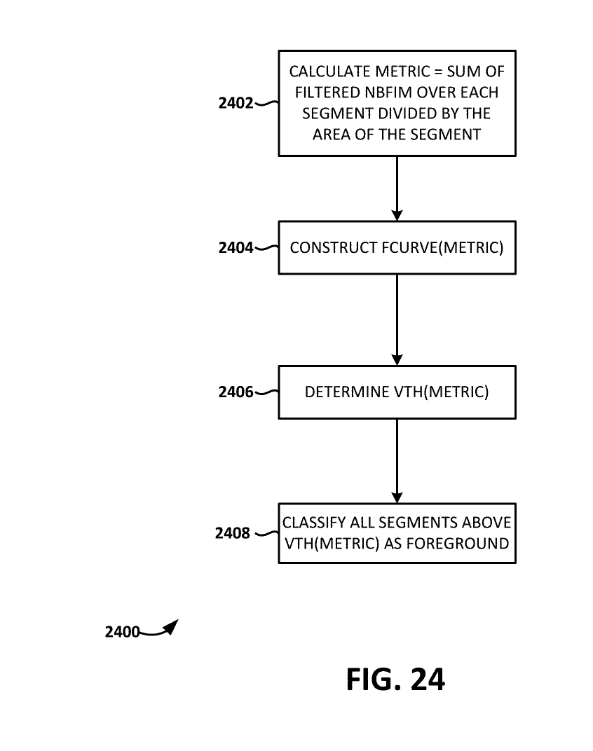

The filtered NBFIM can be used for foreground detection in a manner analogous to the binary case. FIG. 24 depicts an illustrative method 2400 for foreground detection using an NBFIM in accordance with embodiments of the disclosure. As shown, the illustrative method 2400 includes calculating a foreground metric (block 2402), which may, for example, be the sum of the filtered NBFIM over each segment divided by the area of the segment. The calculated foreground metric is used for constructing a foreground curve (FCURVE(METRIC)) (block 2404). The method 2400 includes determining a variable threshold (VTH(METRIC)), such as, for example, by determining the intersection between FCURVE(METRIC) and a threshold curve (block 2406). In embodiments, the threshold curve may be, for example, the line from (0, 0.5) through (1, 0.0). As in the binary case, segments above the variable threshold may be classified as foreground (block 2408).

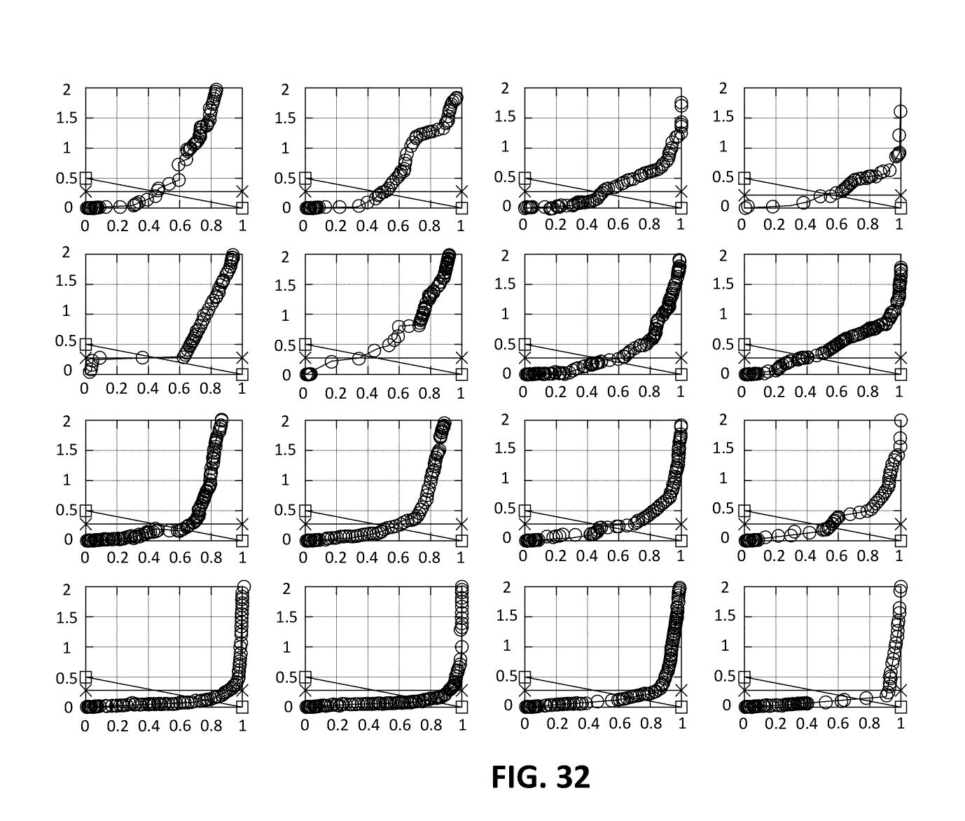

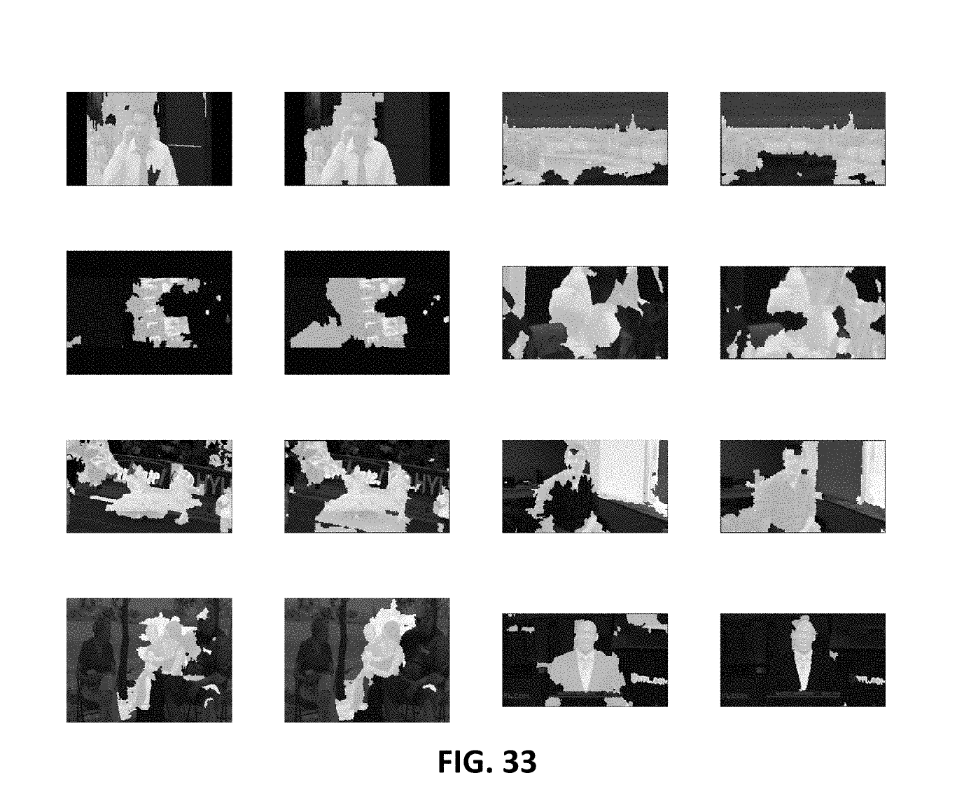

Samples of the foreground curves and determined foreground for a number of cases are illustrated in FIGS. 32 and 33, in which threshold curves are indicated by line segments. In FIG. 33, the highlighted regions indicated foreground and the darkened regions indicated background. Note that the letterbox mattes in the four cases in the upper left corner are excluded from the foreground analysis and are treated as having zero area and no foreground as part of the foreground curve. Though there is clearly some room for improvement, these figures illustrate that our non-binary foreground detection algorithm can perform reasonably well even in a number of challenging cases.

According to embodiments, a number of other possible foreground metrics may exist. For example, even in some difficult cases, embodiments of the methods described above may facilitate eliminating noise while retaining many desired one-dimensional structures. Thus, for example, a simple edge-enhancing technique can be applied to the filtered NBFIM to help identify the edges of moving objects. One such technique may include setting the preliminary mask to be the set of all points in the filtered NBFIM that have a value greater than unity, and setting the base mask=dilate3×3(preliminary mask), where dilate3×3( ) means that each pixel of the output is set to the maximum value among the corresponding pixel and its 8 neighbors (this step may be performed to reduce any gaps in the structures). The technique may further include setting the outline mask=base mask & (erode3×3(base mask)), where erode3×3( ) is analogous to dilate3×3( ) but uses the minimum, “&” indicates a bit-wise “and operation”, and “ ” indicates a negation. The outline mask may give the outline of the base mask, not the edges of moving objects. We then set the edge mask=imerode3×3(imdilate3×3(outline mask)). Samples of the base, outline, and edge masks are shown in FIGS. 32 And 33, respectively. It may be possible to use this additional information as part of another foreground metric to improve foreground determination.

According to various embodiments of the disclosure, the choice of the variable threshold may allow for some room for customization and/or optimization. For example, embodiments may focus on finding the “knee” of the foreground curves, which may be considered as the minima of the derivative of (the foreground curve minus x−), which serves as a discrete analogue of search for points where df/dx=1. Embodiments may incorporate some method of detecting locally varying illumination changes, such as that used by Farmer, as described in M. E. Farmer, “A Chaos Theoretic Analysis of Motion and Illumination in Video Sequences”, Journal of Multimedia, Vol. 2, No. 2, 2007, pp. 53-64; and M. E. Farmer, “Robust Pre-Attentive Attention Direction Using Chaos Theory for Video Surveillance”, Applied Mathematics, 4, 2013, pp. 43-55, the entirety of each of which is hereby incorporated herein by reference for all purposes. Embodiments may include applying the fractal-analysis filter or a variable threshold to the difference image, such as is shown in FIG. 26E.

For the non-binary case, embodiments may include various modifications. For example, embodiments may make use of a multi-pass method, as we described above for the binary case. For example, the first pass may be sufficient to identify any clearly moving objects; then, if too little area were identified as foreground, a second pass may be performed to identify slight motion. In embodiments, the calculation of the threshold image may be performed in any number of different ways such as, for example, by applying one or more filters to it, and/or considering the temporal variation of pixels as part of the threshold. Another approach, according to embodiments, may include dividing the foreground sum by some linear measure of a segment size, e.g., the square root of the area. Embodiments of the foreground detection techniques described herein may be used to detect foreground in images that have not been segmented. That is, for example, an FIM (e.g., a BFIM and/or an NBFIM) may be constructed based on an unsegmented image. In embodiments, such a FIM may be filtered and the remaining foreground pixels may be classified as foreground.

### Segment-Based Motion Estimation

### Multi-View Motion Estimation

To produce multi-view video content, (e.g., three-dimensional (3D) video, augmented-reality (AR) video, virtual-reality (VR) video, etc.) multiple views may be used to present a scene (or scene augmentation) to a user. A view refers to a perspective of a scene and may include one or more images corresponding to a scene, where all of the images in the view represent a certain spatial (and/or temporal) perspective of a video scene (e.g., as opposed to a different perspective of the video scene, represented by a second view). According to embodiments, a perspective may include multiple spatial and/or temporal viewpoints such as, for example, in the case in which the “viewer”—that is, the conceptual entity that is experiencing the scene from the perspective—is moving relative to the scene, or an aspect thereof (or, put another way, the scene, or an aspect thereof, is moving relative to the viewer).

In embodiments, a view may include video information, which may be generated in any number of different ways such as, for example, using computing devices (e.g., computer-generated imagery (CGI)), video cameras (e.g., multiple cameras may be used to respectively record a scene from different perspectives), and/or the like. Accordingly, in embodiments, a view of a scene (e.g., computer-generated and/or recorded by a video camera) may be referred to herein as a video feed and multiple views of a scene may be referred to herein as video feeds. In embodiments, each video feed may include a plurality of video frames.

To encode a scene for multi-view video, some conventional systems and methods may independently encode the video feeds. That is, in embodiments, a first video feed may be encoded without regard to other video feeds. For example, during encoding, conventional systems and methods may estimate the motion vectors for each of the video feeds independently. Independently estimating motion vectors for each video feed independently can be computationally burdensome. Embodiments of this disclosure may provide a solution that is less computationally burdensome.

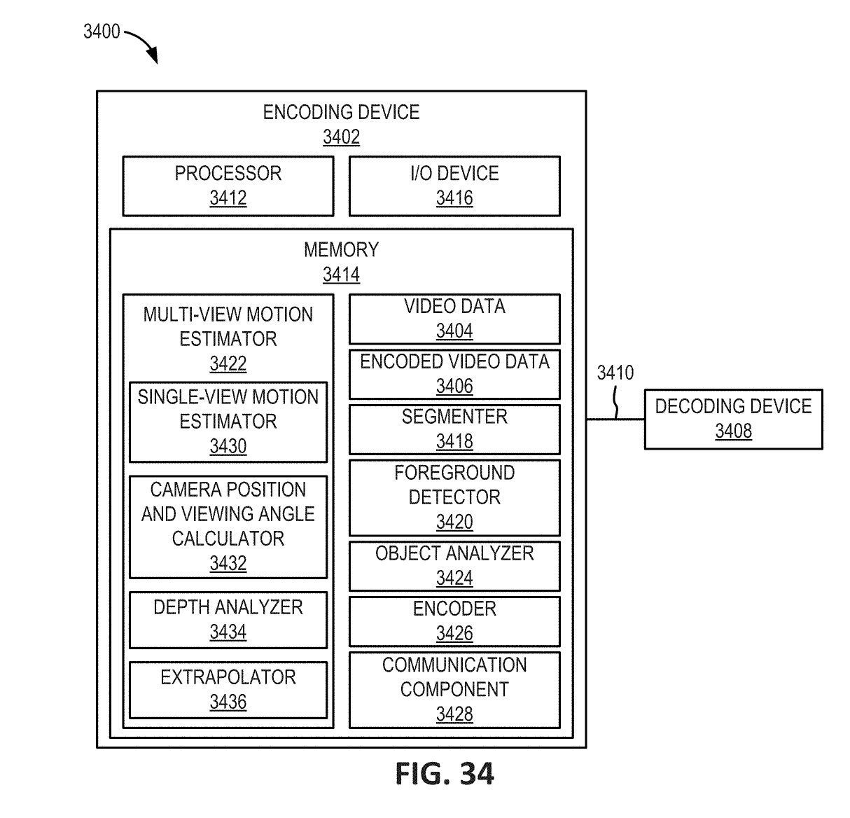

FIG. 34 is a block diagram illustrating an operating environment 3400, in accordance with embodiments of the subject matter disclosed herein. In embodiments, aspects of the operating environment 3400 may be, include, be similar to, or be included in, a system for processing video information such as, for example, the video processing platform 102 depicted in FIG. 1, and/or the video processing device 302 depicted in FIG. 3. The illustrative operating environment 3400 includes an encoding device 3402 (e.g., the video processing device 302 depicted in FIG. 3) that may be configured to encode video data 3404 to produce encoded video data 3406.

In embodiments, the video data 3404 may include views of a scene embodied in a number of video feeds. In embodiments, the video feeds of the scene, or aspects thereof, may have been respectively recorded by cameras positioned at different locations so that the scene is recorded from multiple different viewpoints. In embodiments, the video feeds of the scene, or aspects thereof, may have been computer-generated. In some instances, view information—information about the perspective corresponding to the view (e.g., camera angle, virtual camera angle, camera position, virtual camera position, camera motion (e.g., pan, zoom, translate, rotate, etc.), virtual camera motion, etc.)—may be received with (or in association with) the video data 3404 (e.g., multiplexed with the video data 3404, as metadata, in a separate transmission from the video data 3404, etc.). In other embodiments, view information may be determined, e.g., by the encoding device 3402. Each of the video feeds of the video data 3404 may be comprised of multiple video frames. In embodiments, the video feeds may be combined to produce multi-view video.

As described herein, while producing the encoded video data 3406 from the video data 3404, the encoding device 3402 may determine motion vectors of the video data 3404. In embodiments, the encoding device 3402 may determine motion vectors of the video data 3404 in a computationally less demanding way than conventional encoding systems, and, in embodiments, methods that include extrapolating motion vectors from a first video feed to other video feeds.

As shown in FIG. 34, the encoding device 3402 may also be configured to communicate the encoded video data 3406 to a decoding device 3408 (e.g., the receiving device 108 depicted in FIG. 1 and/or the decoding device 308 depicted in FIG. 3) via a communication link 3410 (e.g., the communication links 106 and/or 110 depicted in FIG. 1).

As shown in FIG. 34, the device 3402 may be implemented on a computing device that includes a processor 3412, a memory 3414 and an input/output (I/O) device 3416. Although the device 3402 is referred to herein in the singular, the device 3402 may be implemented in multiple instances, distributed across multiple computing devices, instantiated within multiple virtual machines, and/or the like. In embodiments, the processor 3412 executes various program components stored in the memory 3414, which may facilitate encoding the video data 3404. In embodiments, the processor 3412 may be, or include, one processor or multiple processors. In embodiments, the I/O device 3416 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 3414 stores computer-executable instructions for causing the processor 3412 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components may include a segmenter 3418, a foreground detector 3420, a multi-view motion estimator 3422, an object analyzer 3424, an encoder 3426 and a communication component 3428.

As indicated above, in embodiments, the video data 3404 includes multiple video feeds and each video feed includes multiple video frames. In embodiments, the segmenter 3418 may be configured to segment one or more video frames into a plurality of segments. The segments may include, for example, objects, groups, slices, tiles, and/or the like. The segmenter 3418 may employ any number of various automatic image segmentation techniques such as, for example, those discussed herein. For example, the segmenter 3418 may use image color and corresponding gradients to subdivide an image into segments that have similar color and texture. Two embodiments of image segmentation techniques include the watershed algorithm and optimum cut partitioning of a pixel connectivity graph. In embodiments, the segmenter 3418 may use Canny edge detection to detect edges on a video frame for optimum cut partitioning, and create segments using the optimum cut partitioning of the resulting pixel connectivity graph. In embodiments, the segmenter 3418 implements aspects of the segmentation techniques described in Iuri Frosio and Ed Ratner, “Adaptive Segmentation Based on a Learned Quality Metric,” Proceedings of the 10^{th} International Conference on Computer Vision Theory and Applications, March 34015, the entirety of which is hereby incorporated herein by reference for all purposes.

The resulting segment map of image segments includes an assignment of indices to every pixel in the image, which allows for the frame to be dealt with in a piecemeal fashion. Each index, which may be indexed and stored in memory 3414, may be considered a mask for this purpose.

In embodiments, the foreground detector 3420 may be configured to perform foreground detection on one or more video frames of the video data 3404. For example, in embodiments, the foreground detector 3420 may perform segment-based foreground detection, where the foreground segments, or portions of the segments, are detected using any number of different techniques such as, for example, those discussed above with respect U.S. application Ser. No. 14/737,418, filed Jun. 11, 2015, entitled “FOREGROUND DETECTION USING FRACTAL DIMENSIONAL MEASURES,” the entirety of which is incorporated herein. For example, in embodiments, the foreground detector 3420 may identify a segment as a foreground segment or a background segment by: determining at least one foreground metric for the segment based on a filtered binary foreground indicator map (BFIM), determining at least one variable threshold based on the foreground metric, and applying the at least one variable threshold to the filtered BFIM to identify the segment as either a foreground segment or background segment. Alternatively, the foreground detector 3420 may perform foreground detection on images that have not been segmented. In embodiments, results of foreground detection may be used by the segmenter 3418 to inform a segmentation process.

In embodiments, the multi-view motion estimator 3422 is configured to perform motion estimation for multiple video feeds of video data 3404. To facilitate motion estimation, the multi-view motion estimator 3422 may include one or more program components. Examples of such program components include a single-view motion estimator 3428, a camera position and viewing angle calculator 3430, a depth analyzer 3434 and an extrapolator 3436.

The single-view motion estimator 3430 may be configured to estimate the motion of one or more segments between video frames of a single video feed. For example, the single-view motion estimator 3430 may receive a single video feed of the video data 3404. The single video feed may be received after video frames of the video feed are segmented by the segmenter 3418. The single-view motion estimator 3430 may then perform motion estimation on the segmented video frames of the video feed. That is, the single-view motion estimator 3430 may estimate the motion of a segment between video frames of the single video feed, with the current frame in the temporal sequence serving as the source frame and the subsequent frame in the temporal sequence serving as the target frame.

In embodiments, the single-view motion estimator 3430 may utilize any number of various motion estimation techniques known in the field. Two example motion estimation techniques are optical pixel flow and feature tracking. As an example, the single-view motion estimator 3430 may use feature tracking in which Speeded Up Robust Features (SURF) are extracted from both a source image (e.g., a source frame) and a subsequent image (e.g., a subsequent frame). The individual features of the two images may then be compared using a Euclidean metric to establish a correspondence between features, thereby generating a motion vector for each feature. In embodiments, a motion vector for a segment may be the median of all of the motion vectors for each of the segment's features. After a motion vector for a segment is determined, each segment may be categorized based on its motion properties. For example, a segment may be categorized as either moving or stationary.

After the single-view motion estimator 3430 determines motion vectors for a single video feed, the multi-view motion estimator 3422 may extrapolate motion vectors for the other video feeds of the video data 3404. To do so, in embodiments, the camera position and viewing angle calculator 3430 may calculate the relative positions and viewing angles of the cameras that respectively recorded the video feeds of the video data 3404 based on the field of views of each of the cameras. The relative positions and angles of the cameras may be used to determine 3D coordinates of a video scene. Additionally or alternatively, the relative positions and viewing angles of the cameras may be included in metadata of the video data 3404 and received by the multi-view motion estimator 3422.

As shown in FIG. 34, the multi-view motion estimator 3422 also includes a depth analyzer 3434. The depth analyzer 3434 is configured to receive two or more video feeds of the video data 3404. Based on the relative positions of the cameras used to record the video feeds, the depth analyzer 3434 is configured to calculate and assign a pixel depth for each pixel located in the video frames of the video feeds. As an example, if an object encompasses an area of a₁×b₁ pixels in one video feed and the same object encompasses an area of a₂×b₂ pixels in another video feed, then, based on the relative positions and angles of the two cameras used to recorded to the two video feeds, a transformation function can be determined that will transform the object from a₁×b₁ pixels to a₂×b₂ pixels. Due to the transformation function being based on the relative positions and angles of the cameras, the transformation function will include distance information that can be used to calculate the distance of the object from the first camera used to record the first video feed. That is, a depth can be assigned to the pixels including the object. Similarly, distances to other objects included in the video feed may be determined. Once the distances to each of the objects are calculated, a pixel depth (i.e., a depth coordinate) can be assigned to each object and pixel included in a video feed. And, based on the calculated pixel depth, a 3D map of each video feed may be determined. That is, for each pixel of a video frame, a depth coordinate (e.g., a z coordinate) can be included in the horizontal and vertical coordinates (e.g., x, y coordinates).

After the 3D map is created, the extrapolator 3436 may be configured to extrapolate the motion vectors determined by the single-view motion estimator 3422 of a video feed to other video feeds. To do so, in embodiments, the extrapolator 3436 assigns 3D coordinates to each of the motion vectors computed by the single-view motion estimator 3430 based on the 3D map. That is, the extrapolator 3436 may be configured to receive two-dimensional motion vector data from the single-view motion estimator 3430 and determine the three dimensional representations of the motion vectors using the 3D map determined from the calculated pixel depth. The extrapolator 3436 then can use the 3D representation of motion vectors to compute two-dimensional projections onto one or more of the other two-dimensional coordinate systems associated with the other video feeds. In embodiments, a local search can be performed by the extrapolator 3436 to determine whether the motion vectors projected onto a video feed accurately represent motion vectors for the video feed. In embodiments, the projected motion vectors may be compared to computed motion vectors for one or more of the other video feeds using a Euclidean metric to establish a correspondence between motion vectors and/or determine an projection error of the projected motion vectors.

In embodiments, the object analyzer 3424 may be configured to identify, using the segment map and/or the motion vectors computed by the multi-view motion estimator 3422, the presence of objects (e.g., clusters of segments that move together, or at least approximately together) within digital images such as, for example, frames of video. In embodiments, the object analyzer 3424 may be configured to identify and/or analyze only objects that are moving within a particular scene. In embodiments, the object analyzer 3424 may perform object analysis on images that have not been segmented. Results of object group analysis may be used by the segmenter 3418 to facilitate a segmentation process, by an encoder 3926 to facilitate an encoding process, and/or the like.

As shown in FIG. 34, the encoding device 3402 also includes an encoder 3426 configured for entropy encoding of partitioned video frames. In embodiments, the communication component 3428 is configured to communicate encoded video data 3406. For example, in embodiments, the communication component 3428 may facilitate communicating encoded video data 3406 to the decoding device 3408.

The illustrative operating environment 3400 shown in FIG. 34 is not intended to suggest any limitation as to the scope of use or functionality of embodiments of the subject matter disclosed herein. Neither should the illustrative operating environment 3400 be interpreted as having any dependency or requirement related to any single component or combination of components illustrated therein. Additionally, any one or more of the components depicted in FIG. 34 may be, in embodiments, integrated with various ones of the other components depicted therein (and/or components not illustrated), all of which are considered to be within the ambit of the subject matter disclosed herein.

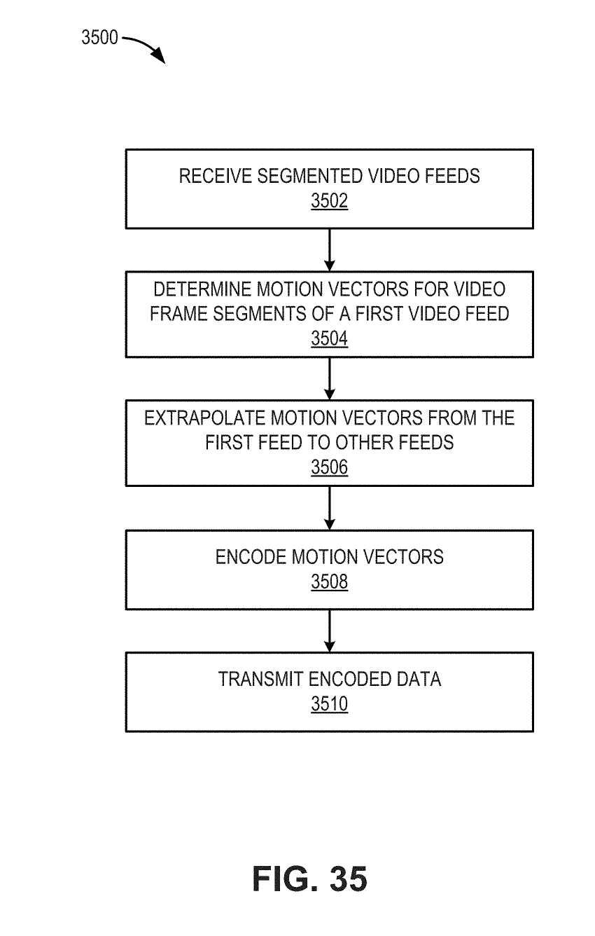

FIG. 35 is a flow diagram depicting an illustrative multi-view motion estimation method 3500, in accordance with embodiments of the subject matter disclosed herein. Embodiments of the illustrative method 3500 may be performed, for example, by a device such as the encoding device 3402.

As shown in FIG. 35, the illustrative multi-view motion estimation method 3500 includes receiving segmented video feeds (block 3502). In embodiments, a scene is recorded from multiple different viewpoints. Each recorded viewpoint is a video feed of the scene and each video feed comprises a sequence of video frames. A sequence of video frames having a common central subject matter, action, setting, background, theme, and/or the like may be referred to as a scene and the multiple recorded viewpoints may be used to produce multi-view video (e.g., 3D, AR and/or VR video) of the scene. According to embodiments, any number of different techniques for determining scene cuts may be implemented in the context of embodiments of the disclosed subject matter. The video information may include the raw video information, segmentation information (e.g., information about the segmentation process performed on the images of the scene, segment maps, segment identifications, and/or the like).

As shown in FIG. 35, the illustrative multi-view motion estimation method 3500 further includes determining motion vectors for video frame segments of a first video feed (block 3504). Determining motion vectors for video frame segments may include any number of different techniques known in the field. Two example motion estimation techniques are optical pixel flow and feature tracking. As an example, Speeded Up Robust Features (SURF) may be extracted from both a source image (e.g., a source frame) and a subsequent image (e.g., a subsequent frame). The extracted features of the two images may then be compared using a Euclidean metric to establish a correspondence between features, thereby generating a motion vector for each feature. In embodiments, a motion vector for a segment may be the median of all of the motion vectors for each of the segment's features.

Embodiments of the method 35 further include extrapolating motion vectors from the first feed to other feeds (block 3506). Embodiments describing a motion vector extrapolation method 400 are discussed below with respect to FIG. 4. In embodiments, determining motion vectors of a first feed and extrapolating motion vectors from the first feed to other feeds may be performed by a multi-view motion estimator 3422, as shown in FIG. 35.

After the motion vectors from a first feed are extrapolated onto other feeds, the motion vectors are encoded (block 3508). By extrapolating motion vectors from a first feed onto another feed, the computational demands of encoding multiple video feeds may be reduced. That is, for example, extrapolating motion vectors from one video feed onto another video feed may be computationally less demanding than computing motion vectors for each video feed independently. In embodiments, encoding the motion vectors may be performed by an encoder 3426, as shown in FIG. 34.

After encoding the motion vectors, the encoded motion vector data may be transmitted (block 3510). The encoded motion vector data may be transmitted to a decoding device (e.g., the decoding device 3408 depicted in FIG. 34). In embodiments, the communication component 3428 depicted in FIG. 34 may facilitate transmission of the encoded video data over a communication network (e.g., the communication network 3410 depicted in FIG. 34).

The illustrative method 3500 shown in FIG. 35 is not intended to suggest any limitation as to the scope of use or functionality of embodiments of the subject matter disclosed herein. Neither should the method 3500 be interpreted as having any dependency or requirement related to any block illustrated therein.

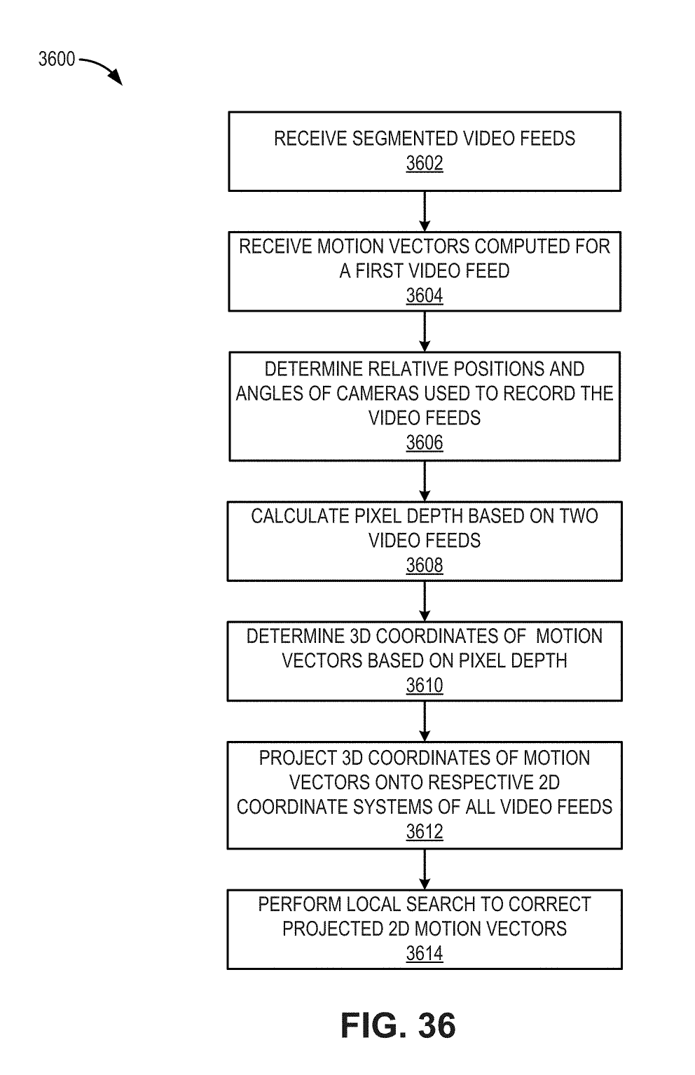

FIG. 36 is a flow diagram depicting an illustrative motion vector extrapolation method 3600, in accordance with embodiments of the subject matter disclosed herein. Embodiments of the illustrative method 3600 may be performed, for example, by a device such as the multi-view motion estimator 3422 depicted in FIG. 34.

As shown in FIG. 36, embodiments of the illustrative method 3600 include receiving segmented video feeds (block 3602). As described above in regards to FIGS. 34 and 35, a scene is recorded from multiple different viewpoints to produce 3D, AR and/or VR video of the scene. The video information may include the raw video information, segmentation information (e.g., information about the segmentation process performed on the images of the scene, segment maps, segment identifications, and/or the like).

Embodiments of the method 3600 further include receiving motion vectors computed for a first video feed (block 3604). Determining motion vectors for video frame segments may include any number of different techniques known in the field, such as the ones described above in relation to FIGS. 34 and 35.

In embodiments, the method 3600 may further comprise determining relative positions and angle of cameras used to record the video feeds (block 3606). In embodiments, the relative positions and angles of the cameras may be computed based on a comparison of the field of views of each of the cameras. Additionally or alternatively, the relative positions and viewing angles of the cameras may be included in metadata of the received segmented video feeds. The relative positions and angles of the cameras may be used to determine 3D coordinates of a video scene, as described below. In embodiments, a camera position and viewing angle calculator 3432, as depicted in FIG. 34, may be used to determine relative positions and angle of cameras used to record the video feeds.

Based on the relative positions of the cameras used to record the two video feeds, pixel depths may be calculated and a 3D map may be created (block 3608). As an example, if an object encompasses an area of a₁×b₁ pixels in one video feed and the same object encompasses an area of a₂×b₂ pixels in another video feed, then, based on the relative positions and angles of the two cameras used to recorded to the two video feeds, a transformation function can be determined that will transform the object from a₁×b₁ pixels to a₂×b₂ pixels. Due the transformation function being based on the relative positions and angles of the cameras, the transformation function will include distance information that can be used to calculate the distance of the object from the first camera used to record the first video feed. That is, a depth can be assigned to the pixels including the object. Similarly, distances to other objects included in the video feed may be determined. Once the distances to each of the objects are calculated, a pixel depth (i.e., a depth coordinate) can be assigned to each object and pixel included in a video feed. And, based on the calculated pixel depth, a 3D map of a video feed may be determined. That is, for each pixel of a video frame, a depth coordinate (e.g., a z coordinate) can be included in the horizontal and vertical coordinates (e.g., x, y coordinates). In embodiments, a depth analyzer 3434, as depicted in FIG. 34, may be used to calculate the pixel depths and create a 3D map of a video feed.

As shown in FIG. 36, once a 3D map of a video feed is determined, 3D coordinates (i.e., adding a new depth coordinate to each motion vector) can be assigned to each motion vector for the scene (block 3610). As such, each motion vector for the first video feed may be represented by 3D coordinates. Then, the 3D coordinate representation of each of the motion vectors may be projected onto a respective two-dimensional coordinate system of one or more other video feeds (block 3612). In embodiments, to correct for any errors in projecting a 3D motion vector for a first video feed onto a respective two-dimensional coordinate system of another video feed, the method 3600 may include performing a local search (block 3614). As stated above in relation to FIG. 34, by extrapolating motion vectors from a first feed onto another feed, as opposed to independently calculating motion vectors for each feed, the computational demands of encoding multiple video feeds may be reduced. In embodiments, the projected motion vectors may be compared to computed motion vectors for one or more of the other video feeds using a Euclidean metric to establish a correspondence between motion vectors and/or determine an projection error of the projected motion vectors.

The illustrative method 3600 shown in FIG. 36 is not intended to suggest any limitation as to the scope of use or functionality of embodiments of the subject matter disclosed herein. Neither should the method 3600 be interpreted as having any dependency or requirement related to any block illustrated therein.

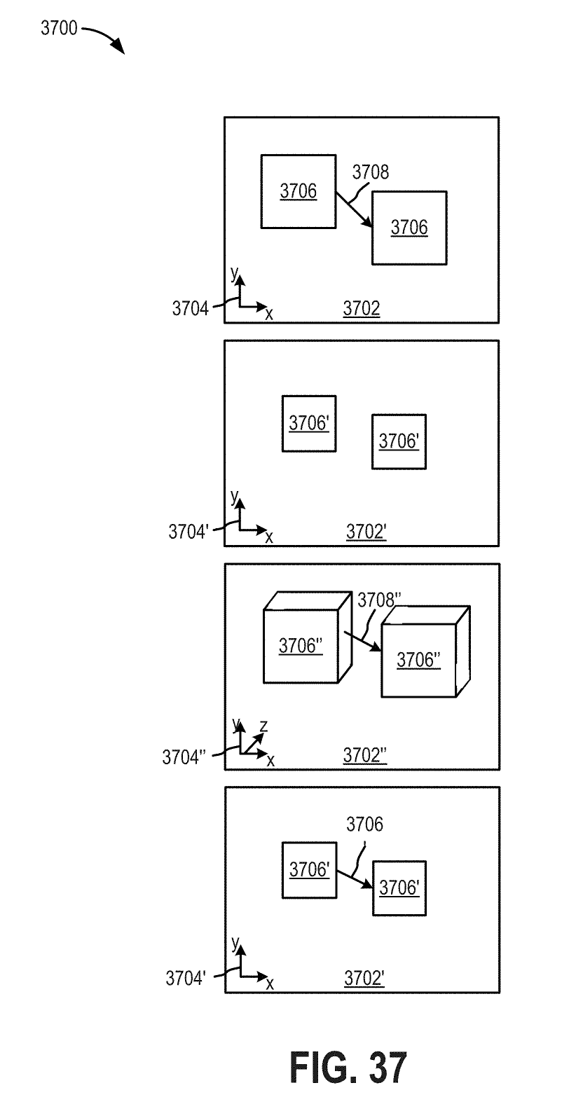

FIG. 37 is a block diagram of an illustrative motion vector transformation 3700, in accordance with embodiments of the subject matter disclosed herein. In the illustrated motion vector transformation 3700, a viewpoint 3702 of a scene is depicted. In embodiments, the viewpoint 3702 is recorded by a first video camera from a respective position and angle. In embodiments, the viewpoint 3702 of the scene includes a two-dimensional coordinate system 3704. A motion vector 3706 for a segment 3708 between a first frame and a second frame of the scene is determined. In embodiments, the motion vector 3706 and the segment 3708 may be determined according to any of the embodiments disclosed herein. In embodiments, the motion vector 3708 may be characterized by a vector in the two-dimensional coordinate system 3704.

In addition, the same scene is recorded by a second video camera from a second viewpoint 3702′. The second video camera has a respective position and angle relative to the scene. In embodiments, the viewpoint 3702′ of the scene includes a two-dimensional coordinate system 3704′. According to embodiments, the same or substantially the same segment 3706 may be determined for the two-dimensional coordinate system 3704′. The segment 3706 is depicted as segment 3706′ in the two-dimensional coordinate system 3702′. In embodiments, the segment 3706′ may be determined using a variety of embodiments, including, for example, the embodiments described above in relation to FIGS. 34-36. As shown, the segment 3706′ has a different appearance than the segment 3706 in viewpoint 3702. This may be due to the different viewpoint of the second camera relative to the first camera.

Based on the representations of the segments 3706, 3706′ a pixel depth may be calculated based on the respective positions and angles of the first and second cameras. In addition, using the calculated pixel depth, a three-dimensional representation of the segment 3706, 3706′ and/or the motion vector 3708 may be determined. That is, depth coordinates may be assigned to the segment 3706, 3706′ and/or the motion vector 3708. In embodiments, the pixel depth and three-dimensional representation may be determined using a variety of embodiments, including, for example, the embodiments described above in relation to FIGS. 34-36. The viewpoint 3702″ depicts the three-dimensional representation of the segment 3706″ and the motion vector 3708″.

After a three-dimensional representation of the motion vector 3708″ is determined, the motion vector 3708″ may be projected onto the two-dimensional coordinate system 3702′ to yield a projected motion vector 3706′. In embodiments, a local search may be performed to determine whether the motion vector 3706′ projected onto the two-dimensional accurately represent the motion vector for the segment 3706′. For example, the projected motion vector 3706′ may be compared to computed motion vector for the two-dimensional coordinate system 3702′ using a Euclidean metric to establish a correspondence between the motion vectors and/or to determine a projection error of the projected motion vectors. Additionally or alternatively, the motion vector 3708″ may be projected onto other viewpoints of the scene recorded by other video cameras.

By not computing the motion vector for the two-dimensional coordinate system 3702′, processing video feeds from multiple video feeds may reduce the computational requirements of a system encoding the video feeds.

The illustrative block diagram 3700 shown in FIG. 37 is not intended to suggest any limitation as to the scope of use or functionality of embodiments of the subject matter disclosed herein. Neither should the block diagram be interpreted as having any dependency or requirement related to any individual block illustrated therein.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

### Object Group Analysis

### Clustering

As explained above, embodiments of systems and methods described herein include an object group analysis process (e.g., the object group analysis process 212 depicted in FIG. 2). Object group analysis refers to analysis of groups of objects such as, for example, analysis of the location and movement of objects in a video scene. An object, in the context of object group analysis, may include any set of information associated with video data such as, for example, a segment, an identified object, a region of interest (ROI), an emblem, and/or the like. In this manner, object group analysis enables identification and tracking of objects that are moving together. According to embodiments, object group analysis process involves identifying the shape, border, location, and/or movement of an object, without actually classifying the type of object (that may happen, for example, in a further object classification process such as, for example, the object classification process 218 depicted in FIG. 2). Object group analysis may include any number of different types of techniques and algorithms such as, for example, statistical techniques, machine-learning techniques (e.g., classifiers, deep learning, neural networks, etc.), clustering techniques, and/or the like.

In embodiments, graph partitioning may be used in an object group analysis process. Graph partitioning often arises as a useful component of solving many numerical problems. Many graph partitioning methods have been devised, and selection of an appropriate method for a given problem may depend on the meaning of the underlying data and available computational resources. In the context of various aspects of video processing, graphs can be useful for performing processes such as, for example, image segmentation, object analysis and tracking, partitioning, and/or the like.

Embodiments include a graph partitioning algorithm that uses a max-flow technique. Embodiments of the algorithm include selecting source and drain vertices from within the existing graph to generate the min-cut.

Embodiments include a clustering algorithm for partitioning graphs using a max-flow/min-cut technique. See, for example, P. Sanders and C. Schulz (2011), “Engineering Multilevel Graph Partitioning Algorithms,” Proceedings of the 19th European Symposium on Algorithms (ESA), pp. 469-480 (hereinafter “Sanders & Schulz”), for an illustrative discussion of max-flow/min-cut techniques, the entirety of which is hereby incorporated herein by reference for all purposes. In contrast to conventional max-flow/min-cut techniques, in which a source vertex (sometimes referred to, interchangeably, as an “origin”) and a drain vertex (sometimes referred to, interchangeably, as a “sink”) are added to the graph to facilitate refining a candidate cut, embodiments of the subject matter disclosed herein include a max-flow/min-cut technique in which the source and drain vertex are selected from the set of graph vertices. Embodiments of the clustering algorithm described herein may be used for any number of purposes such as, for example, for object group analysis, segmentation, network modeling (e.g., routing of Internet Protocol (IP) packets), scheduling (e.g., scheduling of encoding jobs distributed between encoders, scheduling of tasks associated with distributed processing, etc.), other problems that may be modeled using graph partitioning, and/or the like. For example, in object group analysis, embodiments of the clustering algorithm described herein may be used to identify object boundaries, thereby facilitating more efficient encoding. For example, embodiments may be utilized with other techniques described herein to increase video processing efficiency by between approximately 10 and approximately 30 percent.

Embodiments of the disclosed algorithm may facilitate use of max-flow/min-cut techniques in situations in which these techniques may not have been traditionally used, more accurate partitioning process, and/or the like. For example, max-flow/min-cut partitioning techniques are typically used only when there is a good indication of which graph vertices the added source and drain vertices should be attached to. For example, as explained in U.S. Pat. Nos. 6,973,212 and 7,444,019, filed on Aug. 30, 2001, and Feb. 15, 2005, respectively, the entirety of each of which is hereby incorporated herein by reference for all purposes, a source vertex may be connected to graph vertices identified as object seeds, and the drain vertex may be connected to graph vertices identified as background seeds. Embodiments of the clustering algorithm described herein may be used to generalize the problem to situations in which object and/or background seeds are not known. In this manner, embodiments facilitate use of the max-flow/min-cut partitioning technique in situations in which other types of algorithms (e.g., spectral partitioning, Markov Cluster (MCL) algorithms, etc.) are typically used.

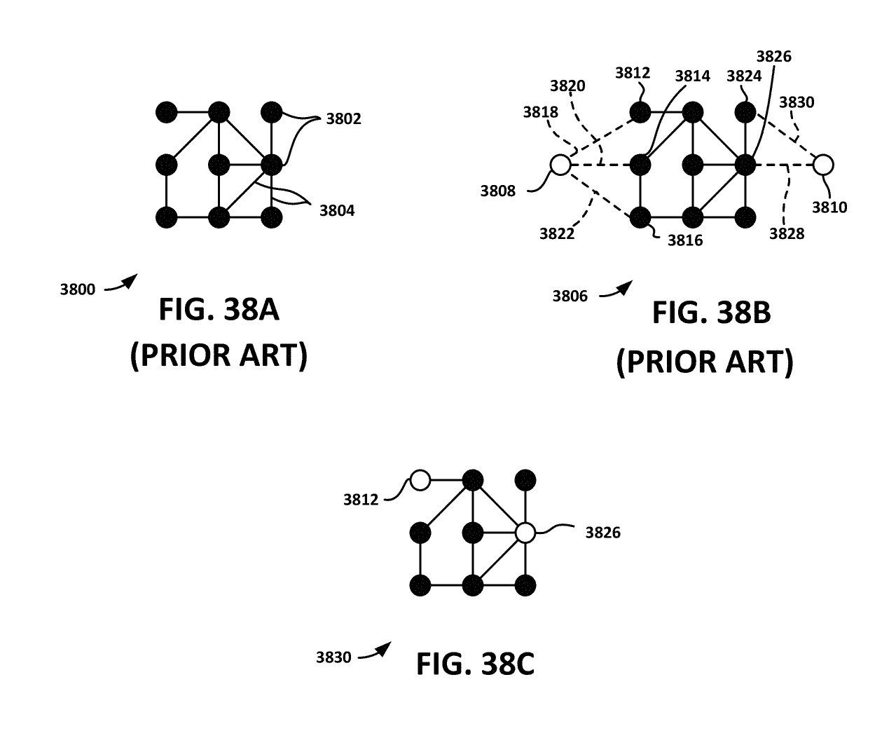

FIG. 38A depicts an illustrative undirected graph 3800 having vertices 3802 and edges 3804. As shown in FIG. 38B, in conventional max-flow/min-cut techniques (as described, for example, in Sanders & Schulz), a source vertex 3808 and drain vertex 3810, neither of which are vertices of the graph 3800, are attached to the graph 3800 to create a network 3806 that is used to refine a candidate cut. For example, as shown, the source vertex 3808 may be attached to graph vertices 3812, 3814, and 3816 via added edges 3818, 3820, 3822, respectively; and the drain vertex 3810 may be attached to graph vertices 3824 and 3826 via added edges 3828 and 3830, respectively.

In contrast with the conventional max-flow/min-cut techniques, embodiments disclosed herein include a clustering algorithm in which the source and drain vertices used for the partitioning are selected from the existing graph vertices. In comparison to conventional methods, this technique and the other embodiments described herein may provide one or more advantages because max flow algorithms optimize the max flow metric and spectral algorithms optimize cut-ratio metric. That is, the embodiments described herein can perform well on both metrics simultaneously. Conventional embodiments cannot. In addition, the embodiments described herein produce partitions that are more meaningful from an object creation point of view.

An example is depicted in FIG. 38C. In particular, embodiments of the clustering techniques described herein may include selecting, for example, vertex 3812 as the source and vertex 3826 as the drain. In embodiments, any number of different techniques may be used for selecting the source and drain vertices and, in embodiments, the selection of source and drain vertices may be changed throughout the process. In this manner, for example, embodiments may facilitate checking various paths associated with various combinations of sources and drains. In embodiments, for example, an iterated sub-algorithm of a merit function may be used to choose two existing vertices within the graph as the source and drain vertices. Through experimentation, the inventors have found embodiments of the clustering algorithm described below to have excellent performance on graphs of interest under a flow ratio metric (a performance measurement metric, defined below, that measures the amount of flow between partitions against the maximum amount of flow that any vertex in the graph could generate), and to have reasonably good performance compared to the conventional spectral partitioning method under the widely used cut ratio metric for the reasons stated above. That is, the embodiments described herein can perform well on both the max flow metric and the optimize cut-ratio metric simultaneously.

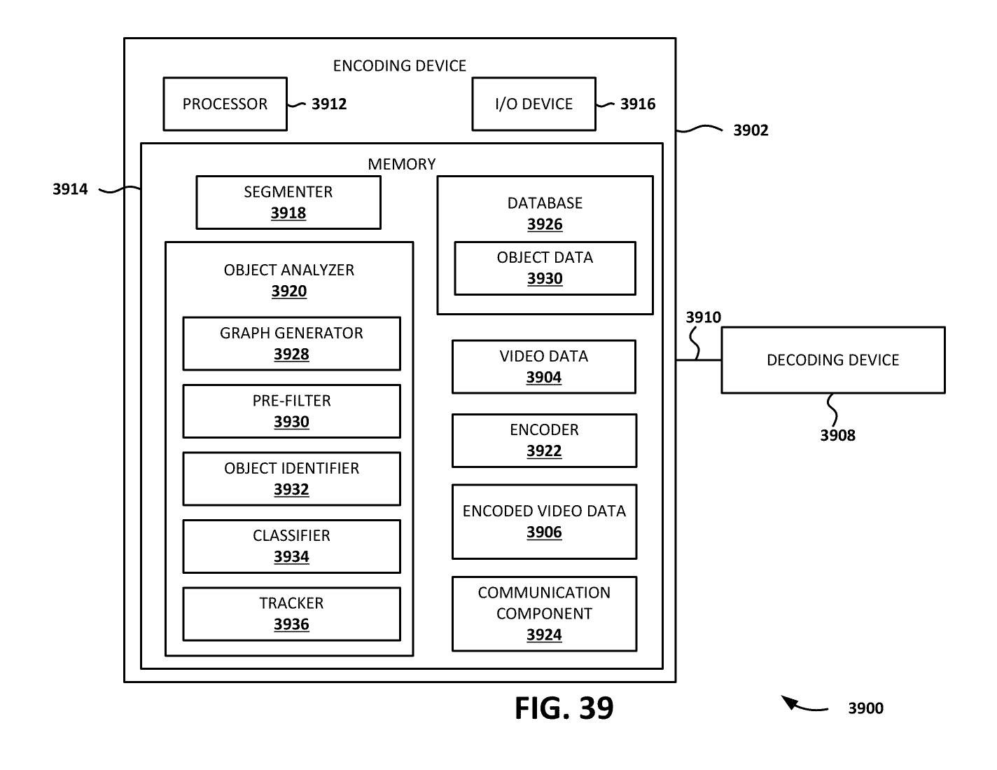

Embodiments disclosed herein include systems and methods for object group analysis. FIG. 39 is a block diagram illustrating an operating environment 3900, in accordance with embodiments of the subject matter disclosed herein. In embodiments, aspects of the operating environment 3900 may be, include, or be included in, a system for processing video information, e.g., by analyzing objects within a video scene. The operating environment 3900 includes an encoding device 3902 (e.g., the video processing platform 102 depicted in FIG. 1 and/or the video processing device 302 depicted in FIG. 3) that may be configured to encode video data 3904 to create encoded video data 3906. As shown in FIG. 39, the encoding device 3902 may also be configured to communicate the encoded video data 3906 to a decoding device 3908 (e.g., the receiving device 108 depicted in FIG. 1 and/or the decoding device 308 depicted in FIG. 3) via a communication link 3910 (e.g., the communication links 106 and/or 110 depicted in FIG. 1, and/or the communication link 310 depicted in FIG. 3).

As shown in FIG. 39, the encoding device 3902 may be implemented on a computing device that includes a processor 3912, a memory 3914, and an input/output (I/O) device 3916. Although the encoding device 3902 is referred to herein in the singular, the encoding device 3902 may be implemented in multiple instances, distributed across multiple computing devices, instantiated within multiple virtual machines, and/or the like. In embodiments, the processor 3912 executes various program components stored in the memory 3914, which may facilitate encoding the video data 3904. In embodiments, the processor 3912 may be, or include, one processor or multiple processors. In embodiments, the I/O device 3916 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 3914 stores computer-executable instructions for causing the processor 3912 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 3918, an object analyzer 3920, an encoder 3922, and a communication component 3924.

In embodiments, the segmenter 3918 may be configured to segment a video frame into a number of segments to generate a segment map. The segments may include, for example, objects, groups, slices, tiles, and/or the like. The segmenter 3918 may employ any number of various automatic image segmentation methods known in the field. In embodiments, the segmenter 3918 may use image color and corresponding gradients to subdivide an image into segments that have similar color and texture. Two examples of image segmentation techniques include the watershed algorithm and optimum cut partitioning of a pixel connectivity graph. For example, the segmenter 3918 may use Canny edge detection to detect edges on a video frame for optimum cut partitioning, and create segments using the optimum cut partitioning of the resulting pixel connectivity graph. In embodiments, the segmenter 3918 implements aspects of the segmentation techniques described in Iuri Frosio and Ed Ratner, “Adaptive Segmentation Based on a Learned Quality Metric,” Proceedings of the 10^{th} International Conference on Computer Vision Theory and Applications, March 2015, the entirety of which is hereby incorporated herein by reference for all purposes.

The resulting segment map of image segments includes an assignment of indices to every pixel in the image, which allows for the frame to be dealt with in a piecemeal fashion. Each index, which may be indexed in a database 3926 stored in the memory 3914, may be considered a mask for this purpose. The database 3926, which may refer to one or more databases, may be, or include, one or more tables, one or more relational databases, one or more multi-dimensional data cubes, and the like. Further, though illustrated as a single component, the database 3926 may, in fact, be a plurality of databases 3926 such as, for instance, a database cluster, which may be implemented on a single computing device or distributed between a number of computing devices, memory components, or the like.

In embodiments, the object analyzer 3920 may be configured to identify, using the segment map, the presence of objects (e.g., clusters of segments that move together, or at least approximately together) within digital images such as, for example, frames of video. In embodiments, the object analyzer 3920 may be configured to identify and/or analyze only objects that are moving within a particular scene. In embodiments, the object analyzer 3920 may perform object analysis on images that have not been segmented. Results of object group analysis may be used by the segmenter 3918 to facilitate a segmentation process, by an encoder 3922 to facilitate an encoding process, and/or the like.

According to embodiments, as shown in FIG. 39, the object analyzer 3920 includes a graph generator 3928 configured to generate a graph based on video information, segmentation information, and/or motion information (e.g., received from a motion estimator such as, for example, the motion estimator 324 depicted in FIG. 3). According to embodiments, the graph generator 3928 may be configured to generate, for example, a weighted undirected graph in which each vertex corresponds to an image segment and each edge is weighted to correspond to a strength of overlap between a translated segment in a first frame and a segment in a second (e.g., next) frame. According to embodiments, the graph may be generated in any number of other manners, to represent any number of other types of information about a particular scene, segment, frame, and/or the like.

As shown in FIG. 39, the object analyzer 3920 may include a pre-filter 3930 configured to determine whether a particular graph, generated by the graph generator 3928, is useful for object group analysis. That is, for example, the pre-filter 3930 may be configured to evaluate the graph, and the underlying information represented by the graph, to determine whether the graph is likely to be useful or relatively meaningless noise. If the pre-filter 3930 determines that the graph is not likely to be useful, the graph may be removed from the process, and another graph may be generated.

The object analyzer 3920 also may include an object identifier 3932 configured to identify the presence of one of more objects in an image. In embodiments, the object identifier 3932 may represent more than one object identifier 3932. The object identifier 3932 may utilize any number of different types of object identification techniques such as, for example, clustering. According to embodiments, an object may be a group of one or more segments that move at least approximately together from frame to frame. After identifying the objects, the objects may be classified using a classifier 3934 configured to classify at least one of the objects to identify characteristics of the objects. The classifier 3934 may be configured to receive input information and produce output that may include one or more classifications. In embodiments, the classifier 3934 may be a binary classifier and/or a non-binary classifier. The classifier 3934 may include any number of different types of classifiers such as, for example, a support vector machine (SVM), an extreme learning machine (ELM), a neural network, a kernel-based perceptron, a k-NN classifier, a bag-of-visual-words classifier, and/or the like. The object analyzer 3920 may include a tracker 3936 that is configured to track one or more of the identified objects, groups of objects, and/or the like, as they move throughout the video.

As shown in FIG. 39, the encoding device 3914 also includes an encoder 3922 configured for entropy encoding of partitioned video frames. In embodiments, the communication component 3924 is configured to communicate encoded video data 3906. For example, in embodiments, the communication component 3924 may facilitate communicating encoded video data 3906 to the decoding device 3908.

The illustrative operating environment 3900 shown in FIG. 39 is not intended to suggest any limitation as to the scope of use or functionality of embodiments of the present invention. Neither should the illustrative operating environment 3900 be interpreted as having any dependency or requirement related to any single component or combination of components illustrated therein. Additionally, any one or more of the components depicted in FIG. 39 may be, in embodiments, integrated with various ones of the other components depicted therein (and/or components not illustrated), all of which are considered to be within the ambit of the present invention.

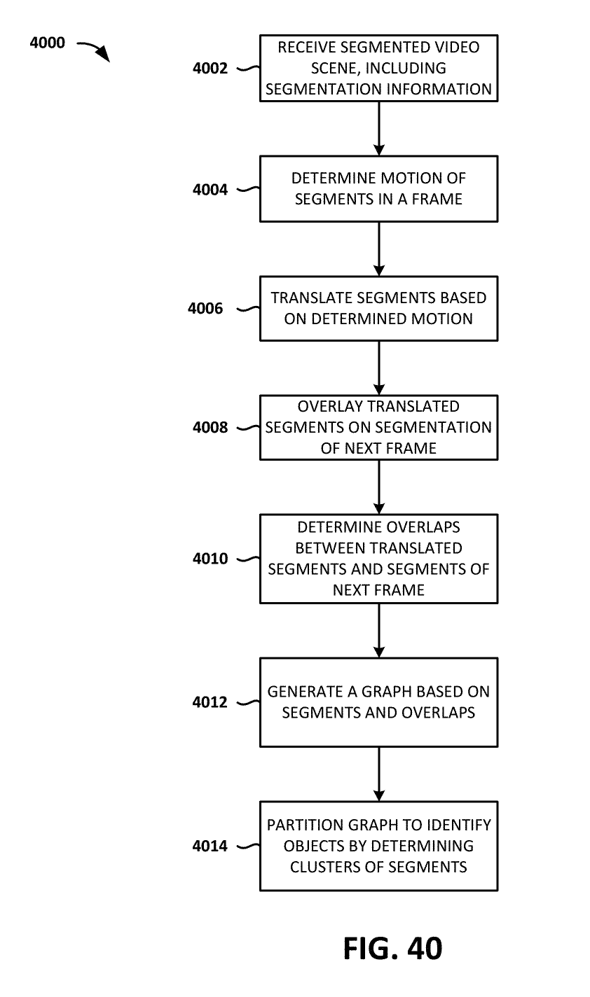

FIG. 40 is a flow diagram depicting an illustrative group object analysis method 4000, in accordance with embodiments of the subject matter disclosed herein. Embodiments of the illustrative method 4000 may be performed, for example, by a device such as the encoding device 3902. In embodiments, as shown in FIG. 39, object group analysis may be performed by an object analyzer. The object analyzer may be, include, or be included within one or more program components and/or other computer-executable instructions.

As shown in FIG. 40, the illustrative group analysis method 4000 includes receiving a segmented video scene, including segmentation information (block 4002). In embodiments, for example, the video scene may include video information corresponding to a scene in a video file. A scene may be any sequence of video frames. Often, for example, a sequence of video frames having a common central subject matter, action, setting, background, theme, and/or the like may be referred to as a scene. According to embodiments, any number of different techniques for determining scene cuts may be implemented in the context of embodiments of the disclosed subject matter. The video information may include the raw video information, segmentation information (e.g., information about the segmentation process performed on the images of the scene, segment maps, segment identifications, and/or the like).

As shown in FIG. 40, the illustrative group analysis method 4000 further includes determining a motion of each of a number of segments in a frame (block 4004). Determining the estimated motion of segments in a frame may be referred to herein as segment-based motion estimation, and may include any number of different techniques such as, for example, those discussed above. According to embodiments, the estimated motion of every segment in a frame may be determined and used in the object group analysis process, while, in other embodiments, only some of the segments in the frame may be used in the object group analysis process.

Embodiments of the method 40 further include translating each of the segments based on the determined estimated motion (block 4006) and overlaying the translated segments on the segmentation of the next frame (e.g., the immediately following frame) (block 4008). In this manner, embodiments of the method 40 facilitate determining overlaps between the translated segments and the segments of the next frame (block 4010).

As shown in FIG. 40, embodiments of the illustrative method 4000 further include generating a graph based on the segments and determined overlaps (block 4012). In embodiments, for example, a weighted undirected graph may be generated by assigning each translated segment of the frame and each segment of the next frame as a vertex (sometimes referred to, interchangeably, as a “node”), and assigning each edge connecting two vertices a weight corresponding to the strength of overlap between the two connected vertices.

As is further shown in FIG. 40, embodiments of the method 4000 include partitioning the graph to identify objects by determining clusters of segments (block 4014). In this manner, for example, an object may be defined according to a set of segments that move together. According to embodiments, partitioning the graph may be accomplished using any number of different techniques such as, for example, a spectral partitioning method, a max-flow/min-cut technique, and/or the like. The clusters of segments may be referred to as an object for the purposes of object analysis. In embodiments, the location of the objects may be determined and tracked from frame to frame, scene to scene, and/or the like. In some embodiments, objects may be created by grouping segments with similar next frame motion. For example, in embodiments in which multiple sequential frames have little motion or very few objects with very consistent motion, an object group analysis algorithm may be configured to create one or more objects by grouping segments based on next frame motion, thereby reducing some computational burden.

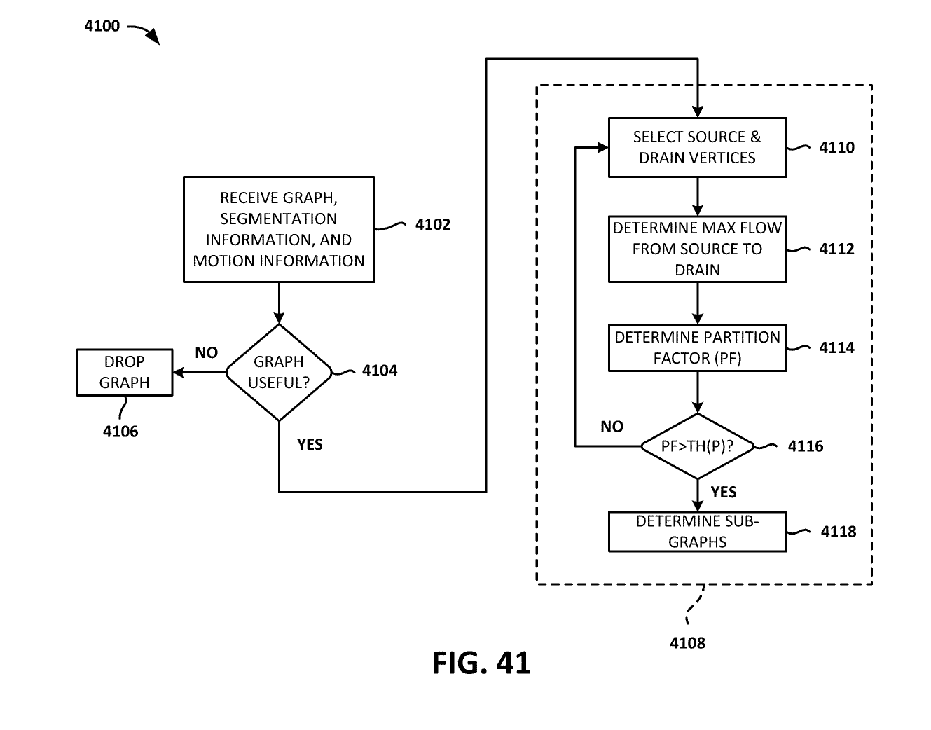

FIG. 41 is a flow diagram depicting an illustrative method 4100 of performing object group analysis, in accordance with embodiments of the subject matter disclosed herein. As shown in FIG. 41, embodiments of the method 4100 include receiving a graph, segmentation information, and motion information (block 4102). According to embodiments, the graph may be a connected weighted undirected graph, G=(V, E), with vertices V and edges E. In embodiments, the graph may be a disconnected graph, in which case, disconnected subgraph may be treated as a separate original graph for the purposes of embodiments of the clustering algorithm described herein. In the context of embodiments of the clustering algorithm described here, the edge weights of the edges are considered to be capacities. As individuals of ordinary skill in the relevant arts will appreciate, a capacity, in the context of graph partitioning, is a measure of the total amount of flow that the edge can support (that is, the edge's capacity).

In embodiments, each group of segments in each frame may be a vertex, and the edge weights to be the amount of overlap between (camera and group) motion compensated groups, modified according to a difference in group motion. According to embodiments, segments may be grouped in any number of different manners. In embodiments, adjacent segments may be grouped based on characteristics of their respective motion from a current frame to the subsequent frame. For example, a number of segments may be associated with a particular group if they are adjacent (e.g., within a specified distance from one another), and if their motion vectors are similar. According to embodiments, two or more motion vectors may be similar if they satisfy a similarity metric. For example, motion vectors may be deemed to be similar if their respective directions are within a specified number of degrees of one another, if a difference between their magnitudes are within a specified range or exceed a specified threshold (or are less than a specified threshold), if a metric calculated based on one or more features of the motion vectors satisfy a specified criteria, and/or the like. Using the grouped segments, graphs may be generated and partitioned to create objects, as described herein. In embodiments, for the purpose of creating graphs, each group of edges may be a group of one—that is, for example, graph vertices may correspond to individual segments. For example, an edge weight may be defined as follows:

edgeWeight=floor(10*motionFactor*(forwardOverlap+backwardOverlap)/2),

where the forwardOverlap is based on the forward motion of each warped (camera motion compensated) group onto groups in the next frame, the backwardOverlap is based on the backward motion of each unwarped group onto groups in the previous frame, the floor(10* . . . ) is used to convert from order-unity-or-greater floating point values to integer values, and the motionFactor is given by:

dx=max{0,|vₓ₁+vₓ₂|−vₛₒₐₖ},

dy=max{0,|v_{y1}+v_{y2}|−vₛₒₐₖ},

v_{Δ}=sqrt(dx²+dy²),

v_{Σ}=sqrt(vₓ₁²+vₓ₂²+v_{y1}²+v_{y2}²),

v₀²=v_{A}²+v_{B}*v_{Σ}+c*v_{Σ}², and

motionFactor=v₀²/(v₀²+v_{Δ}²),

where vₓ₁, v_{y1} are the forward motion vector components of one group, vₓ₂, v_{y2} are the backward motion vector components of the other group (hence the use of addition to obtain dx, dy); max{0, x} is x if x is positive and 0 otherwise; sqrt( ) is the square root function; and the other symbols are constants. In embodiments, for example, vₛₒₐₖ=0.5, v_{A}=0.002, v_{B}=0.1, and c=0.0. According to various embodiments, these consonants may be assigned any number of other combinations of values. The values of the consonants may be adjusted to achieve edge capacities that produce results meeting any number of different outcome criteria.

In embodiments, when constructing edges weights, the algorithm does not directly consider how well the overlapping pixels match—this information is somewhat captured by the (typically L₁) residuals during segment motion, and that information impacts declaration of which segments can be said to be moving and how groups (“proto-groups”) are formed. But, in embodiments, the residuals are not directly considered when constructing the edge weights. In other embodiments, the residuals are considered when constructing edge weights. For example, embodiments of the method 4100 may include examining the actual overlaps between groups. In embodiments, considering, instead of the actual overlaps between groups, the aggregate residuals of the segments in each group, may facilitate a computationally less intensive operation while maintaining the robustness of the algorithm.

As shown in FIG. 41, embodiments of the method 4100 further include determining whether the graph is likely to be useful with regard to the purpose of the clustering algorithm (block 4104). As discussed above, this step may be performed by a pre-filter (e.g., the pre-filter 3930 depicted in FIG. 39). In embodiments, for example, a particular graph may, or may not (depending on the nature of the underlying information represented by the graph, the nature of the partitioning problem, etc.) be likely to be useful to the analysis being performed (of which the clustering algorithm is a part). Any number of different types of techniques may be employed to determine the usefulness of a graph such as, for example, statistical analysis, component analysis, and/or the like. For example, a pre-filter (e.g., the pre-filter 3930 depicted in FIG. 39) may be configured to calculate a metric based on the graph, and to determine whether the graph is likely to be useful based on the value of the metric (e.g., whether the metric exceeds a threshold, whether the metric falls within a specified range of values, whether the metric in combination with another metric exhibits a specified characteristic, etc.). The likelihood that a graph may be useful may be, in embodiments, expressed in terms of probabilities, confidence levels, and/or the like. If it is determined that the graph is not likely to be useful, the graph may be dropped (block 4106) (e.g., excluded from further object group analysis). In embodiments, a graph may be discarded if the duration of the graph is less than a certain number of frames and/or the area of the group associated with a graph is below a certain threshold. On the other hand, if it is determined that the graph is likely to be useful, the graph may be subjected to a max-flow/min-cut partitioning algorithm 4108.

As shown in FIG. 41, embodiments of the partitioning algorithm 4108 include selecting the source and drain vertices (block 4110). According to embodiments, any number of different techniques may be used to select source and drain vertices from among the graph vertices, V. For example, in embodiments, source and drain vertices may selected randomly, using statistical analysis, based on information associated with the graph, and/or the like. In embodiments, an iterated sub-algorithm of a merit function may be used for selecting two of the graph vertices, V, as the source and drain vertices.

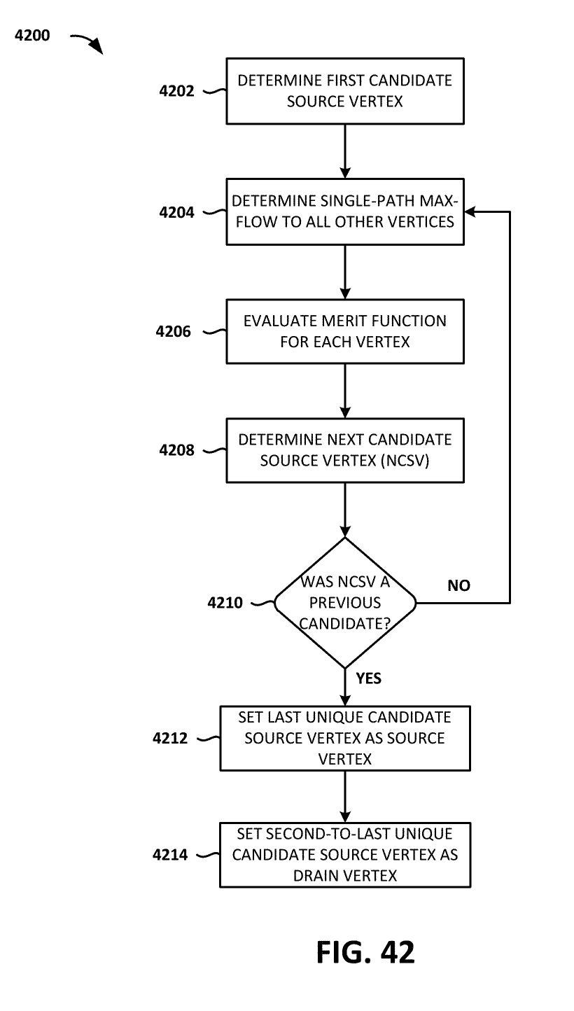

Turning briefly to FIG. 42, a flow diagram is presented that depicts an illustrative method 4200 of selecting source and drain vertices for use in a graph partitioning (e.g., clustering) algorithm (e.g., the clustering algorithm described herein with respect to FIGS. 39, 40, 41, 42, 43), in accordance with embodiments of the subject matter disclosed herein. As shown in FIG. 42, the illustrative method 4200 includes determining a first candidate source vertex (block 4202). In embodiments, the first candidate source vertex, v_{source}, may be determined to be the vertex with the greatest vertex strength, where the vertex strength (i.e., the strength of a vertex, v) is the sum of the edge capacities, capacity(u,v), of that vertex:

strength(v)≡Σᵤcapacity(u,v).

Embodiments of the method 4200 further include determining the single-path max-flow, spmFlow(u,vsource) from the first candidate source vertex, vsource, to each of the other vertices (block 4204). In embodiments, spmFlow(u,vsource) may be determined by solving the widest path problem. A merit function is evaluated for each vertex (block 4206) and the next candidate source vertex (represented by “NCSV” in FIG. 42) is determined (block 4208). In embodiments, the merit function may be defined as follows:

merit(u)≡strength(u)/spmFlow(u,v_{source}),

where merit(v_{source})=−1. The vertex with the greatest merit is taken to be the next candidate source vertex.

According to embodiments, the partitioning algorithm may be improved by modifying the merit function used to select the source and drain vertices. Similarly, modifying the merit function may allow the algorithm to be tuned to a desired application. For example, one may consider using not just the single-path max-flow and the vertex strength, but also the greatest edge capacity among the edges associated with each vertex and any other information available about each vertex or edge based on the underlying meaning of the graph. In embodiments, one or more of these types of information may be combined with one or more other types of information (whether or not listed here) to obtain a useful merit function that produces results appropriate for a type of video content, application, and/or the like.

As shown in FIG. 42, a determination is made as to whether the next candidate source vertex was a previous candidate (block 4210). If the next candidate source vertex was not a previous candidate, the illustrative process returns to step 4204, and the next candidate source vertex is evaluated using steps 4204, 4206, 4208, and 4210. On the other hand, if it is determined that the next candidate source vertex, the last unique candidate (e.g., the next candidate source vertex) is set as the source vertex (block 4212) and the immediately preceding candidate source vertex is set as the drain vertex (block 4214).

The source and drain vertex-selecting process may be repeated any number of times (e.g., up to five times), or until the next candidate source vertex was a previous candidate. In practice, this process has been generally found to converge after 3 iterations. Accordingly, in embodiments, the process may be programmed to be terminated after two iterations.

With reference to FIG. 41, embodiments of the method 4100 further include determining the maximum flow from the selected source vertex to the selected drain vertex. According to embodiments, any number of different techniques for calculating the maximum flow may be used to determine the maximum flow. For example, the Augmenting Path Algorithm may be used to determine the maximum flow. As another example, the Edmonds & Karp Algorithm may be used to determine the maximum flow. In embodiments, for example, the Boykov-Kolmogorov maximum flow algorithm may be used to determine the maximum flow between the selected source and drain vertices, as described, for example, in Yuri Boykov and Vladimir Kolmogorov, “An Experimental Comparison of Min-Cut/Max-Flow Algorithms for Energy Minimization in Vision,” IEEE Transactions on Pattern Analysis and Machine Intelligence, vol. 26, no. 9, pp. 1124-1137, September 2004, the entirety of which is hereby incorporated herein by reference for all purposes. In embodiments, the residual capacity also may be calculated. For example, if maxFlow is the calculated value of the maximum flow, and flow(u,v) is the absolute value of the flow between vertices v to u under the calculated maximum flow, the associated residual capacity is:

residual(u,v)≡capacity(u,v)−flow(u,v).

Embodiments of the method 4100 further include deciding whether or not to accept the candidate partition, which may include evaluating the partition factor, PF (block 4114):

PF≡maxFlow/min{strength(v_{source}),strength(v_{drain})},

where v_{source} and v_{drain} are the source and drain vertices, and min{ . . . } indicates the smallest value in the set. The partition factor is compared to a partition factor threshold, TH(P), and it is determined whether the partition factor exceeds the partition factor threshold (block 4116). If the partition factor does not exceed the partition factor threshold, the partition factor may be rejected and a new set of source and drain vertices may be selected (block 4110) and evaluated, as shown in FIG. 41. For example, in embodiments, the candidate partition may be rejected if the partition factor is 3 or less; otherwise the candidate partition may be accepted. Any number of other values may be used as the partition factor threshold (e.g., 2, 4, 5, etc.). According to embodiments, the decision to accept or reject the partition is made without having to determine the partition itself.

As shown in FIG. 41, if the partition is accepted (e.g., if the partition factor exceeds the partition factor threshold), embodiments of the method 4100 include determining the source- and drain-side subgraphs (block 4108). According to embodiments, the subgraphs are determined by dividing the graph vertices between source-side and drain-side, cutting all edges between the two. To determine the subgraphs, embodiments of the method 4100 include calculating the preliminary source-side subgraph, which includes all vertices that are connected to the source vertex in the undirected residual graph—that is, embodiments of the algorithm consider edges only with strictly positive residual capacity. The preliminary drain-side subgraph also may be determined, which includes the set of all vertices and edges of the capacity graph excluding all vertices (and associated edges) in the preliminary source-side graph. Note that the preliminary drain-side subgraph may be disconnected. Embodiments of the method 4100 further include taking the drain-side subgraph to be all vertices (and associated edges) in the preliminary drain-side subgraph that are connected to the drain vertex. Correspondingly, the source-side subgraph includes all of the vertices (and associated edges) that are not part of the drain-side subgraph.

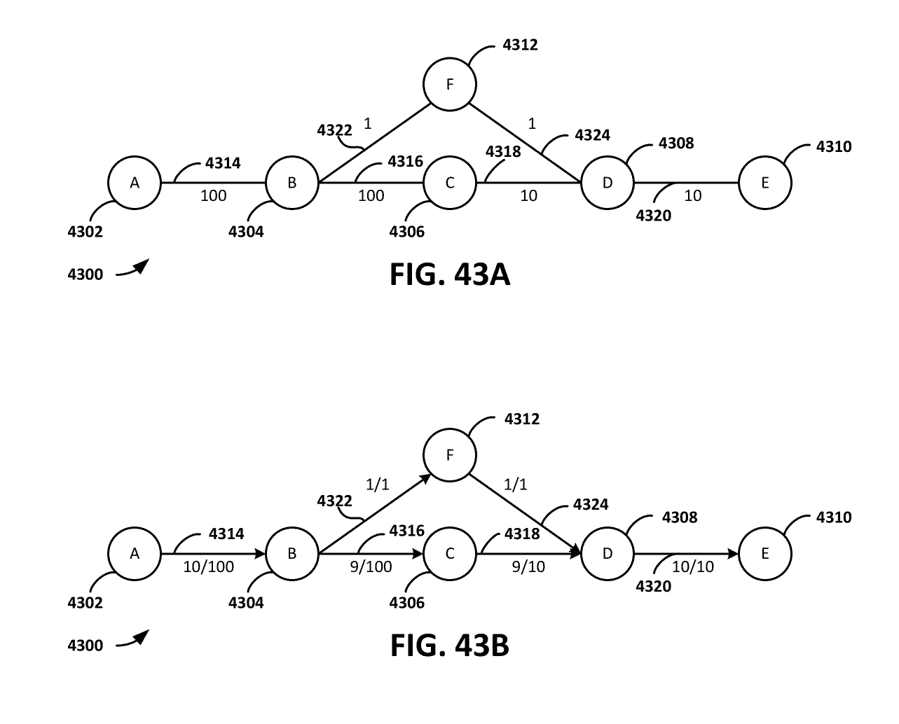

Embodiments of the process of determining the source- and drain-side subgraphs are depicted in FIGS. 43A and 43B. As shown, FIG. 43A depicts a capacity graph 4300, having vertices A 4302, B 4304, C 4306, D 4308, E 4310, and F 4312. An edge 4314 having capacity 100 connects vertices A 4302 and B 4304; an edge 4316 having capacity 100 connects vertices B 4304 and C 4306; an edge 4318 having capacity 10 connects vertices C 4306 and D 4308; an edge 4320 having capacity 10 connects vertices D 4308 and E 4310; an edge 4322 having capacity 1 connects vertices B 4304 and F 4312; and an edge 4324 having capacity 1 connects vertices F 4312 and D 4308. In the capacity graph 4300, the vertex A 4302 is the source vertex, and the vertex E 4310 is the drain vertex. FIG. 43B depicts the graph 4300, and indicates, for each edge, the value of flow/capacity. That is, for example, the flow along edge 4314 is 10, and, accordingly, the value of flow/capacity is 10/100. It can be seen, from FIG. 43B, that the maxFlow is 10 in the illustrated case. In this example, the preliminary source-side subgraph will consist of vertices A 4302, B 4304, C 4306, and D 4308. The preliminary drain-side subgraph will consist of vertices E 4310 and F 4312, which are disconnected. Accordingly, the drain-side subgraph will include vertex E 4310, and the source-side subgraph will be vertices A 4302, B 4304, C 4306, D 4308, and F 4312.

According to embodiments, if the partition was accepted, the process described above may be applied to both of the determined sub-graphs iteratively until all subgraphs have been dropped or have been rejected for partitioning. According to embodiments, any number of various refinements, additional criteria, filtering processes, and/or the like may be employed as part of the clustering algorithm described above.

As described above, embodiments include a novel graph partitioning algorithm that may be used to partition graphs to identify clusters, which may be referred to as objects. Identification of the objects may facilitate object group analysis, in which the position and motion of objects and/or groups of objects are tracked. Information about objects, groups of objects, the location (in video frames) of objects, the motion of objects, and/or the like, may be used to facilitate more efficient partitioning, encoding, and/or the like.

The inventors have found, through experimentation, that embodiments of the algorithm described herein facilitate more effective and useful partitioning of graphs related to video frames. When analyzing a partitioning method, it is beneficial to have a simple numerical method to determine how “good” a cut is. The appropriate measure depends on what is meant by a “good” cut for a given purpose. One of the most widely used measures of merit is the cut ratio, which is the sum of the edge capacities cut divided by the lesser of the sum of the edge capacities in either partition:

cutRatio≡(Σ_{edgesCut}Weight_{edge})/(min{Σ_{left partition}weight_{edge},Σ_{right partition}weight_{edge}}),

where the identification of which partition is “left” and which is “right” is arbitrary.

For many of applications, a more appropriate measure of merit may be a measure of merit defined herein, called the “flow ratio,” defined as follows. First, for each vertex in each partition, consider the strength of each vertex to be the sum of the capacities of the edges connected to that vertex. For any candidate partition, consider the maximum vertex strength in each candidate subgraph; and the lesser of those two is the min-max vertex strength. Finally, for any candidate partition, the flow ratio is the sum of the weights of the edges cut divided by the min-max vertex strength. The flow ratio may also be called the min-max vertex strength cut ratio. Note that the flow ratio is similar to, but different from, the partitionFactor used in embodiments of the partitioning algorithm described above. The flow ratio may be expressed in the following form:

$$flowRatio ≡ \frac{{\sum }_{edgesCut} {weight}_{edge}}{min \{ \begin{matrix}{max}_{left - partition vertices} \{ strength ( vi ) \} , \\ {max}_{right - partition vertices} \{ strength ( {v}_{j} ) \}\end{matrix} \}} .$$

One of the simplest traditional partitioning methods is based on minimum spanning trees. In this method, one first constructs an approximate minimum spanning tree from the original graph, using the reciprocal of the capacities of each edge as the cost of the edge. Prim's algorithm provides a simple greedy method for constructing an approximate minimum spanning tree, and works essentially as follows: starting with an arbitrary vertex, grow the tree one edge at a time, always adding the cheapest edge that connects the tree to a vertex not yet connected to the tree, and continue until all vertices are connected. Given an approximate minimum spanning tree, then decide which edge to cut in the tree, and partition vertices in the original graph according to the partitioning of the vertices in the tree. A simple approach would be to cut the tree at the weakest edge; and a more sophisticated approach would be to consider every edge in the tree and evaluate the resultant cut ratio in the original graph, taking the cut according to the best cut ratio. One of the downsides of this method is that it can perform very poorly in some cases, due to the greedy algorithm used to construct the tree.

Another widely used method of partitioning is spectral partitioning, and its properties been the subject of extended analysis. See, for example, Stephen Guattery and Gary L. Miller, “On the Performance of Spectral Graph Partitioning Methods,” Proceedings of The Second Annual ACM-SIAM Symposium on Discrete Algorithms, ACM-SIAM, 1995, pp. 233-242; and Daniel A. Spielman and Shan-Hua Teng, “Spectral partitioning works: Plana graphs and finite element meshes,” Linear Algebra and its Applications 421 (277) 284-305, the entirety of each of which is hereby incorporated herein by reference for all purposes. The method works as follows: First, consider the adjacency matrix A, with [A]ᵢⱼ being the capacity between vertex i and j in the graph and [A]ᵢᵢ=0 for any i. Construct the diagonal strength matrix D, with [D]ᵢᵢ=the sum of the edge capacities of all edges attached to vertex i and [D]ᵢⱼ=0 for i≠j. Now construct the Laplacian matrix L=D−A. Evaluate the Fiedler vector, which is the eigenvector corresponding to the second smallest eigenvalue of L. In spectral partitioning methods, the vertices in the graph are partitioned based on how the corresponding element in the Fiedler vector compares to one or more thresholds. One of the simplest thresholds would be to partition all vertices with a positive Fiedler value from those with a negative Fieldler value. In many cases, better results are achieved by taking the threshold to be such that some measure of partition merit is optimized.

The inventors have applied embodiments of the new max-flow graph partitioning algorithm described herein (referred to herein, interchangeably, as “the new algorithm” and “the new method”) to several graphs that arise during a video analysis application. The algorithm was applied to four different cases (“persp”, “fishClip”, “quickAtk” and “dog”), distinguishing the base graphs used as input to the algorithm from the induced graphs which resulted from the application of the algorithm. Several of the statistics of these graphs are summarized in Table 1.

TABLE 1

| | Num | | | |
|---|---|---|---|---|
| Set Name | Graphs | Num Vertices | Num Edges | Density |
| pesrp-base | 210 | 5~78 (25 ± 16) | 4~205 (44 ± 40) | 0.162 ± 0.065 |
| persp-induced | 222 | 5~59 (18 ± 13) | 4~155 (33 ± 33) | 0.213 ± 0.088 |
| fishClip-base | 72 | 5~498 (160 ± 170) | 4~1687 (470 ± 550) | 0.122 ± 0.116 |
| fishClip-induced | 551 | 5~484 (100 ± 110) | 4~1622 (280 ± 350) | 0.116 ± 0.096 |
| quickAtk-base | 62 | 5~688 (210 ± 270) | 4~1682 (490 ± 660) | 0.141 ± 0.124 |
| quickAtk-induced | 741 | 5~665 (100 ± 140) | 4~1651 (250 ± 370) | 0.119 ± 0.096 |
| dog-base | 945 | 5~653 (70 ± 110) | 4~1390 (160 ± 270) | 0.147 ± 0.104 |
| dog-induced | 5211 | 5~646 (65 ± 95) | 4~1394 (140 ± 230) | 0.140 ± 0.098 |

The first column of Table 1 lists the name for each set. The second column lists the total number of graphs in that set. The third column lists the distribution of the number of vertices in the graphs in that set, in the format: minimum˜maximum (mean±standard deviation). The graph with the most vertices contained 688 vertices and was in the quickAtk-base set. The fourth column lists the distribution of the number of edges in the graphs in each set similarly. The graph with the most edges had 1,687 edges and was in the fishClip-base set. The fifth column lists the distribution of the density (number of edges divided by (number of vertices squared)) of the graphs in each set, showing only the mean and standard deviation.

The merit of the generated partitions was evaluated using both the cut ratio and flow ratio merits, and the results have been compared to those obtained using spectral partitioning. In Table 2, results for the cut ratio are displayed, taking the spectral partition to minimize the cut ratio. For each graph, the inventors examined and classified the partitioning into one of five possible outcomes, in order: (1) the two methods yielded identical cuts (“Idnt”); (2) neither method found a good cut because the cut ratio was >1/3 for both (“No”); (3) the new method yielded a better cut (lower cut ratio) (“Bet”); (4) the new method yielded a worse cut (higher cut ratio) (“Wrs”); and (5) the two methods yielded a cut with an equivalent cut ratio to within numerical precision. Outcome 5 never occurred in these data sets, and is not indicated in the table. Note that the new method can partition an individual vertex from the rest of the graph, leading to an infinite cut ratio; and in all graphs where that happened, the spectral partitioning produced a partition with a cut ratio of over 1/3, leading to such graphs being classified as outcome (2) (“No”). The last two columns list the mean±standard deviation of the cut ratios for graphs that resulted in outcomes (3)˜(5), for the spectral partitioning and the new max-flow partitioning algorithm respectively.

TABLE 2

| Set Name | Tot | Idnt | No | Bet | Wrs | SP Cut Ratio | New Cut Ratio |
|---|---|---|---|---|---|---|---|
| pesrp-base | 210 | 98 | 68 | 28 | 16 | 0.23 ± 0.23 | 0.26 ± 0.34 |
| persp-induced | 222 | 49 | 134 | 30 | 9 | 0.24 ± 0.10 | 0.27 ± 0.34 |
| fishClip-base | 72 | 24 | 12 | 29 | 7 | 0.042 ± 0.042 | 0.036 ± 0.037 |
| fishClip-induced | 551 | 119 | 139 | 182 | 111 | 0.14 ± 0.12 | 0.15 ± 0.18 |
| quickAtk-base | 62 | 39 | 9 | 2 | 12 | 0.048 ± 0.078 | 0.07 ± 0.12 |
| quickAtk-induced | 741 | 221 | 128 | 133 | 259 | 0.14 ± 0.16 | 0.18 ± 0.20 |
| dog-base | 945 | 572 | 85 | 140 | 148 | 0.088 ± 0.093 | 0.10 ± 0.12 |
| dog-induced | 5211 | 1832 | 975 | 1132 | 1272 | 0.14 ± 0.12 | 0.16 ± 0.19 |

Table 2, above, indicates the results of a comparison of the new algorithm to spectral partitioning using the min-cut ratio. The first two columns are the same as in Table 1, above. Column 3 (“Idnt”) lists the number of graphs where the two partitioning methods produce an identical partition. Column 4 (“No”) lists the number of graphs where both the new algorithm and spectral partitioning produce a cut with a cut ratio of over 1/3; and it is deemed that no cut exists in this case. Columns 5 (“Bet”) and (“Wrs”) list the number of graphs where the new method produces a cut with a better cut ratio than spectral partitioning; and similarly, Column 6 (“Wrs”) is the number where the new method is worse. Column 7 (“SP Cut Ratio”) lists the mean±standard deviation of the cut ratios generated using spectral partitioning among cases in the “Bet” and “Wrs” categories. Column 8 (“New Cut Ratio”) lists the same for the new partitioning method among cases in the “Bet” and “Wrs” category.

As indicated in Table 2, the new algorithm produces an identical cut a significant fraction of the time and generally similar results overall—and, this happens without any analysis of the cut ratio factoring into the new algorithm. Further, in four of the sets (both the base and induced graphs for the “persp” and “fishClip” cases), switching to the new algorithm yields a better cut (lower cut ratio) more often than it yields a worse cut (higher cut ratio). However, for most of the sets, the new algorithm yields a slightly higher mean cut ratio; the exceptions are the fishClip-base set, where a somewhat lower mean cut ratio was obtained, and the quickAtk-base set, where a much higher mean cut ratio was obtained. Note that an increase in the mean cut ratio is reconciled with having more “better” than “worse” outcomes by the fact that there are a few worse cases that are significantly worse, while most of the other better and worse cases change by less.

In Table 3, results for the flow ratio are shown, taking the spectral partition to minimize the flow ratio. Table 3 depicts the results of a comparison of the new algorithm to spectral partitioning using the min-max vertex strength ratio. The meanings of the columns are identical to those of Table 2, above, except that the last two columns list flow ratios instead of cut ratios. Observe that the two methods produce identical partitions somewhat more often than when using the cut ratio. However, for every set, the new algorithm produces results that are equal or better than spectral partitioning, and is sometimes significantly better.

TABLE 3

| Set Name | Tot | Idnt | No | Bet | Wrs | SP Flow Ratio | New Flow Ratio |
|---|---|---|---|---|---|---|---|
| pesrp-base | 210 | 106 | 66 | 34 | 4 | 0.25 ± 0.17 | 0.20 ± 0.11 |
| persp-induced | 222 | 60 | 121 | 36 | 5 | 0.34 ± 0.18 | 0.26 ± 0.12 |
| fishClip-base | 72 | 25 | 12 | 28 | 7 | 0.093 ± 0.066 | 0.070 ± 0.062 |
| fishClip-induced | 551 | 134 | 149 | 197 | 71 | 0.21 ± 0.14 | 0.17 ± 0.11 |
| quickAtk-base | 62 | 46 | 6 | 5 | 5 | 0.08 ± 0.12 | 0.08 ± 0.11 |
| quickAtk-induced | 741 | 268 | 135 | 204 | 134 | 0.22 ± 0.15 | 0.20 ± 0.13 |
| dog-base | 945 | 624 | 71 | 182 | 68 | 0.13 ± 0.12 | 0.11 ± 0.10 |
| dog-induced | 5211 | 2093 | 942 | 1423 | 753 | 0.20 ± 0.14 | 0.17 ± 0.12 |

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

### Feature-Based Pattern Recognition

Embodiments of the systems and methods described herein include a feature-based pattern recognition process (e.g., the feature-based pattern recognition process 216 depicted in FIG. 2). According to embodiments, for example, a video processing device (e.g., the video processing platform 102 depicted in FIG. 1 and/or the video processing device 302 depicted in FIG. 3), may be configured to perform a feature-based pattern recognition process on video data to identify patterns associated with any number of different features of a video file. In embodiments, any number of different types of techniques for feature-based pattern recognition may be utilized to extract features from a video file and identify patterns associated therewith. In embodiments, feature-based pattern recognition may be used for facilitating object classification, generating descriptive metadata about a video file, and/or the like.

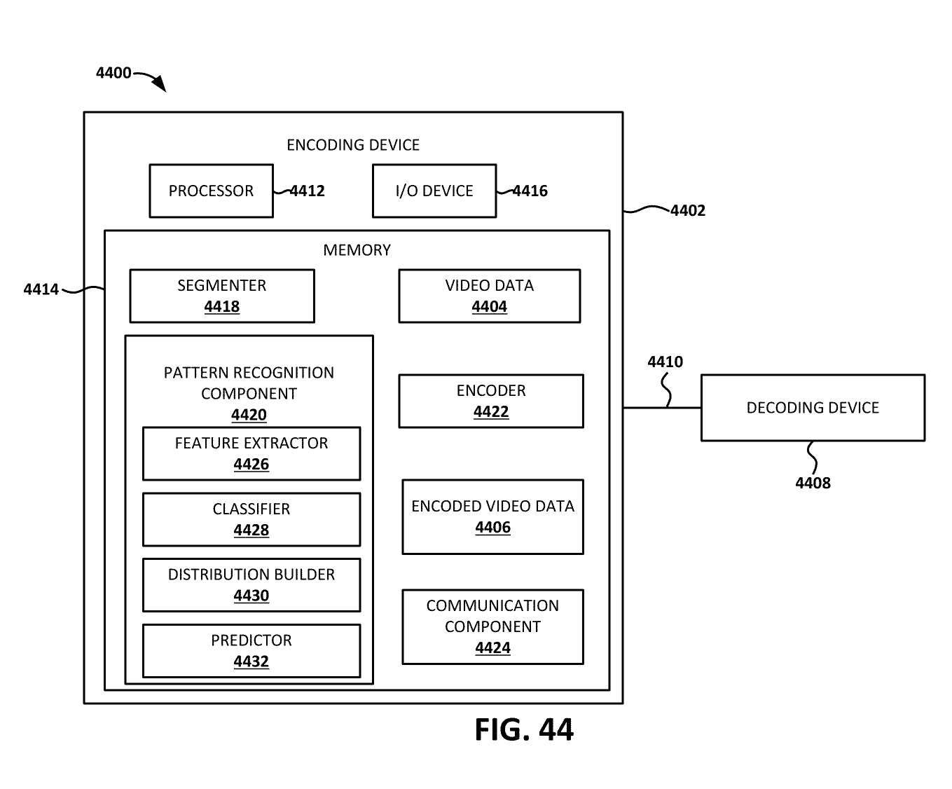

In embodiments, the feature-based pattern recognition process may be facilitated using segmentation information, foreground/background information, object group analysis information, and/or the like. According to embodiments, for example, a pattern recognition component (e.g., the pattern recognition component 4420 described below with regard to FIG. 44) may receive video data, segmentation information associated with the video data (e.g., resulting from a segmentation process such as, e.g., segmentation process 202 depicted in FIG. 2), motion information associated with the video data (e.g., resulting from a motion estimation process such as, e.g., the segment-based motion estimation process 210 depicted in FIG. 2), and/or object group information associated with the video data (e.g., resulting from an object group analysis process such as, for example, the object group analysis process 212 depicted in FIG. 2), and may be configured to use aspects of the received information to identify feature-based patterns in the video data.

### Object Classification

### Object Categorization Using Statistically-Modeled Classifier Outputs

Embodiments of the systems and methods described herein include an object classification process (e.g., the object classification process 218 depicted in FIG. 2). According to embodiments, one or more classifiers may be used to classify objects within video data. That is, for example, the one or more classifiers may be configured to receive any number of different inputs such as, for example, video data, segmentation information associated with the video data (e.g., resulting from a segmentation process such as, e.g., segmentation process 202 depicted in FIG. 2), motion information associated with the video data (e.g., resulting from a motion estimation process such as, e.g., the segment-based motion estimation process 210 depicted in FIG. 2), object group information associated with the video data (e.g., resulting from an object group analysis process such as, for example, the object group analysis process 212 depicted in FIG. 2), and/or feature-based pattern recognition information (e.g., resulting from a feature-based pattern recognition process such as, e.g., the feature-based pattern recognition process 216 depicted in FIG. 2), and may be configured to use aspects of the received information to classify objects in the video data. Classifying an object in video data may include, for example, identifying the existence of an object, determining and/or tracking the location of the object, determining and/or tracking the motion of the object, determining a class to which the object belongs (e.g., determining whether the object is a person, an animal, an article of furniture, etc.), developing an object profile (e.g., a set of information corresponding to the object such as, e.g., characteristics of the object) corresponding to an identified object, and/or the like.

According to embodiments, multiple classifiers may be used for a more robust labeling scheme. Embodiments of such a technique involve extracting meaningful features from video data. Extracting the features may be achieved using any number of different feature-extraction techniques such as, for example, kernel-based approaches (e.g. Laplacian of Gaussian, Sobel, etc.), nonlinear approaches (e.g. Canny, SURF, etc.), and/or the like. After feature vectors are extracted, a learning algorithm (e.g., SVM, neural network, etc.) is used to train a classifier. Approaches such as deep learning seek to use cascaded classifiers (e.g., neural networks) to combine together the decisions from disparate feature sets into one decision.

Embodiments involve characterizing the output of a classifier using a histogram, and applying classical Bayesian decision theory on the result to build a statistically-backed prediction. Embodiments of this approach may facilitate improved accuracy and/or computational efficiency. For example, embodiments of the technique may be implemented in a modular manner, in that models may be trained independently, and added to the boosting stage ad-hoc, thereby potentially improving accuracy on the fly. As another example, by implementing a model that automatically provides a statistical model of a number of classifier outputs, computational efficiencies may be realized due, at least in part, to avoiding complex schemes for using cascaded classifiers to combine together the decisions from disparate features sets. Embodiments of the techniques and systems described herein may be applicable to any number of different situations in which classifiers are used, and although pattern recognition is one example, and any other situation in which one or more classifiers are utilized is contemplated herein.

FIG. 44 is a block diagram illustrating an operating environment 4400, in accordance with embodiments of the present disclosure. The operating environment 4400 includes an encoding device 4402 (e.g., the video processing platform 102 depicted in FIG. 1 and/or the video processing device 302 depicted in FIG. 3) that may be configured to encode video data 4404 to create encoded video data 4406. As shown in FIG. 44, the encoding device 4402 may also be configured to communicate the encoded video data 4406 to a decoding device 4408 (e.g., the receiving device 108 depicted in FIG. 1 and/or the decoding device 308 depicted in FIG. 3) via a communication link 4410 (e.g., the communication links 106 and/or 110 depicted in FIG. 1 and/or the communication link 310 depicted in FIG. 3.

As shown in FIG. 44, the encoding device 4402 may be implemented on a computing device that includes a processor 4412, a memory 4414, and an input/output (I/O) device 4416. Although the encoding device 4402 is referred to herein in the singular, the encoding device 4402 may be implemented in multiple instances, distributed across multiple computing devices, instantiated within multiple virtual machines, and/or the like. In embodiments, the processor 4412 executes various program components stored in the memory 4414, which may facilitate encoding the video data 4406. In embodiments, the processor 4412 may be, or include, one processor or multiple processors. In embodiments, the I/O device 4416 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 4414 stores computer-executable instructions for causing the processor 4412 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 4418, a pattern recognition component 4420, an encoder 4422, and a communication component 4424.

In embodiments, the segmenter 4418 may be configured to segment a video frame into a number of segments. The segments may include, for example, objects, groups, slices, tiles, and/or the like. The segmenter 4418 may employ any number of various automatic image segmentation methods known in the field. In embodiments, the segmenter 4418 may use image color and corresponding gradients to subdivide an image into segments that have similar color and texture. Two examples of image segmentation techniques include the watershed algorithm and optimum cut partitioning of a pixel connectivity graph. For example, the segmenter 4418 may use Canny edge detection to detect edges on a video frame for optimum cut partitioning, and create segments using the optimum cut partitioning of the resulting pixel connectivity graph.

In embodiments, the pattern recognition component 4420 may perform pattern recognition on digital images such as, for example, frames of video. In embodiments, the pattern recognition component 4420 may perform pattern recognition on images that have not been segmented. In embodiments, results of pattern recognition may be used by the segmenter 4418 to inform a segmentation process. Pattern recognition may be used for any number of other purposes such as, for example, detecting regions of interest, foreground detection, facilitating compression, and/or the like.

According to embodiments, as shown in FIG. 44, the pattern recognition component 4420 includes a feature extractor 4426 configured to extract one or more features from an image. In embodiments, the feature extractor 4426 may represent more than one feature extractors. The feature extractor 4426 may include any number of different types of feature extractors, implementations of feature extraction algorithms, and/or the like. For example, the feature extractor 4426 may perform histogram of oriented gradients (HOG) feature extraction, color feature extraction, Gabor feature extraction, Kaze feature extraction, speeded-up robust features (SURF) feature extraction, features from accelerated segment (FAST) feature extraction, scale-invariant feature transform (SIFT) feature extraction, and/or the like.

As is also shown in FIG. 44, the pattern recognition component 4420 includes a classifier 4428. The classifier 4428 may be configured to receive input information and produce output that may include one or more classifications. In embodiments, the classifier may be a binary classifier and/or a non-binary classifier. The classifier may include any number of different types of classifiers such as, for example, a support vector machine (SVM), an extreme learning machine (ELM), a neural network, a kernel-based perceptron, a k-NN classifier, and/or the like. In embodiments, the classifier 4428 may be configured to define at least one decision hyperplane that separates a first classification region of a virtual feature space from a second classification region of the virtual feature space.

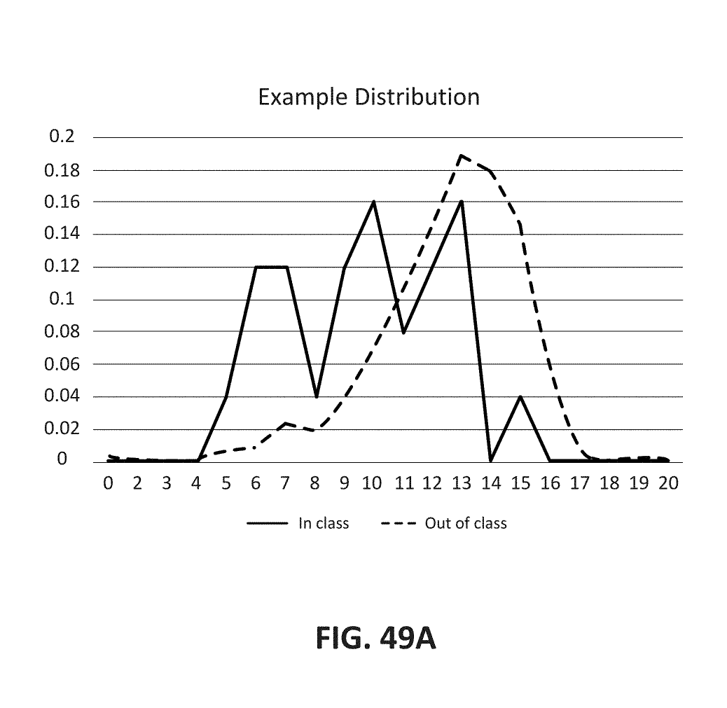

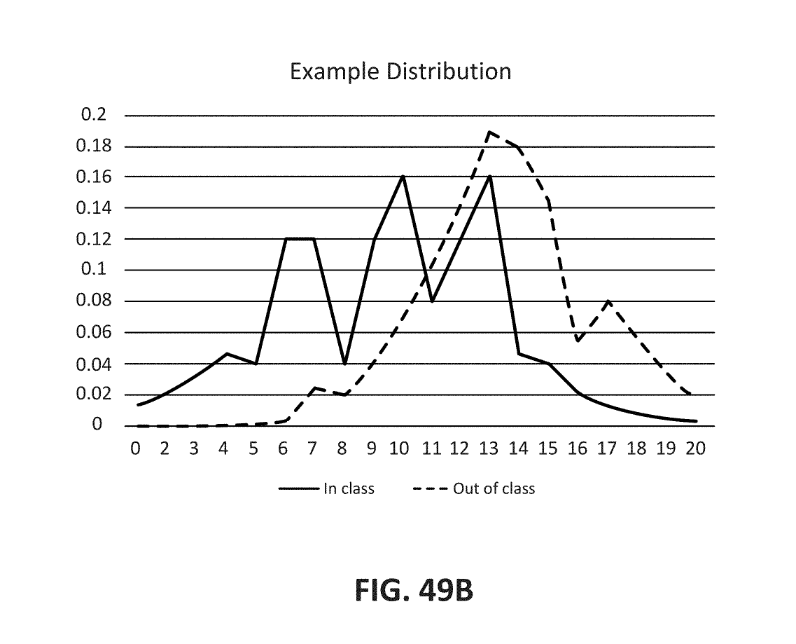

For example, in the case of a binary SVM, embodiments of the learning algorithm include, in simple terms, trying to maximize the average distance to the hyperplane for each label. In embodiments, kernel-based SVMs (e.g., RBF) allow for nonlinear separating planes that can nevertheless be used as a basis for distance measures to each sample point. That is, for example, after an SVM is trained on a test set, distance features may be computed for each sample point between the sample point and the separating hyperplane. The result may be binned into a histogram, as shown, for example, in FIG. 49A. From the example, it will be readily appreciated that a sort of confidence interval can be obtained, for example, by applying Bayesian decision theory. It is worth noting that the “in class” set depicted in FIG. 49A is significantly smaller than the “out of class” set. Because the distribution depicts percentage of samples that falls in each bin, it is possible that some of the discontinuous behavior seen in the “in class” set may be due to insufficient training size.

A similar approach may be taken for the case of an Extreme Learning Machine (ELM). An ELM is a sort of evolution of a neural network that has a series of output nodes, each generally corresponding to a sort of confidence that the sample belongs to class n (where n is the node number). While the ELM isn't necessarily binary in nature, the separate output nodes may allow a similar analysis to take place. In general, for example, the node with the highest output value may be predicted as the classification, but embodiments of the techniques described herein, when applied to the node outputs in a similar way as the SVM decisions, may facilitate significant improvements in performance. According to embodiments, any learning machine with a continuous output may be utilized. Embodiments of the techniques described herein may facilitate boosts in accuracy of classification, as well as more robust characterization of the prediction (e.g., confidence).

The pattern recognition component 4420 may include a distribution builder 4430 that is configured to receive, from the classifier, a number of classifications corresponding to the input information and to determine a distribution of the classifications. In embodiments, the distribution builder 4430 may determine the distributions based on distances between the classifications and the hyperplane.

For example, the distribution builder 4430 may be configured to determine the distribution by characterizing the plurality of classifications using a histogram. In embodiments, the distribution builder may be configured to compute a number of distances features, such as, for example, a distance, in the virtual feature space, between each of the classifications and the hyperplane. The distribution builder 4430 may assign each of the distance features to one of a number of bins of a histogram.

In the case of sparse or incomplete samples in the histogram, it may be advantageous to model the distribution to generate a projected score for a bin. In the case of sufficient data density (e.g., a significant number of samples fall in the bin of interest), it may be advantageous to use computed probabilities directly. As a result, modeling may be done on a per-bin basis, by checking each bin for statistical significance and backfilling probabilities from the modeled distribution in the case of data that has, for example, a statistically insignificant density, as depicted, for example, in FIG. 49B.

In embodiments, for example, the distribution builder 4430 is configured to determine a data density associated with a bin of the histogram, and determine whether the data density is statistically significant. That is, for example, the distribution builder 4430 may determine whether the data density of a bin is below a threshold, where the threshold corresponds to a level of statistical significance. If the data density of the bin is not statistically significant, the distribution builder 4430 may be configured to model the distribution of data in the bin using a modeled distribution. In embodiments, the Cauchy (also known as the Lorentz) distribution may be used, as it exhibits strong data locality with long tails, although any number of other distributions may be utilized.

Having determined statistical distributions associated with outputs from one or more classifiers, the pattern recognition component 4420 may utilize a predictor 4432 configured to generate a prediction by estimating, using a decision engine, a probability associated with the distribution. That is, for example, the class with the highest probability predicted by the distribution may be the one selected by the decision engine. A confidence interval may be calculated for each prediction based on the distribution, using any number of different techniques.

In embodiments, for example, the probability for a single classifier may be estimated using an improper Bayes estimation (e.g., a Bayes estimation without previous probability determinations, at least initially). That is, for example, the decision function may be:

$$P ( in class \vert distance = \frac{P ( distance \vert in class )}{P ( distance \vert in class ) + P ( distances \vert out of class )}$$

Using histogram distributions, the P(distance/in/out class) may be calculated by determining percentage of samples in the distance bin, or by substituting an appropriately modeled projection (any of which may be handled by the model internally). Any number of different decision functions may be utilized, and different decision functions may be employed depending on desired system performance, characteristics of the classifier outputs, and/or the like. In embodiments, for example, the decision function may utilize Bayes estimation, positive predictive value (PPV) maximization, negative predictive value (NPV) maximization, a combination of one or more of these, and/or the like. Embodiments of the statistical model described herein may be well suited to a number of decision models as the sensitivity, specificity, and prevalence of the model are all known. Precision and recall may also be determined from the model directly, thereby facilitating potential efficiencies in calculations.

As shown in FIG. 44, the encoding device 4402 also includes an encoder 4422 configured for entropy encoding of partitioned video frames, and a communication component 4424. In embodiments, the communication component 4424 is configured to communicate encoded video data 4406. For example, in embodiments, the communication component 4424 may facilitate communicating encoded video data 4406 to the decoding device 4408.

The illustrative operating environment 4400 shown in FIG. 44 is not intended to suggest any limitation as to the scope of use or functionality of embodiments of the present disclosure. Neither should the illustrative operating environment 4400 be interpreted as having any dependency or requirement related to any single component or combination of components illustrated therein. Additionally, any one or more of the components depicted in FIG. 44 may be, in embodiments, integrated with various ones of the other components depicted therein (and/or components not illustrated), all of which are considered to be within the ambit of the subject matter disclosed herein.

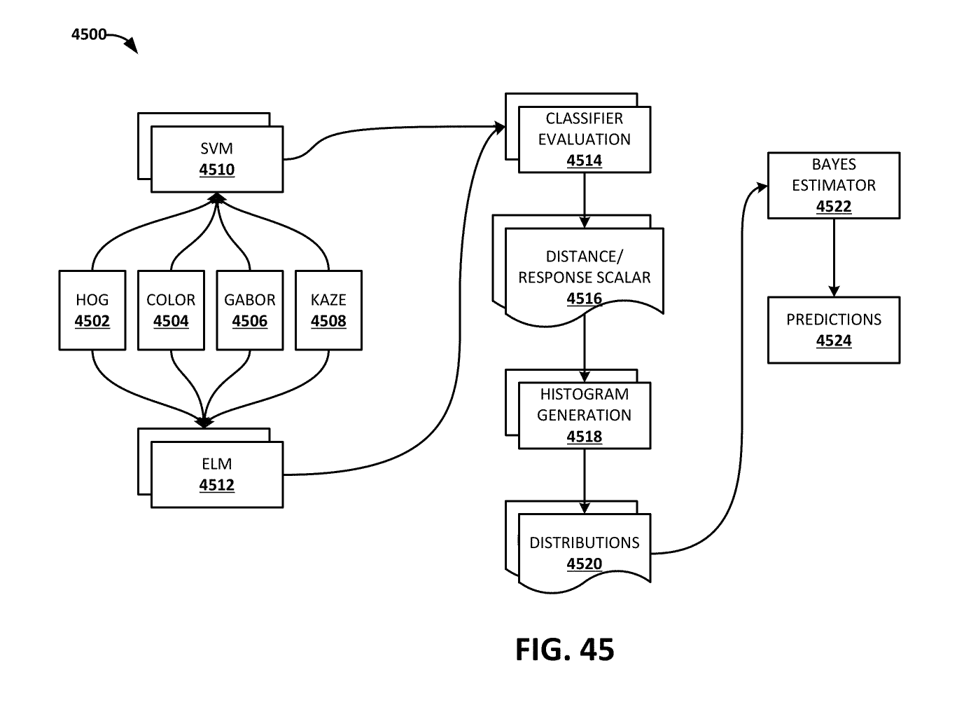

FIG. 45 is a schematic block diagram depicting an illustrative process flow 4500 of performing pattern recognition in an image, in accordance with embodiments of the subject matter disclosed herein. In embodiments, aspects of the process flow 4500 may be performed by a video processing device (e.g., the video processing platform 102 depicted in FIG. 1, the video processing device 302 depicted in FIG. 3, and/or the encoding device 4402 depicted in FIG. 44). As shown in FIG. 45, embodiments of the illustrative process flow 4500 may include a number of feature extractors 4502, 4504, 4506, 4508 that extract features from an image and provide input information, based on the extracted features, to classifiers 4510 and 4512. As shown in FIG. 45, the process flow 4500 includes a HOG feature extractor 4502, a color feature extractor 4504, a Gabor feature extractor 4506, and a Kaze feature extractor 4508. The feature extractors may include, however, any number of different feature extractors. In embodiments, the image may include one or more video frames received by the encoding device from another device (e.g., a memory device, a server, and/or the like). Similarly, the classifiers 4510 and 4512 include an SVM 4510 and an ELM 4512; however, any number of different classifiers may be used such as, for example, neural networks, kernel-based perceptron, k-NN classifiers, and/or the like.

In embodiments, the trained classifiers 4510 and 4512 are used to build distributions that support more robust decision engines. The distribution is generated using a classifier evaluation process 4514 that produces a distance/response scalar 4516. In embodiments, for example, distances between classification output points and a hyperplane are computed and included in the distance/response scalar 4516. The process flow 4518 further includes histogram generation 4518, through which the distributions 4520 are created. A Bayes estimator 4522 may be used to generate, based on the distributions 4520, predictions 4524. According to embodiments, any other prediction technique or techniques.

The illustrative process flow 4500 shown in FIG. 45 is not intended to suggest any limitation as to the scope of use or functionality of embodiments of the present disclosure. Neither should the illustrative operating environment 4500 be interpreted as having any dependency or requirement related to any single component or combination of components illustrated therein. Additionally, any one or more of the components depicted in FIG. 45 may be, in embodiments, integrated with various ones of the other components depicted therein (and/or components not illustrated), all of which are considered to be within the ambit of the subject matter disclosed herein.

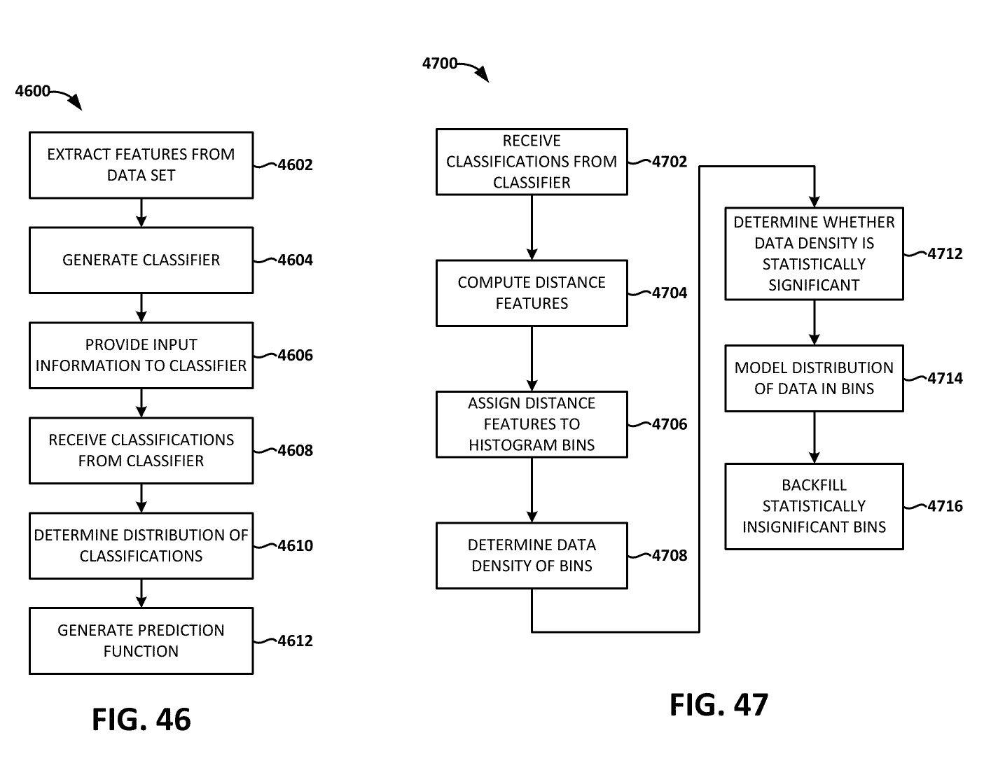

FIG. 46 is a flow diagram depicting an illustrative method 4600 of performing object classification training, in accordance with embodiments of the present disclosure. Embodiments of the flow 4600 may be utilized, for example, to train one or more classifiers and build classification distributions for use in a pattern matching procedure, and/or the like. In embodiments, aspects of the method 4600 may be performed by an encoding device (e.g., the video processing platform 102 depicted in FIG. 1, the video processing device 302 depicted in FIG. 3, and/or the encoding device 4402 depicted in FIG. 44). As shown in FIG. 46, embodiments of the illustrative method 4600 may include extracting one or more features from a data set using one or more feature extractors (block 4602). In embodiments, the data set may include an image, which may include, for example, one or more video frames received by the encoding device from another device (e.g., a memory device, a server, and/or the like).

Embodiments of the method 4600 further include generating at least one classifier (block 4604). The at least one classifier may be configured to define at least one decision hyperplane that separates a first classification region of a virtual feature space from a second classification region of the virtual feature space, and may include, for example, at least one of a support vector machine (SVM), an extreme learning machine (ELM), a neural network, a kernel-based perceptron, a k-NN classifier, and/or the like. Input is provided to the classifier (block 4606), and a number of classifications is received from the at least one classifier (block 4608).

Embodiments of the method 4600 include determining a distribution of the plurality of classifications (block 4610). In embodiments, determining a distribution of the plurality of classifications includes characterizing the plurality of classifications using a histogram. Embodiments of the method 4600 further include generating a prediction function based on the distribution (block 4612). According to embodiments, generating the prediction function may include generating a decision function that may be used for estimating, using the decision function, a probability associated with the distribution, where the decision function may utilize at least one of Bayes estimation, positive predictive value (PPV) maximization, negative predictive value (NPV) maximization and/or the like.

FIG. 47 is a flow diagram depicting an illustrative method 4700 of performing object classification training, in accordance with embodiments of the present disclosure. In embodiments, aspects of the method 4700 may be performed by an encoding device (e.g., the video processing platform 102 depicted in FIG. 1, the video processing device 302 depicted in FIG. 3, and/or the encoding device 4402 depicted in FIG. 44). As shown in FIG. 47, embodiments of the illustrative method 4700 may include receiving, from at least one classifier, a plurality classifications corresponding to the input information (block 4702). Embodiments of the method 4700 further include computing a number of distances features (block 4704). In embodiments, each of the distance features may include a distance, in the virtual feature space, between one of the classifications and the hyperplane.

Embodiments of the method 4700 further include assigning each of the distance features to one of a plurality of bins of a histogram (block 4706). The method 4700 may also include determining a data density associated with a bin of the histogram (block 4708); determining that the data density is below a threshold, wherein the threshold corresponds to a level of statistical significance (block 4712); and modeling the distribution of data in the bin using a modeled distribution (block 4714). For example, in embodiments, the modeled distribution includes a Cauchy distribution. In a final illustrative step of embodiments of the method 4700, the bin is backfilled with probabilities from the modeled distribution (block 4716).

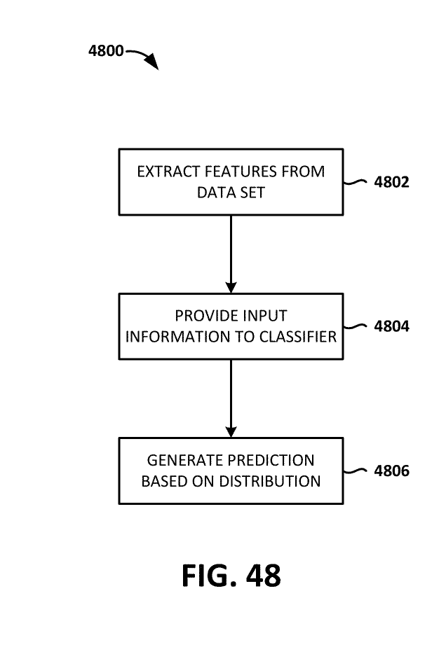

FIG. 48 is a flow diagram depicting an illustrative method 4800 of performing object classification, in accordance with embodiments of the present disclosure. Embodiments of the flow 4800 may be utilized, for example, in a pattern matching procedure, and/or the like. In embodiments, aspects of the method 4800 may be performed by an encoding device (e.g., the video processing platform 102 depicted in FIG. 1, the video processing device 302 depicted in FIG. 3, and/or the encoding device 4402 depicted in FIG. 44). As shown in FIG. 48, embodiments of the illustrative method 4800 may include extracting one or more features from a data set using one or more feature extractors (block 4802). In embodiments, the data set may include, for example, a digital image. The image may include one or more video frames received by the encoding device from another device (e.g., a memory device, a server, and/or the like).

Embodiments of the method 4800 further include providing input information (e.g., the extracted features and/or information derived from the extracted features) to at least one classifier (block 4804). The at least one classifier may be configured to define at least one decision hyperplane that separates a first classification region of a virtual feature space from a second classification region of the virtual feature space, and may include, for example, at least one of a support vector machine (SVM), an extreme learning machine (ELM), a neural network, a kernel-based perceptron, a k-NN classifier, and/or the like. Embodiments of the method 4800 further include generating a prediction based on the classification distribution provided by the at least one classifier (block 4806). According to embodiments, generating the prediction may include using the decision function associated with the distribution, where the decision function may utilize at least one of Bayes estimation, positive predictive value (PPV) maximization, negative predictive value (NPV) maximization and/or the like.

### Object Recognition 3D

To produce multi-view video content (e.g., 3D video, AR video and/or VR video), multiple views may be used to present a scene (or scene augmentation) to a user. A view refers to a perspective of a scene and may include one or more images corresponding to a scene, where all of the images in the view represent a certain spatial (and/or temporal) perspective of a video scene (e.g., as opposed to a different perspective of the video scene, represented by a second view). According to embodiments, a perspective may include multiple spatial and/or temporal viewpoints such as, for example, in the case in which the “viewer”—that is, the conceptual entity that is experiencing the scene from the perspective—is moving relative to the scene, or an aspect thereof (or, put another way, the scene, or an aspect thereof, is moving relative to the viewer).

In embodiments, a view may include video information, which may be generated in any number of different ways such as, for example, using computing devices (e.g., computer-generated imagery (CGI)), video cameras (e.g., multiple cameras may be used to respectively record a scene from different perspectives), and/or the like. Accordingly, in embodiments, a view of a scene (e.g., computer-generated and/or recorded by a video camera) may be referred to herein as a video feed and multiple views of a scene may be referred to herein as video feeds. In embodiments, each video feed may include a plurality of video frames.

Embodiments of this disclosure may provide efficiencies over conventional embodiments when processing video for multi-view video content. Examples of some computational efficiencies include, but are not limited to, reducing encoding redundancies of encoding the same object in another video feed, using an object from one video feed to identify the same object in another frame and/or using the object registration to tag and/or label the same object in more than one video feed.

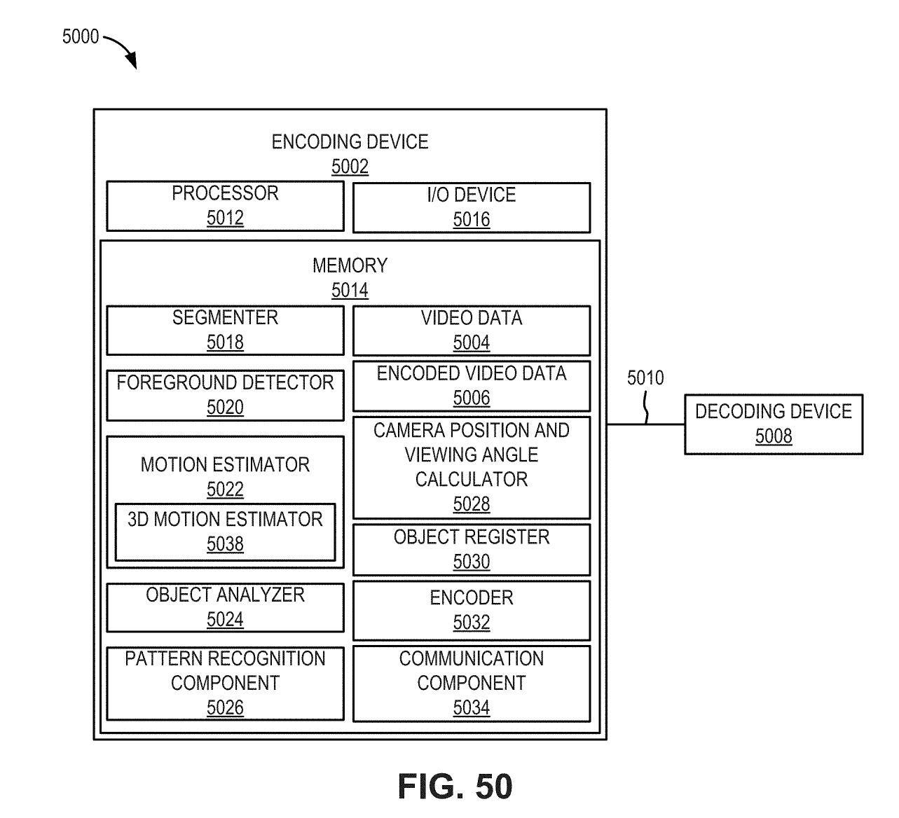

FIG. 50 is a block diagram illustrating an operating environment 5000, in accordance with embodiments of the subject matter disclosed herein. In embodiments, aspects of the operating environment 5000 may be, include, be similar to, or be included in, a system for processing video information such as, for example, the video processing platform 102 depicted in FIG. 1, and/or the video processing device 302 depicted in FIG. 3. The illustrative operating environment 5000 includes an encoding device 5002 (e.g., the video processing device 302 depicted in FIG. 3) that may be configured to encode video data 5004 to produce encoded video data 5006.

In embodiments, the video data 5004 may include views of a scene embodied in a number of video feeds. In embodiments, the video feeds of the scene, or aspects thereof, may have been respectively recorded by cameras positioned at different locations so that the scene is recorded from multiple different viewpoints. In embodiments, the video feeds of the scene, or aspects thereof, may have been computer-generated. In some instances, view information—information about the perspective corresponding to the view (e.g., camera angle, virtual camera angle, camera position, virtual camera position, camera motion (e.g., pan, zoom, translate, rotate, etc.), virtual camera motion, etc.)—may be received with (or in association with) the video data 5004 (e.g., multiplexed with the video data 5004, as metadata, in a separate transmission from the video data 5004, etc.). In other embodiments, view information may be determined, e.g., by the encoding device 5002. Each of the video feeds of the video data 5004 may be comprised of multiple video frames. In embodiments, the video feeds may be combined to produce multi-view video.

As described herein, while producing the encoded video data 5006 from the video data 5004, the encoding device 5002 may determine motion vectors of the video data 5004. In embodiments, the encoding device 5002 may determine motion vectors of the video data 5004 in a computationally less demanding way than conventional encoding systems, and, in embodiments, methods that include extrapolating motion vectors from a first video feed to other video feeds.

As shown in FIG. 50, the encoding device 5002 may also be configured to communicate the encoded video data 5006 to a decoding device 5008 (e.g., the receiving device 108 depicted in FIG. 1 and/or the decoding device 308 depicted in FIG. 3) via a communication link 5010 (e.g., the communication links 106 and/or 110 depicted in FIG. 1).

As shown in FIG. 50, the device 5002 may be implemented on a computing device that includes a processor 5012, a memory 5014 and an input/output (I/O) device 5016. Although the device 5002 is referred to herein in the singular, the device 5002 may be implemented in multiple instances, distributed across multiple computing devices, instantiated within multiple virtual machines, and/or the like. In embodiments, the processor 5012 executes various program components stored in the memory 5014, which may facilitate encoding the video data 5004. In embodiments, the processor 5012 may be, or include, one processor or multiple processors. In embodiments, the I/O device 5016 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 5014 stores computer-executable instructions for causing the processor 5012 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components may include a segmenter 5018, a foreground detector 5020, a motion estimator 5022, an object analyzer 5024, an encoder 5026 and a communication component 5028.

As indicated above, in embodiments, the video data 5004 includes multiple video feeds and each video feed includes multiple video frames. In embodiments, the segmenter 5018 may be configured to segment one or more video frames into a plurality of segments. The segments may include, for example, objects, groups, slices, tiles, and/or the like. The segmenter 5018 may employ any number of various automatic image segmentation techniques such as, for example, those discussed herein. For example, the segmenter 5018 may use image color and corresponding gradients to subdivide an image into segments that have similar color and texture. Two embodiments of image segmentation techniques include the watershed algorithm and optimum cut partitioning of a pixel connectivity graph. In embodiments, the segmenter 5018 may use Canny edge detection to detect edges on a video frame for optimum cut partitioning, and create segments using the optimum cut partitioning of the resulting pixel connectivity graph. In embodiments, the segmenter 5018 implements aspects of the segmentation techniques described in Iuri Frosio and Ed Ratner, “Adaptive Segmentation Based on a Learned Quality Metric,” Proceedings of the 10^{th} International Conference on Computer Vision Theory and Applications, March 2015, the entirety of which is hereby incorporated herein by reference for all purposes.

The resulting segment map of image segments includes an assignment of indices to every pixel in the image, which allows for the frame to be dealt with in a piecemeal fashion. Each index, which may be indexed and stored in memory 5014, may be considered a mask for this purpose.

In embodiments, the foreground detector 5020 may be configured to perform foreground detection on one or more video frames of the video data 5004. For example, in embodiments, the foreground detector 5020 may perform segment-based foreground detection, where the foreground segments, or portions of the segments, are detected using any number of different techniques such as, for example, those discussed above with respect U.S. application Ser. No. 14/737,418, filed Jun. 11, 2015, entitled “FOREGROUND DETECTION USING FRACTAL DIMENSIONAL MEASURES,” the entirety of which is incorporated herein. For example, in embodiments, the foreground detector 5020 may identify a segment as a foreground segment or a background segment by: determining at least one foreground metric for the segment based on a filtered binary foreground indicator map (BFIM), determining at least one variable threshold based on the foreground metric, and applying the at least one variable threshold to the filtered BFIM to identify the segment as either a foreground segment or background segment. Alternatively, the foreground detector 5020 may perform foreground detection on images that have not been segmented. In embodiments, results of foreground detection may be used by the segmenter 5018 to inform a segmentation process.

The motion estimator 5022 is configured to estimate the motion of one or more segments between video frames of a single video feed. For example, the motion estimator 5022 may receive a single video feed of the video data 5004. The single video feed may be received after video frames of the video feed are segmented by the segmenter 5018. The motion estimator 5022 may then perform motion estimation on the segmented video frames of the video feed. That is, the motion estimator 5022 may estimate the motion of a segment between video frames of the single video feed, with the current frame in the temporal sequence serving as the source frame and the subsequent frame in the temporal sequence serving as the target frame.

In embodiments, the motion estimator 5022 may utilize any number of various motion estimation techniques known in the field. Two example motion estimation techniques are optical pixel flow and feature tracking. As an example, the motion estimator 5022 may use feature tracking in which Speeded Up Robust Features (SURF) are extracted from both a source image (e.g., a source frame) and a subsequent image (e.g., a subsequent frame). The individual features of the two images may then be compared using a Euclidean metric to establish a correspondence between features, thereby generating a motion vector for each feature. In embodiments, a motion vector for a segment may be the median of all of the motion vectors for each of the segment's features. After a motion vector for a segment is determined, each segment may be categorized based on its motion properties. For example, a segment may be categorized as either moving or stationary.

In embodiments, the motion estimator 5022 may include a multi-view motion estimator 5038. In embodiments, the multi-view motion estimator 5038 may extrapolate motion vectors for the other video feeds of the video data 5004.

To do so, the multi-view motion estimator 5038 may determine a pixel depth. The multi-view motion estimator 5038 is configured to receive two or more video feeds of the video data 5004. Based on the relative positions of the cameras used to record the video feeds, as determined by the camera position and viewing angle calculator 5028, the multi-view motion estimator 5038 is configured to calculate and assign a pixel depth for each pixel located in the video frames of the video feeds. As an example, if an object encompasses an area of a₁×b₁ pixels in one video feed and the same object encompasses an area of a₂×b₂ pixels in another video feed, then, based on the relative positions and angles of the two cameras used to recorded to the two video feeds, a transformation function can be determined that will transform the object from a₁×b₁ pixels to a₂×b₂ pixels. Due to the transformation function being based on the relative positions and angles of the cameras, the transformation function will include distance information that can be used to calculate the distance of the object from the first camera used to record the first video feed. That is, a depth can be assigned to the pixels including the object. Similarly, distances to other objects included in the video feed may be determined. Once the distances to each of the objects are calculated, a pixel depth (i.e., a depth coordinate) can be assigned to each object and pixel included in a video feed. And, based on the calculated pixel depth, a 3D map of each video feed may be determined. That is, for each pixel of a video frame, a depth coordinate (e.g., a z coordinate) can be included in the horizontal and vertical coordinates (e.g., x, y coordinates).

After the 3D map is created, the multi-view motion estimator 5038 may be configured to extrapolate the motion vectors determined by the single-view motion estimator 5022 of a video feed to other video feeds. To do so, in embodiments, the multi-view motion estimator 5038 assigns 3D coordinates to each of the motion vectors computed by the single-view motion estimator 5030 based on the 3D map. That is, the multi-view motion estimator 5038 may be configured to receive 2D motion vector data from the single-view motion estimator 5030 and determine the three dimensional representations of the motion vectors using the 3D map determined from the calculated pixel depth. The multi-view motion estimator 5038 then can use the 3D representation of motion vectors to compute 2D projections onto one or more of the other 2D coordinate systems associated with the other video feeds. In embodiments, a local search can be performed by the multi-view motion estimator 5038 to determine whether the motion vectors projected onto a video feed accurately represent motion vectors for the video feed. In embodiments, the projected motion vectors may be compared to computed motion vectors for one or more of the other video feeds using a Euclidean metric to establish a correspondence between motion vectors and/or determine an projection error of the projected motion vectors.

In embodiments, the object analyzer 5024 may be configured to identify, using the segment map and/or the motion vectors computed by the motion estimator 5022, the presence of objects (e.g., clusters of segments that move together, or at least approximately together) within digital images such as, for example, frames of video. In embodiments, the object analyzer 5024 may be configured to identify and/or analyze only objects that are moving within a particular scene. In embodiments, the object analyzer 5024 may determine the presence of objects in all of the video feeds of the video data 5004. In embodiments, the object analyzer 5024 may perform object analysis on images that have not been segmented. Results of object group analysis may be used by the segmenter 5018 to facilitate a segmentation process, by an encoder device 5002 to facilitate an encoding process, and/or the like.

According to embodiments, the pattern recognition component 5026 may perform pattern recognition on digital images such as, for example, frames of video. For example, the pattern recognition component 5026 may perform pattern recognition of the objects that are determined by the object analyzer 5024 in one or more frames of video. In embodiments, the pattern recognition component 5026 may recognize patterns of one or more of the objects of a video frame and determine whether the recognized patterns correspond to a specific class of objects. To perform pattern recognition, the pattern recognition component 5026 may use any number of different techniques such as, for example, those discussed in U.S. application Ser. No. 15/237,048, filed Aug. 15, 2016, entitled “OBJECT CATEGORIZATION USING STATISTICALLY-MODELED CLASSIFIER OUTPUTS” and/or U.S. Application Ser. No. 62/368,853, filed Jul. 29, 2016, entitled “LOGO IDENTIFICATION.”

According to embodiments, if the recognized patterns correspond to a class of objects, the pattern recognition component 5026 may classify and label the object as the corresponding class. In embodiments, the pattern recognition component 5026 may classify and label objects using any number of different techniques such as, for example, those discussed in U.S. application Ser. No. 15/237,048, filed Aug. 15, 2016, entitled “OBJECT CATEGORIZATION USING STATISTICALLY-MODELED CLASSIFIER OUTPUTS.” Additionally or alternatively, the pattern recognition component 5026 may be used for any number of other purposes such as, for example, detecting regions of interest, foreground detection, facilitating compression, and/or the like.

According to embodiments, the camera position and viewing angle calculator 5028 may calculate the relative positions and viewing angles of the cameras that respectively recorded the video feeds of the video data 5004 based on the field of views of each of the cameras. The relative positions and angles of the cameras may be used to determine 3D coordinates of a video scene, by the 3D motion estimator 5038 and/or by the object register 5030. Additionally or alternatively, the relative positions and viewing angles of the cameras may be included in metadata of the video data 5004 and received by the 3D motion estimator 5038 and/or the object register 5030.

Based on the relative positions and viewing angles of the cameras, the object register 5030 may transform an identified object from the perspective of a first video feed to the perspective of second video feed. To do so, the object register 5030 may calculate a pixel depth for each of the pixels included in a video frame based on two video feeds and the relative positions and angles of the cameras used to record the two video feeds. As an example, if an object encompasses an area of a1×b1 pixels in one video feed and the same object encompasses an area of a2×b2 pixels in another video feed, then, based on the relative positions and angles of the two cameras used to recorded to the two video feeds, a transformation function can be determined that will transform the object from a1×b1 pixels to a2×b2 pixels. Due the transformation function being based on the relative positions and angles of the cameras, the transformation function will include distance information that can be used to calculate the distance of the object from the first camera used to record the first video feed. That is, a depth can be assigned to the pixels including the object. Similarly, distances to other objects included in the video feed may be determined. Once the distances to each of the objects are calculated, a pixel depth (i.e., a depth coordinate) can be assigned to each object and pixel included in a video feed. And, based on the calculated pixel depth, a 3D map of each video feed may be determined. That is, for each pixel of a video frame, a depth coordinate (e.g., a z coordinate) can be included in the horizontal and vertical coordinates (e.g., x, y coordinates).

After a 3D map is created, the object register 5030 may transform an object from the perspective of a first video camera to the perspective of a second video camera. That is, the 3D representation of an object may be projected onto the perspective of the second video camera. In embodiments, the object register 5030 may compare the transformed object against one or more objects identified in the second feed by the object analyzer 5024. The object register 5030 may then determine the closest match between the transformed object and an object identified in the second feed. After which, the object register 5030 may register the first object to the closest match in the second feed as the same object.

As shown in FIG. 50, the encoding device 5002 also includes an encoder 5032 configured for entropy encoding of partitioned video frames. In embodiments, the registration of the two objects may be encoded with one or both of the objects. In embodiments, the communication component 5034 is configured to communicate encoded video data 5006. For example, in embodiments, the communication component 5034 may facilitate communicating encoded video data 5006 to the decoding device 5008.

The illustrative operating environment 5000 shown in FIG. 50 is not intended to suggest any limitation as to the scope of use or functionality of embodiments of the present invention. Neither should the illustrative operating environment 5000 be interpreted as having any dependency or requirement related to any single component or combination of components illustrated therein. Additionally, any one or more of the components depicted in FIG. 50 may be, in embodiments, integrated with various ones of the other components depicted therein (and/or components not illustrated), all of which are considered to be within the ambit of the present invention.

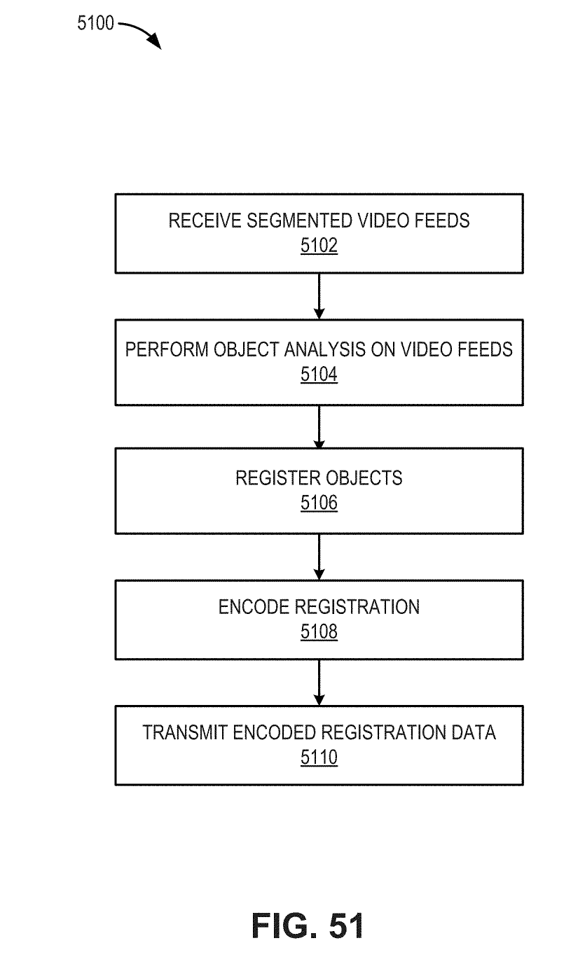

FIG. 51 is a flow diagram depicting an illustrative multi-view object registration method 5100, in accordance with embodiments of the subject matter disclosed herein. Embodiments of the illustrative method 5100 may be performed, for example, by a device such as the encoding device 5002.

As shown in FIG. 51, the illustrative multi-view object registration method 5100 includes receiving segmented video feeds (block 5102). In embodiments, a scene is recorded from multiple different viewpoints. Each recorded viewpoint is a video feed of the scene and each video feed comprises a sequence of video frames. A sequence of video frames having a common central subject matter, action, setting, background, theme, and/or the like may be referred to as a scene and the multiple recorded viewpoints may be used to produce 3D, AR and/or VR video of the scene. According to embodiments, any number of different techniques for determining scene cuts may be implemented in the context of embodiments of the disclosed subject matter. The video information may include the raw video information, segmentation information (e.g., information about the segmentation process performed on the images of the scene, segment maps, segment identifications, and/or the like).

As shown in FIG. 51, the illustrative multi-view object registration method 5100 further includes performing object analysis on the video feeds (block 5104). In embodiments, objects may be determined during the object analysis of method 5100. For example, using the segment map and/or the motion vectors, the presence of objects (e.g., clusters of segments that move together, or at least approximately together) within digital images such as, for example, frames of video may be determined. In embodiments, any of the embodiments disclosed in U.S. application Ser. No. 15/237,048, filed Aug. 15, 2016, entitled “OBJECT CATEGORIZATION USING STATISTICALLY-MODELED CLASSIFIER OUTPUTS” may be used to perform object analysis. In embodiments, the object analyzer 5024 depicted in FIG. 50 may be used to perform the object analysis of method 5100.

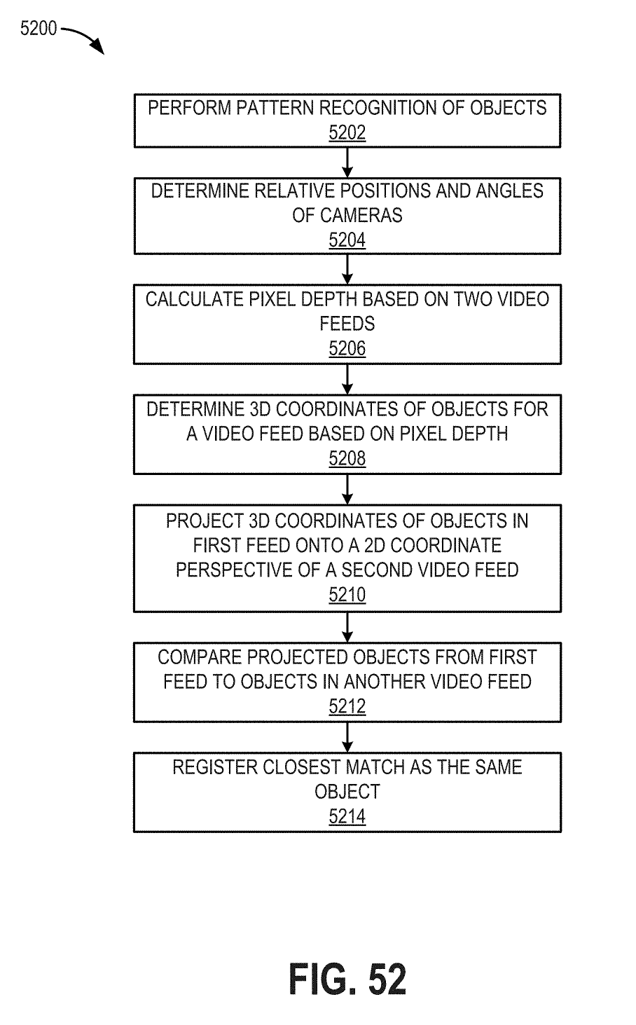

Embodiments of the method 51 further include registering objects of a video feed (block 5106). Embodiments describing an object registration method 5200 are discussed below with respect to FIG. 52. In embodiments, registering objects may be performed by an object register 5030, as shown in FIG. 50.

After the objects are registered, the registered objects are encoded (block 5108). By registering the same object as it appears in different video feeds, computational efficiencies may be obtained. Examples of some computational efficiencies include, but are not limited to, reducing encoding redundancies of encoding the same object in another video feed, using an object from one video feed to identify the same object in another frame and/or using the object registration to tag and/or label the same object in more than one video feed. In embodiments, the encoder 5032 depicted in FIG. 50 may be used to encode the registered objects.

After encoding the motion vectors, the encoded motion vector data may be transmitted (block 5110). The encoded motion vector data may be transmitted to a decoding device (e.g., the decoding device 5008 depicted in FIG. 50). In embodiments, the communication component 5128 depicted in FIG. 51 may facilitate transmission of the encoded video data over a communication network (e.g., the communication network 5010 depicted in FIG. 50).

The illustrative method 5100 shown in FIG. 51 is not intended to suggest any limitation as to the scope of use or functionality of embodiments of the subject matter disclosed herein. Neither should the method 5100 be interpreted as having any dependency or requirement related to any block illustrated therein.

FIG. 52 is a flow diagram depicting an illustrative object registration method 5200, in accordance with embodiments of the subject matter disclosed herein. Embodiments of the illustrative method 5200 may be performed, for example, by an object register 5030, as shown in FIG. 50.

As shown in FIG. 52, the method 5200 may include performing pattern recognition of objects (block 5202). To perform pattern recognition, any number of different techniques may be used such as, for example, the embodiments discussed above with respect to FIGS. 50 and 51. In embodiments, the pattern recognition component 5026 may be used to perform pattern recognition of objects.

According to embodiments, the method 5200 may include determining relative positions and angles of cameras (block 5204). The relative positions and angles of the cameras may be used to determine 3D coordinates of a video scene, as described below. In embodiments, any number of different techniques may be used to determine relative positions and angles of cameras such as, for example, the embodiments discussed above with respect to FIGS. 50 and 51. Additionally or alternatively, the relative positions and viewing angles of the cameras may be included in metadata of the received segmented video feeds. In embodiments, the camera position and viewing angle calculator 5028 may be used to determine relative positions and angles of cameras.

According to embodiments, the method 5200 may include calculating a pixel depth based on two video feeds (block 5206) and determine 3D coordinates of objects for video based on pixel depth (block 5208). As an example, if an object encompasses an area of a₁×b₁ pixels in one video feed and the same object encompasses an area of a₂×b₂ pixels in another video feed, then, based on the relative positions and angles of the two cameras used to recorded to the two video feeds, a transformation function can be determined that will transform the object from a₁×b₁ pixels to a₂×b₂ pixels. Due the transformation function being based on the relative positions and angles of the cameras, the transformation function will include distance information that can be used to calculate the distance of the object from the first camera used to record the first video feed. That is, a depth can be assigned to the pixels including the object. Similarly, distances to other objects included in the video feed may be determined. Once the distances to each of the objects are calculated, a pixel depth (i.e., a depth coordinate) can be assigned to each object and pixel included in a video feed. And, based on the calculated pixel depth, a 3D map of a video feed may be determined. That is, for each pixel of a video frame, a depth coordinate (e.g., a z coordinate) can be included in the horizontal and vertical coordinates (e.g., x, y coordinates). In embodiments, an object register 5030, as depicted in FIG. 50, may be used to calculate the pixel depths and create a 3D map of a video feed.

Then, the 3D coordinate representation of each of the object may be projected onto a respective 2D coordinate system of a second video feed (block 5210). Once a 3D representation of an object is projected onto a 2D coordinate perspective of a second video feed, the projected objects from the first feed are compared to objects identified in a second video feed (block 5212). In embodiments, the closest object of the second video feed to the projected object may be identified and registered as the same object (block 5214).

The illustrative method 5200 shown in FIG. 52 is not intended to suggest any limitation as to the scope of use or functionality of embodiments of the subject matter disclosed herein. Neither should the method 5200 be interpreted as having any dependency or requirement related to any block illustrated therein.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

### Deep Scene Level Analysis

### Metatagging

Embodiments of the systems and methods described herein include a deep scene level analysis process (e.g., the deep scene level analysis process 220 depicted in FIG. 2). In embodiments, deep scene level analysis refers to analysis of video data to identify characteristics of a video scene (e.g., identification of objects in the scene, characteristics of the objects, behavior of the objects, characteristics of foreground/background features, characteristics of segmentation of the images of the video data, characteristics of motion of segments and/or objects in the scene, etc.). According to embodiments, characteristics of a video scene may be captured using a metatagging (referred to herein, interchangeably, as “labeling”) procedure. In embodiments, information resulting from a metatagging procedure may be referred to, for example, as “metadata.” In embodiments such metadata may be stored as a file, in a database, and/or the like.

According to embodiments, metadata may be maintained in a database, provided to users and/or other devices, provided with the video data, and/or the like. In embodiments, metadata may be used to facilitate a partitioning process (e.g., the partitioning process 222 depicted in FIG. 2), an encoding process (e.g., the encoding process 226 depicted in FIG. 2), a super-resolution process (e.g., the super-resolution process 214 depicted in FIG. 2), and/or the like.

Labelling objects within a video feed has conventionally been performed manually by humans. This approach, however, is labor intensive. Further, humans cannot identify and label objects quick enough to facilitate labelling objects in a real-time video feed or in a near real-time video feed (e.g., where a slight delay is introduced into the video feed). Embodiments described herein may provide solutions to these, and other, shortcomings of conventional labelling techniques. In particular, embodiments disclosed herein provide an automated technique for labelling objects within a video feed. As such, labeling of objects using embodiments of the techniques described herein may be less time-consuming than in conventional systems, and, therefore, may be labelled in real-time video feed or a near real time video feed. Further, because embodiments include automatic labelling (e.g., labeling without human intervention), robust, comprehensive labelling of large sets of video data may be facilitated.

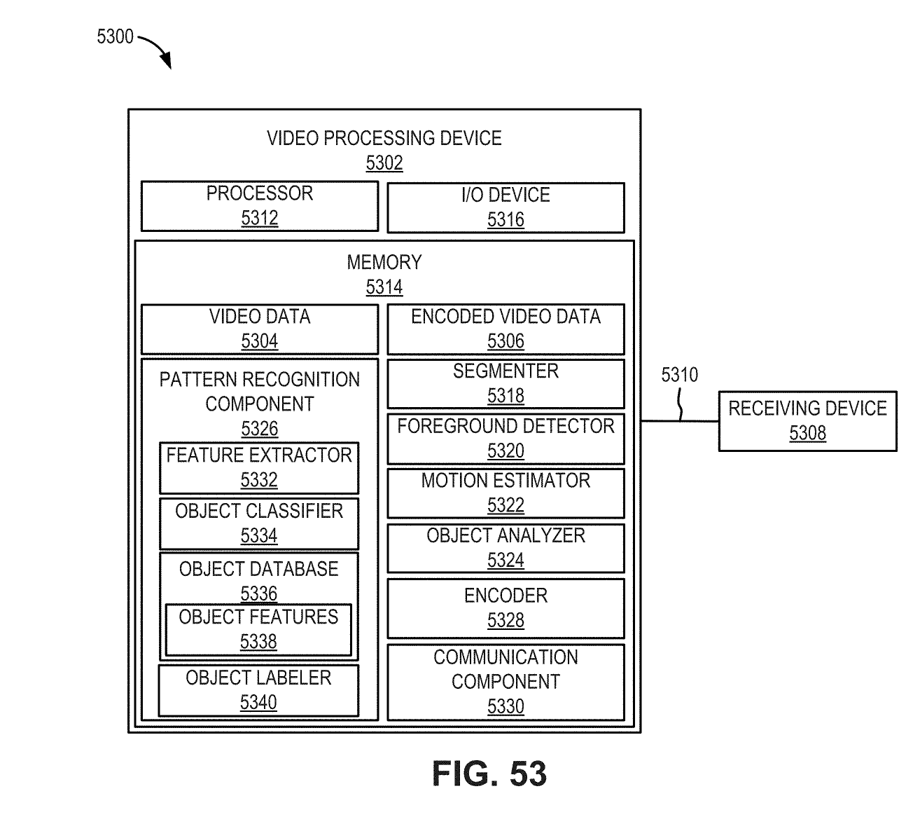

FIG. 53 depicts a block diagram illustrating an operating environment 5300, in accordance with embodiments of the subject matter disclosed herein. In embodiments, aspects of the operating environment 5300 may be, include, be similar to, or be included in, a system for processing video information (e.g., the video processing platform 102 depicted in FIG. 1 and/or the video processing device 302 depicted in FIG. 3). The operating environment 5300 includes a video processing device 5302 (e.g., the video processing platform 102 depicted in FIG. 1 and/or the video processing device 302 depicted in FIG. 3) that may be configured to label video data 5304, encode video data 5304 to produce encoded video data 5306, label encoded video data 5306, and/or the like.

As described herein, while producing the encoded video data 5306 from the video data 5304, the video processing device 5302 may analyze and tag objects in the video data 5304 automatically to facilitate labeling of objects in real time and/or near real time. In embodiments, the video processing device 5302 may be configured to label video data to produce metadata. In embodiments, the video processing device 5302 may be a stand-alone device, virtual machine, program component, and/or the like, and may function independently of encoding functions.

As shown in FIG. 53, the video processing device 5302 may also be configured to communicate the encoded video data 5306 and/or metadata (e.g., object features 5338) to a receiving device 5308 (e.g., the receiving device 108 depicted in FIG. 1 and/or the decoding device 308 depicted in FIG. 3) via a communication link 5310 (e.g., the communication links 106 and/or 110 depicted in FIG. 1 and/or the communication link 310 depicted in FIG. 3).

As shown in FIG. 53, the device 5302 may be implemented on a computing device that includes a processor 5312, a memory 5314 and an input/output (I/O) device 5316. Although the device 5302 is referred to herein in the singular, the device 5302 may be implemented in multiple instances, distributed across multiple computing devices, instantiated within multiple virtual machines, and/or the like. In embodiments, the processor 5312 executes various program components stored in the memory 5314, which may facilitate analyzing the video data 5304 and/or the encoded video data 5306. In embodiments, the processor 5312 may be, or include, one processor or multiple processors. In embodiments, the I/O device 5316 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 5314 stores computer-executable instructions for causing the processor 5312 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components may include a segmenter 5318, a foreground detector 5320, a multi-view motion estimator 5322, an object analyzer 5324, an object recognition component 5326, an encoder 5328, and a communication component 5330.

In embodiments, the segmenter 5318 may be configured to segment one or more video frames into a plurality of segments. The segments may include, for example, objects, groups, slices, tiles, and/or the like. The segmenter 5318 may employ any number of various automatic image segmentation techniques such as, for example, those discussed in U.S. application Ser. No. 14/696,255, filed Apr. 24, 2015, entitled “METHOD AND SYSTEM FOR UNSUPERVISED IMAGE SEGMENTATION USING A TRAINED QUALITY METRIC.” For example, the segmenter 5318 may use image color and corresponding gradients to subdivide an image into segments that have similar color and texture. Two embodiments of image segmentation techniques include the watershed algorithm and optimum cut partitioning of a pixel connectivity graph. For example, the segmenter 5318 may use Canny edge detection to detect edges on a video frame for optimum cut partitioning, and create segments using the optimum cut partitioning of the resulting pixel connectivity graph. In embodiments, the segmenter 5318 implements aspects of the segmentation techniques described in Iuri Frosio and Ed Ratner, “Adaptive Segmentation Based on a Learned Quality Metric,” Proceedings of the 10^{th} International Conference on Computer Vision Theory and Applications, March 2015, the entirety of which is hereby incorporated herein by reference for all purposes.

The resulting segment map of image segments includes an assignment of indices to every pixel in the image, which allows for the frame to be dealt with in a piecemeal fashion. Each index, which may be indexed and stored in memory 5314, may be considered a mask for this purpose.

In embodiments, the foreground detector 5320 may be configured to perform foreground detection on one or more video frames of the video data 5304. For example, in embodiments, the foreground detector 5320 may perform segment-based foreground detection, where the foreground segments, or portions of the segments, are detected using any number of different techniques such as, for example, those discussed in U.S. application Ser. No. 14/737,418, filed Jun. 11, 2015, entitled “FOREGROUND DETECTION USING FRACTAL DIMENSIONAL MEASURES.” For example, in embodiments, the foreground detector 5320 may identify a segment as a foreground segment or a background segment by: determining at least one foreground metric for the segment based on a filtered binary foreground indicator map (BFIM), determining at least one variable threshold based on the foreground metric, and applying the at least one variable threshold to the filtered BFIM to identify the segment as either a foreground segment or background segment. Additionally, or alternatively, the foreground detector 5320 may perform foreground detection on images that have not been segmented. In embodiments, results of foreground detection may be used by the segmenter 5318 to inform a segmentation process.

In embodiments, the motion estimator 5322 is configured to estimate the motion of one or more segments between video frames of a video feed. For example, the motion estimator 5322 may receive a video feed of the video data 5304. The video feed may be received after video frames of the video feed are segmented by the segmenter 5318. The motion estimator 5322 may then perform motion estimation on the segmented video frames of the video feed. That is, the motion estimator 5322 may estimate the motion of a segment between video frames of the single video feed, with the current frame in the temporal sequence serving as the source frame and the subsequent frame in the temporal sequence serving as the target frame.

In embodiments, the motion estimator 5322 may utilize any number of various motion estimation techniques known in the field. Two example motion estimation techniques are optical pixel flow and feature tracking. As an example, the motion estimator 5322 may use feature tracking in which Speeded Up Robust Features (SURF) are extracted from both a source image (e.g., a source frame) and a subsequent image (e.g., a subsequent frame). The individual features of the two images may then be compared using a Euclidean metric to establish a correspondence between features, thereby generating a motion vector for each feature. In embodiments, a motion vector for a segment may be the median of all of the motion vectors for each of the segment's features. After a motion vector for a segment is determined, each segment may be categorized based on its motion properties. For example, a segment may be categorized as either moving or stationary. In embodiments, the motion estimator 5322 may use one or more of the techniques described in U.S. application Ser. No. 15/237,048, filed Aug. 15, 2016, entitled “OBJECT CATEGORIZATION USING STATISTICALLY-MODELED CLASSIFIER OUTPUTS.”

In embodiments, the object analyzer 5324 may be configured to perform object group analysis on one or more video frames of the video data 5304. For example, the object analyzer 5324 may categorize each segment based on its motion properties (e.g., as either moving or stationary) and adjacent segments may be combined into objects. In embodiments, if the segments are moving, the object analyzer 5324 may combine the segments based on similarity of motion. If the segments are stationary, the object analyzer 5324 may combine the segments based on similarity of color and/or the percentage of shared boundaries. Additionally or alternatively, the object analyzer 5324 may use any of the object analyzation embodiments described in U.S. application Ser. No. 15/237,048, filed Aug. 15, 2016, entitled “OBJECT CATEGORIZATION USING STATISTICALLY-MODELED CLASSIFIER OUTPUTS.”

According to embodiments, the pattern recognition component 5326 may perform pattern recognition on digital images such as, for example, frames of video. For example, the pattern recognition component 5326 may perform pattern recognition of the objects that are determined by the object analyzer 5324 in one or more frames of video. In embodiments, the pattern recognition component 5326 may recognize patterns of one or more of the objects of a video frame and determine whether the recognized patterns correspond to a specific class of objects. If the recognized patterns correspond to a class of objects, the pattern recognition component 5326 may classify and label the object as the corresponding class. Additionally or alternatively, the pattern recognition component 5326 may be used for any number of other purposes such as, for example, detecting regions of interest, foreground detection, facilitating compression, and/or the like.

To perform pattern recognition on frames of a video, the pattern recognition component 5326 may include a feature extractor 5332. The feature extractor 5332 may be configured to extract one or more features from a video frame. In embodiments, the feature extractor 5332 may extract features from one or more of the objects determined by the object analyzer 5324. In embodiments, the feature extractor 5332 may be configured to correlate the extracted features with the objects determined by the object analyzer 5324. That is, in addition to labelling the video frame in which the features were extracted from, the feature extractor 5332 may correlate the specific object in a video frame with the extracted features. By correlating extracted features to respective objects, the device 5302 may be less likely to misclassify an object since features of a first object in a video frame will not be mistakenly used to classify a second object in the same video frame.

In embodiments, the feature extractor 5332 may represent more than one feature extractors. The feature extractor 5332 may include any number of different types of feature extractors, implementations of feature extraction algorithms, and/or the like. For example, the feature extractor 5332 may perform histogram of oriented gradients feature extraction (i.e., “HOG” as described, for example, in Navneet Dalal and Bill Triggs, “Histograms of Oriented Gradients for Human Detection,” available at http://lear.inrialpes.fr/people/triggs/pubs/Dalal-cvpr05.pdf, 2005, the entirety of which is hereby incorporated herein by reference for all purposes), Gabor feature extraction (as explained, for example, in John Daugman, “Complete Discrete 2-D Gabor Transforms by Neural Networks for Image Analysis and Compression,” IEEE Transaction on Acoustics, Speech, and Signal Processing, Vol. 4, No. 7, 1988, the entirety of which is hereby incorporated herein by reference for all purposes), Kaze feature extraction, speeded-up robust features (SURF, as explained, for example, in D. G. Lowe, “Distinctive Image Features from Scale-Invariant Keypoints,” International Journal of Computer Vision, 60, 2, pp. 91-110, 2004, the entirety of which is hereby incorporated herein by reference for all purposes) feature extraction, features from accelerated segment (FAST) feature extraction, scale-invariant feature transform (SIFT) feature extraction, and/or the like.

As illustrated in FIG. 53, the pattern recognition component 5326 may also include an object classifier 5334. The object classifier 5334 may be configured to receive input information and produce output that may include one or more classifications. For example, the object classifier 5334 may be configured to receive one or more of the features extracted by the feature extractor 5332 and classify the object based on the extracted features of the object.

To classify the object based on extracted features, the device 5302 may include an object database 5336, and the object database 5336 may include object features 5338 that are correlated to classes of objects. In embodiments, the object classifier 5334 may determine whether one or more of the extracted features correspond to one or more of the object features 5338 stored in the object database 5336. If the extracted features correspond to object features 5338, then the object classifier 5334 may classify the object as the class of object having those object features 5338.

The object classifier 5338 may include any number of different types of classifiers to classify the extracted features. For example, in embodiments, the object classifier 5338 may be a binary classifier, a non-binary classifier and/or may include one or more of the following types of classifiers: a support vector machine (SVM), an extreme learning machine (ELM), a neural network, a kernel-based perceptron, a k-NN classifier, a bag-of-visual-words classifier, and/or the like. In embodiments, high quality matches between extracted features and object features 5338 are selected as matches. According to embodiments, a high quality match is a match for which a corresponding match-quality metric satisfies one or more specified criteria. For example, in embodiments, any number of different measures of the match quality (e.g., similarity metrics, relevance metrics, etc.) may be determined and compared to one or more criteria (e.g., thresholds, ranges, and/or the like) to facilitate identifying matches. Embodiments of classification techniques that may be utilized by the object classifier 5338 include, for example, techniques described in Andrey Gritsenko, Emil Eirola, Daniel Schupp, Ed Ratner, and Amaury Lendasse, “Probabilistic Methods for Multiclass Classification Problems,” Proceedings of ELM-2015, Vol. 2, January 2016; and Gabriella Csurka, Christopher R. Dance, Lixin Fan, Jutta Willamowski, and Cedric Bray, “Visual Categorization with Bags of Keypoints,” Xerox Research Centre Europe, 2004; the entirety of each of which is hereby incorporated herein by reference for all purposes.

According to embodiments, the pattern recognition component 5326 includes an object labeler 5340. The object labeler 5340 is configured to label an object and one or more features of the object (e.g., movement of the object) based on the determined classification of object by the object classifier 5338.

As shown in FIG. 53, the encoding device 5302 also includes an encoder 5328 configured for entropy encoding of partitioned video frames. In embodiments, the classification data of an object may be encoded as metadata of an object. In embodiments, encoding the motion vectors may be performed by an encoder 5328, as shown in FIG. 53.

In embodiments, the communication component 5330 is configured to communicate encoded video data 5306. For example, in embodiments, the communication component 5330 may facilitate communicating encoded video data 5306 to the decoding device 5308. In embodiments, the classification metadata of the objects may be transmitted with or separately from the encoded object data.

The illustrative operating environment 5300 shown in FIG. 53 is not intended to suggest any limitation as to the scope of use or functionality of embodiments of the disclosure. Neither should the illustrative operating environment 5300 be interpreted as having any dependency or requirement related to any single component or combination of components illustrated therein. Additionally, any one or more of the components depicted in FIG. 53 may be, in embodiments, integrated with various ones of the other components depicted therein (and/or components not illustrated), all of which are considered to be within the ambit of the subject matter disclosed herein.

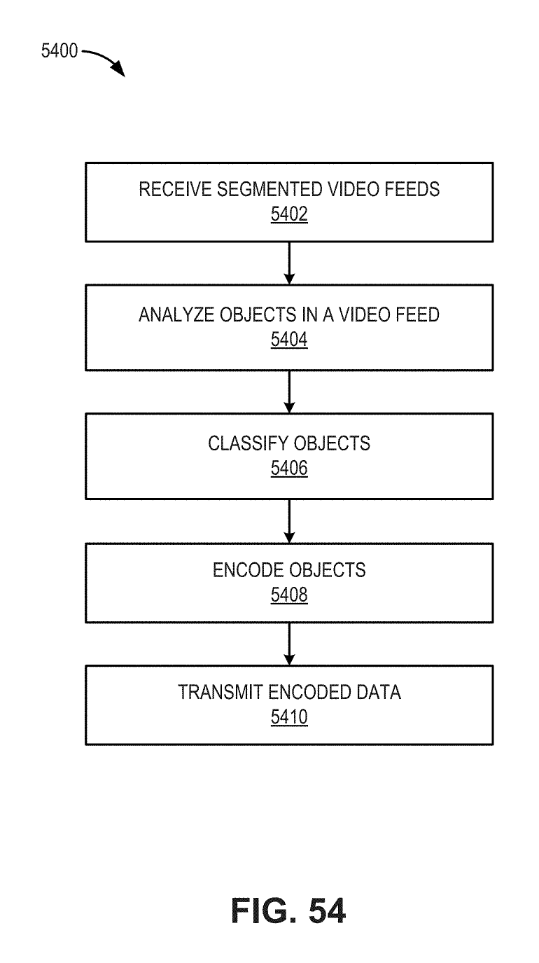

FIG. 54 is a flow diagram depicting a metatagging method 5400, in accordance with embodiments of the subject matter disclosed herein. Embodiments of the illustrative method 5400 may be performed, for example, by a device such as the video processing device 5302.

As shown in FIG. 54, the illustrative metatagging method 5400 includes receiving segmented video feeds (block 5402). A sequence of video frames having a common central subject matter, action, setting, background, theme, and/or the like may be referred to as a scene. According to embodiments, any number of different techniques for determining scene cuts may be implemented in the context of embodiments of the disclosed subject matter. The video information may include the raw video information, segmentation information (e.g., information about the segmentation process performed on the images of the scene, segment maps, segment identifications, and/or the like).

As shown in FIG. 54, the illustrative metatagging method 5400 further includes analyzing objects in a video feed (block 5404). Analyzing objects in a video feed may include performing object group analysis on one or more video frames of the received segmented video feeds. For example, adjacent segments may be combined into objects based on its motion properties of a segment (e.g., as either moving or stationary). In embodiments, if the segments are moving, the segments may be combined based on similarity of motion. If the segments are stationary, the segments may be combined based on similarity of color and/or the percentage of shared boundaries. Additionally or alternatively, analyzing objects in a video feed may use any of the object analyzation embodiments described herein in relation to FIG. 53. In embodiments, analyzing objects may be performed by the object analyzer 5324 depicted in FIG. 53.

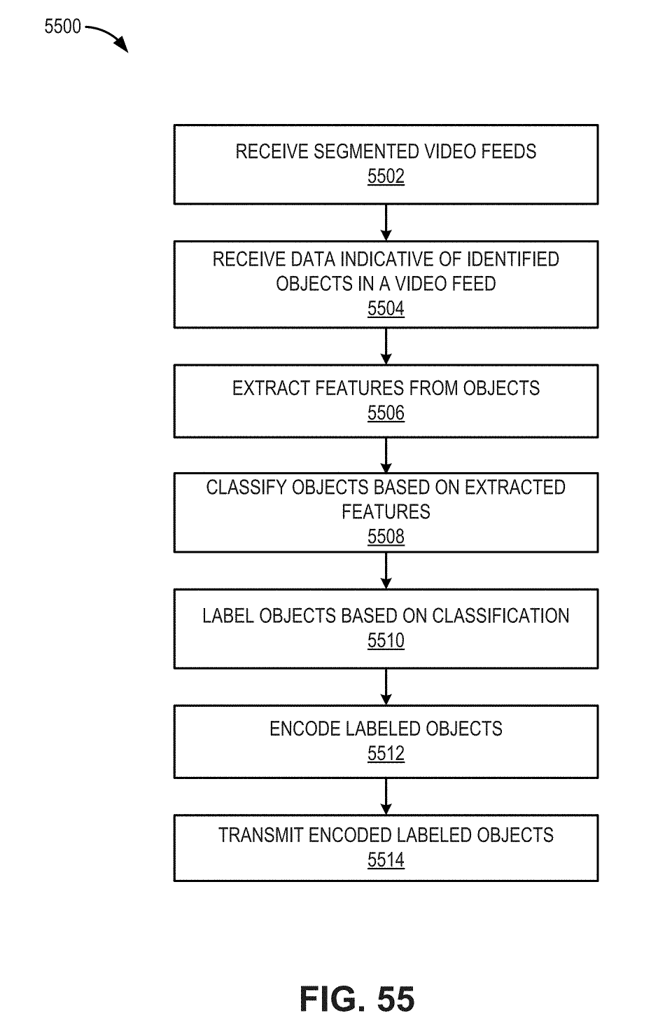

Embodiments of the method 5400 further include classifying objects (block 5406). Embodiments describing an object classification method 5400 are discussed below with respect to FIG. 55. In embodiments, classifying objects may use any of the object classification embodiments described herein in relation to FIG. 53. In embodiments, classifying objects may be performed by a pattern recognition component 5326 depicted in FIG. 53.

After the objects are classified, the objects are encoded (block 5408). In embodiments, the classification data of an object may be encoded as metadata of an object. In embodiments, encoding the motion vectors may be performed by an encoder 5328 as depicted in FIG. 53.

After encoding the objects, the object data may be transmitted (block 5410). In embodiments, the classification metadata of the objects may be transmitted with or separately from the encoded object data. The encoded object data may be transmitted to a decoding device (e.g., the decoding device 5308 depicted in FIG. 53). In embodiments, the communication component 5328 depicted in FIG. 53 may facilitate transmission of the encoded video data over a communication network.

The illustrative method 5400 shown in FIG. 54 is not intended to suggest any limitation as to the scope of use or functionality of embodiments of the subject matter disclosed herein. Neither should the method 5400 be interpreted as having any dependency or requirement related to any block illustrated therein.

FIG. 55 is a flow diagram depicting an illustrative object classification method 5500, in accordance with embodiments of the subject matter disclosed herein. Embodiments of the illustrative method 5500 may be performed, for example, by a device such as the video processing device 5302.

As shown in FIG. 55, the illustrative multi-view motion estimation method 5500 includes receiving segmented video feeds (block 5502). According to embodiments, any number of different techniques for determining scene cuts may be implemented in the context of embodiments of the disclosed subject matter. The video information may include the raw video information, segmentation information (e.g., information about the segmentation process performed on the images of the scene, segment maps, segment identifications, and/or the like).

As shown in FIG. 55, the object classification method 5500 further includes receiving data indicative of identified objects in a video feed (block 5504). In embodiments the objects may have been identified using any of the embodiments described herein including, for example, the objects identified using object analyzer 5324 of FIG. 53.

In embodiments, the method 5500 further comprises extracting features from the objects (block 5506). Features may be extracted using any of a number of different types of feature extraction algorithms including, for example, embodiments of algorithms indicated above. In embodiments, the feature extractor 5332 depicted in FIG. 53 may be used by method 5500 to extract features from one or more objects.

Method 5500 may further include classifying objects based on extracted features (block 5508). To classify the object based on extracted features, extracted features may be correlated to features associated with specific classes of objects. If the extracted features are correlated to features associated with a specific class of objects, then the object may be classified as the class of object having the correlated features. In embodiments, the object classifier 5338 depicted in FIG. 53 may be used by method 5500 to classify objects. In embodiments, one or more of the embodiments described above in relation to FIG. 53 may be used to classify the object.

According to embodiments, the method 5500 may include labeling objects based on the object classification (block 5510) and encoding said labeled objects (block 5512). In embodiments, an object may be labeled using object labeler 5340 and encoded using the encoder 5328 depicted in FIG. 53. Additionally or alternatively, the label of an object may be stored as metadata of the object. The method 5500 may than transmit the encoded labeled objects (block 5514). In embodiments, a communication component (e.g., the communication component 5330 depicted in FIG. 53 may be used to facilitate transmitting the encoded labeled objects. In embodiments, the metadata including the label of an object may be transmitted with or separately from the transmission of an encoded object.

The illustrative method 5500 shown in FIG. 55 is not intended to suggest any limitation as to the scope of use or functionality of embodiments of the subject matter disclosed herein. Neither should the method 5500 be interpreted as having any dependency or requirement related to any block illustrated therein.

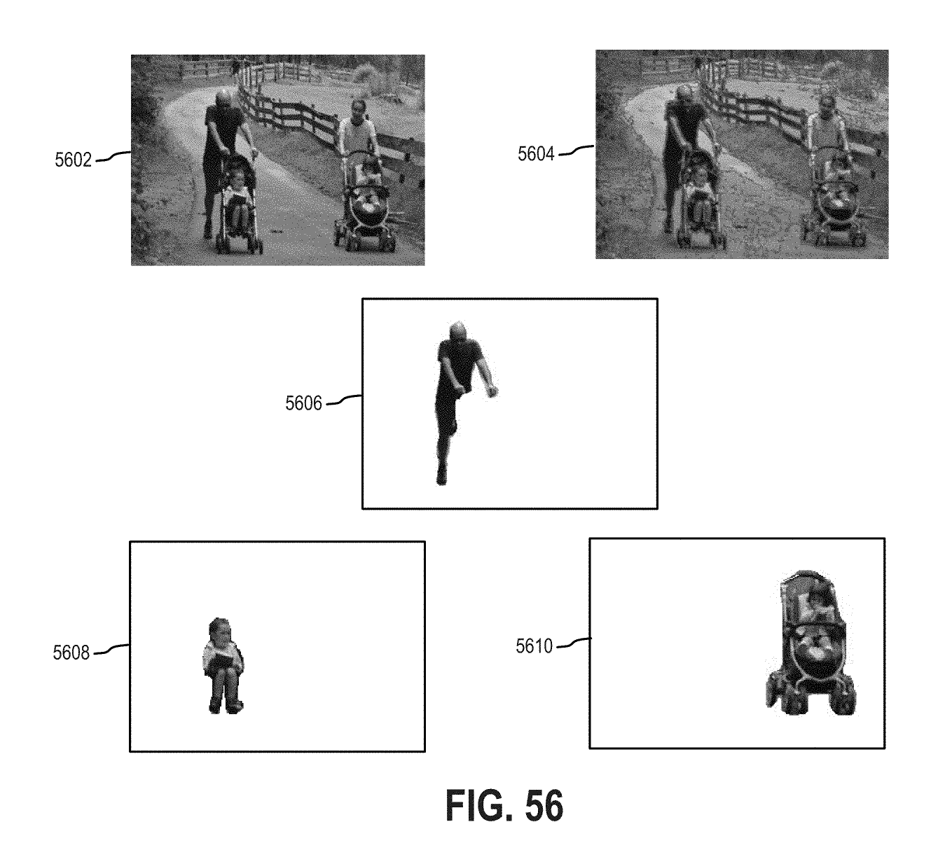

FIG. 56 includes images illustrating a metatagging method, in accordance with embodiments of the subject matter disclosed herein. Image 5602 depicts an image of a man pushing a child and a woman pushing a child. One or more of the image segmentation techniques, foreground detection techniques, motion estimation techniques, object analyzing techniques and/or pattern recognition techniques described herein may be performed on the image 5602 to produce an analyzed image 5604. Based on the analyzed image, objects identified in the image 5602 may be determined. For example, using the techniques described herein, the man may be identified as an object and labeled as a man as shown in image 5606, one or more of the children may be identified as objects and labeled as children as shown in images 5608. Additionally or alternatively, in embodiments, the identified objects may be combined and labeled. For example, a child and a stroller may be identified as an object and labeled as such, i.e., a child in a stroller, as shown in image 5610.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

### Partitioning

### Learning-Based Partitioning for Video Encoding

Embodiments of the systems and methods described herein may include a partitioning process (e.g., the partitioning process 222 depicted in FIG. 2). According to embodiments, the partitioning process may include any number of different techniques for partitioning a video frame for encoding. In embodiments, the efficiency and effectiveness of the partitioning process may be enhanced (as compared to conventional partitioning techniques) by utilizing information generated as a result of one or more previous process such as, for example, segmentation information (e.g., resulting from the segmentation process 202 depicted in FIG. 2); foreground and/or background information (e.g., resulting from the foreground detection process 208 depicted in FIG. 2); motion information (e.g., resulting from the segment-based motion estimation process 210 depicted in FIG. 2); object group information (e.g., resulting from the object group analysis process 212 depicted in FIG. 2); feature-based pattern information (e.g., resulting from the feature-based pattern recognition process 216 depicted in FIG. 2); object classification information (e.g., resulting from the object classification process 218 depicted in FIG. 2); metadata (e.g., resulting from the deep scene level analysis process 220 depicted in FIG. 2); and/or the like.

The process of breaking a video frame into smaller blocks for encoding has been common to the h.26x family of video coding standards since the release of h.261. A more recent version, h.265, uses blocks of sizes up to 64 samples, and utilizes more reference frames and greater motion vector ranges than its predecessors. In addition, these blocks can be partitioned into smaller sub-blocks. The frame sub blocks in h.265 are referred to as Coding Tree Units (CTUs). In H.264 and VP8, these are known as macroblocks and are 16×16. These CTUs can be subdivided into smaller blocks called Coding Units (CUs). While CUs provide greater flexibility in referencing different frame locations, they may also be computationally expensive to locate due to multiple cost calculations performed with respect to CU candidates. Often many CU candidates are not used in a final encoding.

A common strategy for selecting a final CTU follows a quad tree, recursive structure. A CU's motion vectors and cost are calculated. The CU may be split into multiple (e.g., four) parts and a similar cost examination may be performed for each. This subdividing and examining may continue until the size of each CU is 4×4 samples. Once the cost of each sub-block for all the viable motion vectors is calculated, they are combined to form a new CU candidate. This new candidate is then compared to the original CU candidate and the CU candidate with the higher rate-distortion cost is discarded. This process may be repeated until a final CTU is produced for encoding. With the above approach, unnecessary calculations may be made at each CTU for both divided and undivided CU candidates. Additionally, conventional encoders may examine only local information.

Embodiments of the present disclosure use a classifier to facilitate efficient coding unit (CU) examinations. The classifier may include, for example, a neural network classifier, a support vector machine, a random forest, a linear combination of weak classifiers, and/or the like. The classifier may be trained using various inputs such as, for example, object group analysis, segmentation, localized frame information, and global frame information. Segmentation on a still frame may be generated using any number of techniques. For example, in embodiments, an edge detection based method may be used. Additionally, a video sequence may be analyzed to ascertain areas of consistent inter frame movements which may be labeled as objects for later referencing. In embodiments, the relationships between the CU being examined and the objects and segments may be inputs for the classifier.

According to embodiments, frame information may be examined both on a global and local scale. For example, the average cost of encoding an entire frame may be compared to a local CU encoding cost and, in embodiments, this ratio may be provided, as an input, to the classifier. As used herein, the term “cost” may refer to a cost associated with error from motion compensation for a particular partitioning decision and/or costs associated with encoding motion vectors for a particular partitioning decision. These and various other, similar, types of costs are known in the art and may be included within the term “costs” herein. Examples of these costs are defined in U.S. application Ser. No. 13/868,749, filed Apr. 23, 2013, entitled “MACROBLOCK PARTITIONING AND MOTION ESTIMATION USING OBJECT ANALYSIS FOR VIDEO COMPRESSION,” the entirety of which is hereby incorporated by reference herein for all purposes.

Another input to the classifier may include a cost decision history of local CTUs that have already been processed. This may be, e.g., a count of the number of times a split CU was used in a final CTU within a particular region of the frame. In embodiments, the Early Coding Unit decision, as developed in the Joint Video Team's Video Coding HEVC Test Model 12, may be provided, as input, to the classifier. Additionally, the level of the particular CU in the quad tree structure may be provided, as input, to the classifier.

According to embodiments, information from a number of test videos may be used to train a classifier to be used in future encodings. In embodiments, the classifier may also be trained during actual encodings. That is, for example, the classifier may be adapted to characteristics of a new video sequence for which it may subsequently influence the encoder's decisions of whether to bypass unnecessary calculations.

According to various embodiments of the present disclosure, a pragmatic partitioning analysis may be employed, using a classifier to help guide the CU selection process. Using a combination of segmentation, object group analysis, and a classifier, the cost decision may be influenced in such a way that human visual quality may be increased while lowering bit expenditures. For example, this may be done by allocating more bits to areas of high activity than are allocated to areas of low activity. Additionally, embodiments of the present disclosure may leverage correlation information between CTUs to make more informed global decisions. In this manner, embodiments of the present disclosure may facilitate placing greater emphasis on areas that are more sensitive to human visual quality, thereby potentially producing a result of higher quality to end-users.

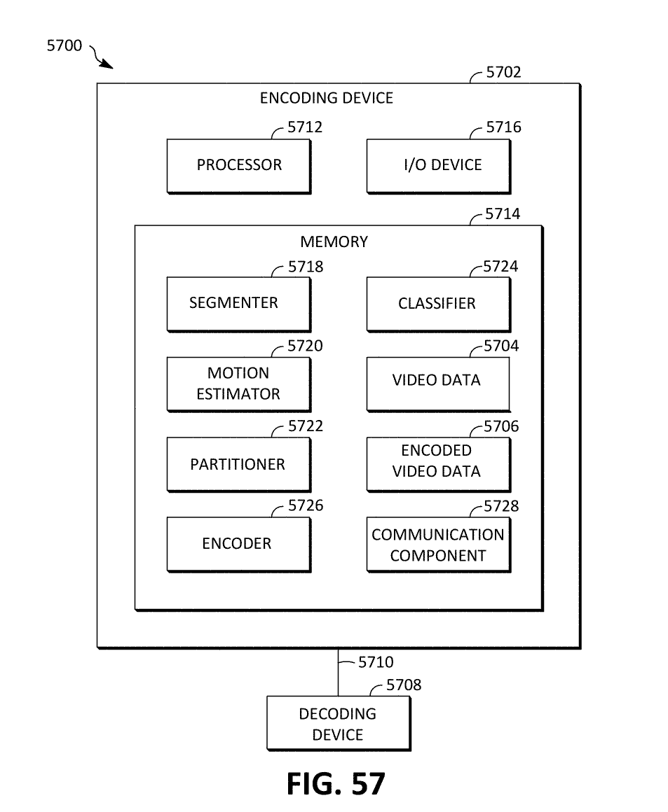

FIG. 57 is a block diagram illustrating an operating environment 5700 in accordance with embodiments of the present disclosure. The operating environment 5700 includes an encoding device 5702 (e.g., the video processing platform 102 depicted in FIG. 1 and/or the video processing device 302 depicted in FIG. 3) that may be configured to encode video data 5704 to create encoded video data 5706. As shown in FIG. 57, the encoding device 5702 may also be configured to communicate the encoded video data 5706 to a decoding device 5708 (e.g., the receiving device 108 depicted in FIG. 1 and/or the decoding device 308 depicted in FIG. 3) via a communication link 5710 (e.g., the communication links 106 and/or 110 depicted in FIG. 1, and/or the communication link 310 depicted in FIG. 3.

As shown in FIG. 57, the encoding device 5702 may be implemented on a computing device that includes a processor 5712, a memory 5714, and an input/output (I/O) device 5716. Although the encoding device 5702 is referred to herein in the singular, the encoding device 5702 may be implemented in multiple instances, distributed across multiple computing devices, instantiated within multiple virtual machines, and/or the like. In embodiments, the processor 5712 executes various program components stored in the memory 5714, which may facilitate encoding the video data 5706. In embodiments, the processor 5712 may be, or include, one processor or multiple processors. In embodiments, the I/O device 5716 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 5714 stores computer-executable instructions for causing the processor 5712 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 5718, a motion estimator 5720, a partitioner 5722, a classifier 5724, an encoder 5726, and a communication component 5728.

In embodiments, the segmenter 5718 may be configured to segment a video frame into a number of segments. The segments may include, for example, objects, groups, slices, tiles, and/or the like. The segmenter 5718 may employ any number of various automatic image segmentation methods known in the field. In embodiments, the segmenter 5718 may use image color and corresponding gradients to subdivide an image into segments that have similar color and texture. Two examples of image segmentation techniques include the watershed algorithm and optimum cut partitioning of a pixel connectivity graph. For example, the segmenter 5718 may use Canny edge detection to detect edges on a video frame for optimum cut partitioning, and create segments using the optimum cut partitioning of the resulting pixel connectivity graph.

In embodiments, the motion estimator 5720 is configured to perform motion estimation on a video frame. For example, in embodiments, the motion estimator may perform segment-based motion estimation, where the inter-frame motion of the segments determined by the segmenter 5718 is determined. The motion estimator 5720 may utilize any number of various motion estimation techniques known in the field. Two examples are optical pixel flow and feature tracking. For example, in embodiments, the motion estimator 5720 may use feature tracking in which Speeded Up Robust Features (SURF) are extracted from both a source image (e.g., a first frame) and a target image (e.g., a second, subsequent, frame). The individual features of the two images may then be compared using a Euclidean metric to establish a correspondence, thereby generating a motion vector for each feature. In such cases, a motion vector for a segment may be, for example, the median of all of the motion vectors for each of the segment's features.

In embodiments, the encoding device 5702 may perform an object group analysis on a video frame. For example, each segment may be categorized based on its motion properties (e.g., as either moving or stationary) and adjacent segments may be combined into objects. In embodiments, if the segments are moving, they may be combined based on similarity of motion. If the segments are stationary, they may be combined based on similarity of color and/or the percentage of shared boundaries.

In embodiments, the partitioner 5722 may be configured to partition the video frame into a number of partitions. For example, the partitioner 5722 may be configured to partition a video frame into a number of coding tree units (CTUs). The CTUs can be further partitioned into coding units (CUs). Each CU may include a luma coding block (CB), two chroma CBs, and an associated syntax. In embodiments, each CU may be further partitioned into prediction units (Pus) and transform units (TUs). In embodiments, the partitioner 5722 may identify a number of partitioning options corresponding to a video frame. For example, the partitioner 5722 may identify a first partitioning option and a second partitioning option.

To facilitate selecting a partitioning option, the partitioner 5722 may determine a cost of each option and may, for example, determine that a cost associated with the first partitioning option is lower than a cost associated with the second partitioning option. In embodiments, a partitioning option may include a candidate CU, a CTU, and/or the like. In embodiments, costs associated with partitioning options may include costs associated with error from motion compensation, costs associated with encoding motion vectors, and/or the like.

To minimize the number of cost calculations made by the partitioner 5722, the classifier 5724 may be used to facilitate classification of partitioning options. In this manner, the classifier 5724 may be configured to facilitate a decision as to whether to partition the frame according to an identified partitioning option. According to various embodiments, the classifier may be, or include, a neural network, a support vector machine, and/or the like. The classifier may be trained using test videos before and/or during its actual use in encoding.

In embodiments, the classifier 5724 may be configured to receive, as input, at least one characteristic corresponding to the candidate coding unit. For example, the partitioner 5722 may be further configured to provide, as input to the classifier 5724, a characteristic vector corresponding to the partitioning option. The characteristic vector may include a number of feature parameters that can be used by the classifier to provide an output to facilitate determining that the cost associated with a first partitioning option is lower than the cost associated with a second partitioning option. For example, the characteristic vector may include one or more of localized frame information, global frame information, output from object group analysis and output from segmentation. The characteristic vector may include a ratio of an average cost for the video frame to a cost of a local CU in the video frame, an early coding unit decision, a level in a CTU tree structure corresponding to a CU, and a cost decision history of a local CTU in the video frame. For example, the cost decision history of the local CTU may include a count of a number of times a split CU is used in a corresponding final CTU.

As shown in FIG. 57, the encoding device 5702 also includes an encoder 5726 configured for entropy encoding of partitioned video frames and a communication component 5728. In embodiments, the communication component 5728 is configured to communicate encoded video data 5706. For example, in embodiments, the communication component 5728 may facilitate communicating encoded video data 5706 to the decoding device 5708.

The illustrative operating environment 5700 shown in FIG. 57 is not intended to suggest any limitation as to the scope of use or functionality of embodiments of the present disclosure. Neither should the illustrative operating environment 5700 be interpreted as having any dependency or requirement related to any single component or combination of components illustrated therein. Additionally, any one or more of the components depicted in FIG. 57 may be, in embodiments, integrated with various ones of the other components depicted therein (and/or components not illustrated), all of which are considered to be within the ambit of the subject matter disclosed herein.

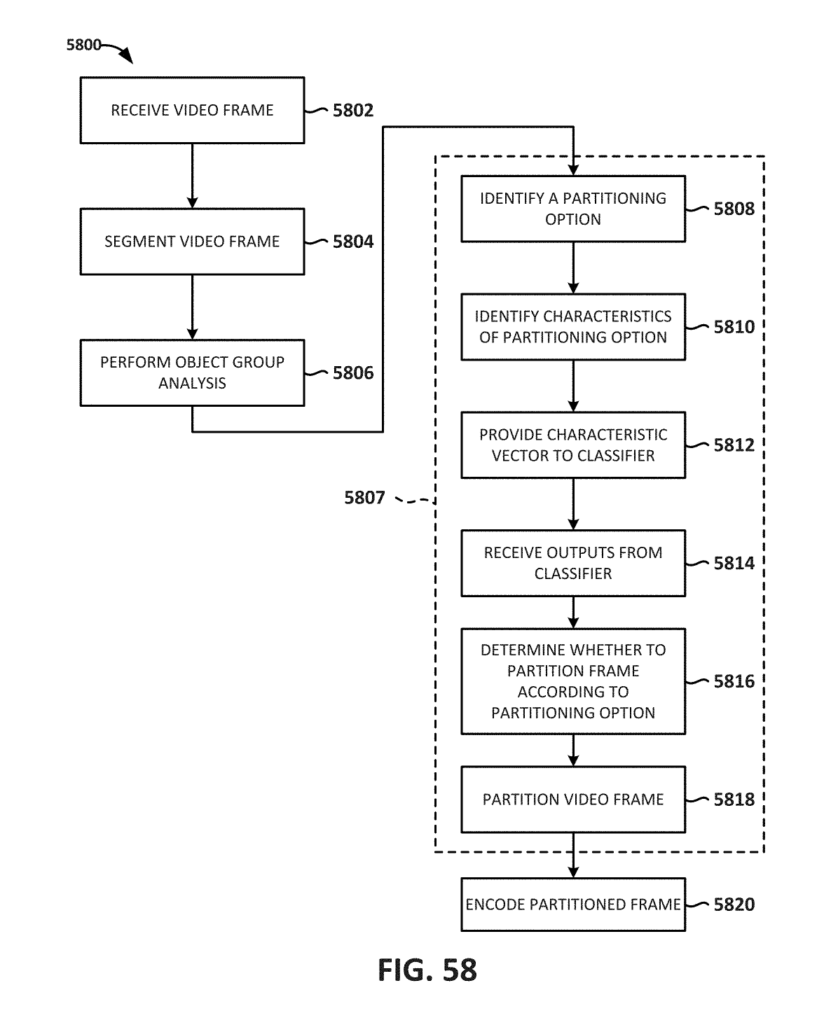

FIG. 58 is a flow diagram depicting an illustrative method 5800 of encoding video. In embodiments, aspects of the method 5800 may be performed by an encoding device (e.g., the encoding device 5702 depicted in FIG. 57). As shown in FIG. 58, embodiments of the illustrative method 5800 include receiving a video frame (block 5802). In embodiments, one or more video frames may be received by the encoding device from another device (e.g., a memory device, a server, and/or the like). The encoding device may perform segmentation on the video frame (block 5804) to produce segmentation results, and perform an object group analysis on the video frame (block 5806) to produce object group analysis results.

Embodiments of the method 5800 further include a process 5807 that is performed for each of a number of coding units or other partition structures. For example, a first iteration of the process 5807 may be performed for a first CU that may be a 64×64 block of pixels, then for each of four 32×32 blocks of the CU, using information generated in each step to inform the next step. The iterations may continue, for example, by performing the process for each 16×16 block that makes up each 32×32 block. This iterative process 5807 may continue until a threshold or other criteria are satisfied, at which point the method 5800 does is not applied at any further branches of the structural hierarchy.

As shown in FIG. 58, for example, for a first coding unit (CU), identifying a partitioning option (block 5808). The partitioning option may include, for example, a coding tree unit (CTU), a coding unit, and/or the like. In embodiments, identifying the partitioning option may include identifying a first candidate coding unit (CU) and a second candidate CU, determining a first cost associated with the first candidate CU and a second cost associated with the second candidate CU, and determining that the first cost is lower than the second cost.

As shown in FIG. 58, embodiments of the illustrative method 5800 further include identifying characteristics corresponding to the partitioning option (block 5810). Identifying characteristics corresponding to the partitioning option may include determining a characteristic vector having one or more of the following characteristics: an overlap between the first candidate CU and at least one of a segment, an object, and a group of objects; a ratio of a coding cost of the first candidate CU to an average coding cost of the video frame; a neighbor CTU split decision history; and a level in a CTU quad tree structure corresponding to the first candidate CU. In embodiments, the characteristic vector may also include segmentation results and object group analysis results.

As shown in FIG. 58, the encoding device provides the characteristic vector to a classifier (block 5812) and receives outputs from the classifier (block 5814). The outputs from the classifier may be used (e.g., by a partitioner such as the partitioner 5724 depicted in FIG. 57) to facilitate a determination whether to partition the frame according to the partitioning option (block 5816). According to various embodiments, the classifier may be, or include, a neural network, a support vector machine, and/or the like. The classifier may be trained using test videos. For example, in embodiments, a number of test videos having a variety of characteristics may be analyzed to generate training data, which may be used to train the classifier. The training data may include one or more of localized frame information, global frame information, output from object group analysis and output from segmentation. The training data may include a ratio of an average cost for a test frame to a cost of a local CU in the test frame, an early coding unit decision, a level in a CTU tree structure corresponding to a CU, and a cost decision history of a local CTU in the test frame. For example, the cost decision history of the local CTU may include a count of a number of times a split CU is used in a corresponding final CTU. As shown in FIG. 58, using the determined CTUs, the video frame is partitioned (block 5818) and the partitioned video frame is encoded (block 5820).

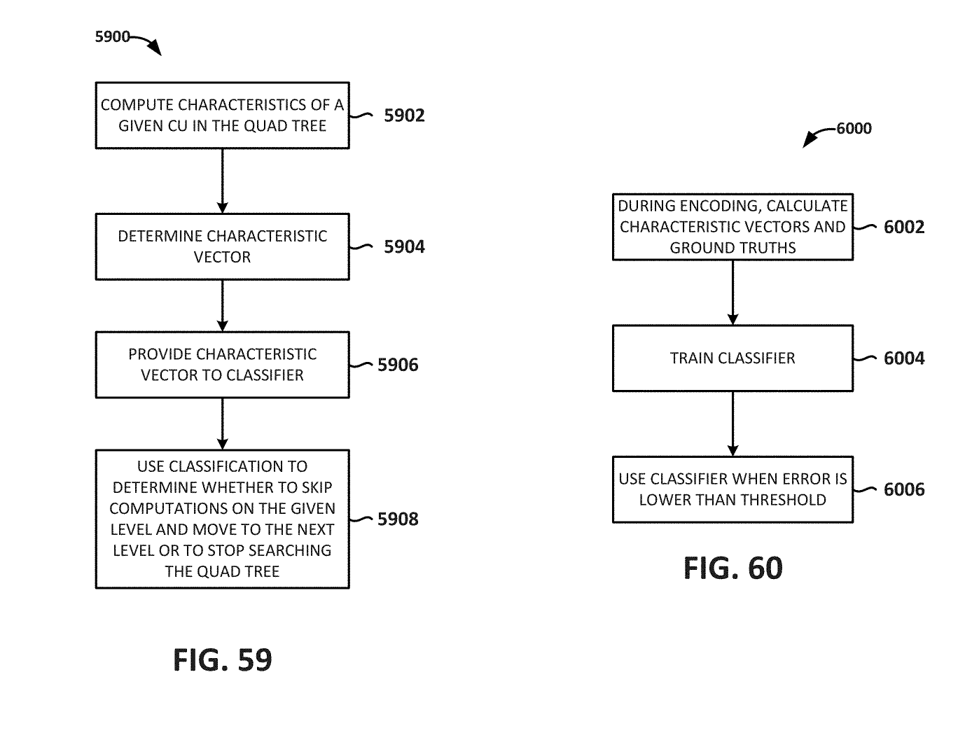

FIG. 59 is a flow diagram depicting an illustrative method 5900 of partitioning a video frame. In embodiments, aspects of the method 5900 may be performed by an encoding device (e.g., the encoding device 5702 depicted in FIG. 57). As shown in FIG. 59, embodiments of the illustrative method 5900 include computing entities needed for generating a characteristic vector of a given CU in a quad tree (block 5902), as compared to other coding unit candidates. The encoding device determines a characteristic vector (block 5904) and provides the characteristic vector to a classifier (block 5906). As shown in FIG. 59, the method 5900 further uses the resulting classification to determine whether to skip computations on the given level of the quad tree and to move to the next level, or to stop searching the quad tree (block 5908).

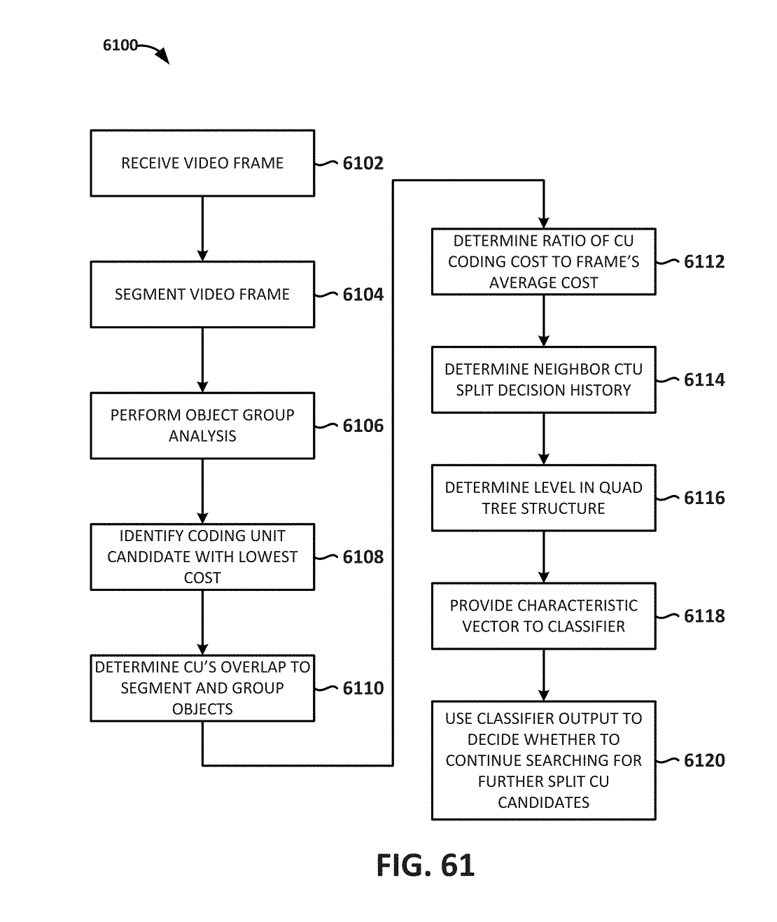

FIG. 60 is a schematic diagram depicting an illustrative method 6000 for encoding video. In embodiments, aspects of the method 6000 may be performed by an encoding device (e.g., the encoding device 5702 depicted in FIG. 57). As shown in FIG. 60, embodiments of the illustrative method 6000 include calculating characteristic vectors and ground truths while encoding video data (block 6002). The method 6000 further includes training a classifier using the characteristic vectors and ground truths (block 6004) and using the classifier when the error falls below a threshold (block 6006).

FIG. 61 is a flow diagram depicting an illustrative method 6100 of partitioning a video frame. In embodiments, aspects of the method 6100 may be performed by an encoding device (e.g., the encoding device 5702 depicted in FIG. 57). As shown in FIG. 61, embodiments of the illustrative method 6100 include receiving a video frame (block 6102). The encoding device segments the video frame (block 6104) and performs an object group analysis on the video frame (block 6106). As shown, a coding unit candidate with the lowest cost is identified (block 6108). The encoding device may then determine an amount of overlap between the coding unit candidate and one or more of the segments and/or object groups (block 6110).

As shown in FIG. 61, embodiments of the method 6100 also include determining a ratio of a coding cost associated with the candidate CU to an average frame cost (block 6112). The encoding device may also determine a neighbor CTU split decision history (block 6114) and a level in a quad tree level corresponding to the CU candidate (block 6116). As shown, the resulting characteristic vector is provided to a classifier (block 6118) and the output from the classifier is used to decide whether to continue searching for further split CU candidates (block 6120).

### Macroblock Partitioning and Motion Estimation Using Object Analysis for Video Compression

Modern video compression techniques take advantage of the fact that information content in video exhibits significant redundancy. Video exhibits temporal redundancy inasmuch as, in a new frame of a video, most content was present previously. Video also exhibits significant spatial redundancy, inasmuch as, in a given frame, pixels have color values similar to their neighbors. The first commercially widespread video coding methods, MPEG1 and MPEG2, took advantage of these forms of redundancy and were able to reduce bandwidth requirements substantially.

For high quality encoding, MPEG1 generally cut from 240 Mbps to 6 Mbps the bandwidth requirement for standard definition resolution. MPEG2 brought the requirement down further to 4 Mbps. MPEG2 is resultantly used for digital television broadcasting all over the world. MPEG1 and MPEG2 each took advantage of temporal redundancy by leveraging block-based motion compensation. To compress using block-based motion compensation, a new frame that is to be encoded by an encoder is broken up into fixed-size, 16×16 pixel blocks, labeled macroblocks. These macroblocks are non-overlapping and form a homogenous tiling of the frame. When encoding, the encoder searches for the best matching macroblock of a previously encoded frame, for each macroblock in a new frame. In fact, in MPEG1 and MPEG2 up to two previously encoded frames can be searched. Once a best match is found, the encoder establishes and transmits a displacement vector, known in this case as a motion vector, referencing and, thereby, approximating, each macroblock.

MPEG1 and MPEG2, as international standards, specified the format of the motion vector coding but left the means of determination of the motion vectors to the designers of the encoder algorithms. Originally, the absolute error between the actual macroblock and its approximation was targeted for minimization in the motion vector search. However, later implementations took into account the cost of encoding the motion vector, too. Although MPEG1 and MPEG2 represented significant advances in video compression, their effectiveness was limited, due, largely, to the fact that real video scenes are not comprised of moving square blocks. Realistically, certain macroblocks in a new frame are not represented well by any macroblocks from a previous frame and have to be encoded without the benefit of temporal redundancy. With MPEG1 and MPEG2, these macroblocks could not be compressed well and contributed disproportionately to overall bitrate.

The newer generation of video compression standards, such as H.264 and Google's VP8, has addressed this temporal redundancy problem by allowing the 16×16 macroblocks to be partitioned into smaller blocks, each of which can be motion compensated separately. The option is to go, potentially, as far down as 4×4 pixel block partitions. The finer partitioning potentially allows for a better match of each partition to a block in a previous frame. However, this approach incurs the cost of coding extra motion vectors. The encoders, operating within standards, have the flexibility to decide how the macroblocks are partitioned and how the motion vectors for each partition are selected. Regardless of path, ultimately, the results are encoded in a standards compliant bitstream that any standards compliant decoder can decode.

Determining how to partition and motion compensate each macroblock is complex, and the original H.264 test model used an approach based on rate-distortion optimization. In rate-distortion optimization, a combined cost function, including both the error for a certain displacement and the coding cost of the corresponding motion vector, is targeted for minimization. To partition a particular macroblock, the total cost-function is analyzed. The total cost function contains the errors from motion compensating each partition and the costs of encoding all the motion vectors associated with the specific partitioning. The cost is given by the following equation:

F(v₁, . . . ,v_{N})=ΣₚₐᵣₜᵢₜᵢₒₙₛErrorₚₐᵣₜᵢₜᵢₒₙ+αΣₚₐᵣₜᵢₜᵢₒₙₛR(vₚₐᵣₜᵢₜᵢₒₙ), (1)

where a is the Lagrange multiplier relating rate and distortion, ΣₚₐᵣₜᵢₜᵢₒₙₛErrorₚₐᵣₜᵢₜᵢₒₙ is the cost associated with the mismatch of the source and the target, and Σₚₐᵣₜᵢₜᵢₒₙₛ R(vₚₐᵣₜᵢₜᵢₒₙₛ) is the cost associated with encoding the corresponding motion vectors.

For each possible partitioning, the cost function F is minimized as a function of motion vectors v. For the final decision, the optimal cost functions of each potential partitioning are considered, and the partitioning with lowest overall cost function is selected. The macroblocks are encoded in raster scan order, and this choice is made for each macroblock as it is encoded. The previous macroblocks impact the current macroblock by predicting differentially the motion vectors for the current macroblock and, thus, impacting the coding cost of a potential candidate motion vector. This approach is now used de facto in video compression encoders for H.264 and VP8 today.

Embodiments of the methods and systems herein may include a method of partitioning including: determining objects within a frame, such determining being at least partially based on movement characteristics of pixels of the frame; creating a mask corresponding to the frame; determining a pre-scaling cost function value associated with each of a plurality of partitioning options for partitioning a macroblock of the frame, the pre-scaling cost function value comprising a sum of motion compensation errors associated with the partitioning option and the costs of encoding the motion vectors associated with the partitioning option; determining a post-scaling cost function value associated with each of the plurality of partitioning options, comprising: determining, based on the mask, that a macroblock overlaps at least two of the determined objects; determining that a first partitioning option of the plurality of partitioning options results in partitioning the macroblock into a plurality of blocks, wherein the first portioning option separates at least some of the determined objects into different blocks of the plurality of blocks; and reducing, by a scaling factor, a pre-scaling cost function value of the first partitioning option to create a post-scaling cost function value of the first partitioning option in response to determining that the first partitioning option results in partitioning the macroblock into a plurality of blocks, wherein the first portioning option separates at least some of the determined objects into different blocks of the plurality of blocks; selecting a partitioning option of the plurality of partitioning options having the lowest associated post-scaling cost function value; and partitioning the frame into blocks according to the selected partitioning option.

In an exemplary and non-limited embodiment, aspects of the disclosure are embodied in a method of encoding video including determining objects within a frame at least partially based on movement characteristics of underlying pixels and partitioning the frame into blocks by considering a plurality of partitioning options, such partitioning favoring options that result in different objects being placed in different blocks. That is, for example,

In another example, aspects of the present disclosure are embodied in a partitioner operable to partition a frame into blocks by considering a plurality of partitioning options, such partitioning favoring options that result in different objects being placed in different blocks.

In yet another example, aspect of the present disclosure are embodied in a computer readable media having instructions thereon that when interpreted by a processor cause the processor to determine objects within a frame at least partially based on movement characteristics of underlying pixels; and partition a frame into blocks by considering a plurality of partitioning options, such partitioning favoring options that result in different objects being placed in different blocks.

The methods and systems described herein improve on the currently prevailing compression approach by taking a more global view of the encoding of a frame of video. Using the traditional rate-distortion optimization approach, no weight is given to the fact that the choice of partitions and their corresponding motion vectors will impact subsequent macroblocks. The result of this comes in the form of higher cost for encoding motion vectors and potential activation of the de-blocking filter, negatively impacting overall quality.

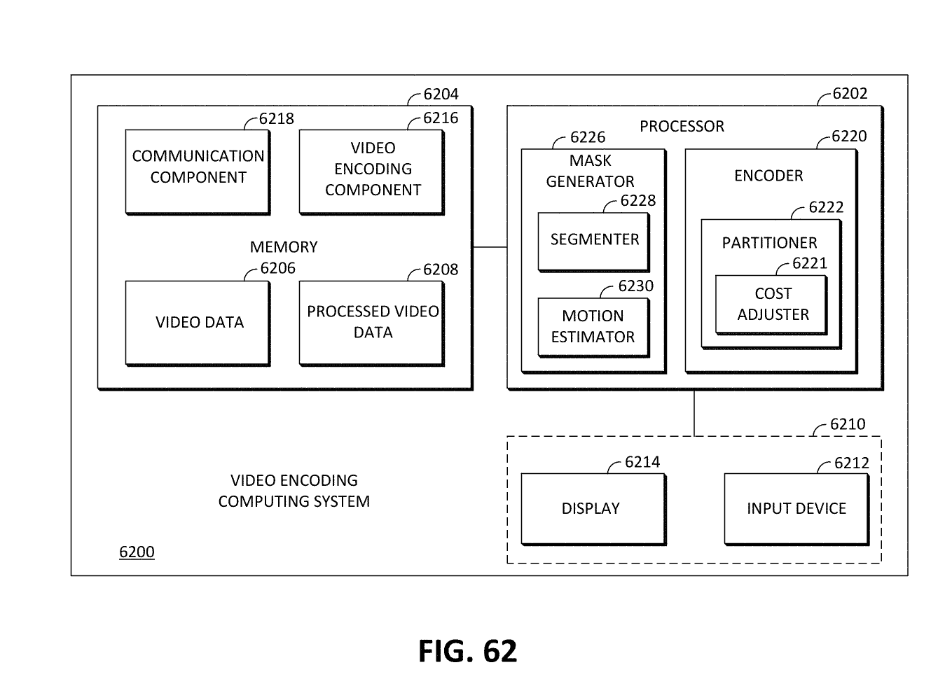

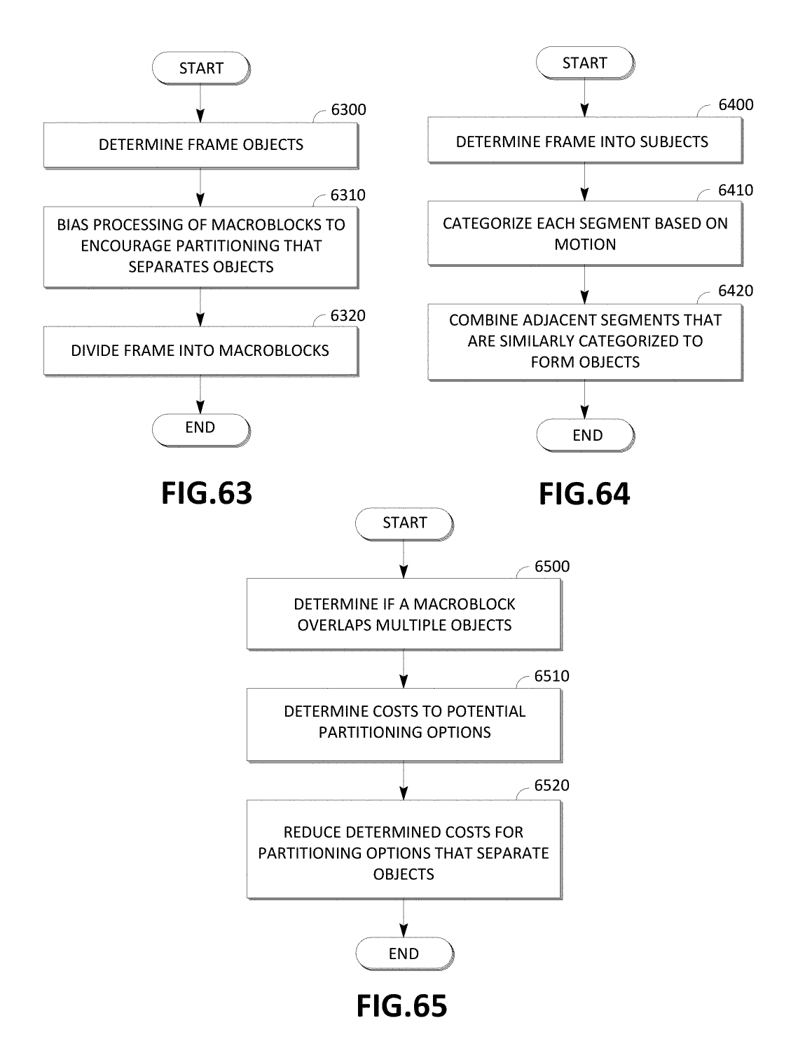

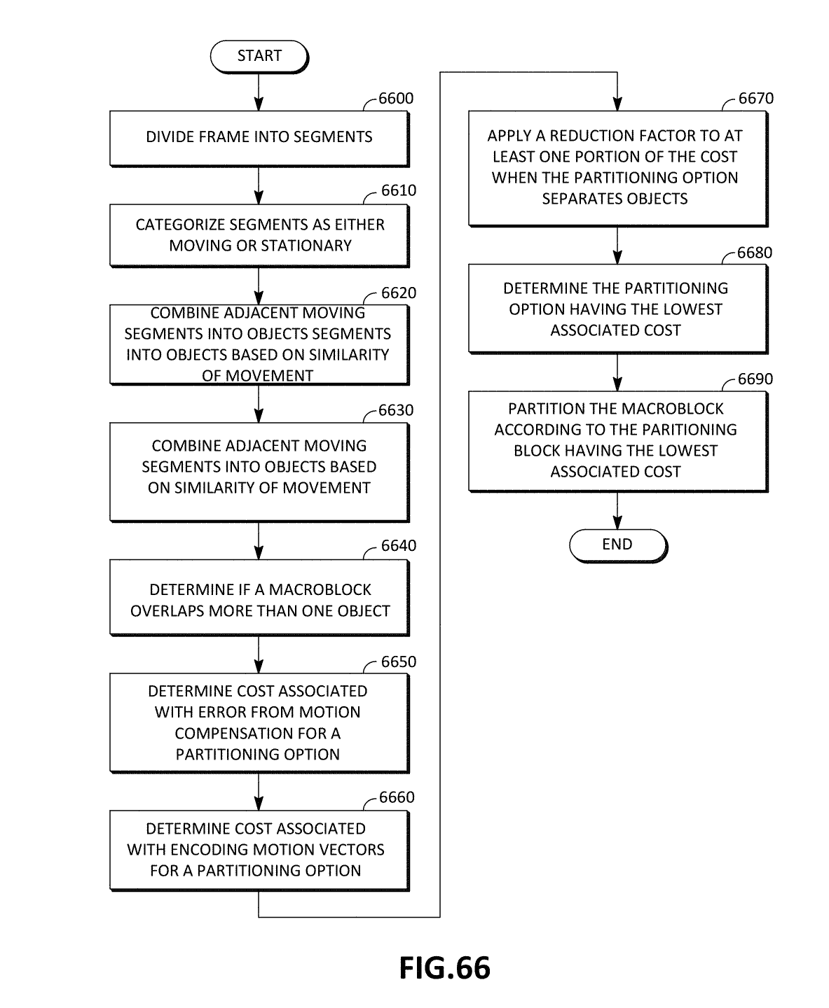

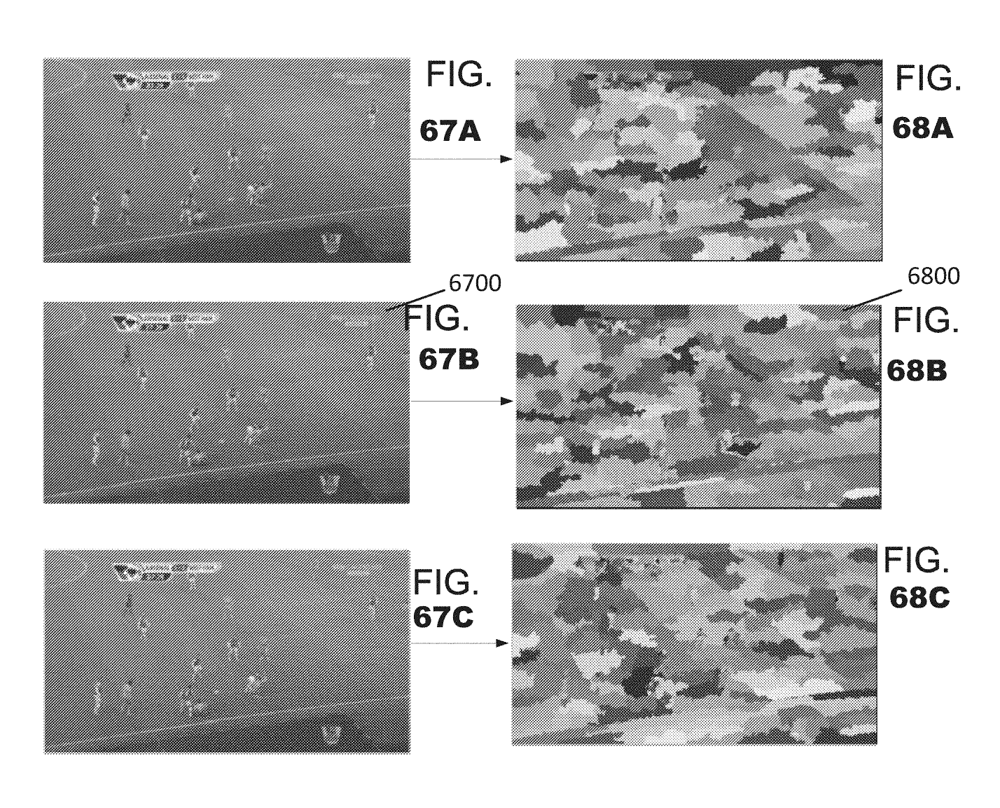

Referring to FIG. 62, an illustrative video encoding device 6200 is represented, in accordance with embodiments of the subject matter disclosed herein. Video encoding device 6200 includes a processor 6202, memory 6204, and interfaces 6210. According to embodiments, the encoding device 6200 may be, include, be similar to, or be included in, the video processing device 300 depicted in FIG. 3. The processor 6202 includes a mask generator 6226 and encoder 6220. Each of mask generator 6226 and encoder 6220 are illustratively provided as controller 6202 executing instructions. Mask generator 6226 includes segmenter 6228 and motion estimator 6230. Encoder 6220 includes partitioner 6222. Partitioner 6222 includes cost adjuster 6221. Processor 6202 has access to memory 6204.

Memory 6204 includes communication component 6218 which when executed by processor 6202 permit video encoding computing system 6200 to communicate with other computing devices over a network. Although illustrated as software, communication component 6218 may be implemented as software, hardware (such as state logic), or a combination thereof. Video encoding computing system 6200 further includes data, such as at least one video file 6206, to be encoded which is received from a client computing system and is stored on memory 6204. The video file is to be encoded and subsequently stored as a processed video file 6208. Exemplary video encoding computing systems 6200 include desktop computers, laptop computers, tablet computers, cell phones, smart phones, and other suitable computing devices. In the illustrative embodiment, video encoding computing system 6200 includes memory 6204 which may be multiple memories accessible by processor 6202.

Memory 6204 associated with the one or more processors of processor 6202 may include, but is not limited to, memory associated with the execution of software and memory associated with the storage of data. Memory 6204 includes computer readable media. Computer-readable media may be any available media that may be accessed by one or more processors of processor 6202 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by processor 6202.

Memory 6204 further includes video encoding component 6216. Video encoding component 6216 relates to the processing of video file 6206. Exemplary processing sequences of the video encoding component are provided below. Although illustrated as software, video encoding component 6216 may be implemented as software, hardware, or a combination thereof.

Video encoding computing system 6200 further includes a user interface 6210. User interface 6210 includes one or more input devices 6212 and one or more output devices, illustratively a display 6214. Exemplary input devices include a keyboard, a mouse, a pointer device, a trackball, a button, a switch, a touch screen, and other suitable devices which allow an operator to provide input to video encoding computing system 6200. Exemplary output devices include a display, a touch screen, a printer, and other suitable devices which provide information to an operator of video encoding computing system 6200.

In one embodiment, the computer systems disclosed in U.S. application Ser. No. 13/428,707, filed Mar. 23, 2012, titled VIDEO ENCODING SYSTEM AND METHOD, the entirety of which is hereby incorporated by reference herein for all purposes, utilize the video encoding processing sequences described herein to encode video files.

### Video Encoding Processing Sequences

In embodiments, a two-pass approach through the video is implemented. In the first pass, video is analyzed both for coherently moving and for stationary objects. With respect to each frame of video, mask generator 6226 generates a mask. Mask generator 6226 assigns each pixel of a frame to either a moving or a stationary object. Objects are determined (block 6300) and enumerated with each objects numeral corresponding to the pixel value in the mask. Moreover, via motion estimator 6230, associated metadata may specify which objects are in motion.

According to embodiments, the first pass includes two steps. In the first step, segmenter receives a frame 6700 and breaks up the frame into image segments 6800 (FIGS. 68a-c)(Blocks 6400, 6600).

A number of different automatic image segmentation methods are known to practitioners in the field. Generally, the techniques use image color and corresponding gradients to subdivide an image into segment regions that have similar color and texture. Two examples of image segmentation techniques include the watershed algorithm and optimum cut partitioning of a pixel connectivity graph. In the specific embodiment, Canny edge detection is used to detect edges on an image for optimum cut partitioning. Segments are then created using the optimum cut partitioning of the pixel connectivity graph.

The second step is segment-based motion estimation, where the motion of the segments is determined. Once the segments are created, motion estimator 6230 estimates motion of the segment between frames, with the current frame in the temporal sequence serving as the source frame and the subsequent frame in the temporal sequence serving as the target frame. A number of motion estimation techniques are known to practitioners in the field. Two examples are optical pixel flow and feature tracking. In a feature tracking technique, for example, Speeded Up Robust Features (SURF) are extracted from both the source image and the target image. The individual features of the two images are then compared using a Euclidean metric to establish a correspondence. This generates a motion vector for each feature. A motion vector for a segment is the median of all of the segment's features. Accordingly, in embodiments, each segment is categorized based on its motion properties (Block 6410). Such categorization includes categorizing each segment as either moving or stationary (Block 6610).

As shown, adjacent segments, as understood from the foregoing two steps, are combined into objects (Block 6420). If the segments are moving, they are combined based on similarity of motion (Block 6620). If the segments are stationary, they are combined based on similarity of color and the percentage of shared boundaries (Block 6630). Objects are enumerated, and a mask is generated for a given frame.

In the second pass, the actual encoding is performed by encoder 6220. The object mask generated by the first pass is available to encoder 6220. Partitioner 6222 operates to determine which macroblocks are kept whole and which macroblocks are further divided into smaller partitions. Partitioner 6222 makes the partitioning decision by taking object mask information into account. Partitioner 6222 illustratively “decides” between multiple partitioning options.

Partitioner 6222 determines if a macroblock overlaps multiple objects of the mask (Block 6500, 6640). The costs associated with each partitioning option are determined (Block 6510). In one example, costs associated with error from motion compensation for a particular partitioning decision is determined (Block 6650). Costs associated with encoding motion vectors for a particular partitioning decision are also determined (Block 6660).

In the case where a macroblock overlaps two objects, cost adjuster 6221 favors the partitioning option that separates the two objects by adjusting (reducing) its cost function via multiplying it by a coefficient, β, which is less than 1 (Block 6520, 6670). Stated differently, the processing of macroblocks is biased to encourage partitioning that separates objects (block 6310). β is a learned constant and, in the specific embodiment, depends on whether one of two objects is moving, both objects are moving, or both are stationary. In the case of a macroblock containing more than two objects, the cost function of a partition that separates three of the objects is further scaled by β₂. This approach is applied potentially indefinitely for an indefinite number of additional objects within a macroblock. In the specific embodiment, β's past β₂ are equal to 1. The partition corresponding to the best cost function value post-scaling is determined (block 6680), selected, and processed (Block 6690).

The specific cost functions are given by:

F(v₁, . . . ,vₙ)_{objects separated}=β(ΣₚₐᵣₜᵢₜᵢₒₙₛErrorₚₐᵣₜᵢₜᵢₒₙ+αΣₚₐᵣₜᵢₜᵢₒₙₛR(vₚₐᵣₜᵢₜᵢₒₙₛ))

F(v₁, . . . ,vₙ)_{objects together}=ΣₚₐᵣₜᵢₜᵢₒₙₛErrorₚₐᵣₜᵢₜᵢₒₙ+αΣₚₐᵣₜᵢₜᵢₒₙₛR(vₚₐᵣₜᵢₜᵢₒₙₛ)

Partitioning that favors separation of objects is hereby more likely because β less than one gives such partitioning a lower cost. In other words, additional present real cost is taken on in anticipation that such present cost results in later savings. Moreover, this leads potentially to less expensive encoding of macroblocks reached subsequently when they contain portions of one of the objects in the considered macroblock. In the specific embodiment, the error metric chosen (i.e., the first addend) is the sum of absolute differences. The coding cost of the motion vectors (i.e., the second addend) is derived by temporarily quantifying the vectors' associated bitrates using Binary Adaptive Arithmetic Coding. Nothing is written to the bitstream until the final choice for the macroblock is made. Once such macroblock choice is made, along with the decisions for all other macroblocks, the frame is divided into macroblocks (Block 6320).

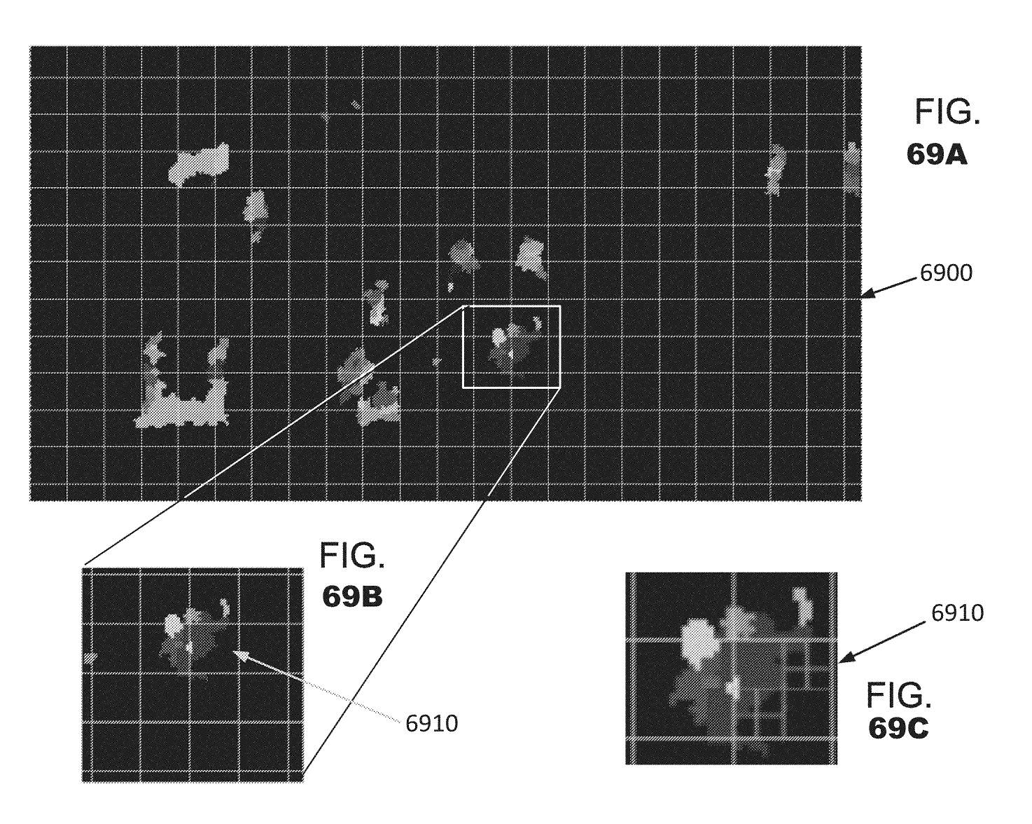

An exemplary processing will now be described with reference to FIGS. 67A-C, 68A-C, and 69A-C. FIGS. 67A-C show three consecutive frames 6700 of video information depicting a soccer match. FIGS. 68A-C show those three frames broken up into segments 6800 based on colors, edges, and textures.

Based on analysis of the motion of the segments from frame to frame, segments are grouped into objects. FIG. 69a shows one such frame with objects thereon. It is specifically noted that the majority of the frame depicts the green grass of the field that does not move from frame to frame. Thus, this lack of motion and consistency of color results in the grass all being grouped as a single object (background object). The non-background objects correspond with the images of the players. FIG. 69b is an enlarged area of FIG. 69a. FIG. 69c is an enlarged area of FIG. 69b showing a macroblock of interest 6910.

In the current example, macroblocks are illustratively 16 pixels by 16 pixels in size. FIGS. 69a-c show an overlay that depicts the 16×16 macroblock partitioning 6900. Encoder 6220 has to decide whether to motion compensate the 16×16 macroblock 6910 as one whole piece or subdivide it into smaller pieces. FIG. 69c shows a first order subdivision that divides macroblock 6910 into four 8 pixels by 8 pixels blocks. FIG. 69c also shows a further subdivision of two 8×8 blocks (top right and lower left) into four 4 pixels by 4 pixels blocks.

In the present example, the cost calculation has determined that the changes between frames warrants subdivision within the 16×16 macroblock to give four 8×8 macroblocks. Similar cost calculations are performed for each resulting 8×8 macroblock. It should be appreciated that two of the 8×8 macroblocks (upper left and lower right) are deemed to be homogenous enough and/or stationary enough to not warrant further division. However, the other two 8×8 macroblocks (those that contain the majority of the edges of the objects) have satisfied the criteria (cost calculation) for further division. As previously noted, the cost calculation is biased to favor division of objects.

### Encoding

### Video Encoding System and Method

Embodiments of the systems and methods described herein may include an encoding process (e.g., the encoding process 226 depicted in FIG. 2). As video viewing has proliferated on the World Wide Web, more and more websites require flexible encoding solutions. Videos often need to be encoded at multiple resolutions and multiple bitrates. In addition, many websites support multiple encoded formats. The websites obtain original source content in many video formats and often acquire their new content at random, unpredictable times. Thus, for example, on one day, a website may receive one hundred new videos to host and, on a different day, ten thousand. Video content often has timely relevance (e.g., strong incentives exist to make new content available quickly, often the same day, to potential viewers). Traditionally, video encoding has been performed by the content provider's owning a bank of encoders within its own facility. Since each encoder can process only a fixed amount of video content in a given day and given the timeliness factor, the content provider must provision its system for peak use. This necessitates the creation of a large bank of encoders that sit idle most of the time. Further, the creation of the bank of encoders requires a significant up-front capital expenditure, later amortized over long periods of usage.

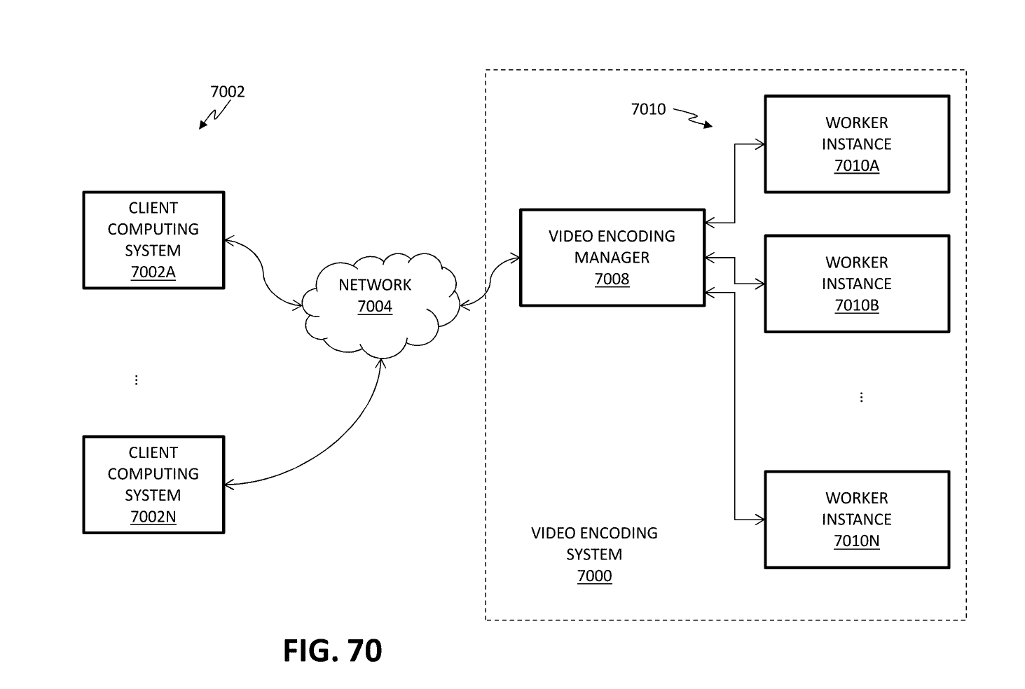

Referring to FIG. 70, a video encoding system 7000 is shown, in accordance with embodiments of the subject matter described herein. According to embodiments, the video encoding system 7000 may be, include, be similar to, or be included in the video processing platform 102 depicted in FIG. 1 and/or the video processing device 302 depicted in FIG. 3. According to embodiments, the video encoding system 7000 receives information from, and sends information to, a plurality of client computing systems 7002 through a network 7004. According to embodiments, the network 7004 may be, include, be similar to, or be included in the communication link 106 depicted in FIG. 1, the communication link 110 depicted in FIG. 1, and/or the communication link 310 depicted in FIG. 3. A client computing system 7002 may be or include one or more computing devices, one or more servers, and/or the like. In embodiments, the client computing systems 7002 may be, include, be similar to, or be included in the receiving device 108 depicted in FIG. 1 and/or the decoding device 308 depicted in FIG. 3.

Exemplary information that the video encoding system 7000 receives from a client computing system 7006A-N is a video file and information regarding a processing of the video file. In embodiments, the client computing system 7006A-N sends the video file to the video encoding system 7000 or instructs another computing system to send the video file to the video encoding system 7000. In embodiments, the client computing system 7006A-N provides video encoding system 7000 instructions on how to retrieve the video file.

Exemplary information that the video encoding system 7000 sends to the client computing system 7006A-N includes at least one processed video file, which is generated based on the video file and the information regarding processing of the video file. In embodiments, the video encoding system 7000 sends the processed video file to the client computing system 7006A-N or instructs another computing system to send the processed video file to the client computing system 7006A-N. In embodiments, the video encoding system 7000 sends the processed video file to a destination specified by the client computing system 7006A-N or instructs another computing system to send the processed video file to a destination specified by the client computing system 7006A-N. In embodiments, the video encoding system 7000 provides client computing system 7006A-N instructions on how to retrieve the processed video file.

In embodiments, the information regarding processing of the video file may include information related to the desired video encoding format. Exemplary information related to the format of the video file includes the video encoding format, a bit rate, a resolution, and/or other suitable information. Additional exemplary information regarding the processing of the video file may include key point positions and other metadata. In embodiments, the information relates to multiple encoding formats for the video file so that multiple processed video files are produced by video encoding system 7000.

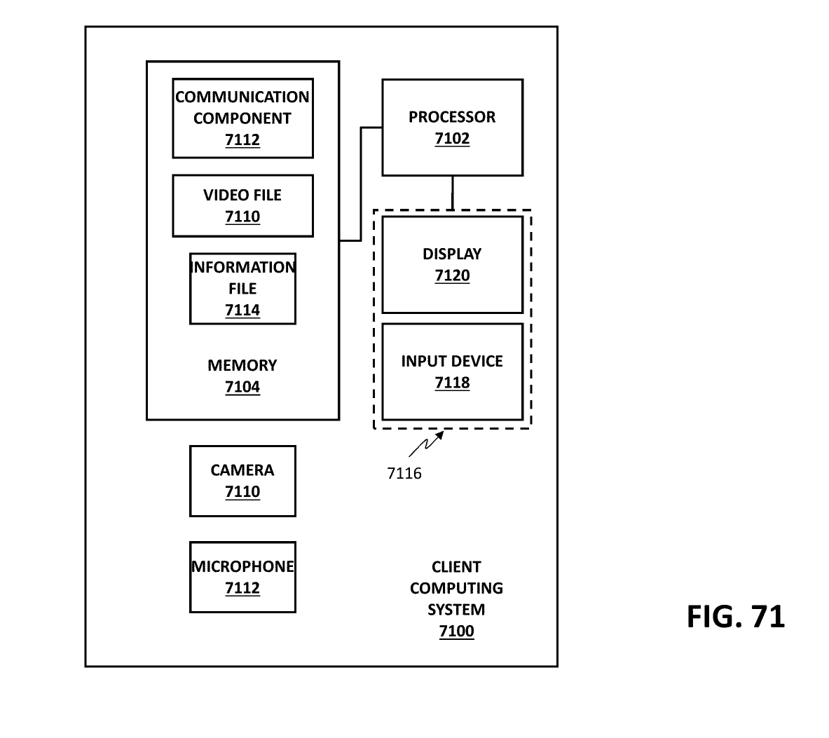

Referring to FIG. 71, an illustrative client computing system 7100 is represented, in accordance with embodiments of the subject matter disclosed herein. The illustrative client computing system 7100 may be implemented on a computing device that includes a processor 7102, a memory 7104, and input/output (I/O) devices 7106 and 7108. Although the client computing system 7100 is referred to herein in the singular, the client computing system 7100 may be implemented in multiple instances, distributed across multiple computing devices, instantiated within multiple virtual machines, and/or the like. In embodiments, the processor 7102 executes various program components stored in the memory 7104, which may facilitate encoding the video file 7110. In embodiments, the processor 7102 may be, or include, one processor or multiple processors. In embodiments, as shown, the I/O devices 7106 and 7108 may be a camera and a microphone, respectively. In embodiments, the I/O device 7106 and 7108 may be or include, any number of different types of devices such as, for example, a monitor, a keyboard, a printer, a disk drive, a universal serial bus (USB) port, a speaker, pointer device, a trackball, a button, a switch, a touch screen, and/or the like.

In embodiments, the memory 7104 stores computer-executable instructions for causing the processor 7102 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. An example of such a program component may include a communication component 7112. In embodiments, the information file 7114 includes the information regarding processing of the video file 7110. In embodiments, the information regarding processing of the video file 7110 is stored as part of the video file 7110.

In embodiments, the client computing system 7100 further includes a user interface 7116. The user interface 7116 includes one or more input devices 7118 and one or more output devices, illustratively a display 7120. Exemplary input devices include a keyboard, a mouse, a pointer device, a trackball, a button, a switch, a touch screen, and other suitable devices which allow an operator to provide input to the client computing system 7100. Exemplary output devices include a display, a touch screen, a printer, speakers, and other suitable devices which provide information to an operator of the client computing system 7100. In embodiments, as indicated above, the client computing system 7100 may include a video camera 7106 and associated microphone 7108. The video camera 7106 may be used to capture the video file 7110. In embodiments, the client computing system 7100 receives the video file 7110 from another computing device.

Returning to FIG. 70, the video encoding system 7000 includes a video encoding manager 7008 and a plurality of worker instances 7010A-N. In embodiments any one or more of the video encoding manager 7008 and the plurality of worker instances 7010A-N may be implemented on a separate computing device, on a computing device with another one or more of the video encoding manager 7008 and the plurality of worker instances 7010A-N, and/or the like. That is, for example, in embodiments, any one or more of the video encoding manager 7008 and the plurality of worker instances 7010A-N may be implemented as software, hardware, and/or firmware.

In embodiments, the number, N, of the worker instances 7010A-N is fixed, while, in other embodiments, the number, N, of worker instances 7010A-N is dynamic and provides a scalable, on-demand system. In embodiments, for example, the video encoding system 7000 is implemented in a cloud-computing platform. In embodiments, cloud computing refers to a networked server (or servers) configured to provide computing services. Computing resources in a cloud computing platform may include worker instances 7010A-N. An “instance” is an instantiation of a computing resource. In embodiments, a worker instance may include a particular CPU, a certain amount of memory and a certain amount of memory (e.g., hard-disk space). In embodiments, a worker instance may include an instantiated program component. That is, for example, a computing device may be configured to instantiate a number of different worker instances, each of which may be instantiated, for example, in a separate virtual machine. In embodiments, the instances may be launched and shut down programmatically and/or dynamically (e.g., in response to a request for computing resources).

### Optimized Scheduling

According to embodiments, any number of different types of algorithms may be utilized for scheduling encoding tasks among a number of different encoders (e.g., worker instances 7010 depicted in FIG. 70). According to embodiments, a video encoding manager may be configured to implement any number of different machine-learning algorithms, graph-based algorithms, and/or the like, and may be configured to utilize any number of different types of input to determine encoding schedules.

Embodiments of the systems and methods described herein include determining an encoding schedule by using an algorithm configured to minimize (or at least approximately minimize) a cost associated with encoding (e.g., an encoding cost). The encoding cost may be determined based on encoder load capacities, an estimated encoding load associated with a video file, requested encoding parameters (e.g., a requested target encoding format, bitrate, resolution, etc.), and/or other information. In embodiments, a video encoding manager (or any other component configured to determine encoding schedules) may include, as input to the scheduling decision algorithm, a state associated with each encoder. The state may represent the availability of an encoder. That is, for example, in embodiments, an encoder may, at any given time, have an associated state that is one of three potential states: fully available; partially available (e.g., storage available, but computing resources not available, or vice-versa); or fully unavailable.

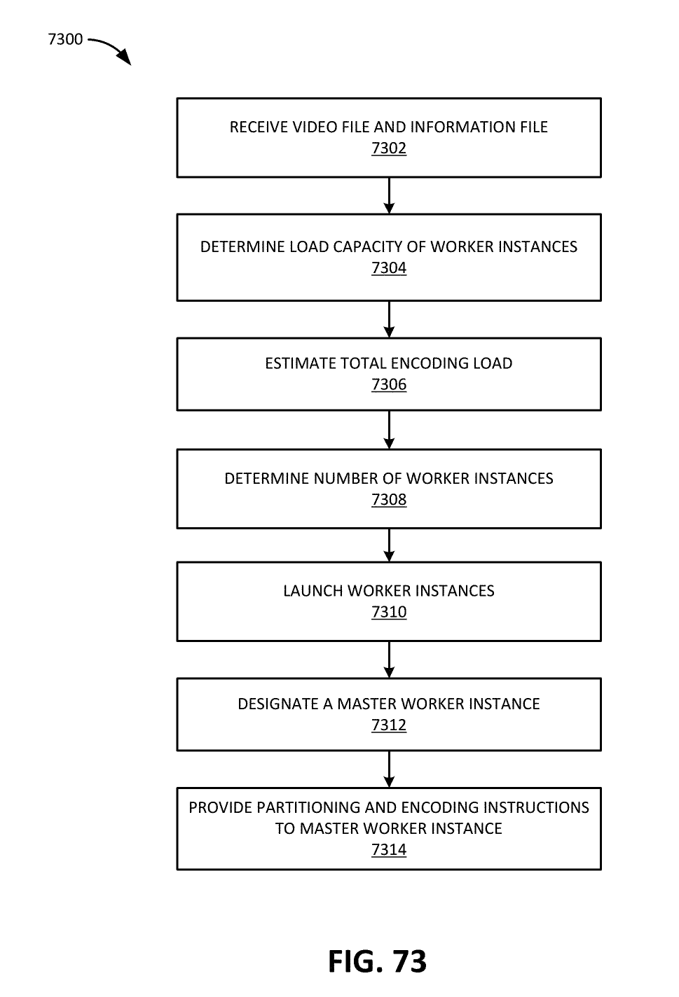

According to embodiments, the video encoding manager may be configured to use any number of different types of mathematical models to determine a cost associated with a potential encoding task, at least partially in view of the respective states of the various (at least potentially) available encoders. An encoder in the fully unavailable state, for example, may be associated with a higher cost than the costs associated with each of the other state options. Similarly, an encoder in the partially available state may be associated with a higher cost than the cost associated with an encoder in the fully available state, but a lower cost than the cost associated with an encoder in the fully unavailable state. In embodiments, the algorithm (e.g., the illustrative method 7300 depicted in FIG. 73) that the video encoding manager uses to determine encoding scheduling may be configured, e.g., using states, to account for the fact that fully unavailable encoders likely will take longer to instantiate, while partially available encoders will take less time to instantiate, but still more time than fully available encoders.

In embodiments, the video encoding manager may be configured to determine the state of an encoder by referencing a database, by querying the encoder (or a component that manages the encoder such as, for example, a master worker instance), and/or the like. In embodiments, the video encoding manager may be configured to determine an estimated time before an encoder in the fully unavailable state becomes partially available and/or fully available, before an encoder in the partially available state becomes fully available (or fully unavailable due to another scheduled encoding task), and/or before an encoder in the fully available state can be instantiated (or becomes partially and/or fully unavailable due to another scheduled encoding task). In this manner, a video encoding manager may be configured, for example, to optimize cost and achieve specified performance requirements (e.g., encoding speed, encoding task duration, encoded video quality, and/or the like). In embodiments, a video encoding manager may also be configured to take into account any number of other scheduled encoding tasks, reserved computing resources, and/or the like, in determining encoding schedules.

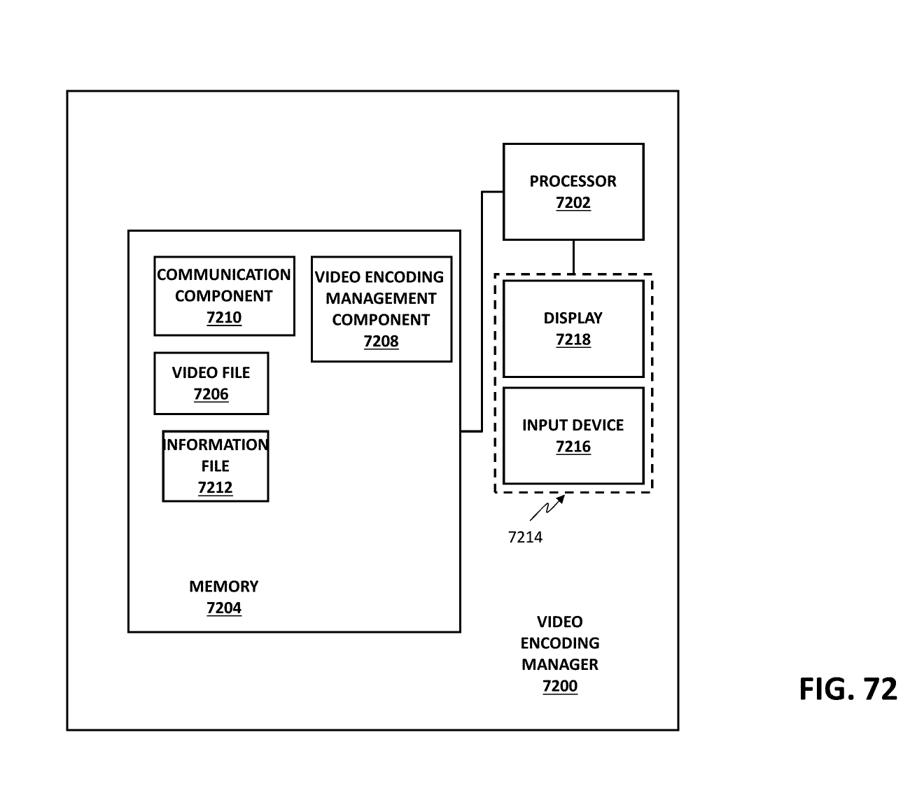

According to embodiments, referring to FIG. 72, an illustrative video encoding manager 7200 is represented, in accordance with embodiments of the subject matter disclosed herein. The illustrative video encoding manager 7200 may be implemented on a computing device that includes a processor 7202 and a memory 7204. Although the video encoding manager 7200 is referred to herein in the singular, the video encoding manager 7200 may be implemented in multiple instances, distributed across multiple computing devices, instantiated within multiple virtual machines, and/or the like. In embodiments, the processor 7202 executes various program components stored in the memory 7204, which may facilitate encoding the video file 7206. In embodiments, the processor 7202 may be, or include, one processor or multiple processors.

In embodiments, the memory 7204 stores computer-executable instructions for causing the processor 7202 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components may include a video encoding management component 7208 and a communication component 7210. In embodiments, the information file 7212 includes the information regarding processing of the video file 7206. In embodiments, the information regarding processing of the video file 7206 is stored as part of the video file 7206.

In embodiments, the video encoding manager 7200 further includes a user interface 7214. The user interface 7214 includes one or more input devices 7216 and one or more output devices, illustratively a display 7218. Exemplary input devices include a keyboard, a mouse, a pointer device, a trackball, a button, a switch, a touch screen, and other suitable devices which allow an operator to provide input to the video encoding manager 7200. Exemplary output devices include a display, a touch screen, a printer, speakers, and other suitable devices which provide information to an operator of the video encoding manager 7200.

According to embodiments, the video encoding management component 7208 may be configured to process the video file 7206, e.g., to facilitate an encoding process. In a cloud or other distributed computing environment, the processor 7202 may be configured to instantiate the video encoding management component 7208 to process the video file 7206. For example, the video encoding management component 7208 may be configured to determine a number of worker instances to use to encode the video file 7206. In embodiments, the video encoding management component 7208 may be configured to determine the number of worker instances to use to encode the video file 7206 based on the size of the video file 7206, requested processing parameters, and a load capacity of each of the worker instances (or an average, or otherwise estimated, load capacity associated with a number of worker instances). In embodiments, the video encoding management component 7208 is configured to assign a worker instance to function as a master worker instance.

Referring to FIG. 73, an exemplary method 7300 for processing a video file is depicted, in accordance with embodiments of the subject matter disclosed herein. Embodiments of the method 7300 may be performed by a video encoding manager (e.g., the video encoding manager 7000 depicted in FIG. 7000 and/or the video encoding manager 7200 depicted in FIG. 7200). According to embodiments of the method 7300, the video encoding manager 7200 receives the video file and the information file (block 7302).

As shown, the video encoding manager 7200 determines the load capacity of each of the worker instances (block 7304). In embodiments, each of the worker instances that can be instantiated may be similarly (or identically) configured, in which case the video encoding manager 7200 only needs to determine one load capacity. In embodiments, two of more of the worker instances may be differently configured. In embodiments, the video encoding manager 7200 may determine the load capacities of the worker instances by accessing the memory 7204, as the load capacities may be stored in the memory of the video encoding manager 7200. In embodiments, the video encoding manager 7200 may be configured to request load capacity information from another device (e.g., from a worker instance, from a website, and/or the like). In embodiments, the load capacity determination may additionally, or alternatively, be based on historical information available regarding the performance of one or more worker instances. According to embodiments, a load capacity of a worker instance refers to its ability to handle an encoding task, and may be calculated based on any number of different parameters such as, for example, the speed at which the worker instance encodes video data under a specified set of circumstances (e.g., to achieve a certain resolution); scheduling information associated with the worker instance (e.g., information regarding other tasks that the worker instance is scheduled to complete, an estimated (or programmed) length of time for completing scheduled tasks, etc.); and/or the like.

Embodiments of the method 7300 include estimating a total encoding load (block 7306). In embodiments, the video encoding manager 7200 may be configured to analyze the video file, the information file, the worker instance load capacities, and/or the like, to estimate the total encoding load. In embodiments, for example, the information file may include a requested target encoding format, the resolution of the target encoding format for the video file, a bit rate of the target encoding format, and/or the like.

According to embodiments, the total load, LOAD, may be determined using the following formula:

LOAD=(A)(T)[(H)(W)]ⁿ, (1)

where (A) is the requested frame rate of the target encoding; (T) is the duration of video file; (H) is the number of rows in the target encoding; (W) is the number of columns in the target encoding; and n is a variable that have a value that is determined based on the speed of each of the worker instances. In embodiments in which all of the worker instances are at least approximately identical in functionality, n may be determined based on the encoding speed of any one of the worker instances. In embodiments in which the worker instances include different capabilities and/or functionalities, n may represent an aggregated characteristic across the different worker instances. In embodiments, a separate calculation may be made for each type of worker instance, in which case a total load for the system may be determined by mathematically combining the multiple calculations. The variable, n, may include any number of different values (e.g., between approximately 0 and approximately 5). For example, in embodiments in which a worker instance includes the Lyrical Labs H.264 encoder available from Lyrical Labs, of New York, N.Y., the value of n may be between approximately 1.2 and approximately 2.5 (e.g., 1.5).

According to embodiments of the method 7300, the video encoding manager may be configured to determine the number of worker instances to use to encode the video file, based on the estimated total load and the worker instance load capacity (block 7308). In embodiments, for example, the number of worker instances to use may be determined based on equation (2):

$$NUM = CEILING [ \frac{LOAD}{SINGLE\_WORKER \_LOAD} ] , \qquad ( 2 )$$

where NUM is the number of worker instances to launch; LOAD is the estimated total encoding load associated with encoding the video file; SINGLE_WORKER_LOAD is the load capacity of an illustrative worker instance; and the CEILING function increases NUM to the smallest following integer. In embodiments, the SINGLE_WORKER_LOAD may be a single value representing an aggregate of multiple load capacities of multiple different worker instances, and/or the like. In embodiments, the SINGLE_WORKER_LOAD may be weighted based on the state, as explained above, associated with the corresponding worker instance. According to embodiments, any number of different techniques may be used to incorporate encoder state, and/or other information discussed herein, into embodiments of the method 7300 to enhance the decision-making process.

In contrast to embodiments of the algorithm described above, conventional encoding systems may be configured to analyze the complexity of the source video file, partition the video file based on the complexity analysis, and determine an encoding rate for each chunk based on the complexity analysis. In the conventional systems, encoding formats are then selected based on the determined encoding rates, rather than based on a desired encoding format that has been received by the system, as in embodiments of the systems and methods described herein. Additionally, embodiments include determining a number of computer resources (e.g., encoding instances) needed to produce a processed video file based on the video file duration, an estimated total encoding load, and a load capacity of each computer resource. Embodiments further include instructing the master computer resource (e.g., the master worker instance) to partition the video file into a number of partitions being equal to the number of computer resources, where each partition corresponds to a time interval of the video file. That is, for example, embodiments include receiving a requested frame rate and/or resolution, determining the estimated total load based on the requested frame rate and/or resolution, and then determining the number of partitions according to the load that was previously determined. In this manner, for example, embodiments facilitate distributing video encoding processes among a number of computer resources that are available, but that may not always be available (e.g., one or more of the computer resources may be available to a number of users for encoding video), by partitioning the video file into a number of partitions equal to the number of available computer resources, based on a calculated load of the video file and the load capacity of each resource.

Embodiments of the method 7300, the video encoding manager may be configured to launch (e.g., instantiate) the determined number of worker instances (block 7310). The video encoding manager may be further configured to designate one of the worker instances as a master worker instance to manage the processing of video file (block 7312). According to embodiments of the illustrative method 7300, the video encoding manager may be configured to provide partitioning instructions and/or encoding instructions to the master worker instance (block 7314). In embodiments, the video encoding manager may be configured to pass the video file to the master worker instance and/or to instruct (e.g., by providing computer-executable instructions to) the master worker instance to partition the video file into a number of partitions. In embodiments, the number of partitions is equal to the number of worker instances launched. In embodiments, for example, the master worker instance may partition the video file into time partitions of equal length. In embodiments, the master worker instance may also be configured to encode a partition of the video file.

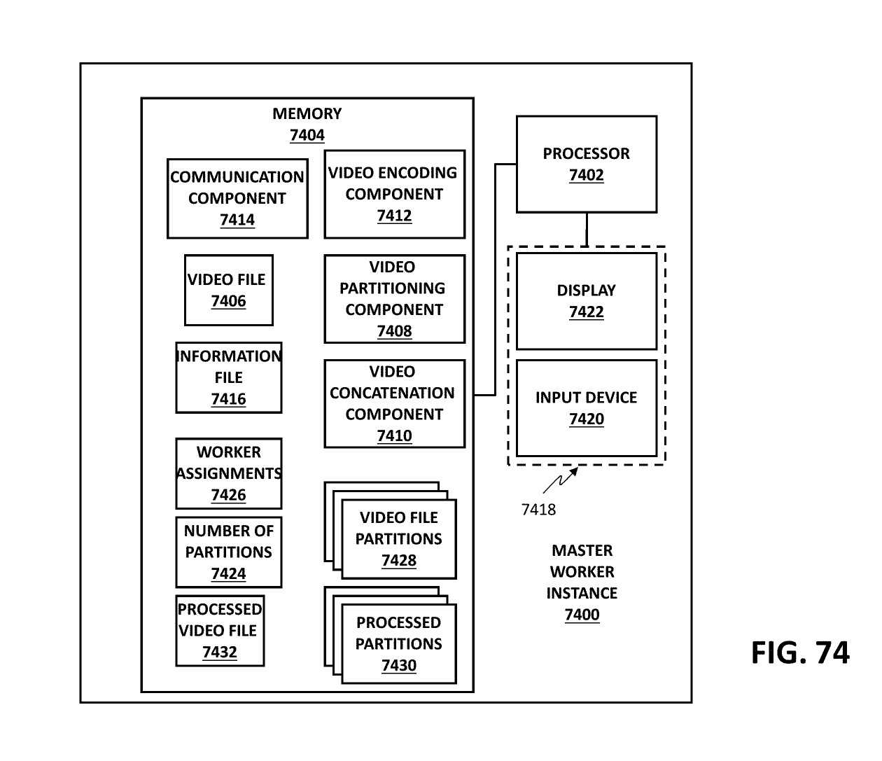

Referring to FIG. 74, an illustrative master worker instance 7400 is represented, in accordance with embodiments of the subject matter disclosed herein. The illustrative master worker instance 7400 may be implemented on a computing device that includes a processor 7402 and a memory 7404. In embodiments, the master worker instance 7400 may be, include, be similar to, or be included in a video encoding manager (e.g., the video encoding manager 7200 depicted in FIG. 72). Although the master worker instance 7400 is referred to herein in the singular, the master worker instance 7400 may be implemented in multiple instances, distributed across multiple computing devices, instantiated within multiple virtual machines, and/or the like. In embodiments, the processor 7402 executes various program components stored in the memory 7404, which may facilitate encoding a video file 7406. In embodiments, the processor 7402 may be, or include, one processor or multiple processors.

In embodiments, the memory 7404 stores computer-executable instructions for causing the processor 7402 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components may include a video partitioning component 7408, a video concatenation component 7410, a video encoding component 7412, and a communication component 7414. In embodiments, the information file 7416 includes the information regarding processing of the video file 7406. In embodiments, the information regarding processing of the video file 7406 is stored as part of the video file 7406.

In embodiments, the master worker instance 7400 further includes a user interface 7418. The user interface 7418 includes one or more input devices 7420 and one or more output devices, illustratively a display 7422. Exemplary input devices include a keyboard, a mouse, a pointer device, a trackball, a button, a switch, a touch screen, and other suitable devices which allow an operator to provide input to the master worker instance 7400. Exemplary output devices include a display, a touch screen, a printer, speakers, and other suitable devices which provide information to an operator of the master worker instance 7400.

According to embodiments, the memory 7404 further includes the determined number of partitions 7424 and a worker instance assignment index 7426. In embodiments, the video partitioning component 7408 partitions the video file 7406 into a plurality of partitions, each partition having a duration of a length that is approximately equal to the length of the duration of each of the other partitions. In embodiments, the video partitioning component 7408 is configured to generate separate video clips, each corresponding to one of the plurality of partitions. In embodiments, the video encoding manager determines the time windows for each partition (e.g., the start and stop times corresponding to each partition), and provides these time intervals to the video partitioning component 7408, which generates the separate video clips. In embodiments, the video partitioning component 7408 may be any type of video partitioning component such as, for example, Ffmpeg, available from FFmpeg.org, located online at http://www.ffmpeg.org. The video concatenation component 7410 concatenates video pieces into a video file. The video concatenation component 7410 can be any type of video concatenation component such as, for example, Flvbind, available from FLVSoft, located online at http://www.flvsoft.com.

The video encoding component 7412 may be configured to encode at least a portion of the video file 7406. In embodiments, the video encoding component 7412 may be configured to encode at least one partition of the video file 7406 to the targeted encoding format specified in the information file 7416. The video encoding component 7412 may be any type of video encoding component configured to encode video according to any number of different encoding standards (e.g., H.264, HEVC, AVC, VP9, etc.), such as, for example, the x264 encoder available from VideoLAN, located online at http://www.videolan.org.

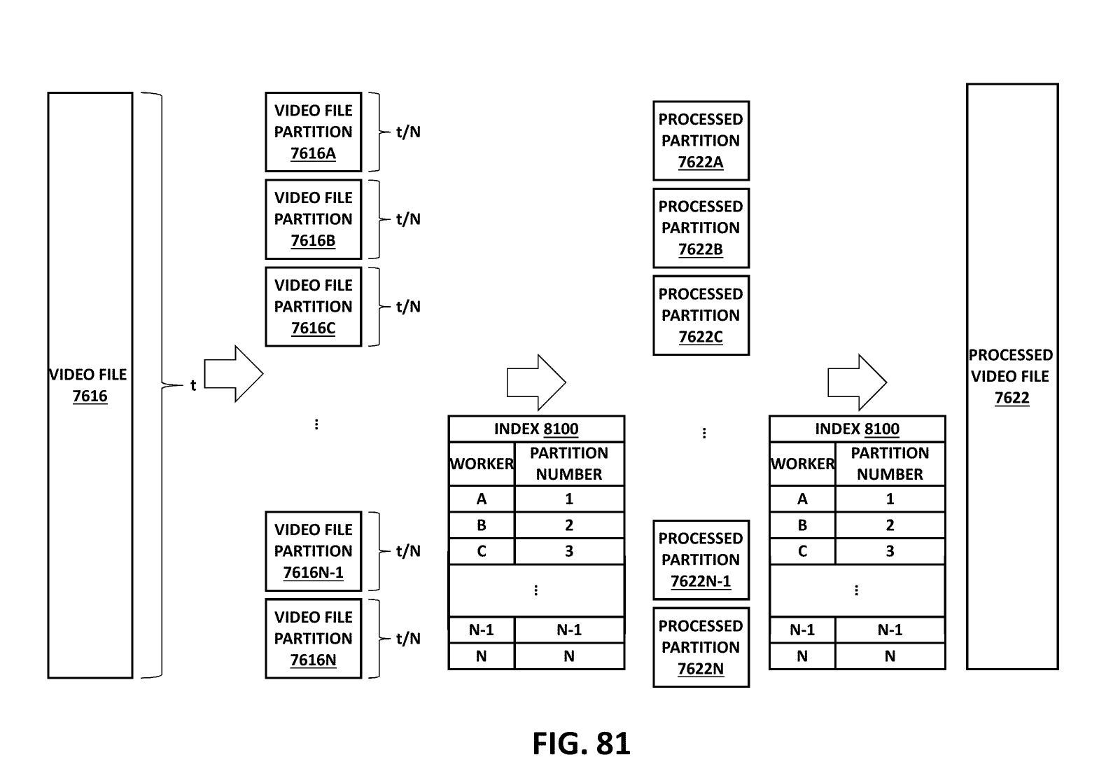

As indicated above, the number of partitions 7424 corresponds to the number of worker instances launched by a video encoding manager (e.g., the video encoding manager 7200 depicted in FIG. 72) to encode the video file 7406. In embodiments, the master worker instance 7400 is configured to partition the video file 7406 into partitions 7428, e.g., using the video partitioning component 7408. In embodiments, partitions 7428 may include video clips, each corresponding to a respective time interval. In those embodiments, the master worker instance 7400 may be configured to instruct the respective worker instance to retrieve the respective partition 7428 and to process the respective partition 7428 of the video file 7406. In embodiments, as shown, for example, in FIG. 81, the master worker instance 7400 may be configured to store an index 8100 of the partitions and the respective worker instances. In this manner, master worker instance 7400 may be configured to arrange the processed partitions 7430 received from the worker instances to generate the processed video file 7432.

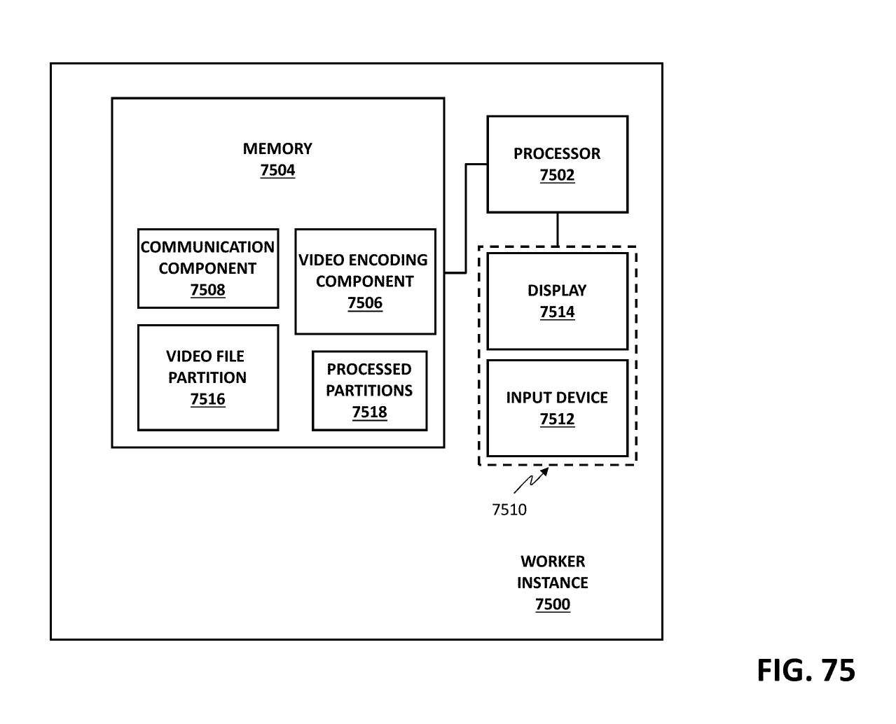

Referring to FIG. 75, an illustrative worker instance 7500 is represented, in accordance with embodiments of the subject matter disclosed herein. The illustrative worker instance 7500 may be implemented on a computing device that includes a processor 7502 and a memory 7504. In embodiments, the worker instance 7500 may be, include, be similar to, or be included in a video encoding manager (e.g., the video encoding manager 7200 depicted in FIG. BJ) and/or a master worker instance (e.g., the master worker instance 7400 depicted in FIG. 74). Although the worker instance 7500 is referred to herein in the singular, the worker instance 7500 may be implemented in multiple instances, distributed across multiple computing devices, instantiated within multiple virtual machines, and/or the like. In embodiments, the processor 7502 executes various program components stored in the memory 7504, which may facilitate encoding a video file. In embodiments, the processor 7502 may be, or include, one processor or multiple processors.

In embodiments, the memory 7504 stores computer-executable instructions for causing the processor 7502 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components may include a video encoding component 7506 and a communication component 7508. In embodiments, an information file includes the information regarding processing of the video file. In embodiments, the information regarding processing of the video file is stored as part of the video file.

In embodiments, the worker instance 7500 further includes a user interface 7510. The user interface 7510 includes one or more input devices 7512 and one or more output devices, illustratively a display 7514. Exemplary input devices include a keyboard, a mouse, a pointer device, a trackball, a button, a switch, a touch screen, and other suitable devices which allow an operator to provide input to the worker instance 7500. Exemplary output devices include a display, a touch screen, a printer, speakers, and other suitable devices which provide information to an operator of the worker instance 7500.

As shown, the worker instance 7500 further includes one or more partitions 7516 of a video file, which may be received from a master worker instance (e.g., the master worker instance 7400 depicted in FIG. 74) and stored on memory 7504. The memory 7504 further includes the video encoding component 7506. The video encoding component 7506 may be configured to encode assigned partitions 7516 of the video file to generate processed partitions 7518. In embodiments, the video encoding component 7506 may be, include, be similar to, or be included in, the video encoding component 7412 depicted in FIG. 74.

When the processed partitions 7518 are received by a master worker instance (e.g., the master worker instance 7400 depicted in FIG. 74), the master worker instance concatenates the processed partitions 7518 to produce a processed video file (e.g., the video file 7432 depicted in FIG. 74). The processed video file may be stored, indexed, communicated to a requesting client computer system, provided to another device, and/or the like.

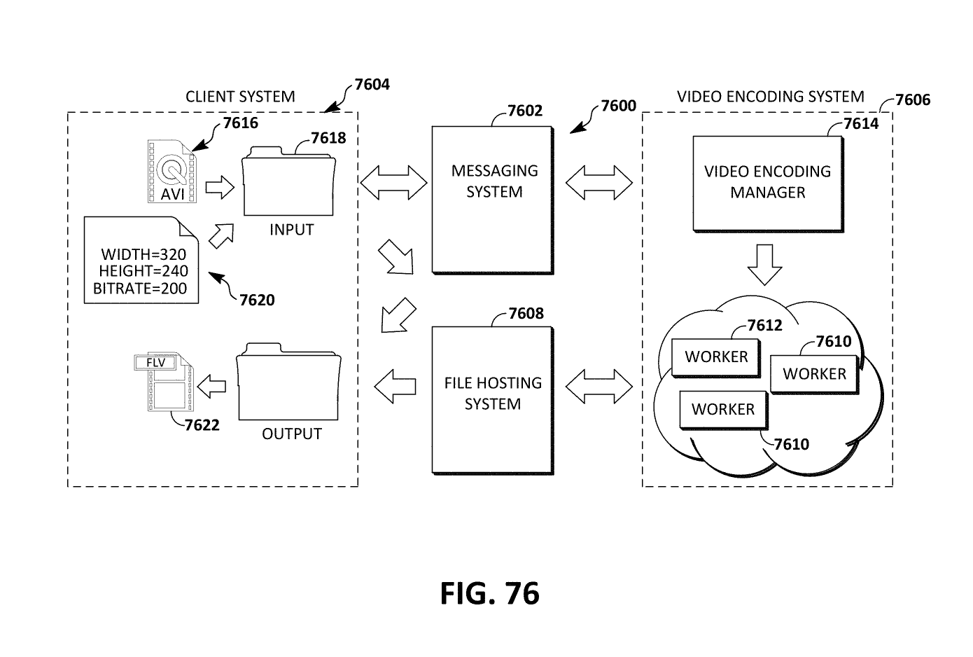

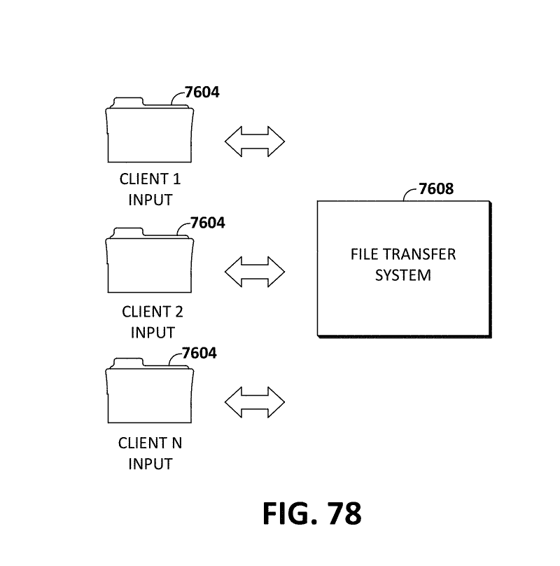

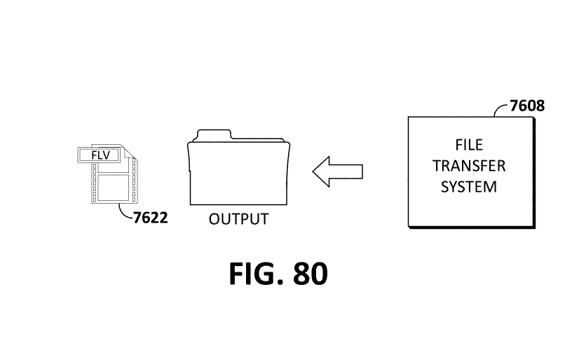

Referring to FIGS. 76-81, an illustrative implementation of a video encoding system 7600 is depicted, in accordance with embodiments of the subject matter disclosed herein. In the illustrated embodiment, an Amazon Elastic Compute Cloud (“Amazon EC2”) service available from Amazon Web Services located online at http://aws.amazon.com is used to provide the computing resources for the on-demand encoding system. The overall system 7600 for the illustrated embodiment is shown in FIG. 76.

A messaging system 7602 is also used for communication between client computing systems 7604 and video encoding system 7606. In the illustrated embodiment, Amazon's Simple Queuing Service (“Amazon SQS”) is used for messaging. A queuing system allows messages to be communicated between client computing system 7604 and the in-the-cloud computing system of video encoding system 7606. A file-hosting system 7608 to share files between instances, the worker instances 7610 and master worker instance 7612, and a video encoding manager 7614, are provided. In the illustrated embodiment, Amazon's S3 file system (“Amazon S3”) is used for file transfer.

The encoding process begins with the content host, hereinafter called the “publisher”, copying a video file 7616 into a specified directory 7618 on its own server, client computing system 7604. In addition to the video file 7616, the publisher provides an information file 7620 specifying the resolution and bitrate for the target encoding. Multiple target resolutions and bitrates may be specified within a single information file 7620.

Next, the files (both the video 7616 and the information files 7620) are transferred to the cloud-based file system by a local service, file-hosting system 7608, running on the publisher's server, client computing system 7604. In the illustrated embodiment, Amazon S3 is used.

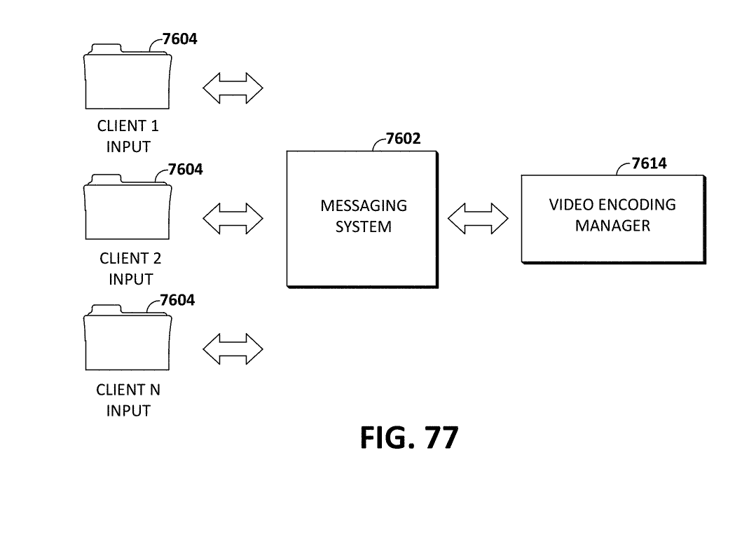

The publisher's local service, file-hosting system 7608, places a message on the message queue of messaging system 7602 that the specific file has been uploaded. In the illustrated embodiment, Amazon SQS is used. The Amazon SQS is a bi-directional, highly available service, accessible by many client computing systems 7604 simultaneously. The Clip Manager or video encoding manager 7214, which is a service running on a cloud-based instance, video encoding system 7606, accesses the queue and reads the specific messages regarding which file to encode. As shown in FIG. 77, the video encoding manager 7200 is able to communicate with multiple client computing system 7604 through messaging system 7602. The Amazon SQS based communication ensures the Clip Manager does not miss messages due to heavy computational loads, as the Clip Manager will simply access Amazon SQS when the Clip Manager has available resources. The video file 7616 and the associated information file 7620 reside on the file-hosting system 7608 ready to be accessed.

When the Clip Manager accesses a message on the message queue indicating that a new file is to be encoded, it accesses the video file 7616 and the information file 7620 from file-hosting system 7608 and determines the resources needed to complete the encoding. The Clip Manager may decide to use a single instance to process a video clip or it may split the job up among multiple instances. In the illustrated embodiment, a single instance is loaded with a fixed compute load (i.e., a video clip at a specific resolution for a particular length of time). Depending on resolution, a video file will be processed in pieces of fixed lengths. The length of the pieces is a function of the target resolution of the encoding. For example, a two hour video clip may be split up into two minute pieces and processed in parallel on 60 instances. However, a 90 second clip would likely be processed on a single instance. The instances are launched programmatically on demand. The cloud-based system only provisions the resources required, and instances that are not used are shut down programmatically.

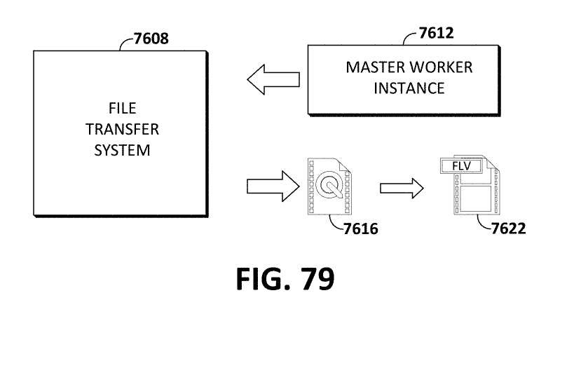

The instances that are launched to encode a given video clip are termed “worker” instances, such as worker instances 7610 and master worker instance 7612. A worker instance is given a pointer to the file in file-hosting system 7608, Amazon S3, along with the information about the target resolution, bitrate and portion of the file it must encode (e.g., the interval between the two minute and four minute marks of the clip). The worker accesses the video file 7616 from file-hosting system 7608, Amazon S3. Given the high availability of file-hosting system 7608, Amazon S3, many workers can access the same file simultaneously with relatively little degradation of performance due to congestion. The worker decodes its designated time interval to a canonical format. In the illustrated embodiment, the format is uncompressed .yuv files. Many programs in the public domain can decode a wide range of standard formats. The .yuv files are subsequently resized to the target resolution for encoding. An encoder then encodes the file to the target format. In embodiments, the Lyrical Labs H.264 encoder available from Lyrical Labs located at 405 Park Ave., New York, N.Y. 10022 encodes a .yuv files (Color Space Pixel Format) as input and outputs either .flv (Flash Video File) or .mp4 (MPEG Audio Stream) files or both. The encoder functions at the full range of commercially interesting resolutions and bitrates. The resultant encoded file is placed back into the Amazon S3 queue as illustrated in FIG. 79. Another exemplary video encoder is x264 available from VideoLAN located online at http://www.videolan.org.

If the encoding process was split into multiple parts or partitions 7616A-N (as shown, e.g., in FIG. 81), a single worker, master worker instance 7612, will collect the processed partitions 7622A-N from S3 and concatenate them into a single encoded file, processed video file 7622. Many programs in the public domain can do this bitstream concatenation. In the specific embodiment, FLVBind was used.

Once the encoded file is placed in Amazon S3, the worker, master worker instance 7612, notifies the Clip Manager, video encoding manager 7614, that the job is complete. The Clip Manager, video encoding manager 7614, assigns a new job to the free worker or terminates the instance if no further jobs exist.

The Clip Manager, video encoding manager 7614, then places both a message on the message queue of messaging system 7602 that a particular encoding job has been complete and a pointer to the encoded file on file-hosting system 7608, Amazon S3. The local service running on the publisher's server will access the message queue and download the encoded file, processed video file 7622. Multiple encoded files can result from a single input file. This process is illustrated in FIG. 81.

In the illustrated embodiment, the publisher does not need to provision a large encoder farm targeted to peak use. The cloud-based system scales to the customer's demands, and the customer's cost is only related to that of the actual compute resources used. There are substantially no up-front costs, so the publisher's costs scale with their business, providing a strong economic advantage.

### Encoding Processes

Whether video data is encoded using a cloud-computing environment, a stand-alone encoding device, a software encoder, or the like, embodiments of the systems and methods described herein may facilitate more efficient and effective encoding by leveraging aspects of the rich metadata generated during aspects of embodiments of video processing processes described herein (e.g., the video processing process 200 depicted in FIG. 2). For example, embodiments of encoding processes described herein (e.g., the encoding process 226 depicted in FIG. 2) may be configured to leverage metadata such as, for example, segmentation information, foreground and/or background information, motion information, object information, object group information, feature information, emblem information, and/or the like, to facilitate encoding that, in embodiments, may be 30-50% more efficient than conventional encoders. In embodiments, this functionality may be achieved without a need for replacing hardware. For example, embodiments include video processing platforms implemented as modified open source encoders.

According to embodiments, metadata such as that described above may be used to facilitate more intelligent macroblock partitioning decisions that may be implemented using machine-learning techniques. In this manner, embodiments of video processing platforms, including, for example, encoders, may be configured to get more efficient over time.

Embodiments of encoding processes described herein may include adaptive quantization techniques, which may be implemented, for example, as part of any number of embodiments of the processes described herein (e.g., the adaptive quantization process 224 depicted in FIG. 2). In conventional systems, quantization is typically performed based on saliency and/or flow. Embodiments of the systems and methods described herein perform adaptive quantization based on objects. In embodiments, for example, quantization may be based on whether a particular pixel or set of pixels is associated with an identified object (e.g., via the object group analysis process 212 and/or the object classification process 218 depicted in FIG. 2). By leveraging segmentation information generated during embodiments of a segmentation process as described herein (e.g., the segmentation process 202 depicted in FIG. 2), object group analysis and classification processes may be enhanced, leading to more accurate object identification and tracking. As a result, embodiments of the systems and methods described herein may facilitate more accurate quantization, thereby reducing noise. For example, the inventors have found, through experimentation, that embodiments of the video processing system described herein can be used to visibly improve the quality of older, black and white, video. According to various embodiments, object-based quantization may be used in conjunction with saliency, flow, and/or any number of other quantization and/or processing techniques.

According to embodiments, metadata (e.g., object information, segmentation information, etc.) may be leveraged to dynamically configure group-of-picture (GOP) structure during encoding. In embodiments, methods of dynamically configuring GOP structure may include specifying a maximum I-frame interval, and selecting I-frame positions in locations (sequential positions within the GOP structure) calculated to result in increased quality. In embodiments, for example, I-frame positions may be selected to maximize (or optimize) video quality (e.g., as measured by a quality metric). In embodiments, the I-frame positions may be selected based on object information. Similarly, P- and/or B-frame positions may be selected based on object information to maximize or optimize quality. In embodiments, a conventional dynamic GOP structure configuring algorithm may be modified to be biased toward favoring certain structures based on various metadata.

For example, in embodiments, I-frames may be favored for placement in locations associated with the appearance or disappearance of an object or objects. In embodiments, P- and B-frames may be favored for placement in locations associated with other material changes that are less significant than the appearance and/or disappearance of an object. For example, P frames might be placed just before a sudden movement of an object within a scene occurs. Embodiments include utilizing machine-learning techniques that may be configured to enhance the GOP structure configuration process. For example, in embodiments, objects and their movements may be treated as feature inputs to a classifier that learns to make GOP structure configuration decisions that improve the video quality and encoding efficiency over time.

Additionally, or alternatively, embodiments may include optimizing encoding of multiple versions of a video file. In conventional video content delivery systems, a content source may maintain multiple encoded renditions of a video file to facilitate rapid access to a rendition encoded at a resolution and/or bitrate that is appropriate for a particular transmission. In embodiments, for example, a video file may be encoded in as many as 8 or 10 (or more) different ways (e.g., 1920×780 at 4 mbps, 1280×720 at 3 mbps, 620×480 at 1.5 mbps, etc.), in which each encoding run is performed independently, and includes a full motion estimation process independent of the others. This conventional practice often is computationally burdensome.

In contrast, embodiments of the systems and methods described herein may be configured to encode a first rendition of the video file, and then leverage motion information generated during a motion estimation process associated with the first encoding run to facilitate more efficient motion estimation in each subsequent encoding run (e.g., by seeding motion vector searches, etc.). In embodiments, the highest mode encoding run is performed fully, as it generates the most information. Each subsequent motion estimation process may be performed, in embodiments, by refining the motion information from the first run. That is, for example, during a second encoding run, the encoder may be configured to adjust the motion information generated during a first encoding run for differences in the bitrate and/or resolution, thereby reducing the computational burden of generating multiple renditions of a video file.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. (canceled)

2. A system for estimating motion vectors of multi-view video data, the system comprising:
memory configured to store a plurality of video feeds of a scene, the plurality of video feeds being recorded by cameras from respective viewpoints and each video feed being comprised of segmented video frames; and
a processor configured to:
receive the plurality of video feeds;
receive one or more motion vectors of a first segmented video frame of a first video feed;
extrapolate one or more motion vectors of a second segmented video frame of a second video feed based on the received one or more computed motion vectors; and
encode the extrapolated motion vectors.

3. The system of claim 2, wherein the processor is configured to extrapolate the one or more motion vectors of the second segmented video frame based on relative positions and angles of the cameras used to record the plurality of video feeds.

4. The system of claim 3, wherein the processor is configured to determine the relative positions and angles of the cameras.

5. The system of claim 4, wherein the processor is configured to determine the relative positions and angles of the cameras based on each camera's field of view.

6. The system of claim 3, wherein the processor is configured to:
determine pixel depths for pixels of the second segmented video frame based on the relative positions and angles of the cameras; and
extrapolate the one or more motion vectors of the second segmented video frame based on the determined pixel depths.

7. The system of claim 2, wherein the processor is configured to perform a local search to determine an accuracy of the extrapolated one or more motion vectors of the second segmented video frame.

8. The system of claim 2, wherein the processor is configured to:
estimate one or more motion vectors of the second segmented video frame based on at least one of: optical pixel flow and feature tracking;
compare the estimated one or more motion vectors of the second segmented video frame and the extrapolated one or more motion vectors of the second segmented video frame; and
determine an error of the extrapolated one or more motion vectors of the second segmented video frame based on the comparison.

9. The system of claim 3, wherein the processor is configured to:
identify objects of the first segmented video feed; and
transform the identified objects from the first segmented video feed to the second segmented video feed based on the relative positions and angles of the cameras.

10. A method for estimating motion vectors of multi-view video data, the method comprising:
receiving a plurality of video feeds of a scene, the plurality of video feeds being recorded by cameras from respective viewpoints and each video feed being comprised of segmented video frames;
receiving one or more motion vectors of a first segmented video frame of a first video feed;
extrapolating one or more motion vectors of a second segmented video frame of a second video feed based on the received one or more computed motion vectors; and
encoding the extrapolated motion vectors.

11. The method of claim 10, further comprising extrapolating the one or more motion vectors of the second segmented video frame based on relative positions and angles of the cameras used to record the plurality of video feeds.

12. The method of claim 11, further comprising determining the relative positions and angles of the cameras.

13. The method of claim 12, further comprising determining the relative positions and angles of the cameras based on each camera's field of view.

14. The method of claim 11, further comprising:
determining pixel depths for pixels of the second segmented video frame based on the relative positions and angles of the cameras; and
extrapolating the one or more motion vectors of the second segmented video frame based on the determined pixel depths.

15. The method of claim 10, further comprising performing a local search to determine an accuracy of the extrapolated one or more motion vectors of the second segmented video frame.

16. The method of claim 10, further comprising:
estimating one or more motion vectors of the second segmented video frame based on at least one of: optical pixel flow and feature tracking;
comparing the estimated one or more motion vectors of the second segmented video frame and the extrapolated one or more motion vectors of the second segmented video frame; and
determining an error of the extrapolated one or more motion vectors of the second segmented video frame based on the comparison.

17. The method of claim 11, further comprising:
identifying objects of the first segmented video feed; and
transforming the identified objects from the first segmented video feed to the second segmented video feed based on the relative positions and angles of the cameras.

18. One or more computer-readable media having embodied thereon executable instructions that, when executed by a processor, cause the processor to:
determine one or more motion vectors of a first segmented video frame of a first video feed;
extrapolate one or more motion vectors of a second segmented video frame of a second video feed based on the received one or more computed motion vectors;
encode the extrapolated motion vectors; and
transmit the encoded extrapolated motion vectors.

19. The media of claim 18, wherein the executable instructions further cause the processor to:
identify objects of the first segmented video feed; and
transform the identified objects from the first segmented video feed to the second segmented video feed based on the relative positions and angles of the cameras.

20. The media of claim 18, wherein the executable instructions further cause the processor to:
segment the video frame of the first video feed; and
segment the video frame of the second video feed.

21. The media of claim 18, wherein the executable instructions further cause the processor to determine an accuracy of the extrapolated one or more motion vectors of the second segmented video frame.
